(19) United States
(12) Patent Application Publication
(10) Pub. No.: US 2015/0221161 A1
(43) Pub. Date: Aug. 6, 2015

(54) SYSTEM FOR OPERATING A LOTTERY

(71) Applicant: LMS PATENTS (ISLE OF MAN) LIMITED, Isle of Man (GB)

(72) Inventors: John Anthony Reid, Auckland (NZ); James William Piper, Auckland (NZ)

(21) Appl. No.: 14/421,444

(22) PCT Filed: Aug. 9, 2013
(86) PCT No.: PCT/IB2013/056506

§ 371 Date: Feb. 13, 2015

(30) Foreign Application Priority Data
Aug. 15, 2012 (NZ) 601824
Sep. 20, 2012 (NZ) 602537
Oct. 17, 2012 (NZ) 603063
Nov. 16, 2012 (NZ) 603674
Apr. 10, 2013 (NZ) 609252

(51) Int. Cl. G07F 17/32

(52) U.S. Cl. CPC G07F 17/329; G07F 17/3211

(57) ABSTRACT

A computerised game involving the recordal of entries consisting of a selection of symbols. The result of the game is determined by ranking the symbols based on the number of times participants select each symbol. The result of the game is determined by comparing the entries of all or at least some of the participants in the game against the ranking of the symbols. Typically the winner is the participant who holds the entry having symbols thereon which are the least picked in or on entries. Typically a number of symbols are picked from an available range of numbers; say 6 symbols are picked from 20 available symbols. The odds of picking 6 symbols from 20 available symbols in order are 1 in 27,907,200 nevertheless methods are described to guarantee a winner of the lottery, and that a sole or single winner can be ‘virtually’ guaranteed.

### FIELD

This invention relates to a gaming system enabling a large number of players to participate, and in particular lends itself to a gaming event in which participants can enter in a large number of ways such as by means of the telephone, mobile communication device, or over the internet directly or by email.

### BACKGROUND

Gaming events are basically of three types. The first is where participants pay to enter and can receive a prize (usually cash or cash equivalent), the second is where participants can play without paying to enter, and may not receive prizes, and the third are promotional systems where eligibility to enter is associated with the purchase or receipt of goods or services.

Lotteries are defined to include any scheme for the distribution of prizes by chance. Most games of chance involving large numbers of participants are lotteries based on (a) sweepstakes, in which customers purchase lottery tickets, or (b) variants of LOTTO or KENO, in which participants either purchase a pre-allocated set of numbers allocated from a larger group of numbers, or purchase a group of numbers chosen by them from a larger group of numbers, in each case purchasing a ticket at a retail outlet, or by mobile device, or over the internet by email. In some cases such purchases are conducted by mail. In all cases the organiser of the lottery will then select the set of winning numbers, from the same larger group of numbers, in some form of random draw, which is often televised. The participant/s that can match some or all of their numbers with those randomly drawn by the organiser of the lottery win prizes.

U.S. Pat. No. 7,100,822 addressed problems relating to some of these gaming systems.

One disadvantage of these gaming systems that U.S. Pat. No. 7,100,822 addressed was in respect of participants needing to go to the retail outlet to purchase the entrance ticket. Another disadvantage addressed was in respect of customers being required to retain their tickets, in order to redeem prizes if they believe they had won. LOTTO allows customers to select different numbers but suffers from the disadvantage that the prize pool may be shared between a number of participants—it is the nature of LOTTO that it cannot guarantee a single division one winner. U.S. Pat. No. 7,100,822 addressed this problem and provided a method to guarantee a single winner. Another matter addressed by U.S. Pat. No. 7,100,822 related to the need to ensure that the selection of the winning tickets/numbers is truly random and is not subject to interference or fraud by any party.

While these problems were addressed in U.S. Pat. No. 7,100,822, there remains the disadvantage that it is difficult to predict the date and time that a gaming system as described in U.S. Pat. No. 7,100,822 will end. Accordingly the gaming systems and/or lotteries run using the methods described in U.S. Pat. No. 7,100,822 cannot easily be run on a regular basis, which causes difficulties if it is desired to run draws to a set finishing time, for example, set finishing times for television programming or use of other media.

Existing lotteries and similar constructs such as promotional systems also have disadvantages in that it is not always possible to provide numerous entry methods, including the desirable attribute of remote entry.

It is also desirable to provide a low cost of entry and convenience for the participants along with an easy method to notify winners.

Integrity of the winning result is an important consideration to minimise the possibility of fraud or scams.

It is also desirable to make provision for the involvement of an independent auditing party.

Further, desirable attributes would be to provide a system where all entries of all participants can be ranked or given a placement amongst all entries within the game and to allow all places in a gaming event such as a lottery to be identified.

The ability to substantially always guarantee a sole winner for the first prize, or in the alternative, in a relatively few occasions, a small group of winners for the first prize, irrespective of the participants' choices on entry, is also desirable.

Many other gaming operators, such as a LOTTO operator, are faced with the practical problem that when increasing the odds against there being tied winners of the first prize, they increase the odds against there being a first prize winner at all. For example, in a game of LOTTO if the odds are set at 30 times the expected number of participants (entries), practically that LOTTO Operator's player base won't have a winner of the first prize, the odds are stacked against there being any first prize winner from that LOTTO game, and their players will come to the belief that they can't win, and will eventually become disillusioned with that LOTTO game and ‘leave’. But on the other hand, if the odds against winning are set too low for the number of participants in that LOTTO game, then too many tied winners will result and the benefits of having a single winner being the sole winner of the first prize in the first division of such a LOTTO game are lost, as the first prize will need to be shared amongst two or more winners of first division.

It would also be desirable for the gaming event to be capable of a number of different methods of presenting the results of the game to participants, particularly in a simplified manner.

With the growth of modern communications it would also be desirable to provide a gaming event which is able to be targeted to selected groups, such as geographical groups of participants, and which is flexible in operation.

### OBJECT

It is an object of this invention to provide a novel gaming system, which will obviate or minimise the foregoing disadvantages or go at least some distance towards meeting the foregoing desirable attributes or at least some of them in a simple yet effective manner or one which will at least provide the public with a useful choice.

### STATEMENTS OF THE INVENTION

Accordingly in one aspect the invention provides a game wherein entries must select at least one of a range of symbols, the result of the game being determined by the number of times participants select each symbol.

In a further aspect the invention provides a gaming system including display means to display a range of symbols to participants who wish to submit entries in the game provided by the gaming system, selection means to enable participants to select one or more of the range of symbols available to be included in or on an entry, and ranking means to rank the number of times each symbol is selected in or on the entries, the result of the game being determined by the number of times each available symbol is selected in or on the entries and compared with the symbol or symbols carried on each entry.

In a further aspect the invention provides a method of conducting a gaming system in which participants are invited to select one or more symbols from a defined available range of available symbols to include in or on an entry, for example between one and n, having at least one computer system for recording the selection of symbols made by each of the participants, including how many times each available symbol was selected in or on each entry in the game, then ranking the symbols in the range of available symbols, and using the resulting rankings to eliminate entries and determine one or more winners, for example by reference to each entry's selection of their one or more symbols from the available symbol range relative to how the selected symbols on each entry compare with the selections on other entries, and compared against the ranking order of the symbols in the available symbol range.

Preferably the symbols are ranked based on how many times each of the symbols in the available symbol range were selected in or on entries.

Preferably entries are eliminated and a winner or winners are determined by reference to each entry's selection of their one or more symbols from the available symbol range relative to how their selected symbols compared with the selections in or on other entries, and compared against the ranking order of the symbols in the available symbol range.

In a still further aspect, the invention provides a method of conducting a gaming system in which participants are invited to select one or more symbols from a defined available range of symbols, for example between one and n, having at least one computer system for recording the symbol selections made in or on each of the entries, including how many times each symbol in the available symbol range was selected in or on each of the entries in the game to provide a selection total, then uniquely ranking each of the symbols in the available symbol range, for example ranking the symbols based on the selection total relevant to each symbol in the available symbol range, and, in circumstances where two or more of the symbols in the available symbol range are tied with the same selection total number, eliminating or resolving ties by ranking those tied symbols utilizing the results from the choices of available symbols in the gaming system in order that each of the symbols in the available symbol range of one to n has its own unique ranking number or placement value.

Preferably the tied symbols are ranked by firstly determining whether or not the selection total number is an ‘odd number’ or an ‘even number’ and secondly, using that ‘odd’ or ‘even’ determination to rank any tied symbols by ordering the tied symbols in accordance with whether the selection total number is ‘odd’ or ‘even’.

Preferably a selection total number that is an ‘odd number’ would result in the tied symbols that are numbers or that can be identified by reference to a number being ordered with the highest face value number being placed first, and a selection total number that is an ‘even number’ would result in the tied symbols that are numbers or that can be identified by reference to a number being ordered with the lowest face value number being placed first.

Alternatively a selection total number that is an ‘even number’ would result in the tied symbols that are numbers or that can be identified by reference to a number being ordered with the highest face value number being placed first, and a selection total number that is an ‘odd number’ would result in the tied symbols that are numbers or that can be identified by reference to a number being ordered with the lowest face value number being placed first.

In a still further aspect, the invention provides a computerised gaming system, such as a lottery or promotional system having at least one computer system for recording entries and determining one or more winners, in which participants are invited to select at least one symbol from a defined available range of n symbols, and to register that selection with the computer, the computer being capable of recording at least the symbol or symbols selected in or on each entry submitted by the participants, including how many times each symbol in the available symbol range was selected in or on the entries in the game to provide a ranking list of the number of times each symbol was selected, and optionally recording the identity or contact details of participants submitting entries, and wherein the game has at least two phases, the first phase running until a defined time has expired whereupon at least one of the symbols is selected, the selection being made by selecting one or more of the symbols in the ranking list, the selection of that symbol or those symbols being based on a pre-determined selection criteria utilising the rankings of the symbols in the ranking list, to provide a number of entries, at least some of which have selected the symbol or one of the symbols selected, and moving the selected entries to a second phase of the game which second phase comprises an elimination process to determine one or more winners from the entries in the second phase, the winner or winners being the final entry or entries at the end of the elimination process.

Preferably the selected symbol from the ranking list is the symbol that is ranked as the least or most selected in or on entries in the game.

In a still further aspect, the invention provides a method of conducting a gaming system in which participants are invited to select at least one symbol from a defined available range of symbols, for example between one and n, to register their selection with a computer system, the computer system being capable of recording at least the symbol or symbols selected in or on each entry, including how many times each symbol in the available symbol range was selected in or on the entries in the game to provide a ranking list of the number of times each symbol was selected in or on the entries, and optionally the identity or contact details of the participant and the date and time and place of the entry, and wherein the game has two phases, the first phase running until a defined time has expired whereupon a selected number of entries, at least some of whom have the symbol or symbols least, or alternatively, most selected move to a second phase of the game which comprises an elimination process to determine one or more winners from the entries in the second phase, the winner or winners being the final entry or entries at the end of the elimination process.

In a still further aspect the invention provides a computerised gaming system having at least one computer system for recording entries and determining one or more winners, in which the game is conducted in at least two phases, in the first phase of which the number of entries are reduced to substantially a selected number and in the second phase of which a winner or winners are found.

In a still further aspect, the invention provides a computerised gaming system, such as a lottery or promotional system having at least one computer system for recording entries and determining one or more winners, in which participants are invited to select two or more symbols from a defined range of symbols, for example between one and n, to register their selection with a computer system, the computer system being capable of recording at least the symbols selected in or on the entries, including how many times each symbol in the defined range of symbols was selected in or on the entries in the game to provide a ranking list of the number of times each symbol was selected in or on entries, and optionally the identity or contact details of the participant and the date and time and place of the entry, and wherein the game has a single phase, the single phase running until a defined time has expired whereupon a winning sole entry or entries is or are selected, at least some of whom have a symbol or symbols least, or alternatively, most selected by reference firstly to an entry's choice of symbol which is least or alternatively, most picked in or on all the entries, then that entry's next symbol which has been selected by the next least or alternatively, most in or on the entries, and continuing the process, until the elimination process is completed and the winning entry or entries are selected, or in the event that a winning entry is not determined after the completion of the before described elimination phases, then preferably the elimination process continues by reference to parameters set around the remaining entries symbol choices, to achieve the desired eliminations.

In a still further aspect, the invention provides a method of conducting a gaming system, in which participants are invited to select two or more symbols from a defined available range of symbols, for example between one and n, to register their selection with a computer system, the computer system being capable of recording at least the symbols selected by the participant, including how many times each symbol in the available symbol range was selected by each of the participants in the game to provide a ranking list of the number of times each symbol was selected in or on the entries, and optionally the identity or contact details of the participant and the date and time and place of the entry, and wherein the game has a single phase the single phase running until a defined time has expired whereupon a winning sole entry or entries is or are selected, at least some of whom have the symbol or symbols least, or alternatively, most selected by reference firstly to an entry's choice of symbol which is least, or alternatively, most picked in or on all the entries, then that entry's next symbol which has been selected in or on the next least, or alternatively, most entries, and continuing the process, until the elimination process is completed and the winning entry or entries are selected, or in the event that a winning entry is not determined after the completion of the before described elimination phases, then preferably the elimination process continues by reference to parameters set around the remaining participants number choices, to achieve the desired eliminations. In still a further aspect the invention provides a computerised gaming system, such as a lottery or promotional system having at least one computer system for recording entries and determining one or more winners, in which participants are invited to select one or more symbols from a defined available range of symbols, for example between one and n, having at least one computer system for recording the symbol selections made in or on each of the entries, and recording a ranking value based on their order from a random draw of all the symbols in the defined range between one and n for each of the symbols in the available symbol range, and using the resulting rankings of each symbol to eliminate entries and determine one or more winners.

Preferably the resulting rankings are used by reference to each entry's selection of their one or more symbols from the available symbol range relative to how their selected symbols compared with the selections in or on other entries and compared against the ranking order of the symbols in the available symbol range.

In a still further aspect the invention provides a method of conducting a gaming system, in which participants are invited to select one or more symbols from an available range of symbols, for example between one and n, having at least one computer system for recording the symbol selections made in or on each entry, and recording a ranking value or a placement value for each of the symbols in the defined symbol range, for example ranking the symbols based on their order from a random draw of all the symbols in the defined range between one and n, and using the resulting rankings of each symbol to eliminate entries and determine one or more winners.

Preferably the resulting rankings are used by reference to each participant's selection of their one or more symbols from the available symbol range relative to how their selected symbols compared with the selections in or on other entries and compared against the ranking order of the symbols in the available symbol range.

Preferably, in a two phase game, when the elimination process is commenced in the second phase, the elimination process continues until only one winner remains.

Preferably the computer system includes: one or more transaction engines (i.e. for entry logging and storage of the raw data during the time the game is open to receiving entries); and a gaming engine, which receives the raw data from the transaction engine(s) after entry into the game is closed, and which then processes raw data using gaming software to determine the results of the game, including the winner/s.

More preferably the transaction engine includes at least one database with each record having fields containing (a) customer information, typically a telephone number or credit card number or email address and/or place of purchase (b) the number or numbers chosen by the customer, and (c) a receipt number or PIN disclosed to the customer as proof of that entry.

More preferably the gaming engine's function results in n records with at least two fields per record:
a first field containing a set of symbols within the available range of n symbols (so that the records can be sequential through the entire range of n symbols for that competition); and
a second numerical field capable of recording a placement value or ranking value for each n symbol, for example by recording a placement value for each n symbol if randomly drawn through the full range of n symbols, or alternatively recording the number of “hits” or number of times each symbol from the defined range of n symbols has been selected by participants in the game, in order that a selection total can be recorded for each of the n symbols; and
optionally a further two fields comprising:
a third field that records the ranking of each symbol within the defined range of n symbols calculated by reference to the fore mentioned second numerical field, including as relevant any symbols within the range of n symbols that are tied with other n symbols; and
a fourth field that can, if necessary, record a unique ranking for each symbol within the defined range of n symbols, with any ties eliminated or resolved by reference to the ranking value or the selection total number as recorded in the second numerical field, in order that each of the symbols in the defined range of n symbols has its own unique ranking within the range of the n symbols.

The databases of the transaction engine and gaming engine can be combined into a single database and operated within a single computer but we believe that this may make it more vulnerable to fraud.

Preferably the transaction engine is separate from the gaming engine and only passes registered entries to the gaming engine once entries into the game are closed.

More preferably, the transaction engine and the gaming engine are duplicated and controlled by an independent party in order for that party to be able to simultaneously receive raw data into its separate transaction engine, to hold that raw data in its transaction engine until entries into the game are closed, to then pass that raw data from the transaction engine to the gaming engine, which gaming engine independently process the raw data using the independent party's copy of the gaming software stored on its gaming engine, to independently determine the results of the game, including the winner/s, and to produce an independent audit report of its results compared with those of the gaming operator.

We believe this above described process involving an independent party will significantly reduce the chance for incidences of fraud arising in games using the invention described herein.

Alternatively the gaming system can be run using a spreadsheet instead of separate databases.

Preferably the participant is able to enter their own symbols/s by remote data entry such as by entering it on a telephone keypad, by sending an SMS message, or email message containing the symbol or symbols they have chosen.

Alternatively it is also possible for the participant to allow the system to choose one or more symbols at random, so that the participant could for example select a “lucky dip” in which the system would select one or more symbols at random and enter them into the competition for the participant.

Preferably the registration process involves the participant paying for their entry. However, in some uses of the gaming system, the entry may be free, with or without a prize for the winning participant.

Preferably, when recording a ranking value for each n symbol, the recording is by way of recording the number of “hits” or number of times each symbol from the defined range of n symbols has been selected by participants in the game, in order that a selection total can be recorded for each of the n symbols.

Preferably, when ranking each n symbol, the ranking is first by way of the n symbol that is chosen the least, then the n symbol that is chosen the second least, and so on to the last ranked n symbol.

We believe using the ‘least chosen’ method is the preferable method because it provides greater control and more predictability, for example on limiting participants as they proceed through elimination stages, thereby giving better and more predictable control to the gaming or lottery organizer, especially in relation to the predictability of prize payout obligations. Further, it avoids participants attempting to ‘club together’ their choices on one set of n symbols, which could occur if the ‘most picked’ method was to be used.

Preferably in selecting entries for the second phase, symbols not selected by any entry are ignored.

Alternatively the symbols not selected by any entry can belong to the house.

Preferably, when the gaming system is used in a two phase game, the elimination process operating in the second phase requires participants to provide entries that select further symbols from a defined range of available symbols, with entries avoiding elimination by selecting a symbol which has been selected the least in or on the relevant entries in any elimination step relevant to the second phase.

Preferably the second phase of the elimination process has secondary procedures usable if a preceding elimination procedure operating in the second phase of the game fails to select a single winner.

Preferably part of the prize pool is set aside for jackpot and/or super draws/games as herein described.

As will be appreciated from the examples, there are a number of ways of operating such a gaming system.

This gaming system can be operated through numerous entry methods. For example, via a message sent in many ways, including by mail, by fax, by email, by SMS or WAP, or by logging into a server on the internet, or by entry through a machine such as a gaming machine, kiosk, lottery terminal, ATM or POS machine, or through a registration process, or via telephone. In each of these cases the participants may have purchased a number of potential entries in advance, or pre-registered and established a credit balance with the gaming operator, or may wish to pay by credit card, or some other rapid payment system.

When operated via the telephone, for example by utilising a 0900 number ordering system, the participant can respond to an advertisement perhaps on television, on the radio, or in the printed media, by calling a defined telephone number and then at the prompt entering the selected symbols by using the number/s via a touch-tone keypad. Alternatively the symbol/s or number/s could be entered using an interactive voice recognition system, by speaking the symbol/s or number/s, and having the computer, or a human operator, repeat the symbol/s or number/s back to the participant. It is however preferred that when operated by the telephone, the operation of the system is fully computerised, and that either a touch-tone keypad can be used, or an interactive voice recognition system can be used (IVR), as this enables the system to be readily scalable, and to operate at relatively low cost (in terms of human operators) 24 hours a day.

In a still further aspect the invention provides a computer system including computer hardware and appropriate software to run the transaction engine and the gaming engine in accordance with the methods outlined above, and means for allowing the automated input of information to the gaming engine.

Preferably the input to the transaction engine involves entries via a telephone keypad, via SMS from mobile phones, via emails, via entries direct to a website, or entries direct to a kiosk or computer terminal at a retail outlet, and less preferably by mail (as this would involve scanning of the entry or human input of the entry and reduces the ability to provide an instantaneous or rapid response to the entrant confirming the details of the entry).

In a still further aspect the invention resides in a method of conducting a regional or worldwide lottery in which participants are invited to select at least one symbol from a defined available range of symbols, for example between one and n, to register their selection with a computer system, the computer system being capable of recording at least the symbol or symbols selected in or on each entry and the originating lottery organization, country or area for each participant, and optionally the identity or contact details of the participant and the date and time of the entry, and where each symbol from the available symbols can be ranked, rated or assigned a placement value, the results of which can then be used at least to include to rank the performance of all entries firstly in the regional or worldwide lottery so that regional or worldwide winners are determined, and separately lottery organization, country or area winners can also be determined, or alternatively the last placed entry or entries can be identified, the results preferably being achieved using one set of data derived from the ranking and/or rating and/or placement values attributed to each symbol that is available to be chosen in the overall regional or worldwide lottery.

In a still further aspect the invention resides in a computerized regional or worldwide lottery having at least one computer system for recording entries and determining one or more winners, in which participants are invited to select at least one symbol from a defined available range of n symbols, and to register their selection with the computer, the computer being capable of recording at least the symbol or symbols selected in or on an entry and the originating lottery organization, country or area for each participant and optionally recording the identity or contact details of the participant, and wherein the regional or worldwide lottery has a first phase, the first phase running until a defined time has expired whereupon a selected number of entries, at least some of whom have the symbol or symbols least, or alternatively most, selected, move to a second phase of the lottery which comprises an elimination process to determine one or more winners from the entries in the second phase, the winner or winners being the final entry or entries at the end of the elimination process and where the computerized lottery system can also record one or more winners from each originating lottery organization, country or area in the first phase and/or second phase.

In a still further aspect the invention resides in a method of conducting a regional or worldwide lottery, in which participants are invited to select at least one symbol from a defined available range of symbols, for example between one and n, to register their selection with a computer system, the computer system being capable of recording at least the symbol or symbols selected in or on an entry, the participant and the originating lottery organization, country or area for each participant, and optionally the identity or contact details of the participant and the date and time of the entry, and wherein the regional or worldwide lottery has a first phase, the first phase running until a defined time has expired whereupon a selected number of entries, at least some of whom have the symbol or symbols least, or alternatively most, selected, move to a second phase of the lottery which comprises an elimination process to determine one or more winners from the entries in the second phase, the winner or winners being the final entry or entries at the end of the elimination process and where the computerized lottery system can also record one or more winners from each originating lottery organization, country or area in the first phase and/or second phase.

In a still further aspect the invention resides in a method of conducting a regional or worldwide lottery, in which participants are invited to select two or more symbols from a defined available range of symbols, for example between one and n, to register their selection with a computer system, the computer system being capable of recording at least the symbols selected in or on an entry and the originating lottery organization, country or area for each participant, and optionally the identity or contact details of the participant and the date and time of the entry, and wherein the regional or worldwide lottery has only a first phase, the first phase running until a defined time has expired whereupon a winning sole entry or entries is/are selected for the regional or worldwide lottery and where the computerized lottery system also records a winning sole entry or entries from each originating lottery organization, country or area, at least some of whom have the symbol or symbols least selected by reference firstly to a participant's choice of symbol which is least picked in or on all the entries, then that entry's next symbol which has been selected the next least in or on the entries, and continuing the process, until the elimination process is completed and the winning entry or entries are selected, or preferably in the event that a winning entry is not determined after the completion of the before described elimination phases, then the elimination process continues by reference to parameters set around the remaining entries symbol choices, which may include by reference to time of entry, to achieve the desired eliminations.

Preferably when the elimination process is commenced the elimination process continues until only one winner remains or a selected small number of entries remain.

Preferably the computer system includes a transaction engine (i.e. for entry logging) and a gaming/lottery engine.

More preferably this includes at least one database with each record having fields containing (a) customer information, typically a telephone number or credit card number or email address, (b) the symbol or symbols chosen by the customer, (c) a receipt number or PIN disclosed to the customer as proof of that entry, and the lottery organisation, country or area through or in which the participant purchased the entry.

More preferably the gaming/lottery engine includes at least one database. The database can contain n records with at least three fields per record—a first field containing the symbol or symbols within the range (so that the records can be sequential through the entire range of n symbols for that competition), a second numerical field capable of recording the number of “hits” or number of times that each symbol has been selected, and a third field containing the lottery organization, country or area through or in which the entry was purchased by a participant.

The databases of the transaction engine and gaming/lottery engine can be combined into a single database and operated within a single computer but we believe that this may make it more vulnerable to fraud.

Alternatively the regional or worldwide lottery can be run using a spreadsheet instead of separate databases, as we used a spreadsheet in our simulation of the invention, as described in U.S. Pat. No. 7,100,822 and herein.

Preferably the participant is allowed to enter their own symbol/s by remote data entry such as by entering it on a telephone keypad, by sending an SMS message, or email message containing the symbol/s or number/s they have chosen. However, it is also possible for the participant to allow the system to choose one or more numbers at random, so that the participant could for example select a “lucky dip” in which the system would select one or more symbols or numbers at random and enter them into the competition for the participant.

Preferably the registration process involves the participant paying for their entry. However, in some gaming or lottery schemes, the entry may be free, with a defined prize for the winning entry.

Preferably the elimination process operating in the second phase of the invention requires participants to select further symbols from a defined available range of symbols, with entries avoiding elimination by selecting a symbol which has been selected the least or alternatively, most by the relevant participants at that elimination step.

Preferably in selecting participants for the second phase, symbols not selected by any participant are ignored.

Alternatively the symbols not selected by any participate can belong to the house.

Preferably at least the second phase of the elimination process has secondary procedures usable if a preceding elimination procedure operating in the second phase of the lottery fails to select a single winner.

Preferably part of the prize pool is set aside for jackpot and/or super draws.

As will be appreciated from the examples, there are a number of ways of operating such a lottery.

One of the advantages of this gaming system is that it can be operated via the telephone, for example by utilising a 0900 number ordering system.

Alternatively the symbol could be entered using an interactive voice recognition system, by speaking the number, and having the computer, or a human operator, repeat the symbol back to the participant. It is however preferred that the operation of the system is fully computerised, and that either a touch-tone keypad can be used, or an interactive voice recognition system be used (IVR) as this enables the system to be readily scalable, and to operate at relatively low cost (in terms of human operators) 24 hours a day.

Alternatively the gaming system can be operated via a message sent in many ways including by mail, by fax, by email, by SMS or WAP, or by logging into a server on the internet, by machine such as a gaming machine, kiosk, lottery terminal, ATM or POS machine, or through a registration process, or via telephone, with participants having pre-registered. In either of these cases the participants may have purchased a number of potential entries in advance, or established a credit balance with the gaming operator, or may wish to pay by credit card, or some other rapid payment system.

In a still further aspect the invention provides a computer system including computer hardware and appropriate software to run the transaction engine and the gaming engine in accordance with the methods outlined above, and means for allowing the automated input of information to the gaming engine.

Preferably the transaction engine is separate from the gaming engine and passes registered entries sequentially to the gaming engine.

Preferably the input to the transaction engine involves entries via a telephone keypad, via SMS from mobile phones, via emails, via entries direct to a website, or entries direct to a kiosk or computer terminal at a retail outlet, and less preferably by mail (as this would involve scanning of the entry or human input of the entry and reduces the ability to provide an instantaneous or rapid response to the entrant confirming the details of the entry).

In another aspect the invention provides a computer program for conducting a gaming event such as a regional or worldwide lottery in which participants are invited to select at least one symbol from a defined range of “n” available symbols, and to register their selection with a computer running the program, the program adapted to record at least the identity or contact details of the participant, the lottery organization, country or area through or in which the participant purchased the entry and the symbol or symbols selected by the participant, and to separately record the number of times each symbol within the range of “n” symbols is chosen by all the participants in the regional or worldwide lottery.

Preferably the symbols are numbers.

A ranking engine for a computerised lottery, the ranking engine comprising one or more computers for recording entries, which entries include at least one symbol selected from a set containing n symbols, the computer or computers being capable of:

recording the symbol or symbols selected in or on each entry and optionally recording at least the identity or contact details, or place or point of entry, associated with each entry;
recording, the number of times each symbol from the set of n symbols has been selected;
ranking each symbol from the set of n symbols from lowest to highest based on the number of times each symbol has been selected in or on the entries;
determining the result of the lottery by comparing one or more of the symbols associated with each entry against the ranking of at least some of the n symbols.

In a still further aspect the invention consists in a ranking engine for a computerised lottery, the ranking engine comprising one or more computers for recording entries and ranking entries, in which entries comprise at least one symbol selected from a set containing n symbols, the computer or computers being capable of:
recording the symbol or symbols selected in or on each entry and optionally recording at least the identity or contact details, or place or point of entry, associated with each entry and;
recording, the number of times each symbol from the set of n symbols has been selected;
ranking each symbol from the set of n symbols from lowest to highest based on the number of times each symbol has been selected in or on the entries;
determining the result of the lottery by comparing one or more of the symbols associated with each entry against the ranking of at least some of the n symbols.

Preferably the ranking of each symbol takes place following closure of entries into the game.

In a still further aspect the invention consists in a computerised lottery which makes use of a ranking engine as described in the two preceding paragraphs.

Preferably the expected number of entries is high enough that the probability that each member of the set of n symbols will be chosen at least once is substantially certain.

Preferably the lottery has a pre-defined close off time and/or date and the number of entries A is at least 10 times greater than the number of symbols n.

Preferably the number of entries A is between 10 times and 500,000 times the number of symbols n.

Preferably each entry comprises r different symbols selected from the set of n symbols.

Preferably r is a number between 4 and 10.

Preferably r is 6.

Preferably there are two or more sets containing symbols n1, n2 . . . nN and each entry comprises a selection of at least one symbol from each set of symbols.

Preferably the ranking engine contains additional rules to eliminate ties between symbols.

Preferably each set of symbols comprises a set of symbols from 2 to 100, with each symbol identified by numerals, or that are numerals.

Preferably each set of symbols comprises a set of symbols from 2 to 40, with each symbol identified by numerals, or that are numerals.

Preferably there are two sets of symbols, with the first set comprising a set of symbols from 2 to 10 in number, and the second set comprising a set of symbols from 10 to 40 in number, with each symbol in each set identified by numerals, or that are numerals.

In a still further aspect the invention consists in a computer program for conducting a computerised lottery, the computer program allowing the recording of entries and ranking entries which select at least one symbol from a set containing n symbols, the computer program being capable of:

recording the symbol or symbols selected in or on each entry and optionally recording at least the identity or contact details, or place or point of entry, associated with each entry;
recording, the number of times each symbol from the set of n symbols has been selected;
ranking each symbol from the set of n symbols from lowest to highest based on the number of times each symbol has been selected in or on the entries;
determining the result of the lottery by comparing one or more of the symbols associated with each entry against the ranking of at least some of the n symbols.

In a still further aspect the invention consists in a computer program for conducting a computerised lottery, the computer program allowing the recording of entries and ranking entries which select at least one symbol from a set containing n symbols, the computer program being capable of:
recording the symbol or symbols selected in or on each entry and optionally recording at least the identity or contact details, or place or point of entry, associated with each entry and;
recording, the number of times each symbol from the set of n symbols has been selected;
ranking each symbol from the set of n symbols from lowest to highest based on the number of times each symbol has been selected in or on the entries;
determining the result of the lottery by comparing one or more of the symbols associated with each entry against the ranking of at least some of the n symbols.

Preferably the program is adapted to record the entry point to the lottery through or in which the participant purchased the entry, and to record other information chosen from the group comprising (a) an identity of a lottery organization, (b) a lottery sub-type, and (c) a country or area; to enable the program to select a winning entry for each of those entry points to the lottery.

In a still further aspect the invention consists in a method of conducting a lottery comprising the steps of recording entries and ranking those entries, in which entries select at least one symbol from a set containing n symbols, the computer or computers being capable of:

recording the symbol or symbols selected in or on each entry and optionally recording at least the identity or contact details, or place or point of entry, associated with each entry;
recording, the number of times each symbol from the set of n symbols has been selected:
ranking each symbol from the set of n symbols from lowest to highest based on the number of times each symbol has been selected in or on the entries;
determining the result of the lottery by comparing one or more of the symbols associated with each entry against the ranking of at least some of the n symbols.

In a still further aspect the invention consists in a method of conducting a lottery comprising the steps of recording entries and ranking those entries, in which entries select at least one symbol from a set containing n symbols, the computer or computers being capable of:
recording the symbol or symbols selected in or on each entry and optionally recording at least the identity or contact details, or place or point of entry, associated with each entry and;
recording, the number of times each symbol from the set of n symbols has been selected;
ranking each symbol from the set of n symbols from lowest to highest based on the number of times each symbol has been selected in or on the entries;
determining the result of the lottery by comparing one or more of the symbols associated with each entry against the ranking of at least some of the n symbols.

Preferably the results of the lottery are displayed/broadcast in the form of a software or computer driven simulation, the end result of which is based on the ranking of the n symbols.

Preferably the simulation is a competitive simulation.

Preferably the competitive simulation is a race simulation.

In a still further aspect the invention consists in a computerised game wherein participants select at least one of a range of symbols, the result of the game being determined by the number of times participants select each symbol, and ranking means to rank the number of times each symbol is selected by participants, the ranking being determined by the number of times participants select each symbol, the result of the game being determined by comparing the entries of all or at least some of the participants in the game against the ranking of the symbols.

In a still further aspect the invention consists in a computerised gaming system including display means to display a range of symbols to participants who wish to play the game provided by the gaming system, selection means to enable participants to select one or more of the range of symbols, and ranking means to rank the number of times each symbol is selected by participants, the ranking being determined by the number of times participants select each symbol, the result of the game being determined by comparing the entries of all or at least some of the participants in the game against the ranking of the symbols.

Preferably the selected symbol from the ranking list is the symbol that is ranked as the least selected or most selected symbol in or on the entries in the game.

In a still further aspect the invention consists in a computerised gaming system having at least one computer system for recording entries and determining one or more winners, in which the game is conducted in at least two phases, the first phase consisting of one or more games from which the number of entries in each first phase game are reduced substantially to a selected number, the selected number comprising less than 40% of all entries in each first phase game and preferably comprising no more than 10% of all entries, and from which a winner or winners of each first phase game is and/or are determined, and in the second phase, the selected number from the one or more first phase games are entered into a final game from which a winner or winners are determined, with the only way for a participant to obtain an entry into the final game is by way of a participant entering into a game in the first phase and becoming one of the selected number from that first phase game.

In a still further aspect the invention consists in a computerised gaming system, such as a lottery, game or promotional system, having at least one computer system for recording entries and determining one or more winners, in which participants are invited to select two or more symbols from a defined available range of symbols from one to n, and to register their selection with a computer system, the computer system being capable of recording at least the symbols selected in or on each entry, including how many times each symbol in the available symbol range from one to n was selected in or on each of the entries in the game, to provide a ranking list of the number of times each symbol in the range of one to n was selected, the ranking being determined either by the number of times each symbol is selected in or on entries, with the order of ranking of each symbol in the ranking list from first to n being determined by firstly, that symbol that is least chosen being ranked first, secondly, that symbol that is second least chosen is ranked second and subsequently continuing the order of ranking in like manner, or alternatively that symbol that is most chosen is ranked first, that symbol that is second most chosen is ranked second and subsequently continuing the order of ranking in like manner, and optionally the computer system being capable of recording the identity or contact details of the participant and the date and time and place of the entry, and wherein the game has a single phase, the single phase running until a defined time has expired whereupon a winning sole entry or entries is or are selected, the winner or winners of the game being determined by comparing the symbol or symbols in all or at least some of the entries of all or at least some of the participants in the game against the ranking of the symbols as set out in the ranking list to make the desired eliminations, by comparing one or more of the symbols chosen in or on each entry against the ranking list of the symbols.

Preferably the step of comparing one or more of the symbols chosen in or on each entry against the ranking list of the symbols comprises the step of progressively eliminating those relevant entries that have a relevant symbol or symbols ranked lower, or alternatively higher, on the ranking list than the symbol or symbols in or on other entries until a winner or winners is or are found.

In a still further aspect the invention consists in a computerised gaming system, such as a lottery, game or promotional system having at least one computer system for recording entries and determining one or more winners, in which participants are invited to select one or more symbols from a defined available range of symbols between one and n, having at least one computer system for recording the symbol selections made on or in each of the entries, and recording a ranking value for each of the symbols in the defined available range of symbols from one to n based on their order of draw from a random draw of some or all of the symbols in the available range, and also recording a ranking list of the symbols from first to n with the order of the symbols in the ranking list being determined by reference to the order in which the symbols become randomly drawn, and using the resulting ranking list to eliminate entries and determine one or more winners.

Preferably the winner or winners of the game are determined by comparing the entries of all or at least some of the participants in the game against the ranking of the symbols as set out in the ranking list to achieve the desired eliminations, in particular, by comparing one or more of the symbols chosen in or on each entry made by each of the participants against the ranking list of the symbols.

Preferably the step of comparing one or more of the symbols chosen in or on each entry against the ranking list of the symbols comprises the step of progressively eliminating those relevant entries that have a relevant symbol or symbols ranked lower, or alternatively higher, on the ranking list than the symbol or symbols in or on other entries until a winner or winners is or are found.

Preferably the computer system includes one or more transaction engines (i.e. for entry logging and storage of the raw data during the time the game is open to receiving entries) and a gaming engine, which receives the raw data from the transaction engine(s) after entry into the game is closed, and which then processes the raw data using the gaming software and determines the results of the game, including the winner/s.

Preferably the transaction engine(s) includes at least one database with each record having fields containing (a) customer information, typically a telephone number or credit card number or email address and/or place of purchase (b) the number or numbers chosen by the customer, (c) a receipt number or PIN disclosed to the customer as proof of that entry.

Preferably the gaming engine accesses at least one database.

Preferably the gaming engine's function results in n records with at least two fields per record comprising:
a first field containing a set of symbols within the available range of n symbols (so that the records can be sequential through the entire range of n symbols for that competition); and
a second numerical field capable of recording a placement value or ranking value for each n symbol, for example by recording a placement value for each n symbol if randomly drawn through the full range of n symbols, or alternatively recording the number of “hits” or number of times each symbol from the defined range of n symbols has been selected in or on entries in the game, in order that a selection total can be recorded for each of the n symbols; and
optionally a further two fields comprising:
a third field that records the ranking of each symbol within the defined range of n symbols calculated by reference to the fore mentioned second numerical field, including as relevant any symbols within the range of n symbols that are tied with other n symbols; and
a fourth field that can, if necessary, record a unique ranking for each symbol within the defined range of n symbols, with any ties eliminated or resolved by reference to the ranking value or the selection total number as recorded in the second numerical field, in order that each of the symbols in the defined range of n symbols has its own unique ranking within the range of the n symbols.

Preferably the databases of the transaction engine and gaming engine are combined into a single database and operated within a single computer.

Preferably the transaction engine is separate from the gaming engine and only passes registered entries to the gaming engine once entry into the game is closed.

Preferably the transaction engine(s) and the gaming engine are duplicated and the duplication controlled by an independent party in order for that party to be able to simultaneously or first receive the raw gaming data into its separate transaction engine(s), to hold that raw data in its transaction engine(s) until entries into the game are closed, to then pass that raw data from the independent party's transaction engine(s) to its gaming engine, to independently process the raw data using the independent party's copy of the gaming software stored on its gaming engine, to independently determine the results of the game, including the winner/s, and to produce an independent audit report of its results compared with those of the gaming operator.

Preferably the participant is able to enter their own number/s by remote data entry such as by entering it on a telephone keypad, by sending an SMS message, or email message containing the number/s they have chosen.

Preferably the participant is allowed by the system to choose one or more symbols, at random.

Preferably the registration process involves the participant paying for their entry.

Preferably when recording a ranking value for each n symbol, the recording is by way of recording the number of “hits” or number of times each symbol from the available range of n symbols has been selected by participants in the game, in order that a selection total can be recorded for each of the n symbols.

Preferably when ranking each n symbol, the ranking is first by way of the n symbol that is chosen the least, then the n symbol that is chosen the second least, and so on to the last ranked n symbol.

Preferably the symbols not selected by any participant are ignored.

Preferably the symbols not selected by any participant can belong to the house.

Preferably the symbols not selected by any participant are given a ranking after symbols which have been selected.

Preferably the symbols not selected by any participant are given a ranking of the most chosen.

Preferably when the gaming system is used in a two phase game, the elimination process operating in the second phase requires entries to select further symbols from an available range, with participants avoiding elimination by selecting a symbol which has been selected the least in or on relevant entries in any elimination step relevant to the second phase.

Preferably at least any second phase of the elimination process has secondary procedures usable if a preceding elimination procedure operating in the second phase of the game fails to select a single winner.

Preferably part of the prize pool is set aside for jackpot and/or super draws/games.

Preferably the symbols are numbers.

In a still further aspect the invention consists in a method of conducting a gaming system in which participants are invited to select one or more symbols from a defined available range of symbols, between one and n, having at least one computer system for recording the symbol selections made in or on each of the entries, including how many times each symbol in the available symbol range was selected in or on each of the entries in the game, then ranking the symbols in the available symbol range, and using the resulting rankings to eliminate entries and determine one or more winners, for example by reference to each entries selection of their one or more symbols from the available symbol range relative to how their selected symbols compared with other entries selections, and compared against the ranking order of the symbols in the available symbol range.

Preferably the symbols are ranked based on how many times each of the symbols in the available symbol range were selected in or on entries.

Preferably the least selected symbol is ranked first, the second least selected symbol is ranked second, and this process is continued to the most selected symbol which is ranked last.

Preferably entries are eliminated and a winner or winners are determined by reference to each entries selection of their one or more symbols from the available symbol range relative to how their selected symbols compared with other entries selections, and compared against the ranking order of the symbols in the defined symbol range.

In a still further aspect the invention consists in a method of conducting a gaming system in which participants are invited to select one or more symbols from an available symbol range between one and n, having at least one computer system for recording the symbol selections made in or on each of the entries, including how many times each symbol in the available symbol range was selected in or on each of the entries in the game to provide a selection total, then uniquely ranking each of the symbols in the available symbol range by ranking the symbols based on the selection total relevant to each symbol in the available symbol range, and, in circumstances where two or more of the symbols in the available symbol range are tied with the same selection total number, eliminating or resolving ties by ranking those tied numbers utilizing the results from the choices in or on entries in the gaming system in order that each of the symbols in the available symbol range of one to n has its own unique ranking number or placement value.

Preferably the tied symbols are ranked by firstly determining whether or not the selection total number is an ‘odd number’ or an ‘even number’ and secondly, using that ‘odd’ or ‘even’ determination to rank any tied symbols by ordering the tied symbols in accordance with whether the selection total number is ‘odd’ or ‘even’.

Preferably a selection total number that is an ‘odd number’ results in the tied symbols that are numbers or that can be identified by reference to a number being ordered with the highest face value number being placed first, and a selection total number that is an ‘even number’ results in the tied symbols that are numbers or that can be identified by reference to a number being ordered with the lowest face value number being placed first.

Alternatively a selection total number that is an ‘even number’ results in the tied symbols that are numbers or that can be identified by reference to a number being ordered with the highest face value number being placed first, and a selection total number that is an ‘odd number’ results in the tied symbols that are numbers or that can be identified by reference to a number being ordered with the lowest face value number being placed first.

In a still further aspect the invention consists in a method of conducting a gaming system in which participants are invited to select at least one symbol from a defined available range of n symbols, and to register their selection with the computer, the computer being capable of recording at least the symbol or symbols selected in or on the entry, including how many times each symbol in the available symbol range was selected in or on each of the entries in the game, and to provide a ranking list of the number of times each symbol or symbols were selected in or on an entry, the ranking being determined by the number of times each symbol was selected in or on an entry, and optionally recording the identity or contact details of the participant, and wherein the gaming system has at least two phases, the first phase running until a defined time has expired whereupon at least one of the n symbols is selected, the selection being made by selecting at least one of the symbols in the ranking list based on selection criteria pre-determined by reference to the rankings of the symbols in the ranking list, to provide a number of entries, at least some of whom have selected one of the n symbols selected, and moving the selected entries to a second phase of the gaming system which second phase comprises an elimination process to determine one or more winners from the entries in the second phase, the winner or winners being the final entry or entries at the end of the elimination process.

In a still further aspect the invention consists in a method of conducting a gaming system having at least one computer system for recording entries and determining one or more winners, in which the game is conducted in at least two phases, the first phase consisting of one or more games from which the number of entries in each first phase game are reduced substantially to a selected number, the selected number comprising less than 40% of all entries in each first phase game and preferably comprising no more than 10% of all entries, and from which a winner or winners of each first phase game is and/or are determined, and in the second phase, the selected number from the one or more first phase games are entered into a final game from which a winner or winners are determined, with the only way for a participant to obtain an entry into the final game is by way of a participant entering into a game in the first phase and becoming one of the selected number from that first phase game.

In a still further aspect the invention consists in a method of conducting a gaming system, in which participants are invited to select two or more symbols from a defined available range of symbols from one to n, and to register their selection with a computer system, the computer system being capable of recording at least the symbols selected in or on each entry, including how many times each symbol in the available symbol range from one to n was selected in or on each of the entries in the game, to provide a ranking list of the number of times each symbol in the range of one to n was selected, the ranking being determined either by the number of times each symbol is selected in or on entries, with the order of ranking of each symbol in the ranking list from first to n being determined by firstly, that symbol that is least chosen being ranked first, secondly, that symbol that is second least chosen is ranked second and subsequently continuing the order of ranking in like manner, or alternatively that symbol that is most chosen is ranked first, that symbol that is second most chosen is ranked second and subsequently continuing the order of ranking in like manner, and optionally the computer system being capable of recording the identity or contact details of the participant and the date and time and place of the entry, and wherein the game has a single phase, the single phase running until a defined time has expired whereupon a winning sole entry or entries is or are selected, the winner or winners of the game being determined by comparing the symbol or symbols in or on all or at least some of the entries of all or at least some of the participants in the game against the ranking of the symbols as set out in the ranking list to make the desired eliminations, by comparing one or more of the symbols chosen in or on each entry against the ranking list of the symbols.

Preferably the step of comparing one or more of the symbols chosen in or on each entry against the ranking list of the symbols comprises the step of progressively eliminating those relevant entries that have a relevant symbol or symbols ranked lower, or alternatively higher, on the ranking list than the symbol or symbols in or on other entries until a winner or winners is or are found.

In a still further aspect the invention consists in a method of conducting a gaming system, in which participants are invited to select one or more symbols from a defined available range of symbols between one and n, having at least one computer system for recording the symbol selections made on or in each of the entries, and recording a ranking value for each of the symbols in the defined available range of symbols from one to n based on their order of draw from a random draw of some or all of the symbols in the available range, and also recording a ranking list of the symbols from first to n with the order of the symbols in the ranking list being determined by reference to the order in which the symbols become randomly drawn, and using the resulting ranking list to eliminate entries and determine one or more winners,

Preferably the winner or winners of the game are determined by comparing the entries of all or at least some of the participants in the game against the ranking of the symbols as set out in the ranking list to achieve the desired eliminations, in particular, by comparing one or more of the symbols chosen in or on each entry made by each of the participants against the ranking list of the symbols, and continually eliminating those relevant participants that have an inferior choice of symbol or symbols compared to one or more other participants choice of symbol or symbols, with that participant or those participants that avoid eliminations and who become the winner or winners having a relevant symbol or symbols ranked higher, or alternatively lower, on the ranking list than the other participants.

Preferably when the elimination process is commenced in the second phase, the elimination process continues until one winner remains.

Preferably the symbols are numbers.

In a still further aspect the invention consists in a computer system including computer hardware and appropriate software to run the transaction engine and the gaming engine in accordance with the methods claimed in any one of the preceding paragraphs, and means to allow the automated input of information to the gaming engine.

Preferably the input to the transaction engine involves entries via a telephone keypad, via SMS from mobile phones, via emails, via entries direct to a website, or entries direct to a kiosk, or computer terminal at a retail outlet, and by mail.

In a still further aspect the invention consists in a method of conducting a regional or worldwide lottery in which participants are invited to select at least one symbol from a defined available range of symbols between one and n, to register their selection with a computer system, the computer system being capable of recording at least the symbol or symbols selected in or on each entry and the originating lottery organization, country or area for each entry, and optionally recording the identity or contact details of the participant and the date and time of the entry, and where each symbol selected in or on each entry from the symbols available to be selected can be ranked, rated or assigned a placement value, the results of which can then be used at least to rank the performance of all entries firstly in the regional or worldwide lottery so that regional or worldwide winners are determined, and separately to determine lottery organization, country or area winners, and optionally, to determine the last placed entry in the regional or worldwide lottery and separately to determine the last placed entries from each participating lottery organization, country or area, the results being achieved using one set of data derived from the ranking and/or rating and/or placement values attributed to each symbol that is available to be chosen in the overall regional or worldwide lottery.

In a still further aspect the invention consists in a method of conducting a regional or worldwide lottery, in which participants are invited to select at least one symbol from a defined available range of symbols, between one and n, to register their selection with a computer system, the computer system being capable of recording at least the symbol or symbols selected in or on each entry and the originating lottery organization, country or area for each entry, and to provide a ranking list of the number of times each symbol was selected, the ranking of each symbol in the ranking list being determined by the number of times each symbol is selected in or on entries, optionally the identity or contact details of the participant and the date and time of the entry, and wherein the regional or worldwide lottery has at least two phases, the first phase running until a defined time has expired whereupon at least one of the n symbols is selected, the selection being made by selecting at least one of the symbols in the ranking list based on selection criteria pre-determined by reference to the rankings of the symbols in the ranking list, to provide a number of entries, at least some of whom have selected one of the n symbols selected, and moving the selected entries to a second phase of the lottery, which second phase comprises an elimination process to determine one or more winners from those entries that were selected to move from the first phase to the second phase, the winner or winners in the second phase being the final entry or entries at the end of a pre-determined elimination process determined for the second phase, and optionally where the computerized lottery system can also record one or more winners from each originating lottery organization, country or area in the first phase and/or second phase.

In a still further aspect the invention consists in a method of conducting a regional or worldwide lottery, in which participants are invited to select two or more symbols from a defined available range of symbols from one to n, and to register their selection with a computer system, the computer system being capable of recording at least the symbols selected in or on each entry, including how many times each symbol in the available symbol range from one to n was selected in or on each of the entries in the game, to provide a ranking list of the number of times each symbol in the range of one to n was selected, the ranking being determined by either the number of times each symbol was selected in or on entries, with the order of ranking of each symbol in the ranking list from first to n being determined by firstly, that symbol that is least chosen being ranked first, secondly, that symbol that is second least chosen is ranked second and subsequently continuing the order of ranking in like manner, or alternatively that symbol that is most chosen is ranked first, that symbol that is second most chosen is ranked second and subsequently continuing the order of ranking in like manner, and recording the originating lottery organization, country or area for each participant or entry, and optionally the computer system being capable of recording the identity or contact details of the participant and the date and time and place of the entry, and wherein the regional or worldwide lottery has only a single phase, the single phase running until a defined time has expired whereupon a winning sole entry or entries is or are selected for the regional or worldwide lottery and where the computerized lottery system can also record a winning sole entry or entries from each originating lottery organization, country or area, the relevant winner or winners of the game being determined by comparing the symbol or symbols in or on at least some of the entries of all or at least some of the participants in the game against the ranking of the symbols as set out in the ranking list to make the desired eliminations, by comparing one or more of the symbols chosen in or on each entry against the ranking list of the symbols.

Preferably the step of comparing one or more of the symbols chosen in or on each entry against the ranking list of the symbols comprises the step of progressively eliminating those relevant entries that have a relevant symbol or symbols ranked lower, or alternatively higher, on the ranking list than the symbol or symbols in or on other entries until a winner or winners is or are found.

Preferably when the elimination process is commenced in the second phase of the lottery, the elimination process continues until only one winner remains or a selected small number of entries remain.

Preferably the symbol or symbols are a number or numbers.

In a still further aspect the invention consists in a computerized regional or worldwide lottery having at least one computer system for recording entries and determining one or more winners, in which participants are invited to select at least one symbol from a defined available range of symbols, between one and n, to register their selection with a computer system, the computer system being capable of recording at least the symbol or symbols selected in or on entries and the originating lottery organization, country or area for each entry, and optionally the identity or contact details of the participant and the date and time of the entry, including how many times each symbol in the available symbol range was selected in or on each of the entries in the game and to provide a ranking list of the number of times each symbol was selected, the ranking of each symbol in the ranking list being determined by the number of times each symbol is selected in or on entries, and wherein the regional or worldwide lottery has at least two phases, the first phase running until a defined time has expired whereupon at least one of the n symbols is selected, the selection being made by selecting at least one of the symbols in the ranking list based on selection criteria pre-determined by reference to the rankings of the symbols in the ranking list, to provide a number of entries, at least some of whom have selected one of the n symbols selected, and moving the selected entries to a second phase of the lottery, which second phase comprises an elimination process to determine one or more winners from those entries that were selected to move from the first phase to the second phase, the winner or winners in the second phase being the final entry or entries at the end of a pre-determined elimination process, and optionally where the computerized lottery system can also record one or more winners from each originating lottery organization, country or area in the first phase and/or second phase.

In a still further aspect the invention consists in a computerised regional or worldwide lottery having at least one computer system for recording entries and determining one or more winners, in which the lottery is conducted in at least two phases, the first phase consisting of one or more lotteries from which the number of entries in each first phase lottery are reduced substantially to a selected number, the selected number comprising less than 40% of all entries in each first phase lottery and preferably comprising no more than 10% of all entries, and from which a winner or winners of each first phase lottery is/are determined, and in the second phase, the selected number from the one or more first phase lotteries are entered into a final lottery from which a winner or winners are determined, with the only way for a participant to obtain an entry into the final lottery is by way of a participant entering into a lottery in the first phase and becoming one of the selected number from that first phase lottery.

In a still further aspect the invention consists in a computerized regional or worldwide lottery having at least one computer system for recording entries and determining one or more winners, in which participants are invited to select two or more symbols from a defined available range of symbols from one to n, and to register their selection with a computer system, the computer system being capable of recording at least the symbols selected in or on each entry, including how many times each symbol in the available symbol range from one to n was selected in or on each of the entries in the game, to provide a ranking list of the number of times each symbol in the range of one to n was selected, the ranking being determined either by the number of times each symbol was selected in or on entries, with the order of ranking of each symbol in the ranking list from first to n being determined by firstly, that symbol that is least chosen being ranked first, secondly, that symbol that is second least chosen is ranked second and subsequently continuing the order of ranking in like manner, or alternatively that symbol that is most chosen is ranked first, that symbol that is second most chosen is ranked second and subsequently continuing the order of ranking in like manner, and recording the originating lottery organization, country or area for each participant or entry, and optionally the computer system being capable of recording the identity or contact details of the participant and the date and time and place of the entry, and wherein the regional or worldwide lottery has only a single phase, the single phase running until a defined time has expired whereupon a winning sole entry or entries is or are selected for the regional or worldwide lottery and where the computerized lottery system can also record a winning sole entry or entries from each originating lottery organization, country or area, the relevant winner or winners of the game being determined by comparing the symbol or symbols in or on all or some of the entries of all or at least some of the participants in the game against the ranking of the symbols as set out in the ranking list to make the desired eliminations, by comparing one or more of the symbols chosen in or on each entry against the ranking list of the symbols.

Preferably the step of comparing one or more of the symbols chosen in or on each entry against the ranking list of the symbols comprises the step of progressively eliminating those relevant entries that have a relevant symbol or symbols ranked lower, or alternatively higher, on the ranking list than the symbol or symbols in or on other entries until a winner or winners is or are found.

Preferably the computer system includes one or more transaction engines (i.e. for entry logging and storage of the raw gaming data during the time the game is open to receiving entries) and a gaming engine, which receives the raw data from the transaction engine(s) after entry into the game is closed, and which then processes the raw data using the gaming software and determines the results of the game, including the winner/s.

Preferably the transaction engine(s) includes at least one database with each record having fields containing (a) customer information, typically a telephone number or credit card number or email address, (b) the number or numbers chosen by the customer, (c) a receipt number or PIN disclosed to the customer as proof of that entry, and the lottery organisation, country or area through or in which the participant purchased the entry.

Preferably the gaming engine accesses at least one database.

Preferably the gaming engine can receive and record the information from the transaction engine(s) and in which the gaming engine's function results in n records with at least two fields per record comprising:
a first field containing a number within the range of n numbers (so that the records can be sequential through the entire range of n numbers for that competition);
a second numerical field capable of recording a placement value or ranking value for each n number, for example by recording a placement value for each n number if randomly drawn through the full range of n numbers, or alternatively recording the number of “hits” or number of times each number from the defined range of n numbers has been selected by participants in the game, in order that a selection total can be recorded for each of the n numbers; and
optionally two further fields comprising:
a third field that records the ranking of each number within the defined range of n numbers calculated by reference to the fore mentioned second numerical field, including as relevant any numbers within the range of n numbers that are tied with other n numbers;
a fourth field that can, if necessary, record a unique ranking for each number within the defined range of n numbers, with any ties eliminated or resolved by reference to the ranking value or the selection total number as recorded in the second numerical field, in order that each of the numbers in the defined range of n numbers has its own unique ranking number within the range of the n numbers.

Preferably the databases of the transaction engine and lottery engine can be combined into a single database and operated within a single computer.

Preferably the participant is allowed to enter their own number/s by remote data entry such as by entering it on a telephone key pad, by sending an SMS message, or email message containing the number/s they have chosen.

Preferably the participant can allow the system to chose one or more symbols at random, so that the participant could for example elect for the computer system to select one or more of the symbols for the participant, in which case the computer system would select one or more numbers at random and enter them into the competition for the participant.

Preferably the transaction engine(s) and the gaming engine are duplicated and with the duplication independently controlled by an independent party in order for that party to be able to simultaneously or first receive the raw gaming data into the independent party's separate transaction engine(s), to hold that raw data in its transaction engine(s) until entries into the game are closed, to then pass that raw data from its transaction engine(s) to its gaming engine, to independently process the raw data using the independent party's copy of the gaming software stored on its gaming engine, to independently determine the results of the game, including the winner/s, and to produce an independent audit report of its results compared with those of the gaming operator.

Preferably the elimination process or processes operating in the second phase of the invention requires participants to select further symbols from a defined available range, with participants avoiding elimination by selecting a symbol which has been selected the least or alternatively, selected the most by all the relevant participants at that relevant elimination step operative in the second phase.

Preferably in selecting entries for the second phase, symbols not selected in or on any entry are given a ranking after symbols which have been selected.

Preferably symbols not selected in or on any entry belong to the house.

Alternatively symbols not selected in or on any entry are given a ranking of the most selected symbol.

Preferably at least the second phase of the elimination process has secondary procedures usable if a preceding elimination procedure operating in the second phase of the lottery fails to select a single winner.

Preferably the symbol or symbols are a number or numbers.

Preferably part of the prize pool is set aside for jackpot and/or super draws.

Preferably the system has a transaction engine separate from the gaming or lottery engine, the transaction engine only passing registered entries to the gaming or lottery engine after entries into the relevant game are closed.

### Inventive Step

The invention as claimed allows a gaming event, including a virtual race and/or a lottery, to operate with prizes, without prizes, or to operate using a totalizer or pari-mutuel system (where the total prize pool depends upon the number of entries and is not a fixed amount) or to operate using a pari-mutuel system in combination with an ‘additional fixed prize’, and wherein the gaming event closes at a defined time or upon the reaching of defined parameters such as the reaching of a predetermined number of ticket sales or prize pool and wherein the gaming system provides for participants to select one or more symbols such as numbers (including for the avoidance of doubt, number equivalents) from a defined available range of symbols from one to n.

The gaming system then provides for the ranking of the symbols in the defined available symbol range one to n based on how many times each of the symbols in the available symbol range were selected by participants, or alternatively, the gaming system can provide for the ranking of each of the n symbols based on a placement value for each n symbol if the n symbols are randomly drawn through the full range of n symbols.

The gaming system then uses the resulting rankings of each of the symbols such as numbers in the defined symbol range to rank and eliminate participants in the gaming event and determine one or more winners. The gaming system does this by, for example, reference to each participant's selection of their one or more symbols from the defined available symbol range relative to how their selected symbol or symbols compared with other participants selections, and compared against the ranking order that has been determined for each of the symbols in the available symbol range and progressively eliminating those relevant entries that have a relevant symbol or symbols ranked lower, or alternatively higher, on the ranking list than the symbol or symbols in or on other entries, until a winner or winners is or are found

Participants can be eliminated to leave a winner from a single phase, or alternatively, the invention allows a gaming event to operate where most of the participants are eliminated in a first phase and only a selected and predetermined number of participants, for example say 9 participants, then participate in a second phase of the game, which then finds a winner from those 9 participants. This allows the second phase to provide the basis of a media event if desired, with that media event set around the eliminations of participants from among those 9 participants in the second phase of a game until a winner or winners are found.

The invention also allows a gaming event to operate involving one or more first phase games, where a winner or winners of the first phase games are selected and receive the relevant first phase game prizes, and a selected and predetermined maximum percentage of participants from those first phase games, for example say a maximum of 5%-10% of all first phase participants, then proceed and go on to participate by way of entry in a second phase of the game which is a ‘super’ game or draw, which then finds a winner or winners from that small group of participants. Participants that become eligible to participate in the ‘super’ game or draw will have great odds of winning the prizes on offer that the gaming system guarantees will be won. Further, such a gaming event allows the second phase of such a game to offer a ‘substantial additional prize’ at an affordable cost to the participants and the gaming operator which ‘may’ be won, in addition to the prizes on offer in the ‘super’ game or draw that ‘will’ be won.

The invention also allows entries to be made remotely e.g. by telephone or email without the need for a pre-printed ticket.

The invention also allows for the involvement of an independent auditing party that can simultaneously replicate the results determining process undertaken by the gaming operator using games based on this invention, and which can produce at the conclusion of each game, an independent audit report confirming the integrity of the results of games using the invention described herein.

### DRAWINGS

These and other aspects of this invention, which will be considered in all its novel aspects, will become apparent from the following descriptions, which are given by way of examples only, with reference to the accompanying drawings in which:

FIG. 1 is a basic overview of the transaction process.

FIG. 2 is a basic overview of the transaction process with the involvement of an independent auditing party.

FIG. 3 is a flow chart setting out the method for the resolution of ties occurring between two or more numbers within the n numbers, by using the ‘odds’ or ‘evens’ totals associated with each number in the defined number range.

FIG. 4 is a series of computer printouts showing by way of example a method of processing by a computer of a gaming event using the invention described herein involving a sample of 100,000 participants playing a [worldwide]game where players pick six numbers from a range of 30 numbers. This series of steps is relevant to the examples set out in Examples 3, 4 and 6 below wherein participants pick six numbers from a number range of 1 to n, and where n=30.

FIG. 5 is a series of computer printouts of a story board relating to a game design of a Virtual Horse Race where players pick six horses from a range of 20 horses. This is described in Example 5 below.

FIG. 6 is a series of computer printouts of a story board relating to a game design of a Virtual Space Race where players pick six space vehicles from a range of twenty space vehicles. This is an adaptation of the horse race set out in Example 5 below.

FIG. 7 shows the odds of picking ‘r’ numbers from a range of ‘n’ numbers and the calculations required to determine those odds.

FIG. 8 shows the ranking of the n numbers, in this example the ranking of the 20 n numbers being determined using all n number picks.

FIG. 9 shows the invention being used in a series of games (all comprising the one game), where the participants pick in each game one n number from a range of n numbers.

FIG. 10 shows a diagrammatic representation of the invention used in a card game played over a number of countries. This is relevant to the example set out in Example 10 below.

FIG. 11 is a series of computer printouts showing by way of example a method of processing by a computer of the card game using the invention described herein involving a sample of 1,000 participants playing a worldwide card game where players pick six cards from a range of 14 cards. This series of steps is relevant to the examples set out in Example 10 below wherein participants pick six cards from a card range of 1 to n, and where n=14. And

FIG. 12 shows alternative forms of presenting the invention.

### BRIEF OVERVIEW OF THE DRAWINGS

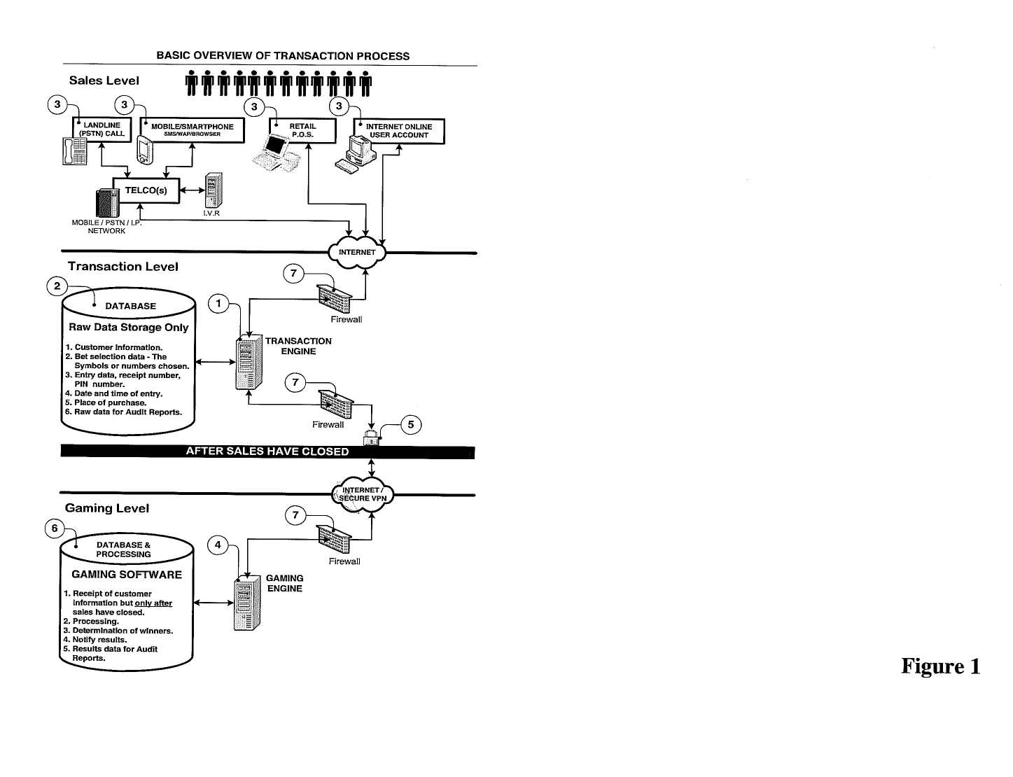

FIG. 1 shows a basic overview of the transaction process, showing the remote entry from a number of different sources, through to a transaction engine (1), which stores the raw data information in a client and transaction database (2). These inputs are indicated at sales level (3). It shows that one of the entries could be from a mobile telephone, smart phone, or from a landline using an interactive voice recognition system (labelled as “IVR”). It shows a separation between the transaction engine (1) and the gaming engine (4), with the transaction engine (1) only passing its raw data to the gaming engine (4) after entries into the game have been closed. While Figure (1) only shows the use of one transaction engine, it will be appreciated that the transaction process could involve more than one transaction engine which would provide further safeguards against unauthorized attempts to access the raw data, as it would not all be stored on the one transaction engine. The flow chart also shows a ‘lock’ (5) which represents the raw data being stored in the database (2) in the transaction engine (1) without the ability of anyone accessing the raw data while the game is open and entries are being accepted. The number choices made by entries into the game are kept secure. All that may be seen by the gaming operator during this time is limited information, the knowledge of which cannot affect or determine the integrity or outcome of the game e.g. information available from the transaction engine (1) could be limited to just the number of accumulated entries, the sales revenues from those entries, and it may include the source of those entries. The gaming engine (4) provides a database and processing software (6) to run the game by receiving information from the transaction engine (1) once the game has closed and then processing the information to determine the winners, notify the results and produce audit reports. Suitable firewalls (7) are provided. The accounting function has been omitted from this flow chart. Once a winner is found, communication will come from the lottery engine back to the transaction engine. The transaction engine can then call information on the winning entry from its database, and communicate back via the appropriate channel to the winner.

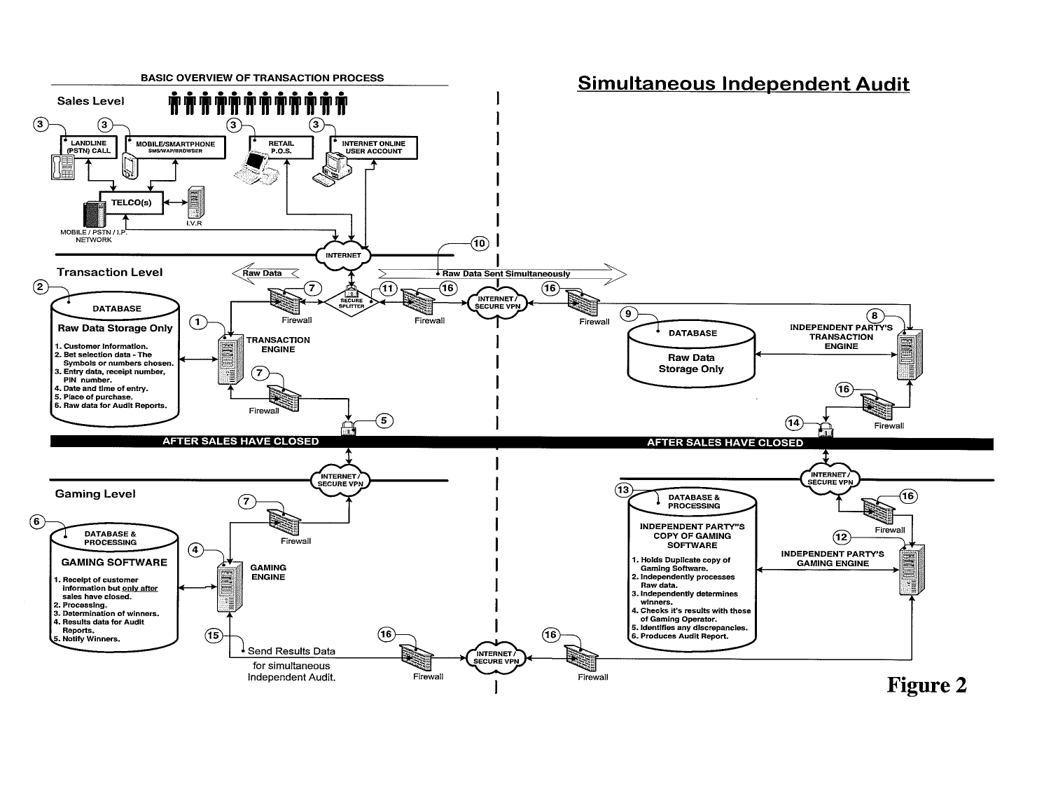

FIG. 2 repeats the information contained in FIG. 1 and in addition shows the involvement of an independent party that has a separate transaction engine (8), which stores the raw data information in a transaction database (9). The simultaneous receipt by the independent party of the raw data information is indicated at (10). One of the ways that this could occur is by way of a secure splitter (11) that sends the sales level data (3) to both the gaming operator's transaction engine (1) and to the independent party's transaction engine (8) simultaneously or first. FIG. 2 also shows a separation between the independent party's transaction engine (8) and its separate gaming engine (12), which contains a duplicate copy of the gaming software (13). This flow chart shows that the independent party's transaction engine (8) simultaneously receives the raw transaction data of the game (10 and 11) and stores it until the entries into the game are closed, following which the raw data is sent by the independent party's transaction engine (8) to the independent party's gaming engine (12) for processing to a winner/s. The flow chart also shows a ‘lock’ (14) which represents the raw data being stored in the database (9) in the transaction engine (8), without the ability of anyone accessing the raw data while the game is open and entries are being accepted. The number choices made by entries into the game are kept secure. All that may be seen by the independent auditing party during this time is limited information, the knowledge of which cannot affect or determine the integrity or outcome of the game e.g. information available from the independent party's transaction engine (8) could be limited to just the number of accumulated entries, the sales revenues from those entries, and it may include the source of those entries. The flow chart also shows the independent party receiving the game results from the gaming operator (15), checking those game results against its own results, identifying any discrepancies and producing an audit report. Procedures are to be provided and followed in the event of there being identified any discrepancies (there should be none). These procedures could include placing a hold on the distribution of any ‘affected’ winners/prizes until any discrepancy is resolved, or if the circumstances warrant, then notifying the appropriate body or authority for further investigation. Further, FIG. 2 shows that suitable firewalls (16) are provided.

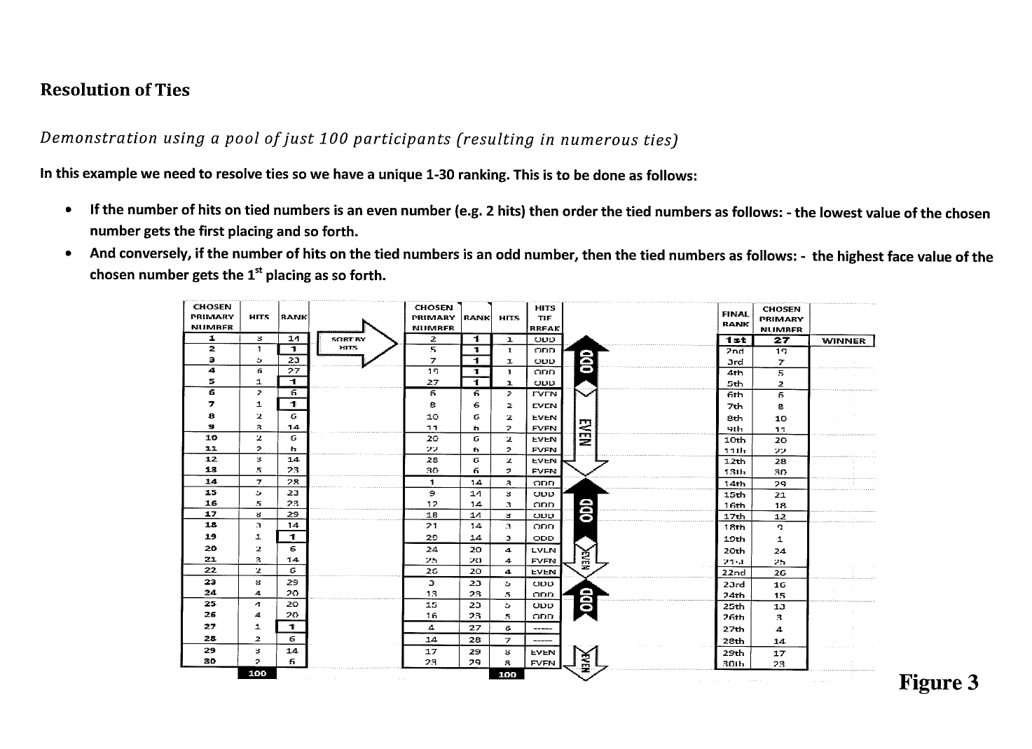

FIG. 3 shows how ties can be resolved in circumstances where two or more numbers within the range of numbers from 1 to n are chosen exactly the same number of times by participants in a game and have the same selection total number. Multiple numbers of ties could also occur. It is preferable that in some uses of the game, for example where the range of numbers from 1 to n, where n is a low number (such as set out in examples 3, 4, 5, 6, 7 and 10 below, where n=30, or n=20, or n=18, or n=14) that all ties are resolved so that a unique ranking of all n numbers, without any ties, is achieved. While there will be a number of ways to resolve ties, such as by a random method, the preferred way is to resolve all ties in games where such ties occur by using the unpredictability of the results of the participants' own choices of n numbers in the game itself, using the resulting ‘odds’ and ‘evens’ totals of the relevant selection total number. This is set out in FIG. 3, and is further set out in Example 3.3 below.

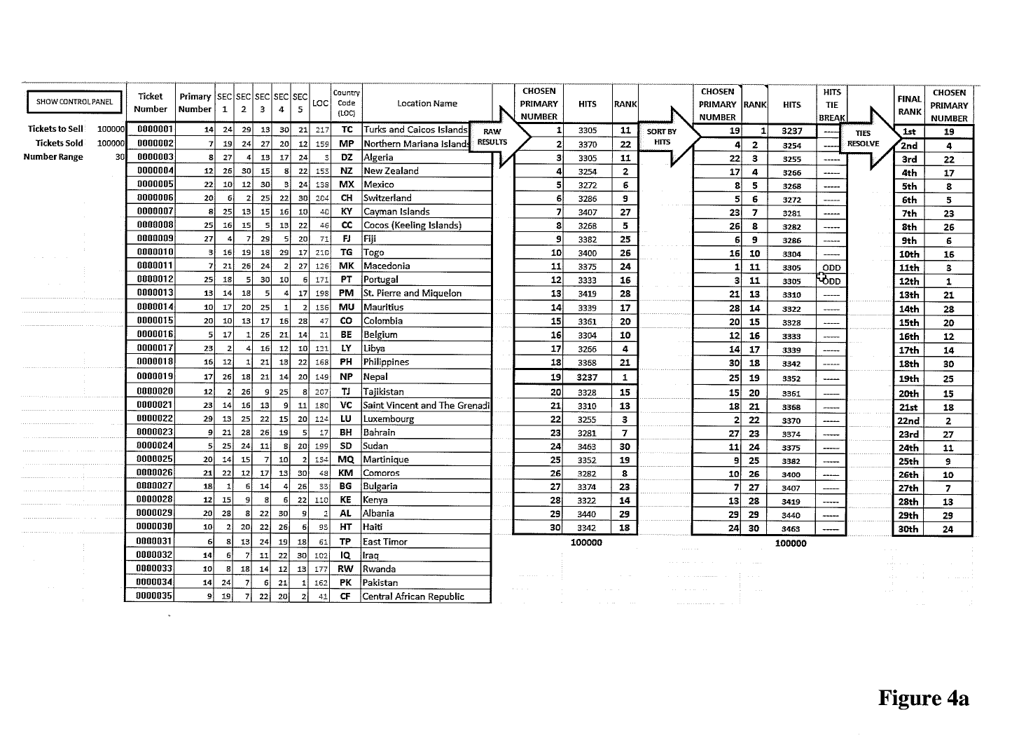

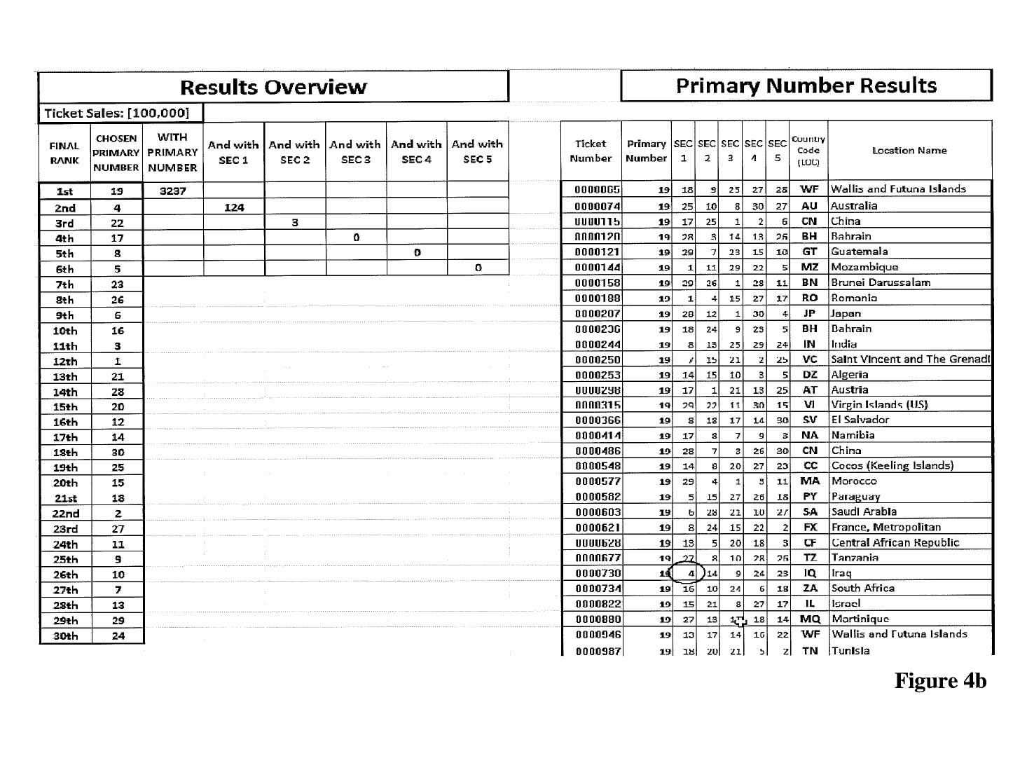

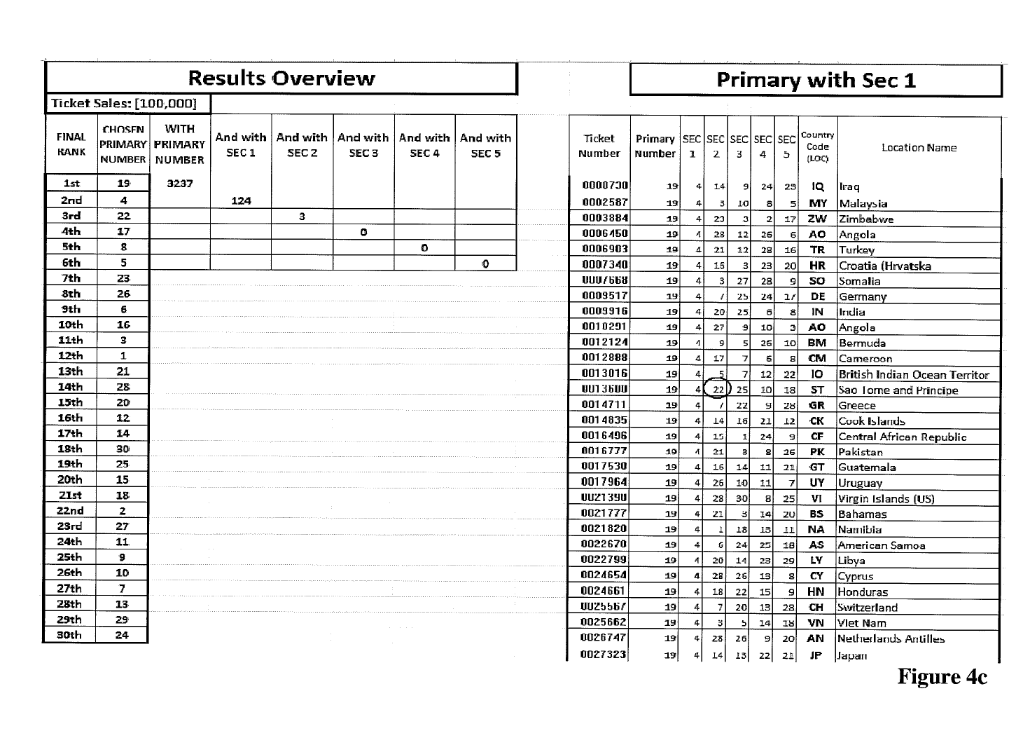

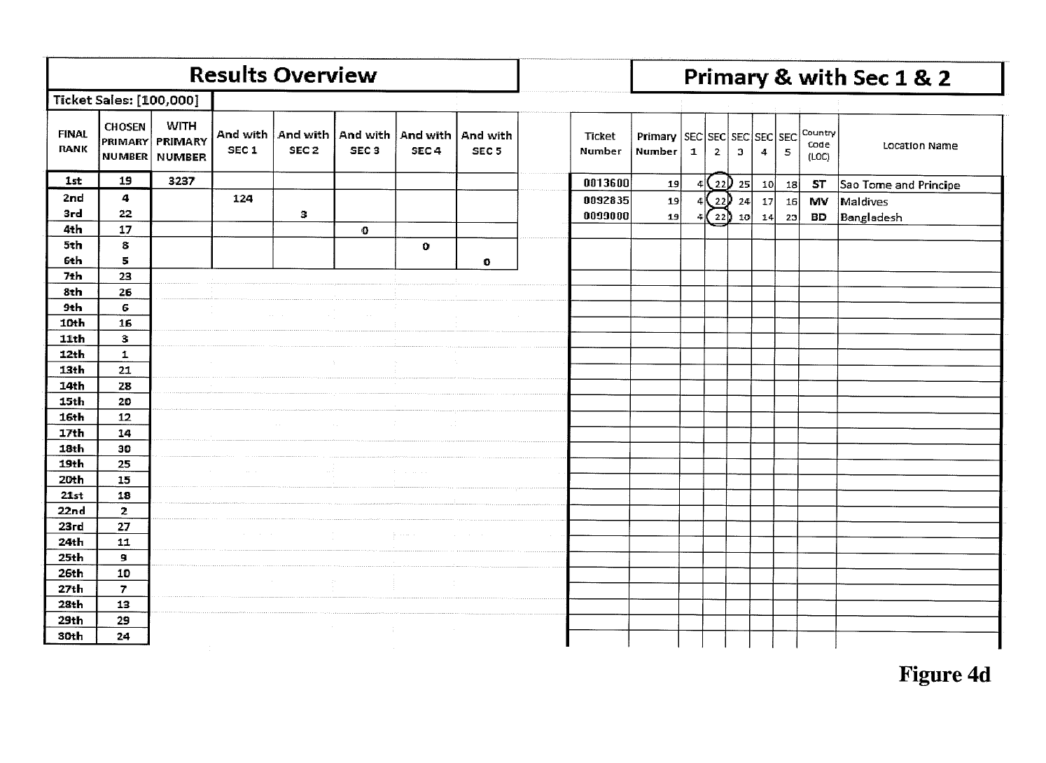

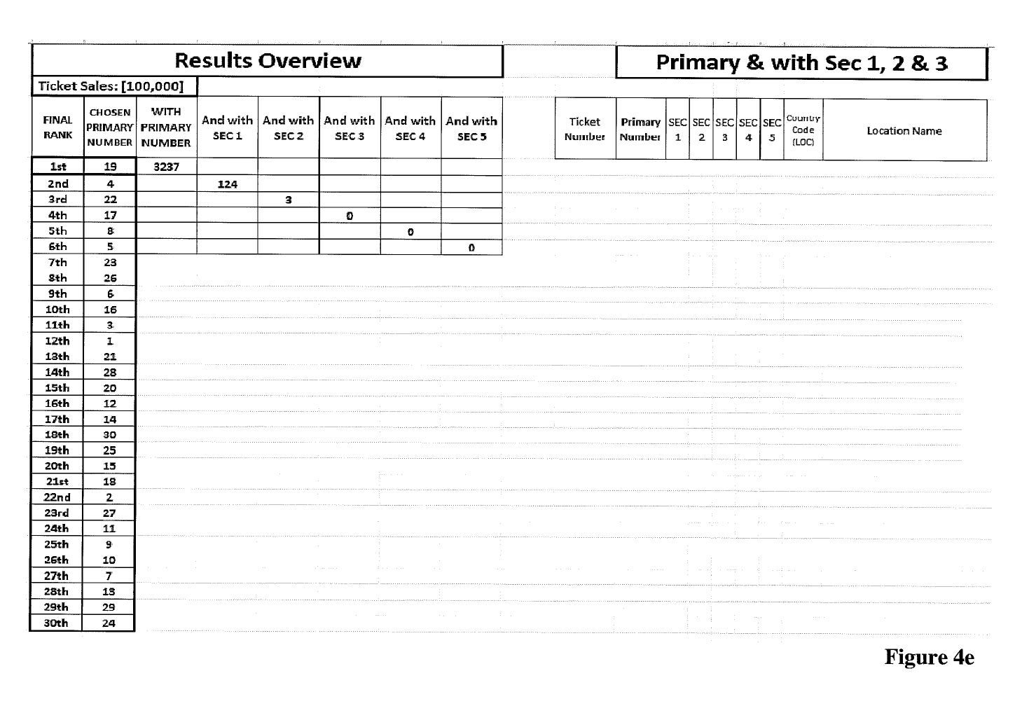

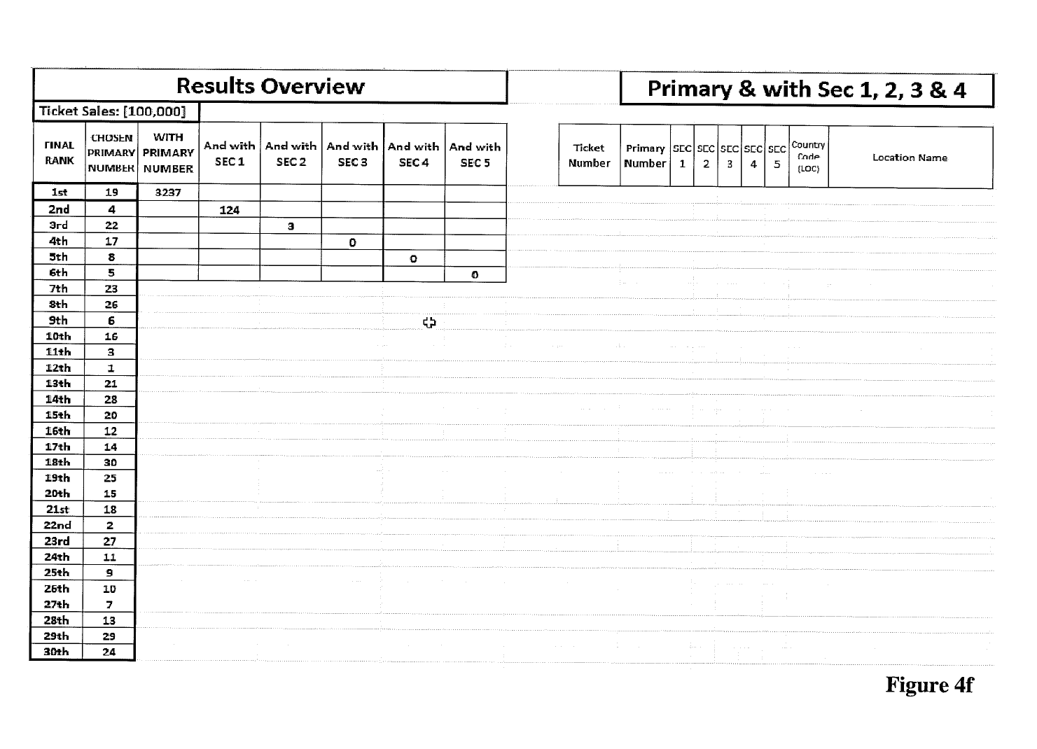

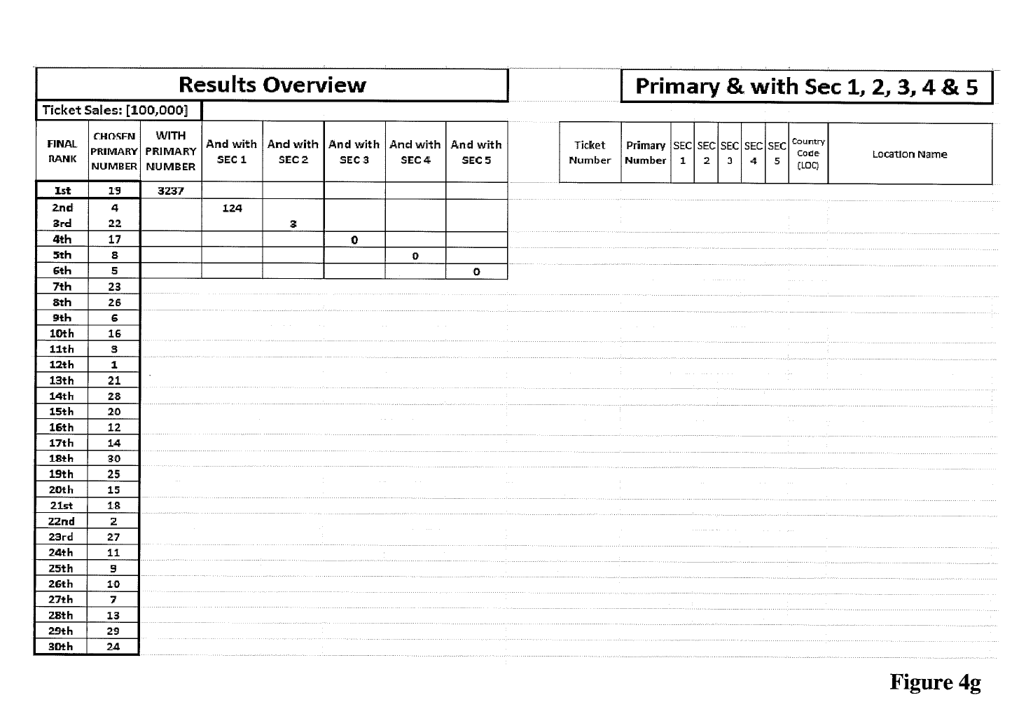

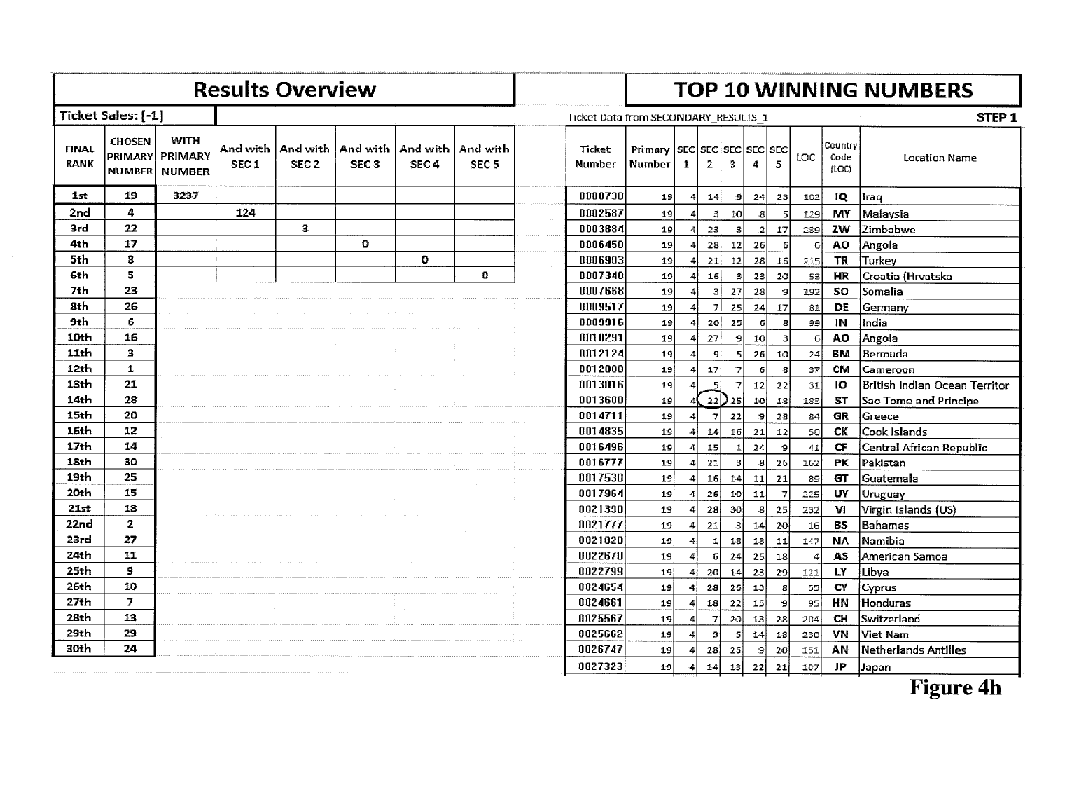

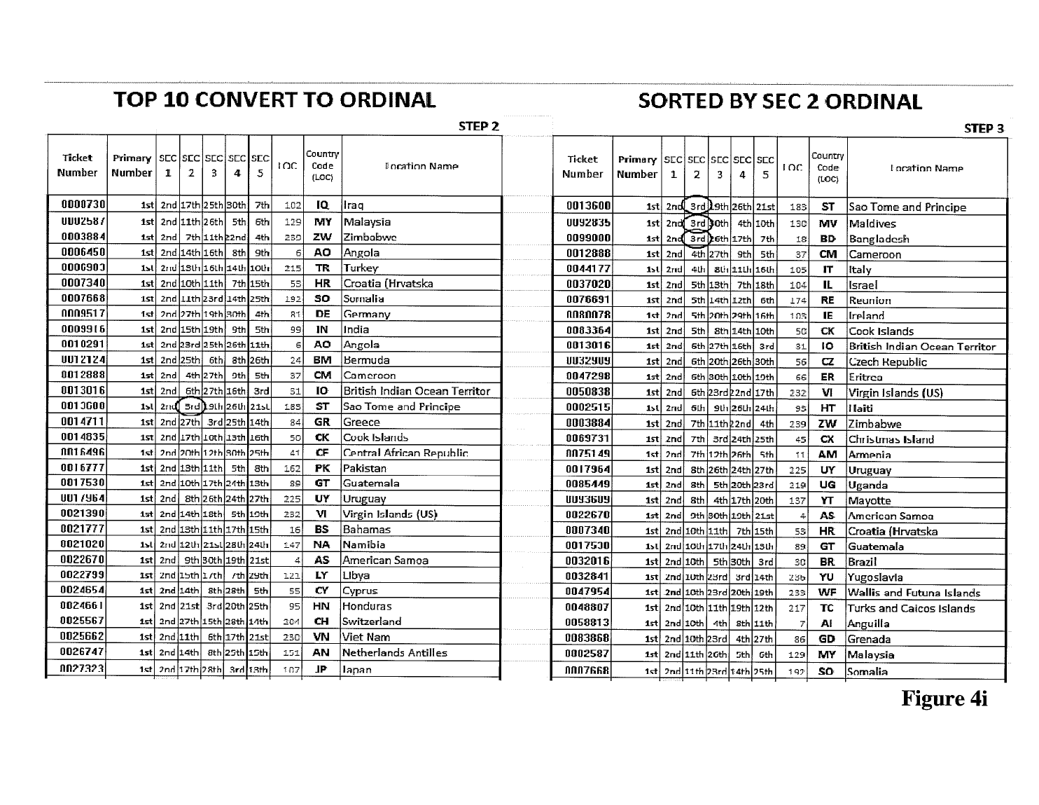

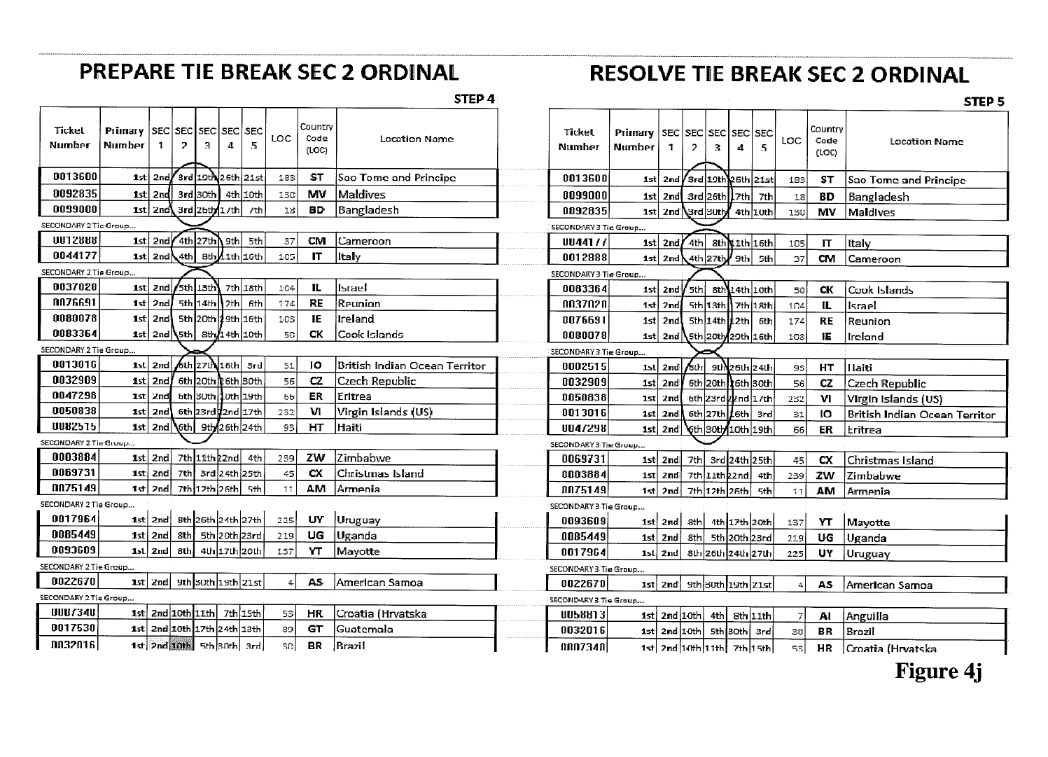

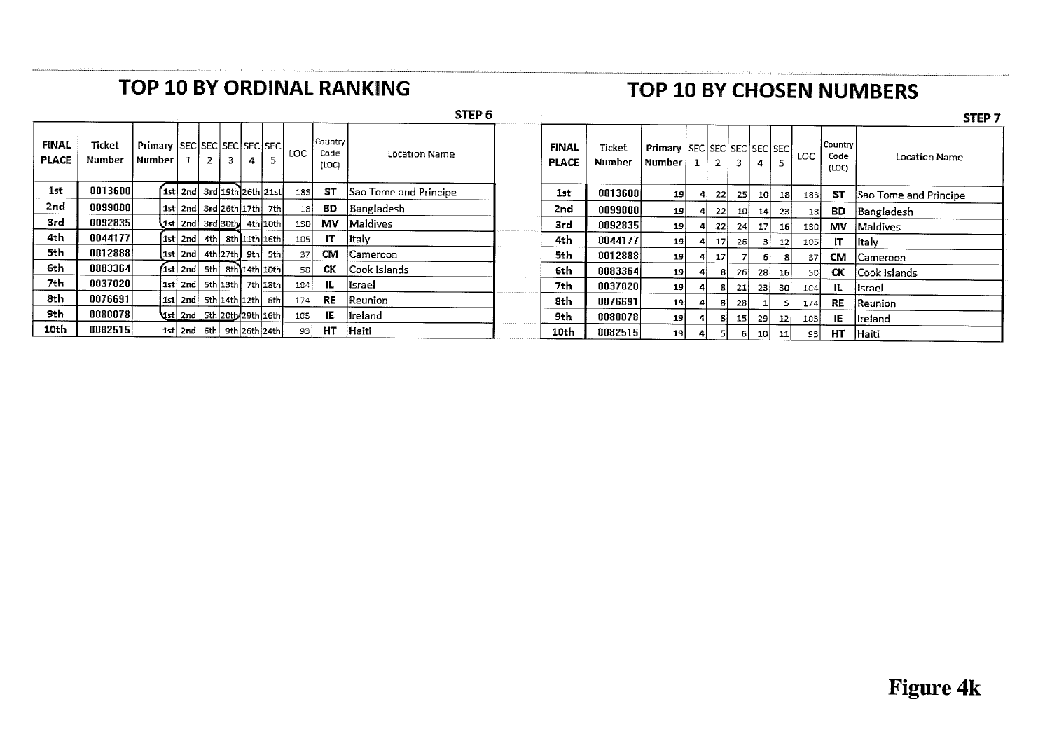

FIG. 4 shows, by way of a series of computer printouts, a method of processing by a computer the results for a 100,000 participant [worldwide] game. The series of computer printouts show:
FIG. 4a shows the ticket sales and the calculation of the ranking system from this example of the game. Ticket numbers 1-34 and each of their 6 chosen numbers are shown on FIG. 4a, but noting that theses ticket numbers continue until ticket number 100,000, as in this example there are 100,000 participants in the game. The raw results are then processed recording how many times each of the 30 numbers in the number range were chosen (“hits”) by participants as their first number (the PRIMARY number) in the game. The total number of hits is equal to the number of participants in the game, in this example the hits total 100,000. The 30 PRIMARY number choices are then ranked by the number of hits attributed to each of the 30 numbers when participants made their PRIMARY number choices. Some numbers may be tied with the same number of hits and in this example PRIMARY number choices of numbers 1 and 3 are tied with 3,305 hits each. Finally FIG. 4a shows the final rankings of the 30 chosen PRIMARY numbers with all ties resolved using the ‘odds’ or ‘evens’ method as set out in the patent.
In summary, the unique ranking of each of the n numbers, being the 30 n numbers that were available for selection, is determined by the participants own choices in the game.
FIG. 4b shows a results overview of the game, and lists all those 3,237 participants out of the 100,000 participants playing the game that correctly chose as their PRIMARY number, the number that was least picked—in this example it is number 19.
FIG. 4c shows a results overview of the game, and lists all those 124 participants out of the 3,237 participants. These 124 participants correctly chose as their PRIMARY number, the number that was least picked—in this example it is number 19 and also correctly chose as their first SECONDARY number, the number in the unique rankings that was the 2nd least picked—in this example it is number 4.
FIG. 4d shows a results overview of the game, and lists all those 3 participants out of the 124 participants. These 3 participants correctly chose as their PRIMARY number, the number that was least picked—in this example it is number 19 and also correctly chose as their first and second SECONDARY numbers, the number in the unique rankings that was the 2nd and 3rd least picked—in this example it is number 4 and 22.
FIGS. 4e, 4f, and 4g shows that there are no participants that, having reached the stage set out in FIG. 4d above, also correctly chose in order, SECONDARY number 3, or SECONDARY numbers 3 and 4, or SECONDARY numbers 3 and 4 and 5. Note that FIGS. 4e, 4f, and 4g would progressively show results in other examples of the game where the number of participants is significantly increased from this example of 100,000.
FIG. 4h shows the commencement of this example's calculation method to identify the Top 10 tickets, in order. Firstly there is a “Results Overview”. Then, Step 1 lists in ticket order those 124 participants that in this example correctly chose the PRIMARY number and the 1st SECONDARY number.
FIG. 4i shows: Step 2 takes those 124 participants and converts their 6 chosen numbers into ordinal numbers based on the unique rankings determined in FIG. 4a of the 30 numbers. Because those 124 participants have all correctly chosen the winning PRIMARY number and the 1st SECONDARY number, Step 3 then orders those 124 participants based on their 2nd SECONDARY number choices by ordering the now converted ordinal numbers in the “SEC 2” column.
FIG. 4j shows: Step 4 then uses the data from Step 3 and separates the 124 participants into groups, being those who had 3rd placing, then 4th and so on, in preparation for tie breaks that are required within a group. Step 5 undertakes the tiebreaks by ordering the participants within each group by reference to each of those participant's next best choices.
FIG. 4k shows the Top Ten Results. Step 6 shows the Top 10 by ordinal ranking. Step 7 shows the Top 10 by the participant's chosen numbers.

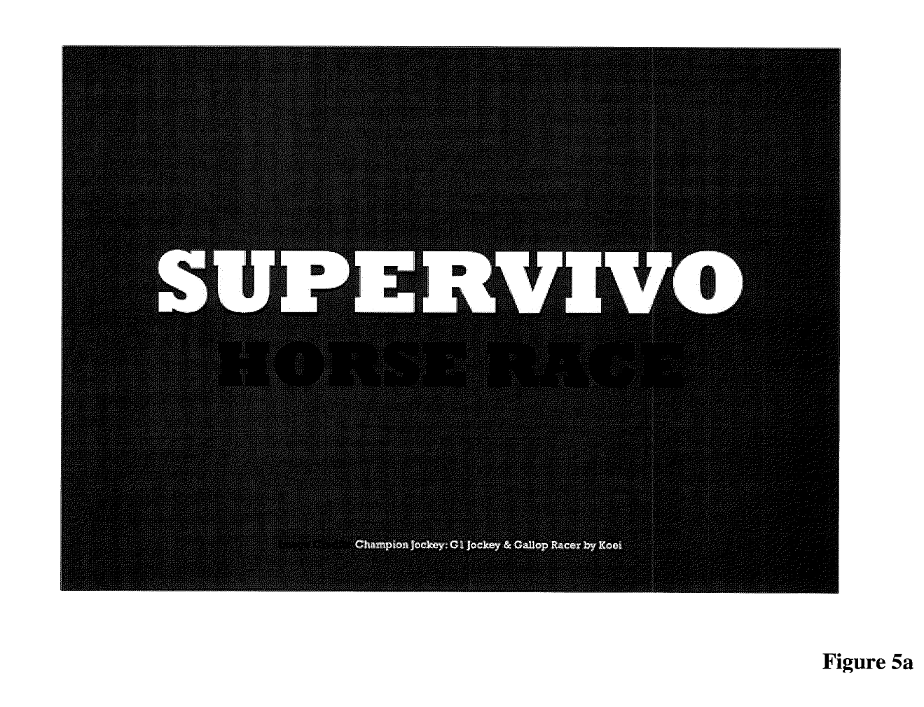

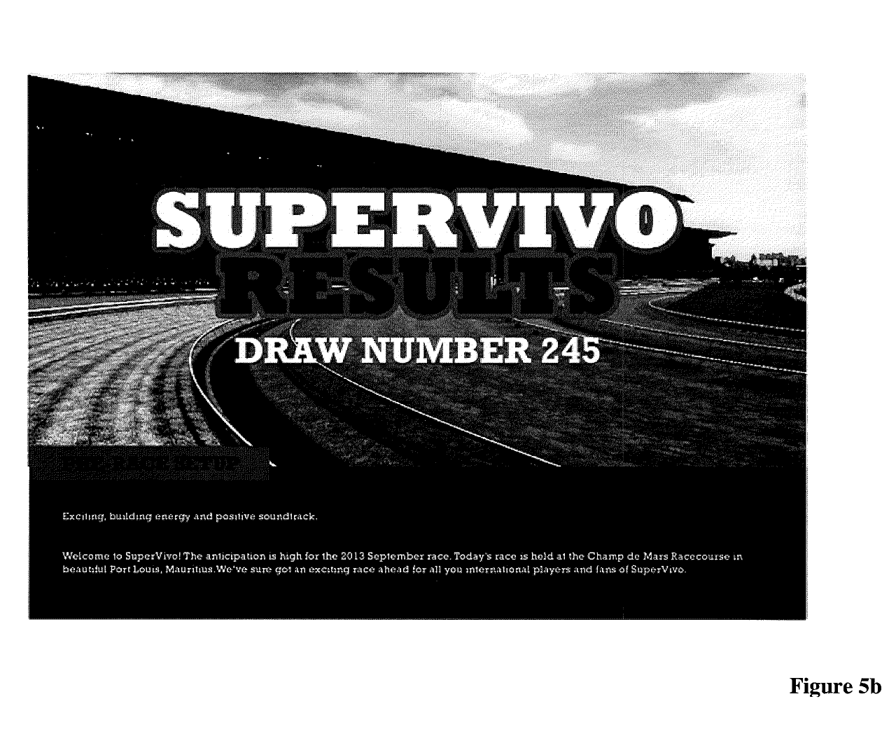

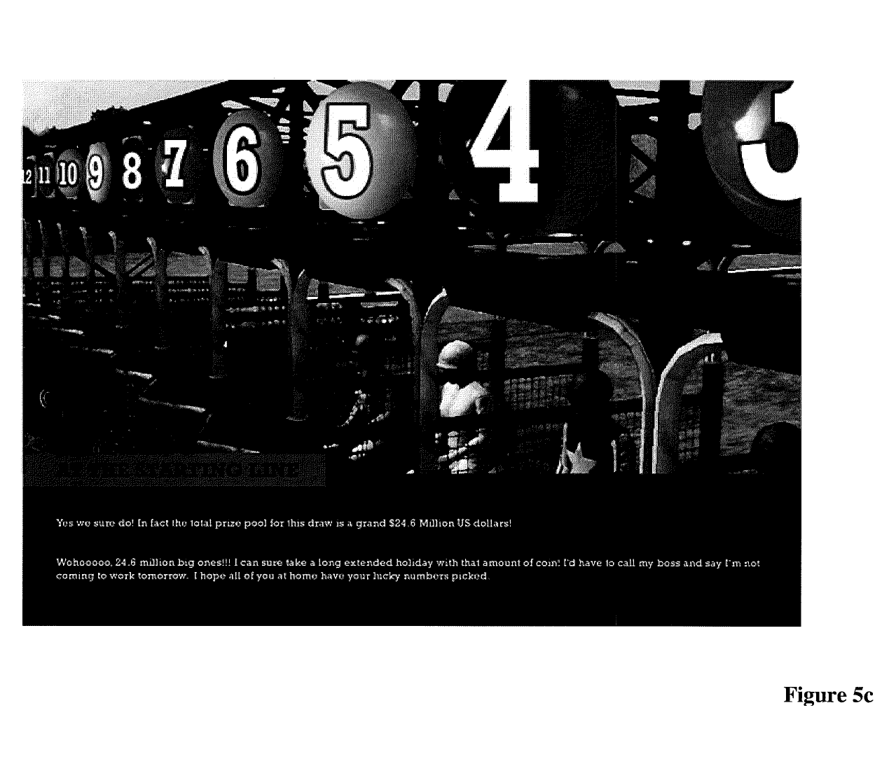

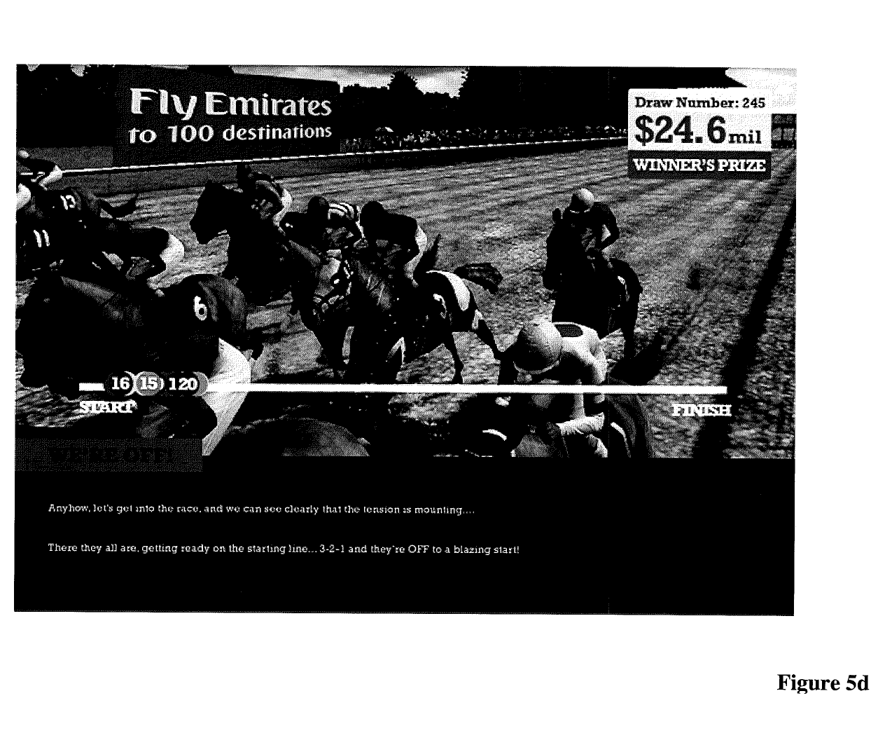

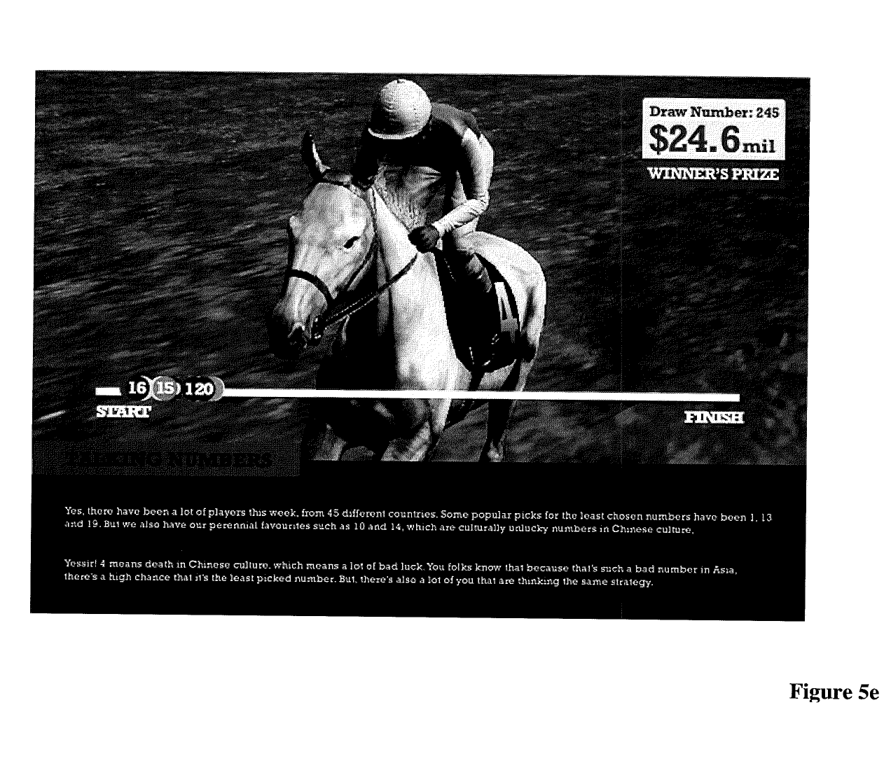

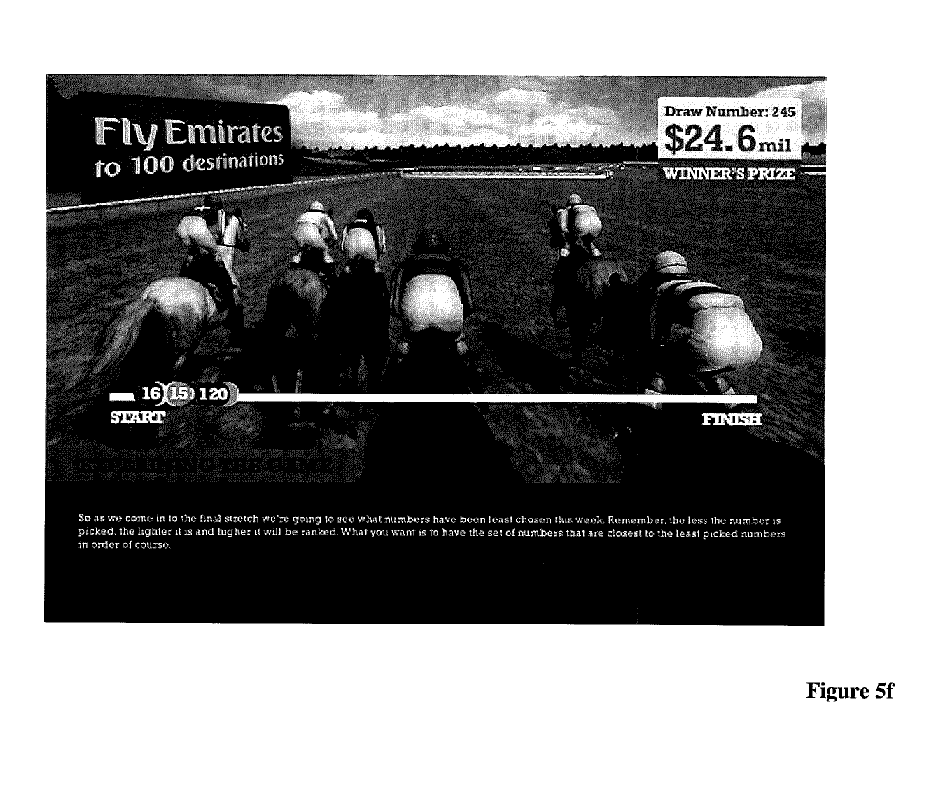

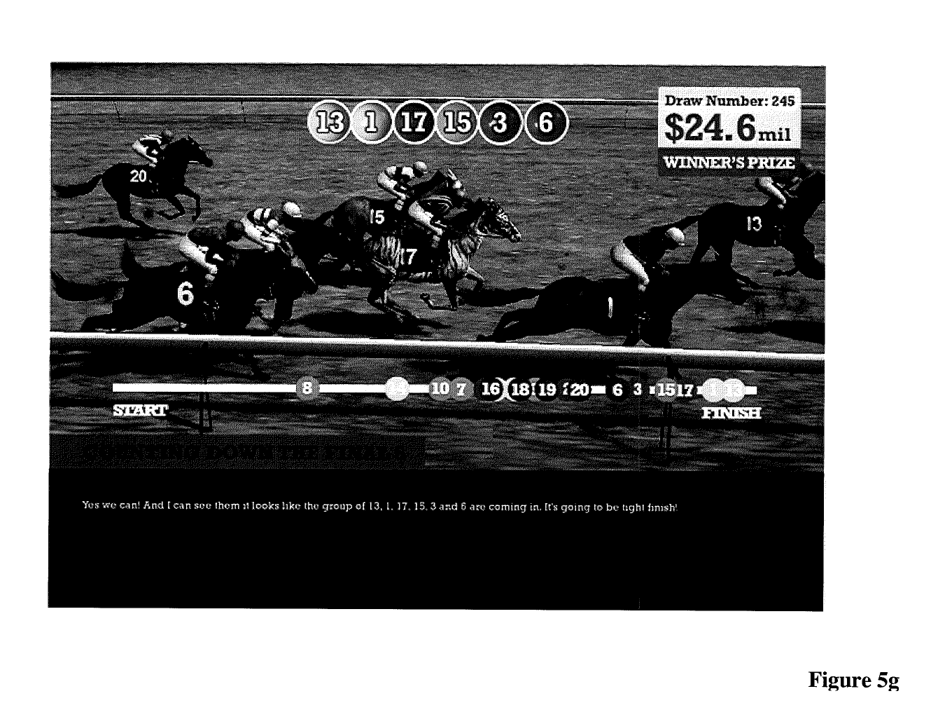

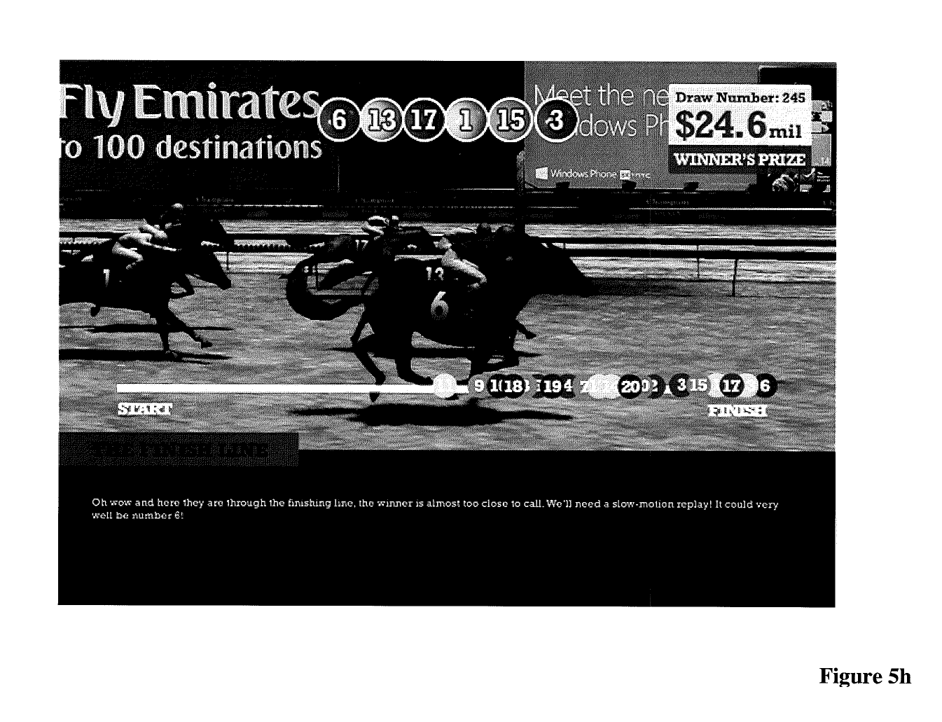

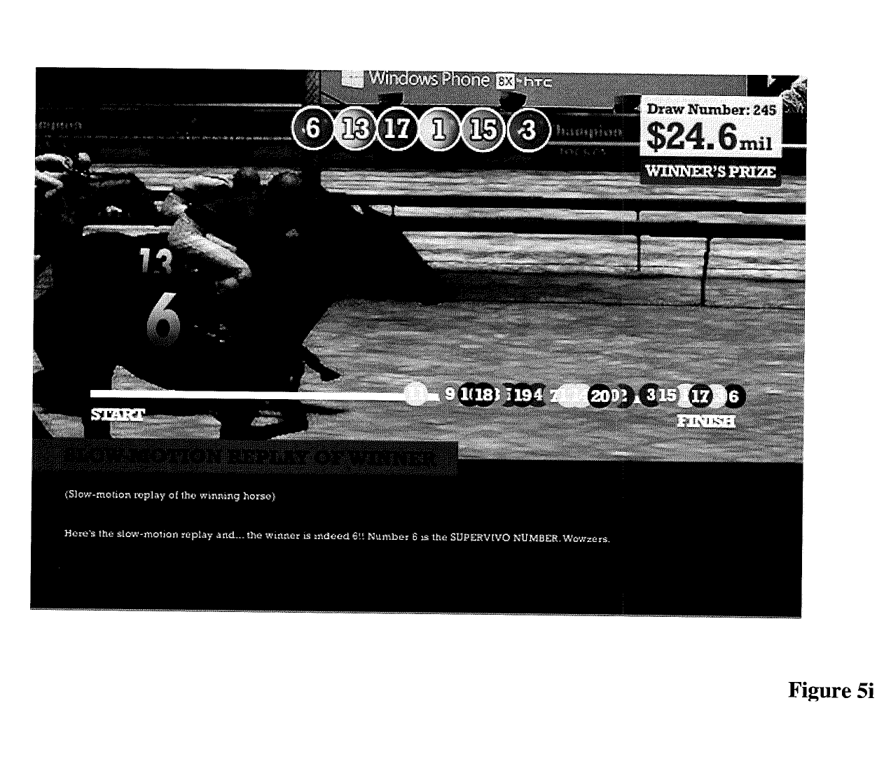

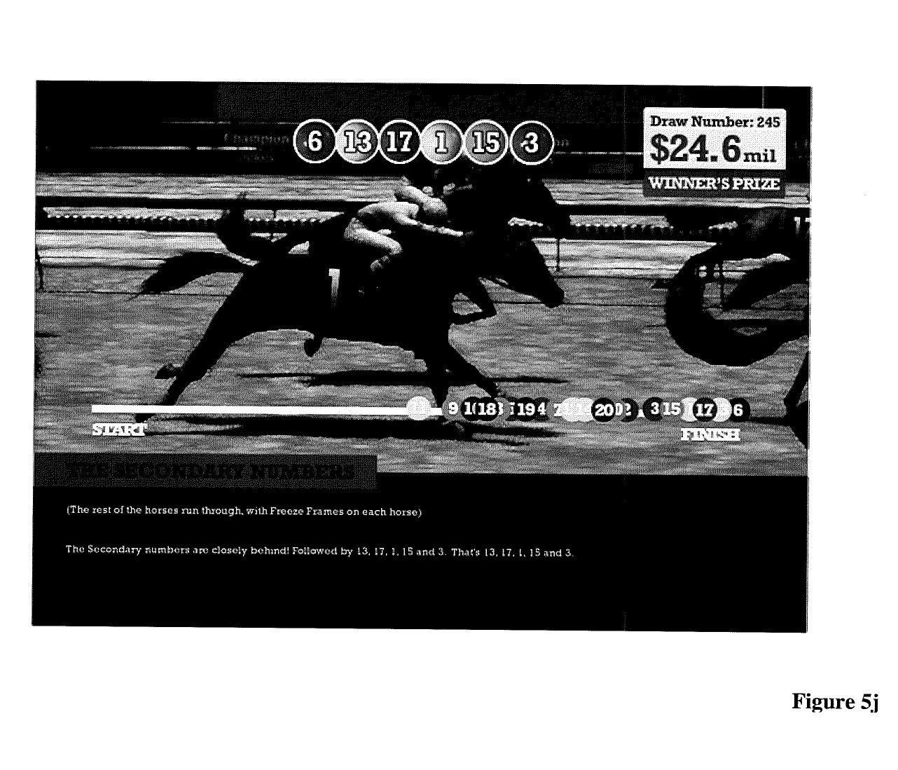

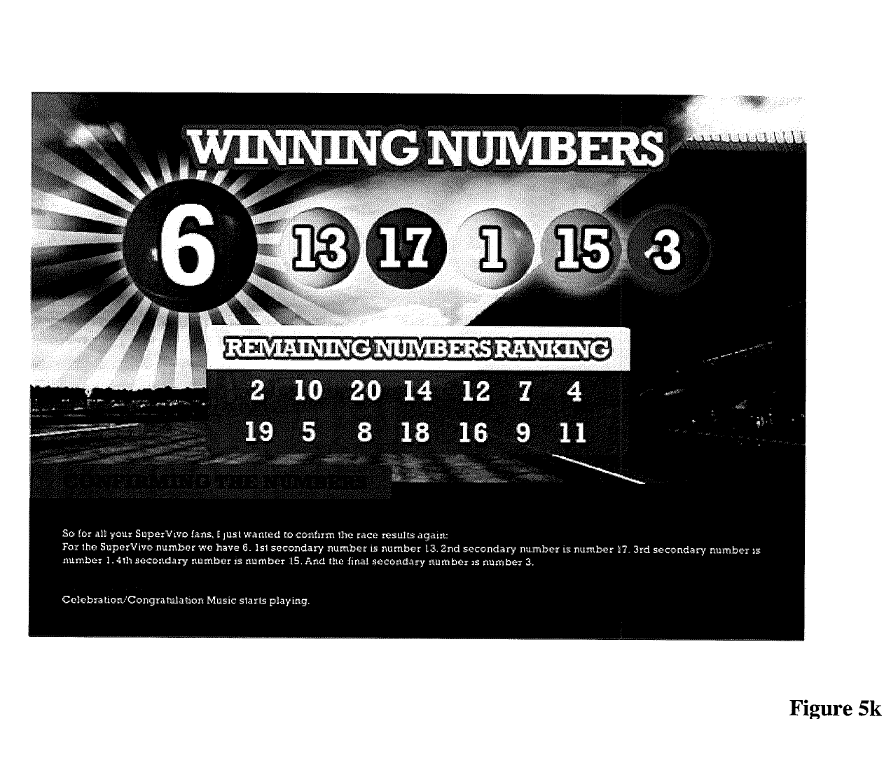

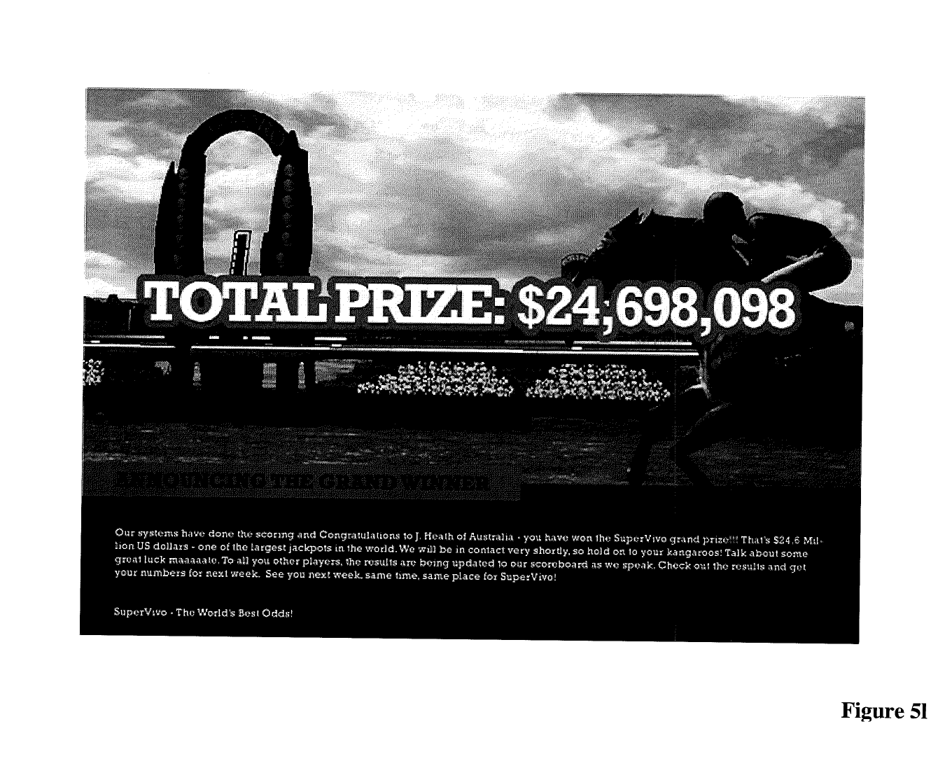

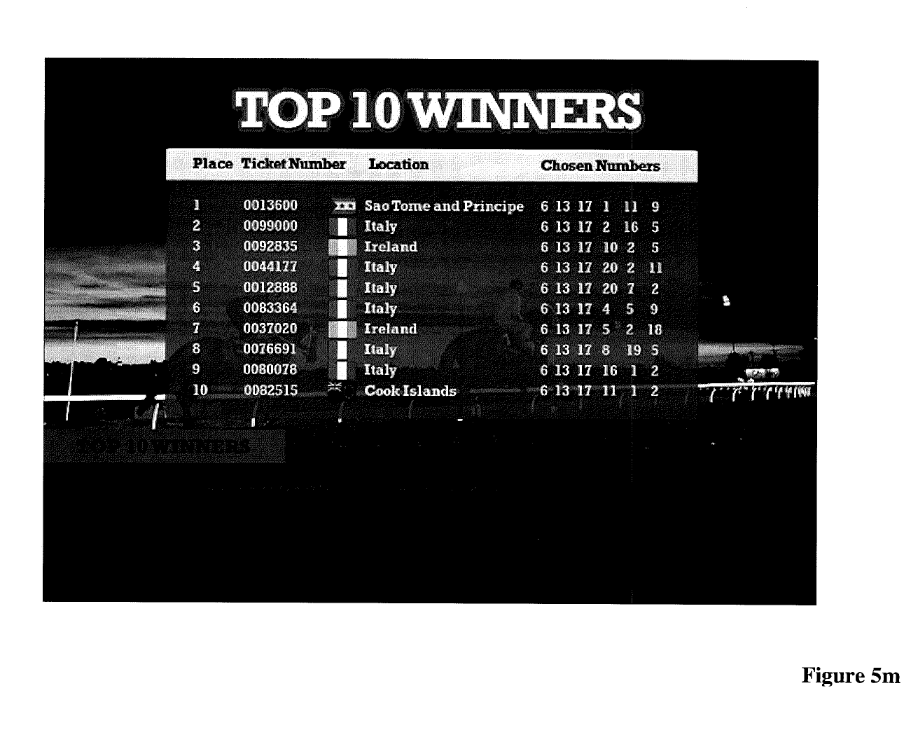

FIG. 5 is a series of computer printouts of a storyboard relating to a game design of a regional or worldwide Virtual Horse Race game where players pick six horses from a range of twenty horses.
FIG. 5a shows the front page of a story board for a Virtual Horse Race.
FIG. 56b shows the pre race set up.
FIG. 5c shows the starting line with some horses in the starting stalls.
FIG. 5d shows the early stages of the Virtual Horse Race. The draw number and winning prize is shown in the top right hand corner of the figure. Paid advertising is also displayed, along with a time line which shows the distance that the race has progressed towards the finish. At the foot of the page is shown a representation of possible discussion between the announcers and also the game mechanics.
FIG. 5e shows further discussion by the announcers of the numbers and the game mechanics as the race continues.
FIG. 5f shows further racing and includes further discussion, including game explanations.
FIG. 5g shows the horses approaching the finish of the race and shows the leading horses.
FIG. 5h shows the finish line and the winning horses.
FIG. 5i shows a slow motion replay of the winning horse winning the race, in this example the winning horse is horse 6.
FIG. 5j shows the five secondary numbers. Relevantly, the placements of the 2^{nd} to 6^{th} horses.
FIG. 5k shows the placements of each of the twenty horses in the race.
FIG. 5l shows the announcement of the winner of the game.
FIG. 5m shows the top ten winning participants in a regional or worldwide game, their ticket numbers, their country, and their chosen six numbers/horses.
FIG. 5n shows the local country winners of, in this example, the ten member countries comprising the exampled regional game.
FIG. 5o shows a control panel for participants in the game to seek further information in relation to the game, and past games.

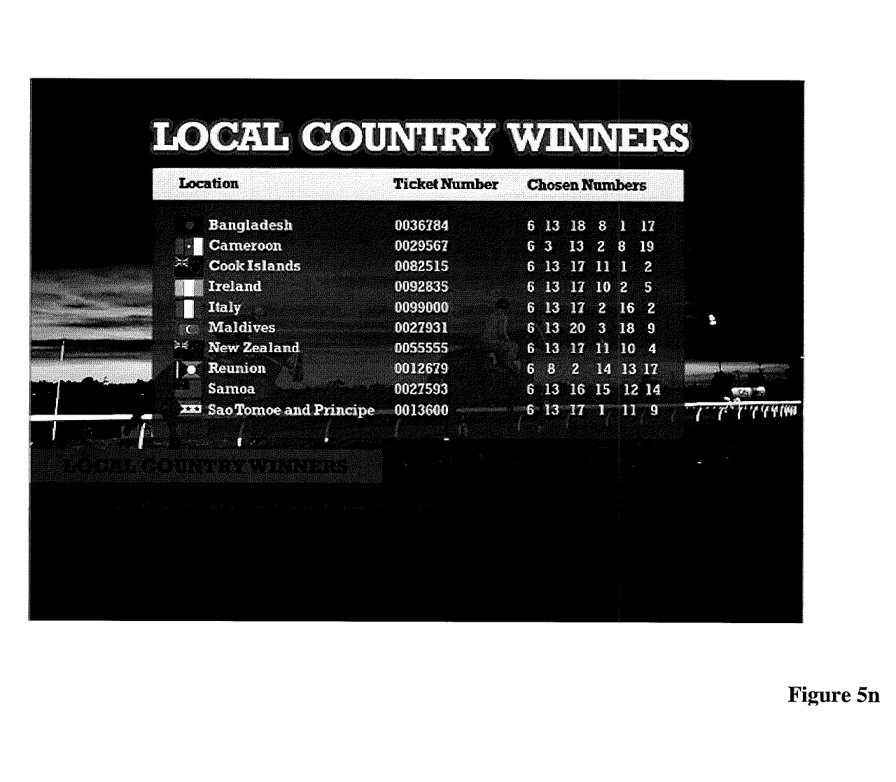

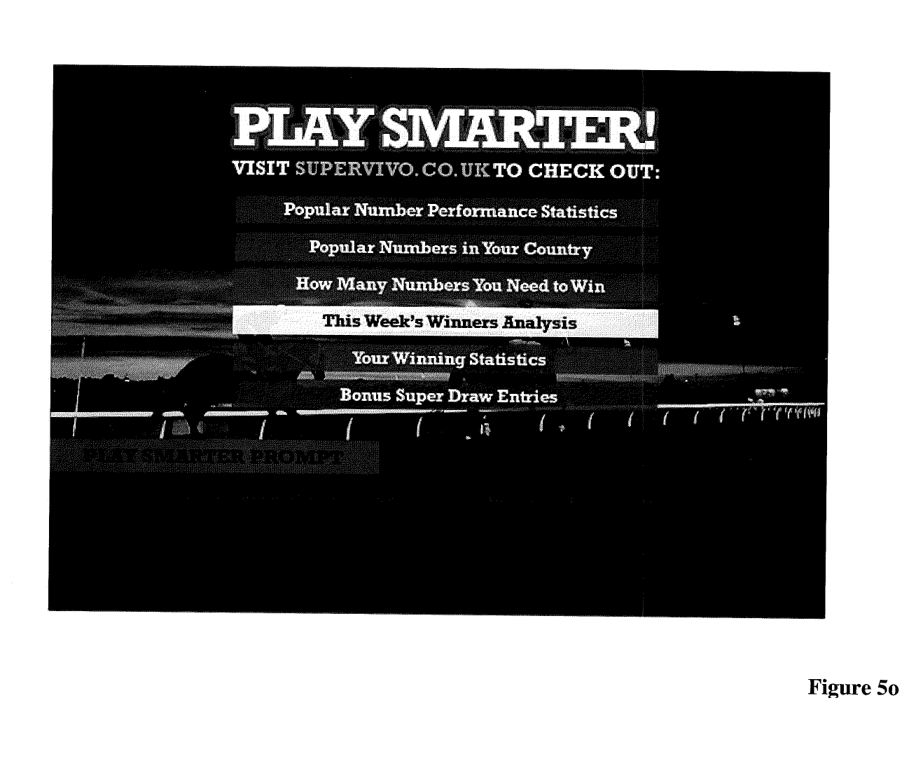

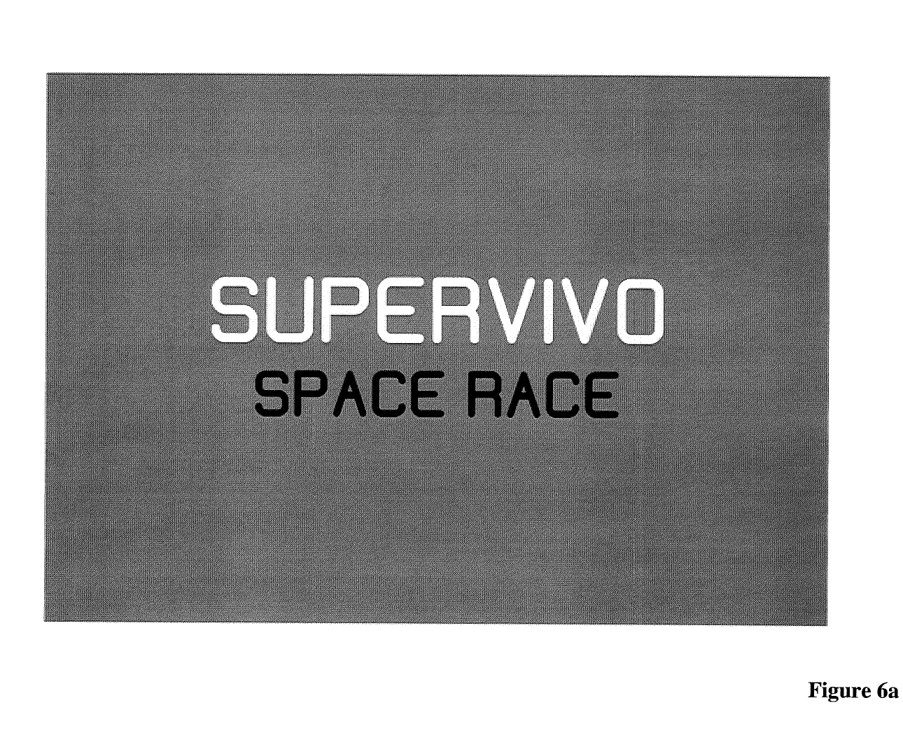

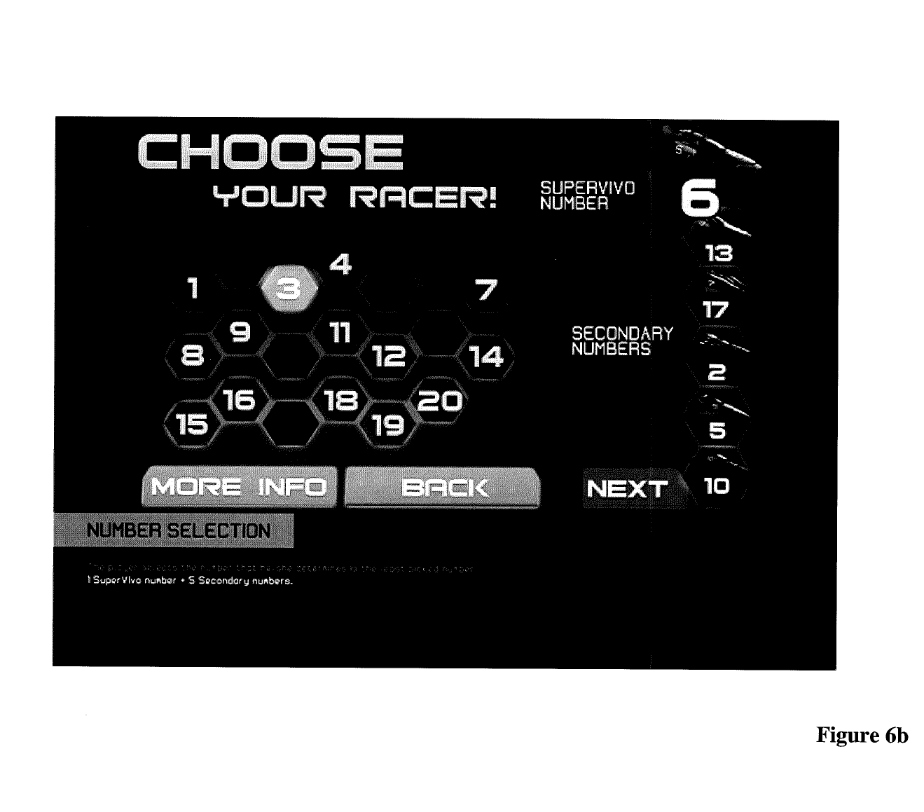

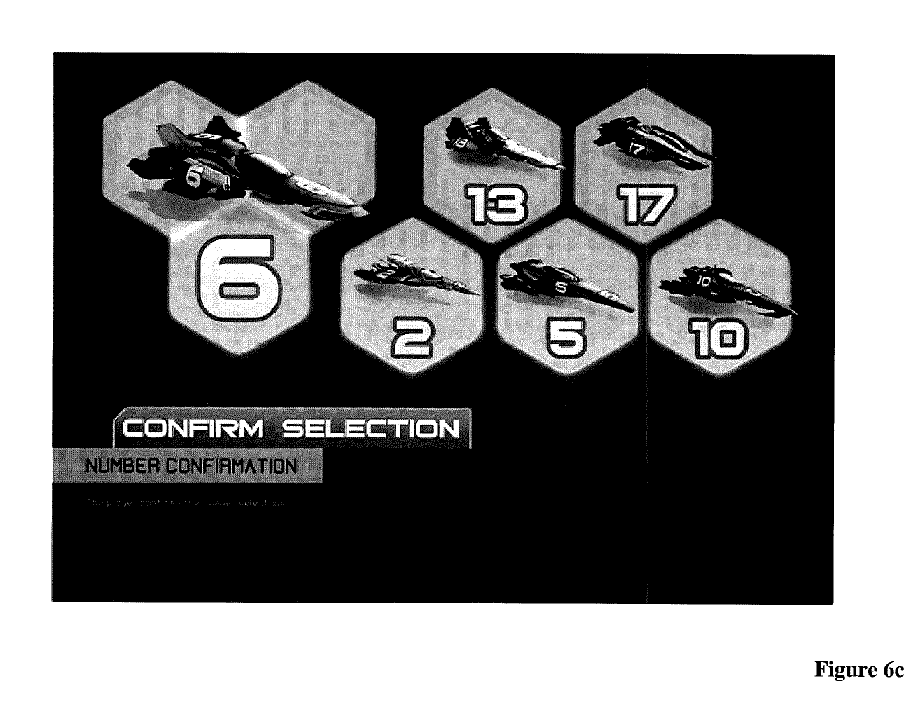

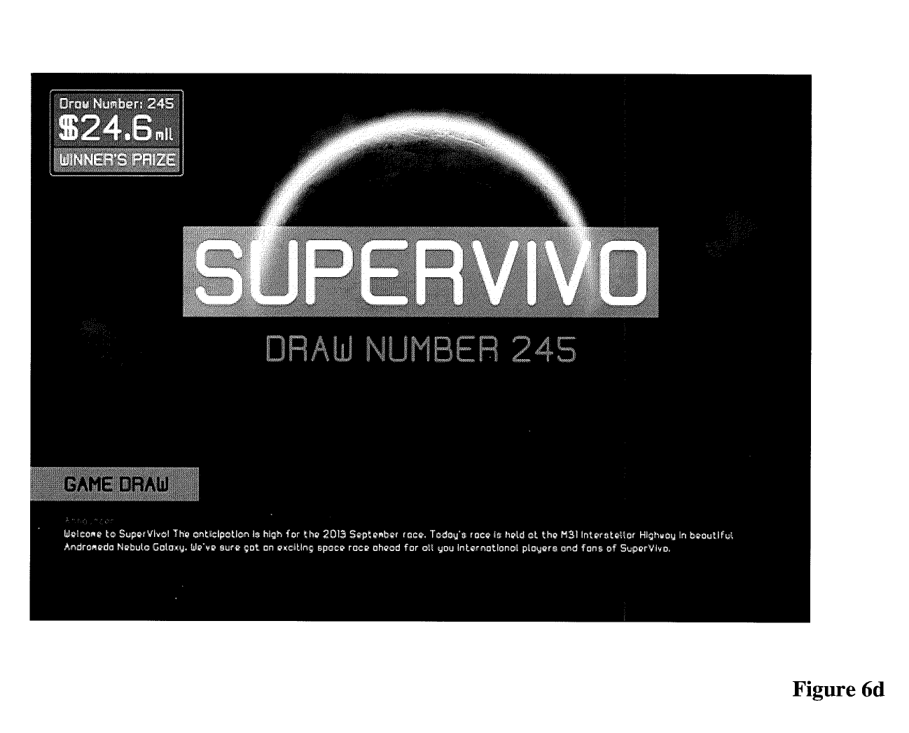

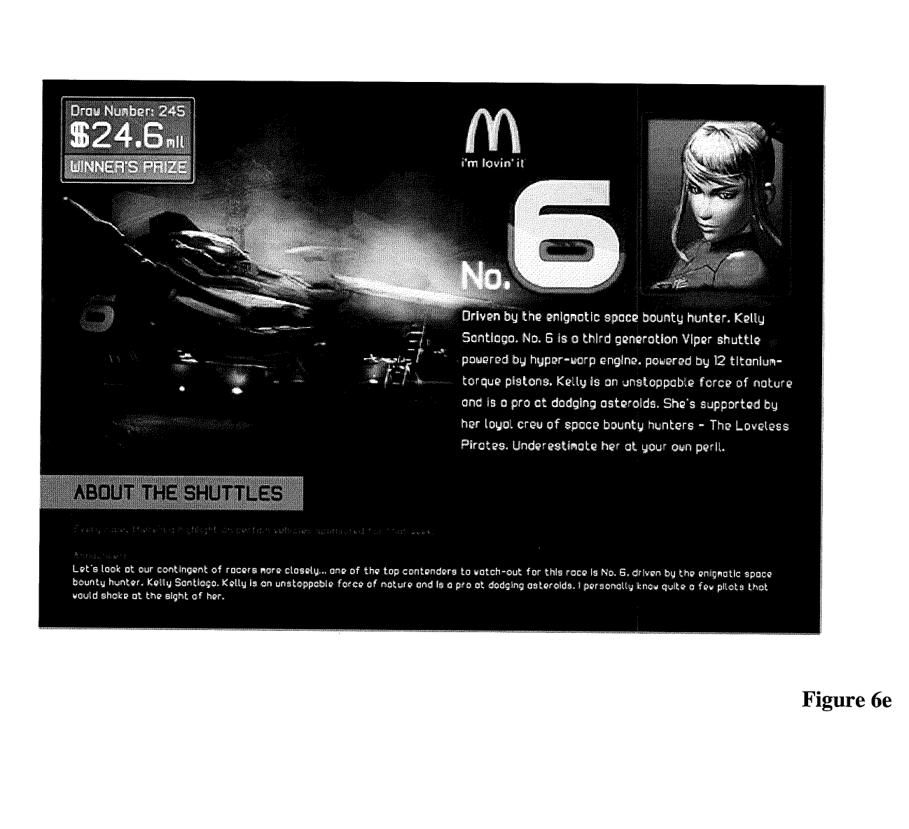

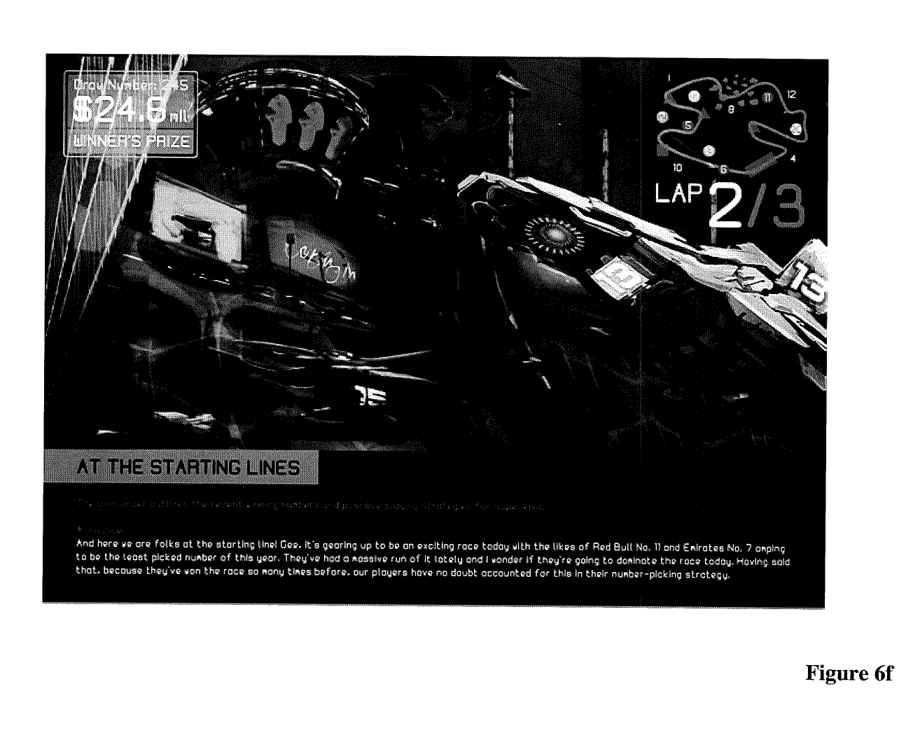

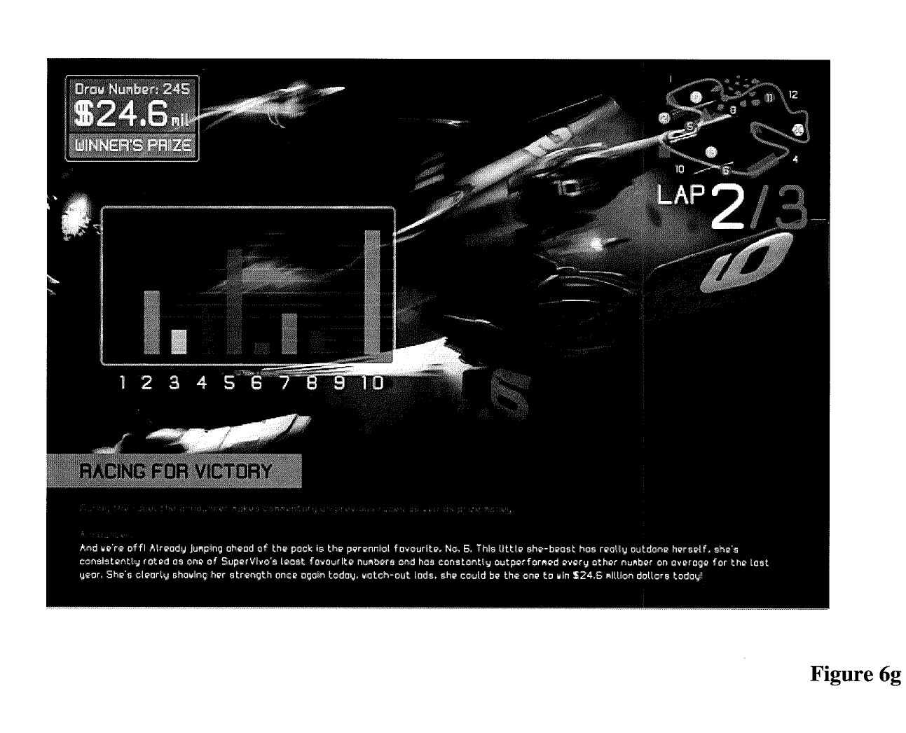

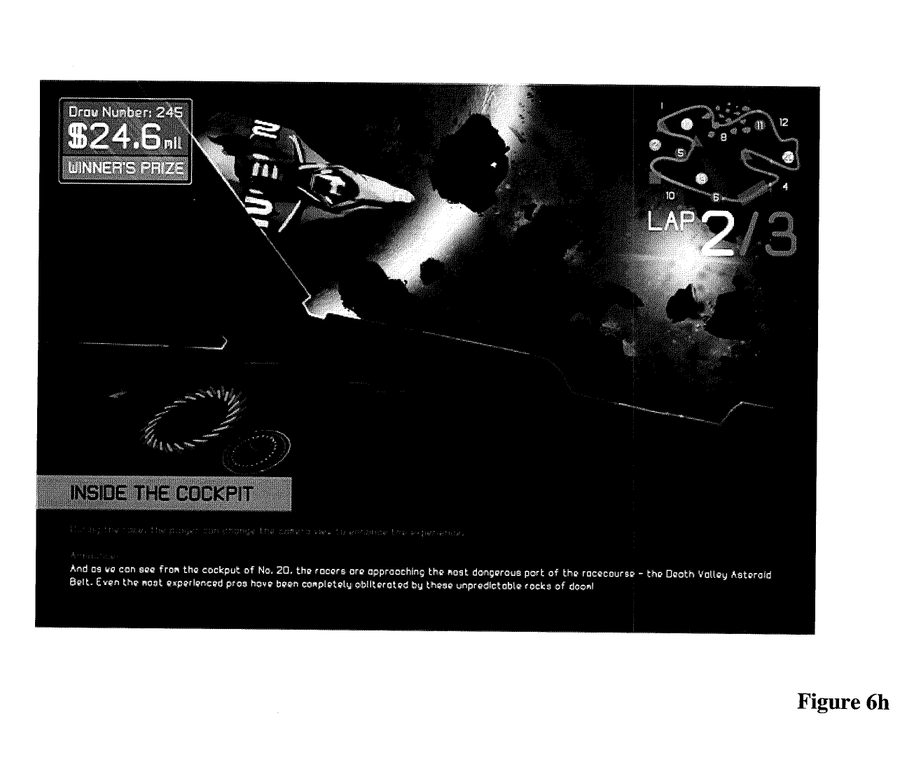

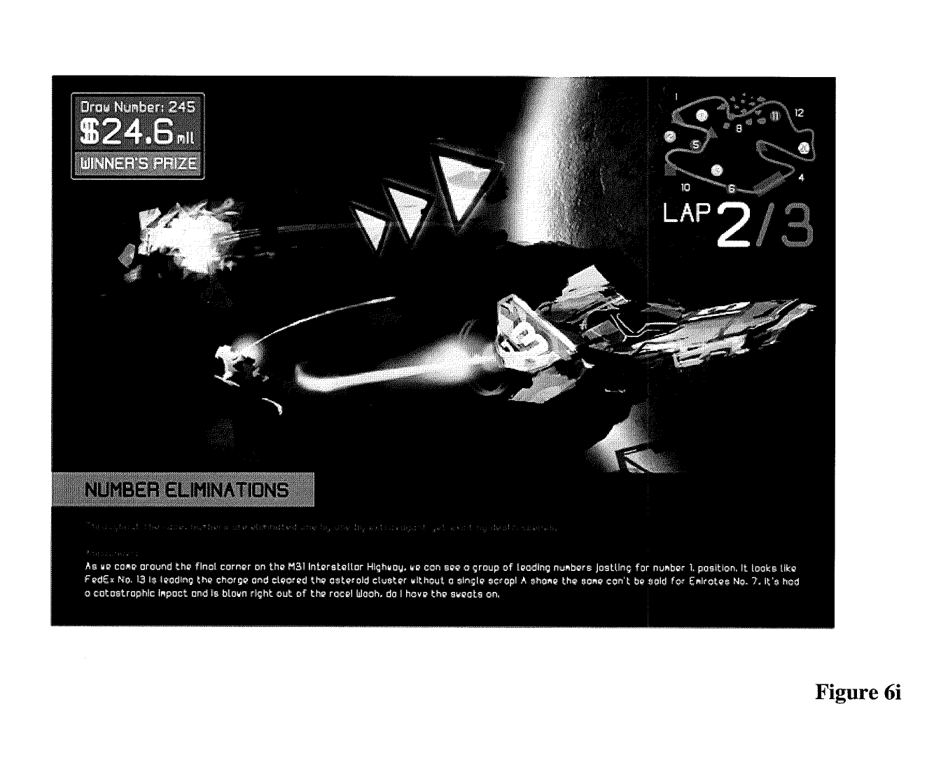

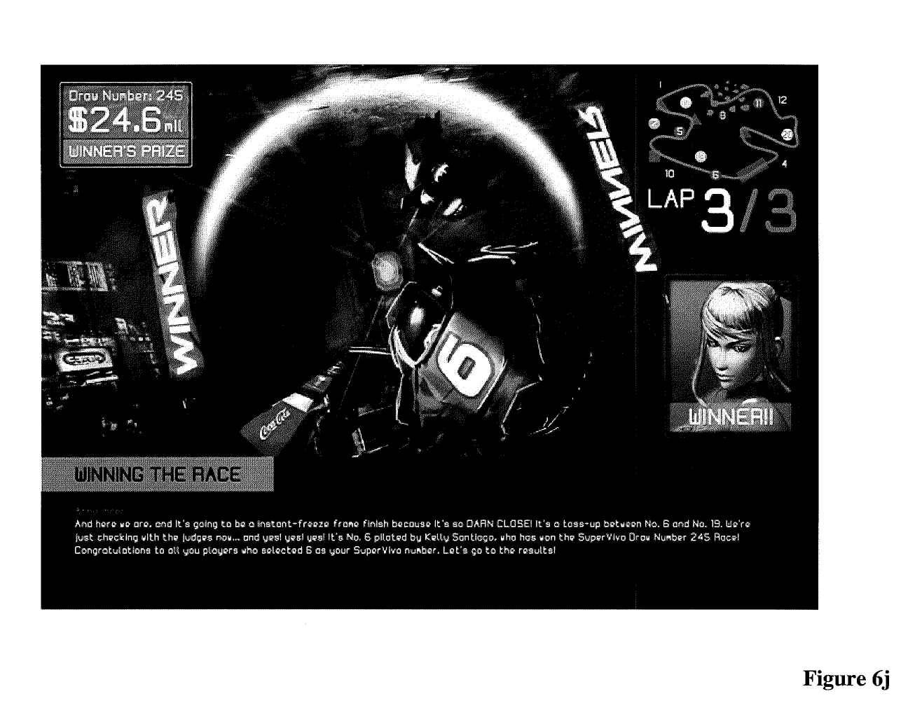

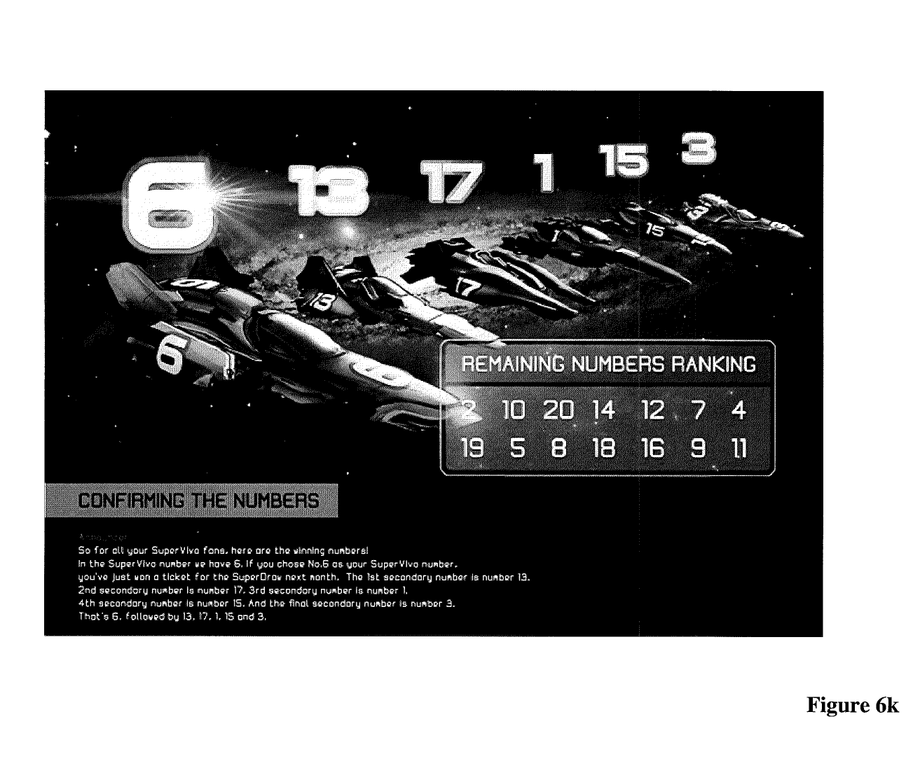

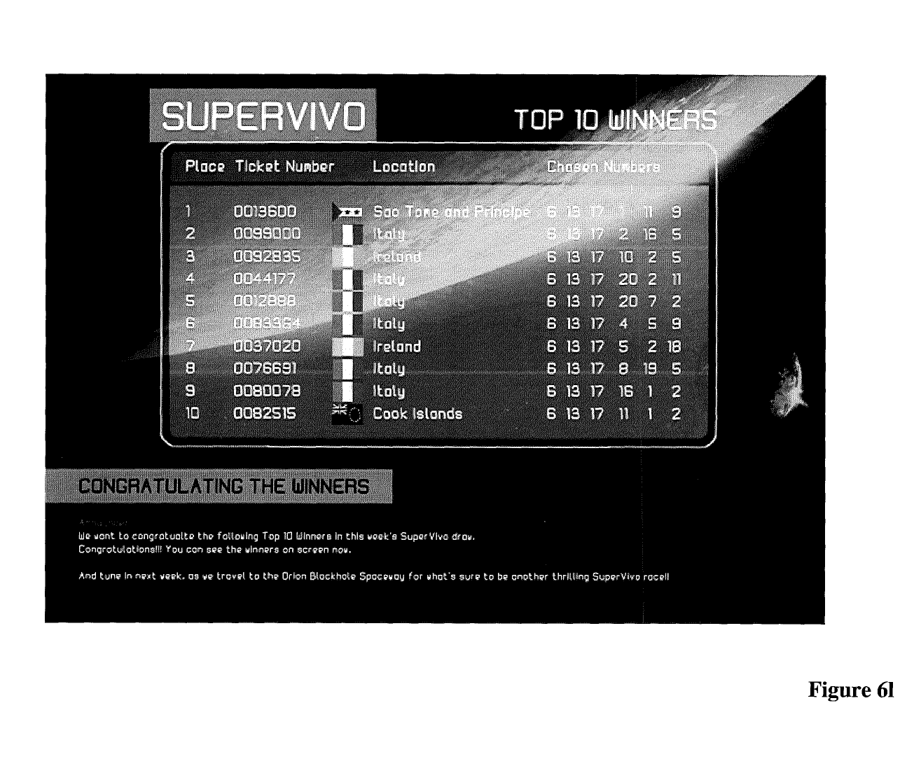

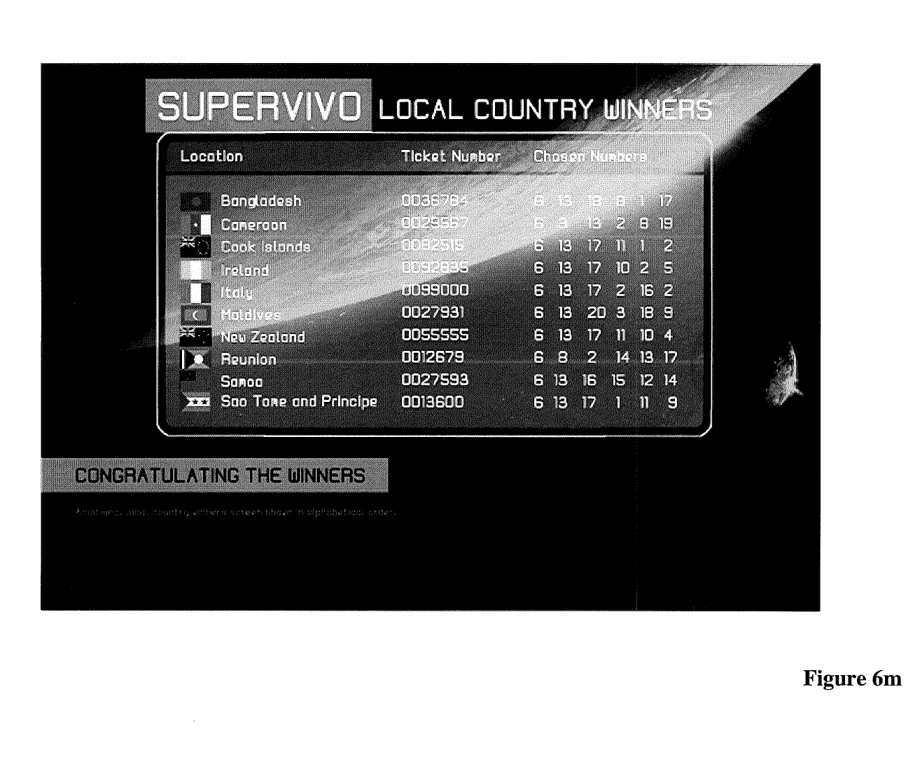

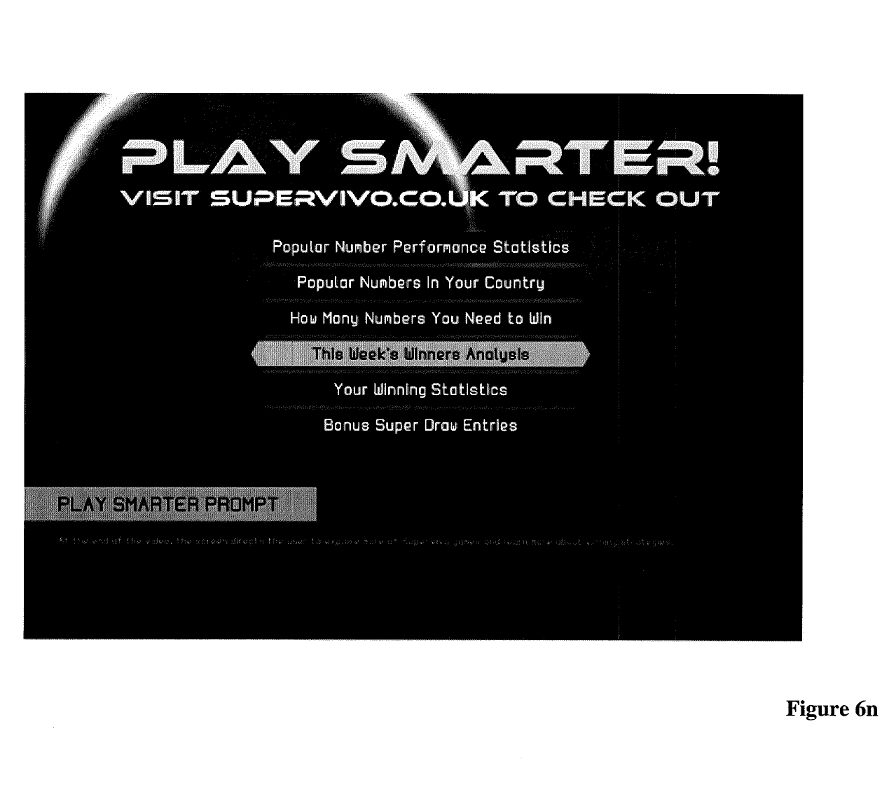

FIG. 6 is a series of computer printouts of a story board relating to a game design of a regional or worldwide Virtual Space Race game where players pick six space vehicles from a range of twenty space vehicles.
FIG. 6a shows the front page of a story board for a Virtual Space Race.
FIG. 6b shows the number/space shuttle selection panel, comprising in this example, twenty selection choices.
FIG. 6c shows the number confirmations of a participant's six number selections.
FIG. 6d shows the game draw number and the announcer's introductions. The draw number and winning prize are also shown.
FIG. 6e shows the space shuttles and the announcer's profiling of one of the shuttle drivers.
FIG. 6f shows the starting line of the Virtual Space Race.
FIG. 6g shows lap 2 of the Virtual Space Race. It also shows a course at the top right hand corner, which shows the position of the shuttles and the relevant lap.
FIG. 6h shows the inside of a space shuttle cockpit profiled during lap 2 of the race.
FIG. 6i shows an example of the number/space shuttle eliminations during lap 2 of the race. Shuttles can be eliminated by events such as that depicted of an impact with an asteroid.
FIG. 6j shows space shuttle number 6 winning the space race at the conclusion of lap 3—number 6 in this example is the least picked number/space shuttle, as least picked by all the participants in the game.
FIG. 6k shows the placements of each of the twenty space vehicles in the race.
FIG. 6l shows the top ten winning participants in a regional or worldwide game, their ticket numbers, their country, and their chosen six numbers/shuttles.
FIG. 6m shows the local country winners of, in this example, the ten member countries comprising the exampled regional game.
FIG. 6n shows a control panel for participants in the game to seek further information in relation to the game, and past games.
FIG. 6o shows examples of racetrack themes for a Virtual Space Race.

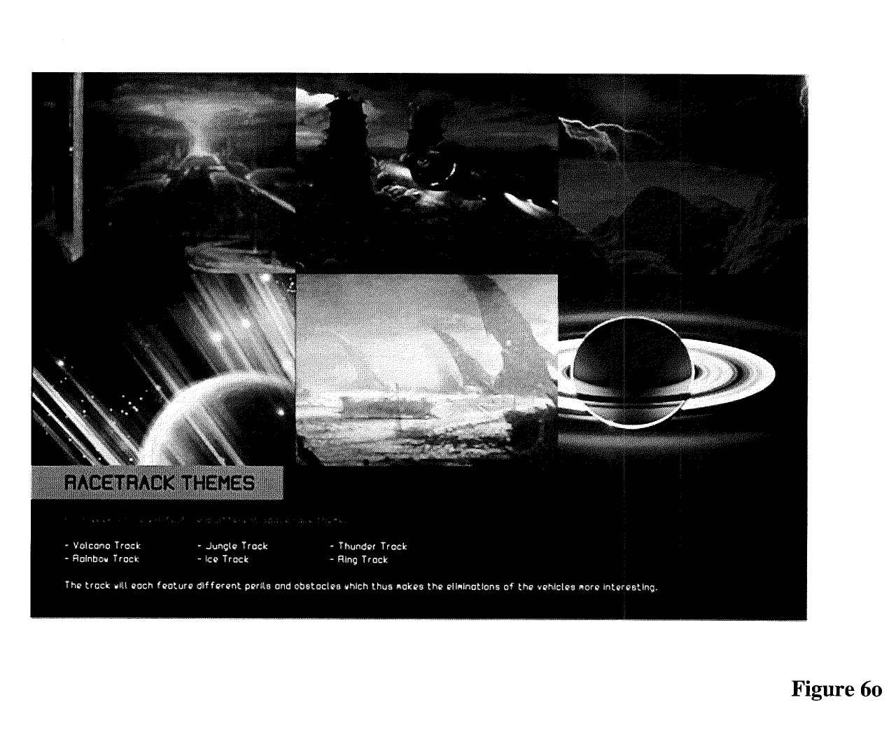

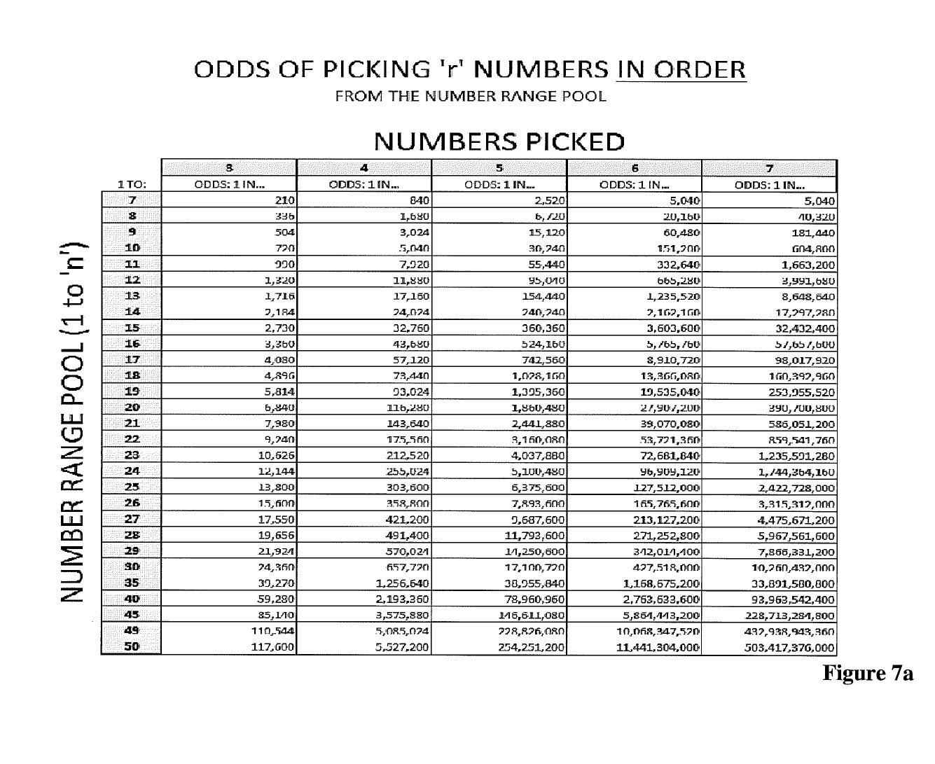

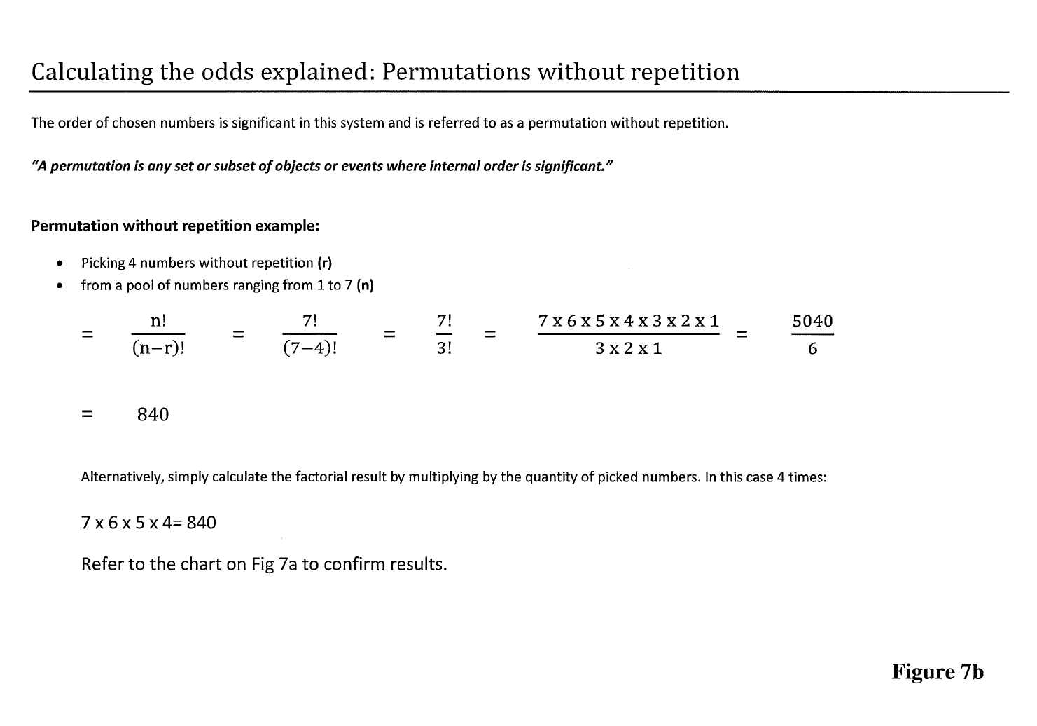

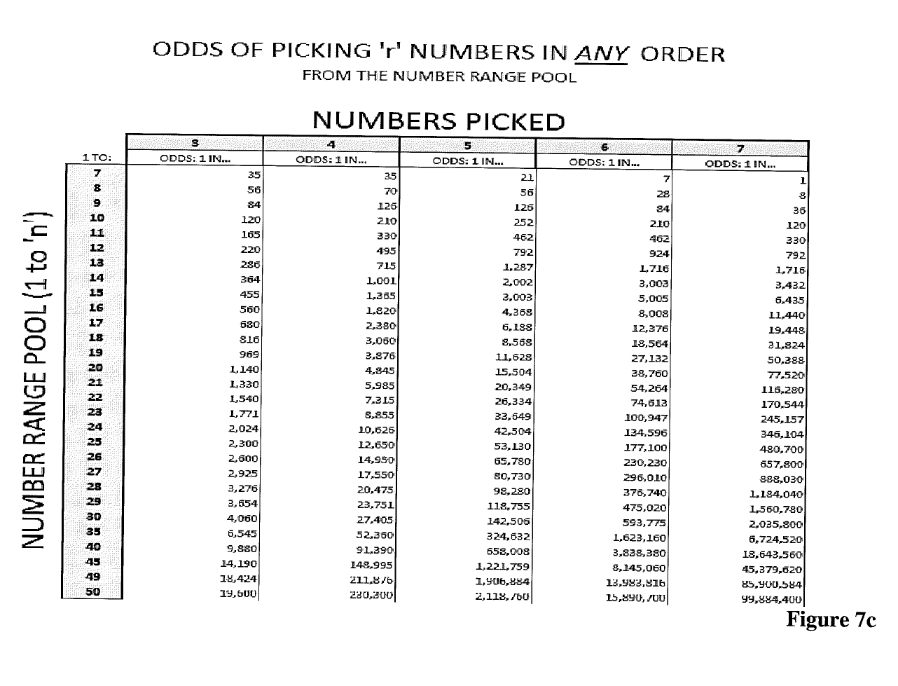

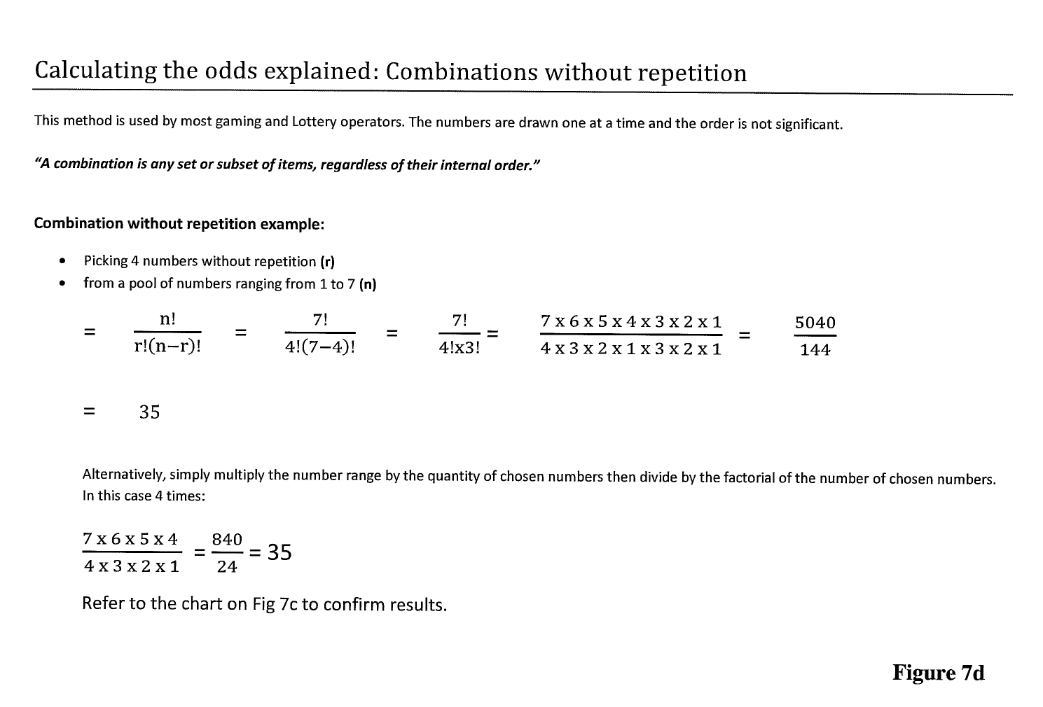

FIG. 7 shows the odds of picking ‘r’ numbers from a range of ‘n’ numbers and the calculations required to determine those odds.
FIG. 7a is a table showing the odds of picking ‘r’ numbers in order from a number pool range (from a range of available numbers from one to n).
FIG. 7b shows the calculation used to calculate the odds represented in FIG. 7a.
FIG. 7c is a table showing the odds of picking ‘r’ numbers in any order from a number range.
FIG. 7d shows the calculations used to calculate the odds represented in FIG. 7c.

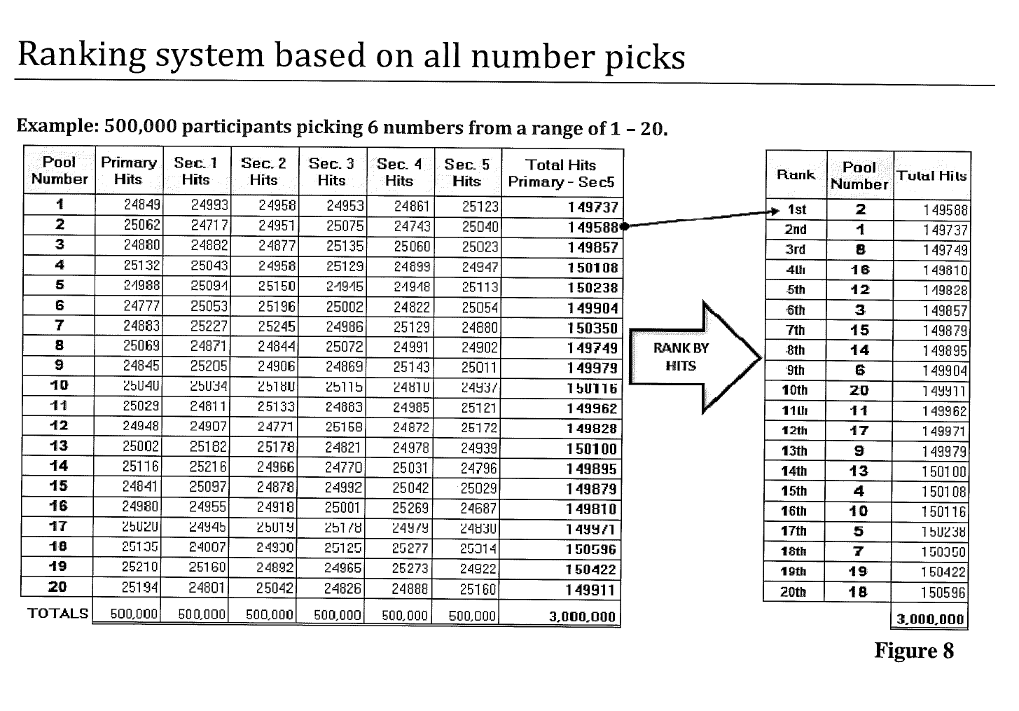

FIG. 8 shows the ranking of the n numbers, in this example the ranking of 20 n numbers, being determined using all n number picks of, in this example, 500,000 participants picking 6 numbers from a number range of 1-20. As can be seen from the “Total Hits” column, the total number of hits (or total number of picks) is a total of 3,000,000—i.e. 500,000×6=3,000,000.

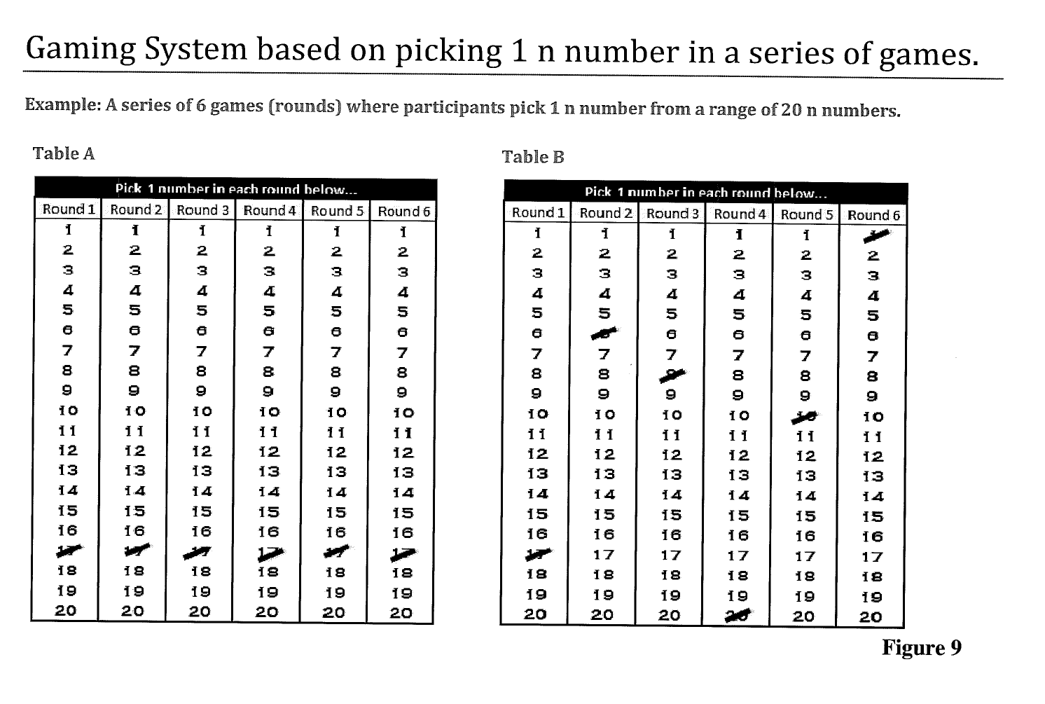

FIG. 9 shows, the invention being used in a series of games, where in this example, the participants pick one n number from a range of 20 n numbers, and participants make their picks from six rounds of the game. Table A shows a participant selecting the same n number (number 17) in each of the six rounds of the game. Table B shows a participant selecting a different n number in each of the six rounds of games (numbers: 17, 6, 8, 20, 10 and 1).

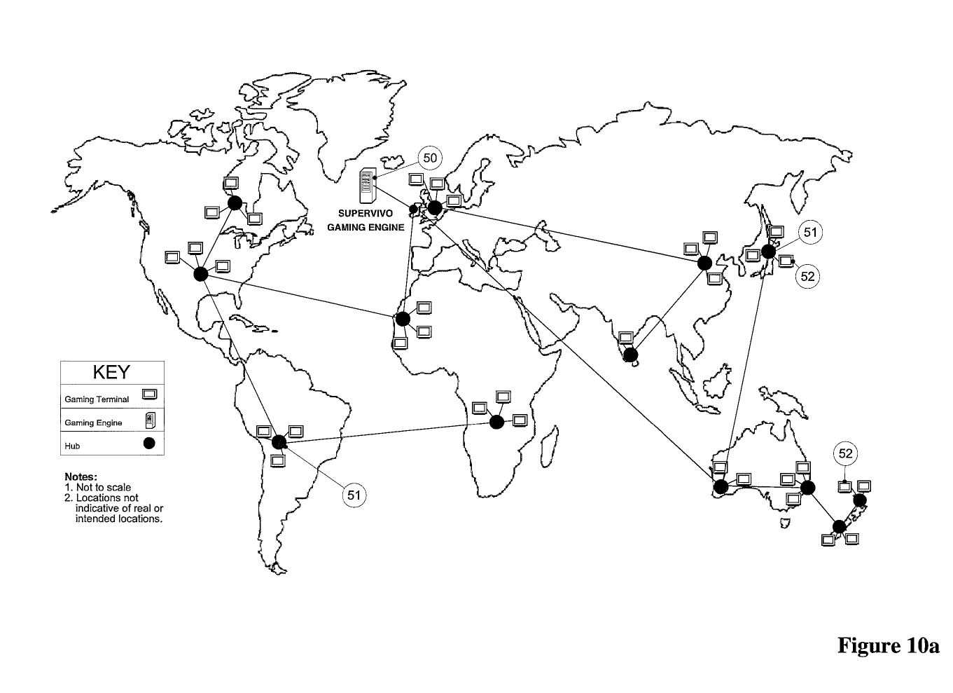

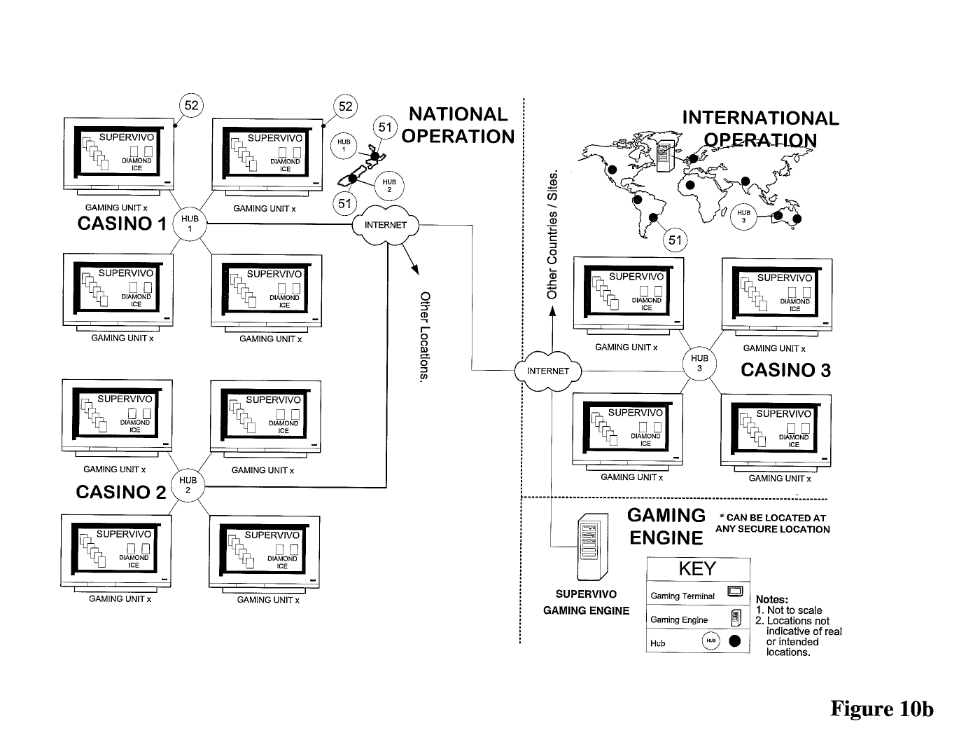

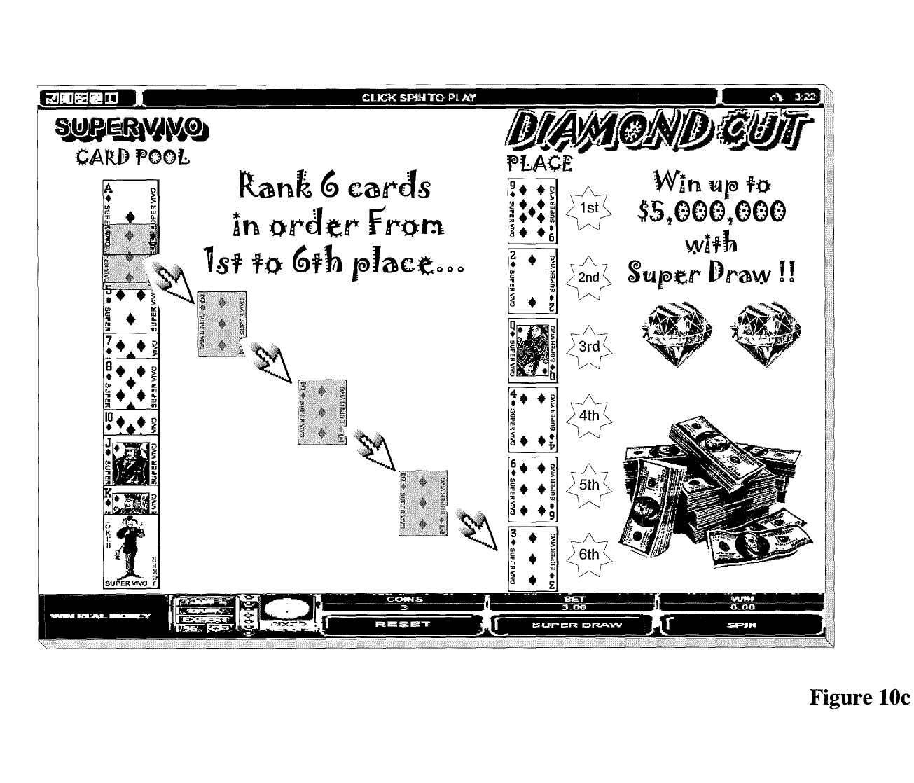

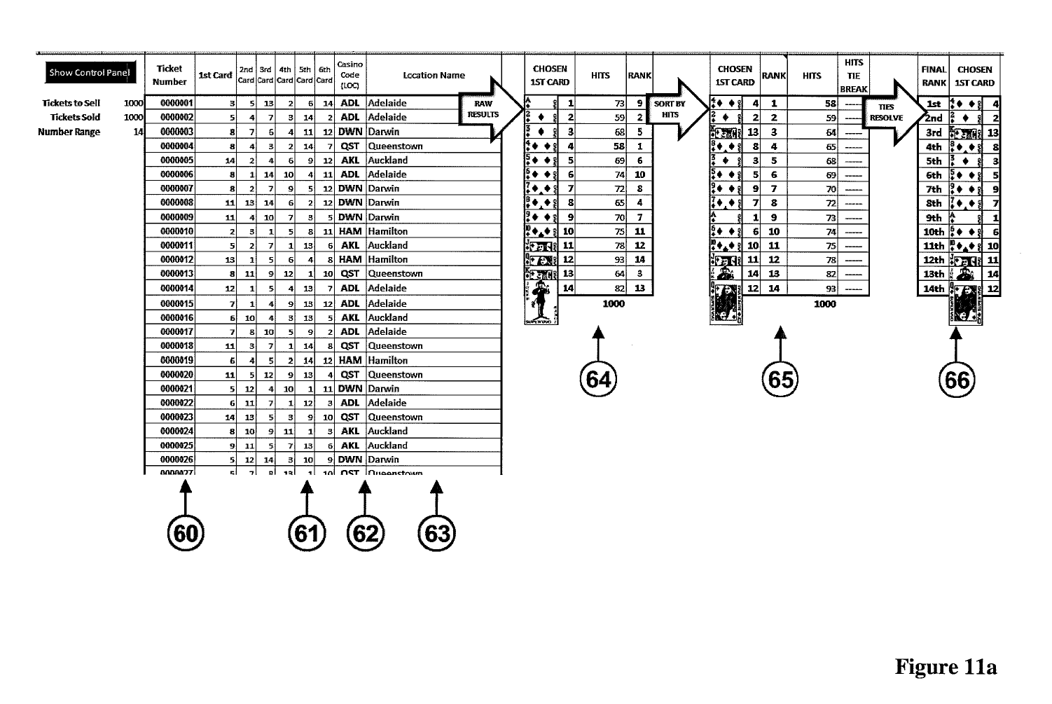

FIG. 10 shows a diagrammatic representation of the invention used in a card game played over a number of countries. The representation shows:
FIG. 10a shows a diagrammatic representation of a card game according to the invention played over a number of countries (this is also relevant to other uses of the invention played over a number of countries),
FIG. 1b shows in diagrammatic form a card game according to the invention over several countries, showing an exampled national and international operation,
FIG. 10c shows a possible promotion for a card based game using the present invention.

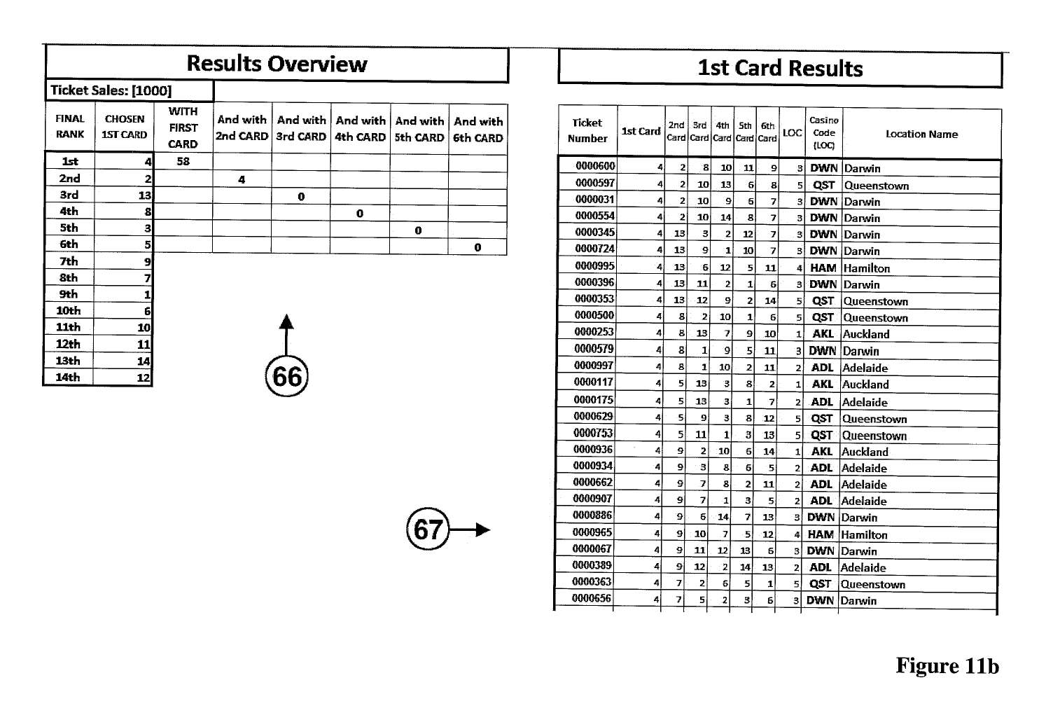

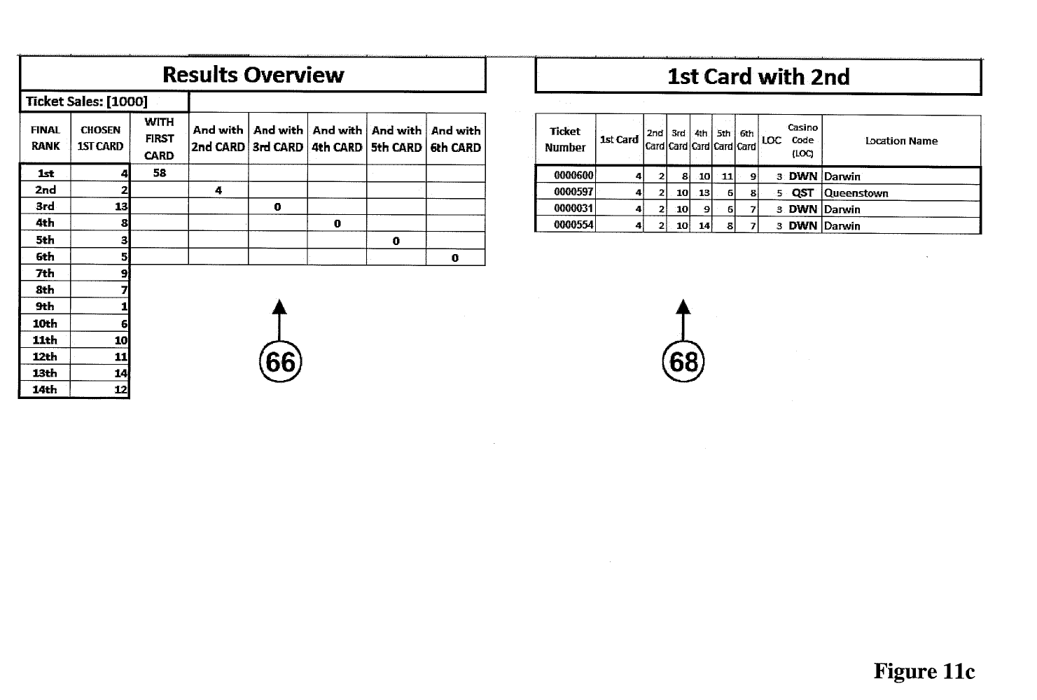

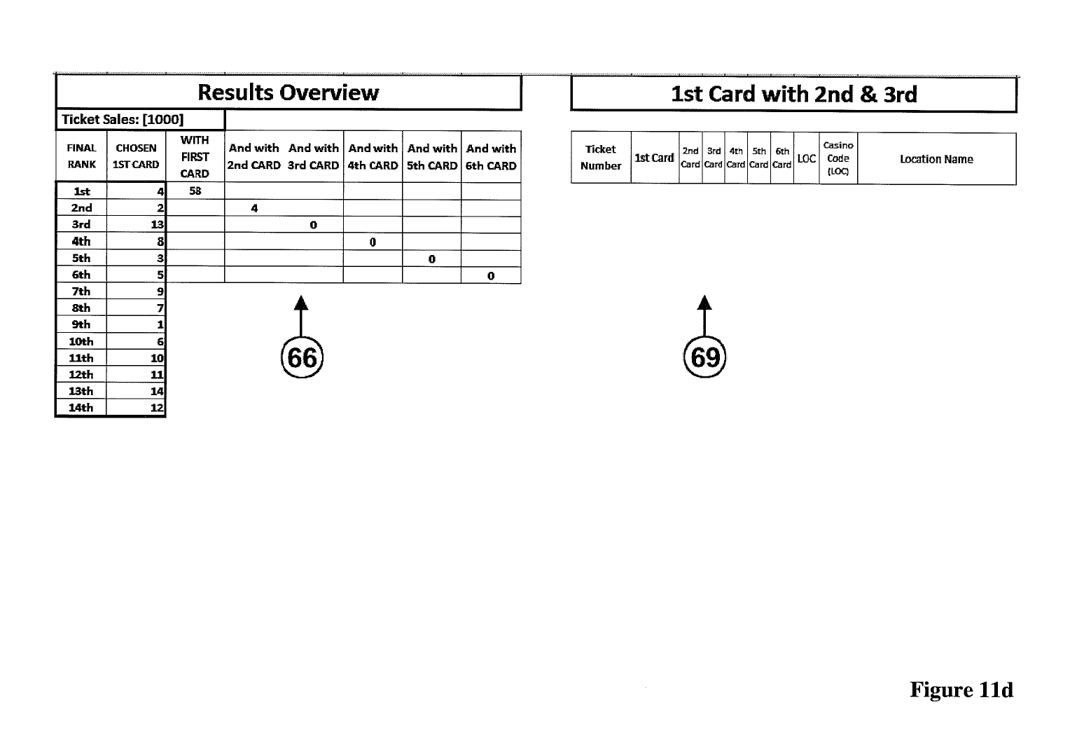

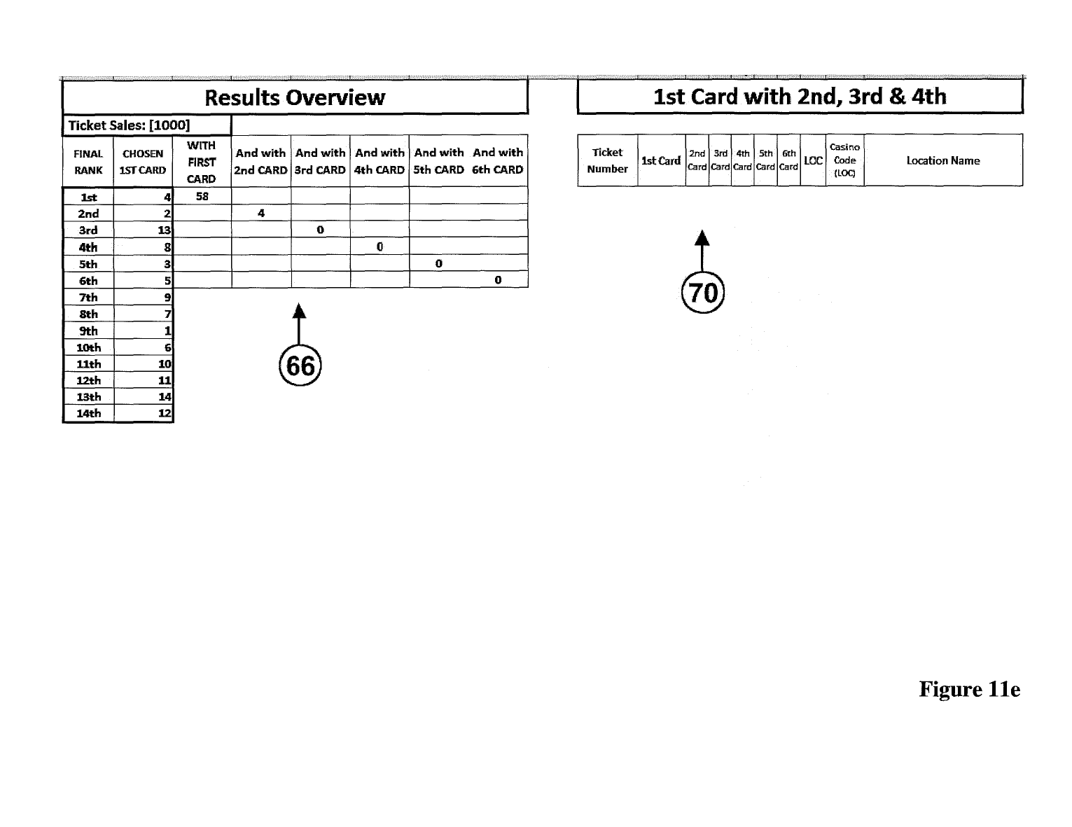

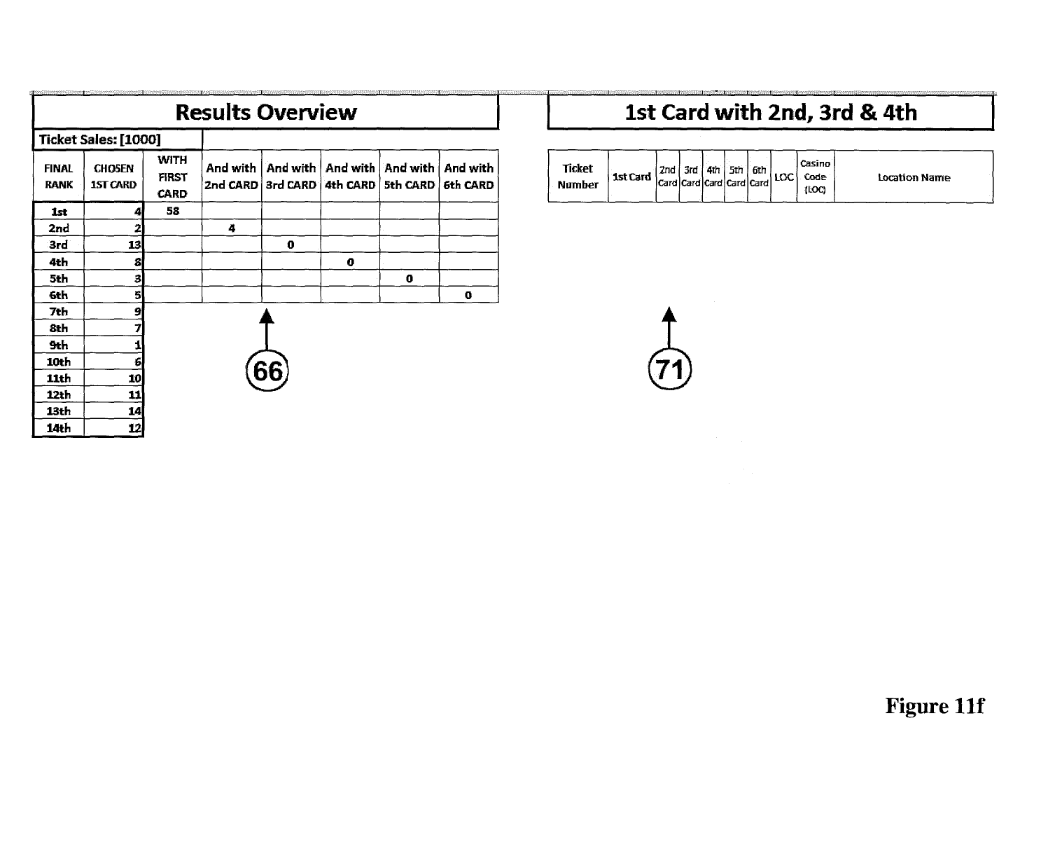

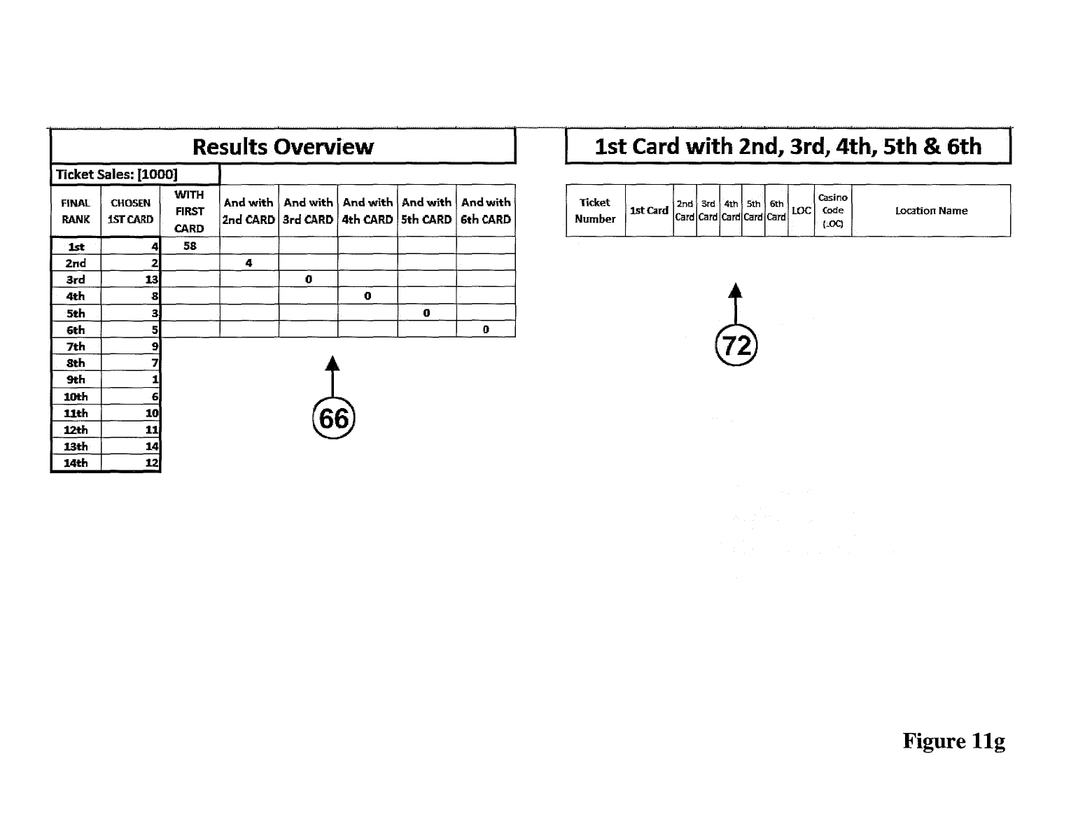

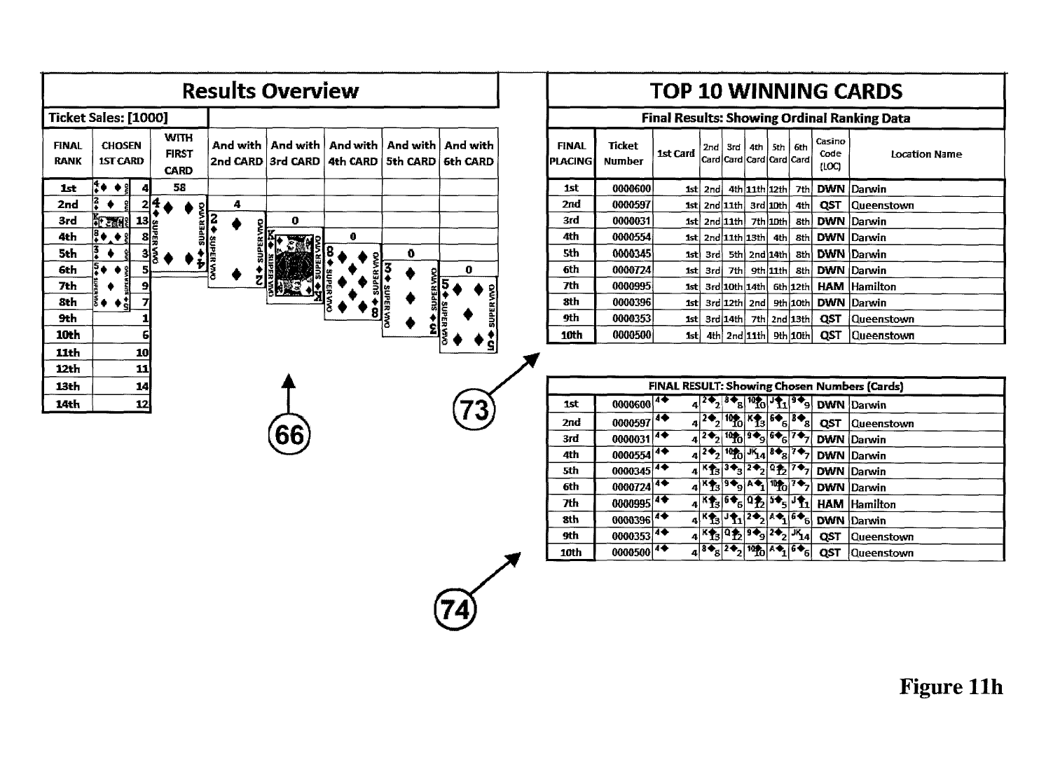

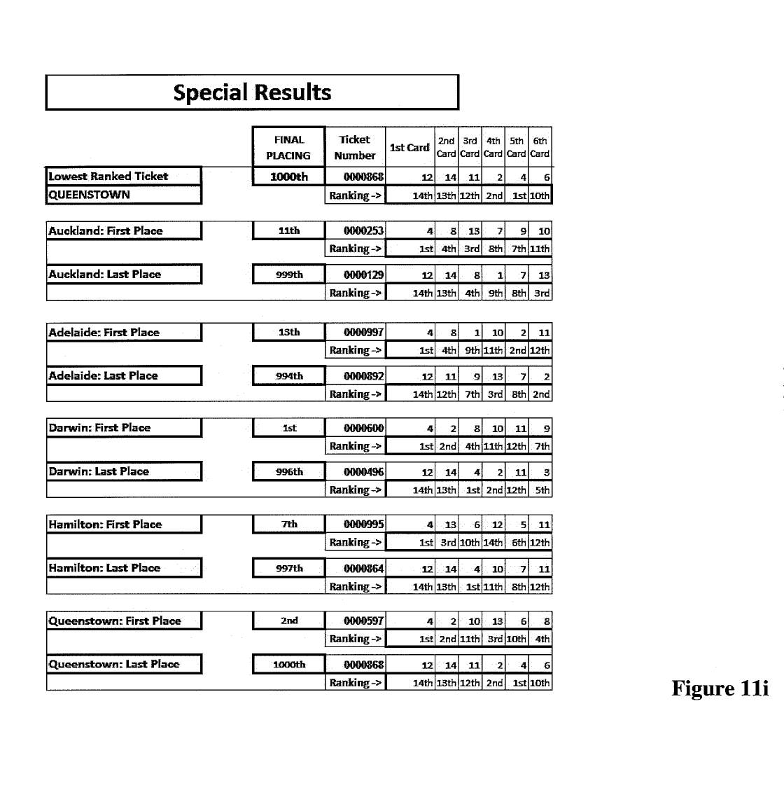

FIG. 11 shows, in tabular form and by way of a series of computer printouts, the progress of the card game as set out in Example 10 and FIG. 10c, a method of processing by a computer the results for a 1,000 participant card game, with players entering from a number of selected locations. The series of computer printouts show:
FIG. 11a shows the ticket sales and the calculation of the ranking system from this example of the game. Ticket numbers 1-26 and each of their 6 chosen cards (represented by numbers) are shown on FIG. 11a, but noting that these ticket numbers continue until ticket number 1,000, as in this example there are 1,000 participants in the card game. The raw results are then processed recording how many times each of the 14 cards in the card range of 14 were chosen (“hits”) by participants as their first card choice in the game. The total number of hits is equal to the number of participants in the game, in this example the hits total 1,000. The first card choices of the 1,000 players are then used to rank the 14 cards that were available to be chosen. The 14 cards are ranked by the number of ‘hits’ or picks attributed to each of the 14 cards, determined by the results from participants making their first card choices. Some cards may be tied with the same number of hits and if so the ties would be resolved, preferably using the methods set out in FIG. 3. However in this example there are no ties. Finally FIG. 11a shows the final rankings of the 14 cards.
FIG. 11b shows a results overview of the card game, and lists all those 58 participants out of the 1,000 participants playing the card game that correctly chose as their first card choice, the card that was least picked—in this example it is card 4 (the 4 of Diamonds).
FIG. 11c shows a results overview of the card game, and lists all those 4 participants out of the 58 participants. These 4 participants correctly chose as their first card choice, the card that was least picked—in this example it is card 4 (the 4 of Diamonds) and also correctly chose as their second card choice, the card in the unique rankings that was the 2nd least picked—in this example it is card number 2 (the 2 of Diamonds).
FIGS. 11d, 11e, 11f, and 11g shows that there are no participants that, having reached the stage set out in FIG. 11c above, also correctly chose in order, the cards that were ranked 3^{rd}, then 4^{th}, then 5^{th} and then 6^{th} as identified in the ranking list in FIG. 11a. Note that FIGS. 11d, 11e, 11f, and 11g would progressively show results in other examples of the card game where the number of participants is significantly increased from this example of 1,000.
FIG. 11h shows the Top Ten Results in the card game. The Top 10 are firstly shown by ordinal ranking, and then by the participant's chosen cards. The sole winner is ticket number 600. Second place is ticket number 597, etc.
FIG. 11i shows Special Results. Ticket number 868 is identified as the “Lowest Ranked Ticket”, with a placing of 1,000^{th} (i.e. last place). And for each participating operator, the first and last placed participant from that operator's pool of players is also identified.

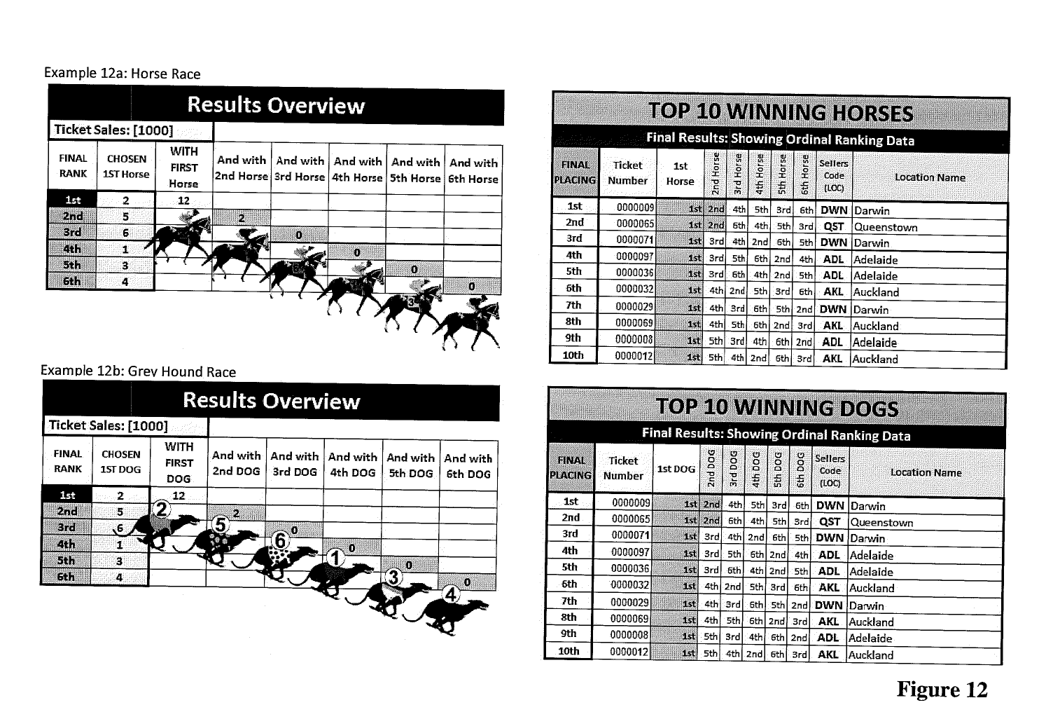

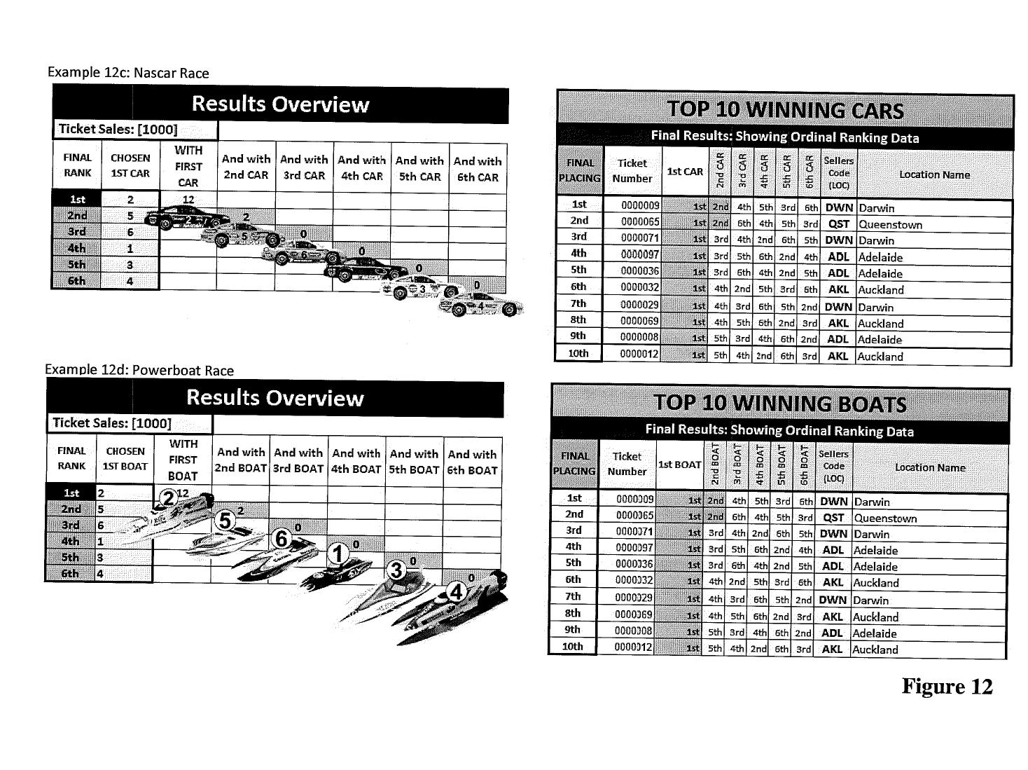

FIGS. 12a-d shows alternative forms of presenting the invention, with examples of a horse race, grey hound race, NASCAR race and a power boat race.

### PREFERRED FORMS OF THE INVENTION

A lottery process is set forth in U.S. Pat. No. 7,100,822, the whole of which is incorporated into this specification by reference.

In U.S. Pat. No. 7,100,822 a computer based gaming system is described which allows entries to be sold over the telephone, by ATM or POS machines, by email, or via kiosks, in which participants are invited to choose at least one unique number from a defined range of n numbers. The participants register their selection with an entry-logging engine (“transaction engine”) which records the identity or contact details of the participant, the number or numbers selected by the participant, the date and time and place of the entry, and the transaction engine giving the participant a receipt or ticket number.

In this invention, when used in the preferred mode, and at least in one respect, the overall objective for each participant generally remains the same as contemplated by patent specification U.S. Pat. No. 7,100,822. That is to pick a number is that is/are least and preferably not picked by all other participants in the game or lottery.

However, this invention differs in many ways from U.S. Pat. No. 7,100,822.

For example, it also provides a useful method in respect of symbols (including numbers) that are most picked, although we believe that implementation of the invention will mostly occur using the least picked approach for reasons that we have set out previously.

This invention also provides a useful method of always getting to a winning result, and doing so within a set timeframe without otherwise relying on the game to ‘run its course’ as is the case in respect of games described in U.S. Pat. No. 7,100,822 (which can only be overcome in games using the methods described in U.S. Pat. No. 7,100,822 by some form of outside intervention, such as a random number generator having to be used in the final stages of an incomplete game to accelerate the elimination of numbers and participants). In this invention, the number of participants is not required to be reduced to one in order to bring the gaming system to a finish with a winner and to stop selling tickets. Instead, this gaming system can be conducted to a set timeframe or set parameters, with ticket sales ceasing once the set timeframe or set parameters are reached, following which the participants in the relevant games using the methods described herein will be subject to elimination processes to determine the winner/s.

Further, the invention described herein provides a useful method to determine the placements of all participants in games using this invention and the methods described herein, which in turn gives great flexibility for a gaming operator when setting outcomes and prizes for the successful participants. For example a last place prize can be awarded, or a series of prizes can be awarded to those participants that are placed on or at certain selected placements, for example prizes could be awarded to those participants that are placed 8^{th}; 88^{th}; 888^{th}; 8,888^{th}; 88,888^{th}; 888,888^{th}; and 8,888,888^{th} and so on in a game. Prizes could also be awarded by ranking players, for example to the top 50,000, then to the top 10,000, then to the top 1,000, then to the top 100, then to the top 10 and then a first prize, with a prize to last place. Prizes could also be set around and awarded to one or more of each group of participants that had as their first symbol choice, the 2^{nd} least picked or ranked symbol, or the 3^{rd}, or the 4^{th} and so on to the last ranked symbol.

The following description refers in the main to the use of numbers, as these are the most practical symbols to use. However in gaming events particularly where a small number of selectable options are provided other symbols such as letters, pictures, diagrams, characters and objects could be used.

It will be appreciated that the invention allows, prior to the launching of the relevant game, for it to be determined that the gaming system is run utilising the invention so as to enter into a second phase of eliminations with a selected number of participants.

Preferably, the participant's objective is to pick a number of number choices from a defined range of n numbers, with the objective of choosing each number on the basis that each pick will be a number that is least (or alternatively, most) picked by all the participants in the lottery.

The elimination system described hereafter also allows for the concurrent running of a “Super Game” and one that does not have to have participants separately pay to enter.

Further, this invention differs from LOTTO in at least the following material respects:
the invention can always get to a winning result of the first prize and can be ‘virtually certain’ that a sole winner will win first prize, irrespective of what numbers are chosen by participants from the available number range of one to n;
in its preferred form, the results of the game are derived by using the participants own choices and from within the game itself, using the ranking system, and not by external third party intervention and event processes used by LOTTO, such as the subsequent random draw of a set of winning numbers following the closure of the LOTTO entries which the LOTTO customers then have to match to their own numbers; and
the invention can, if desired rank every participant in the game, even down to last place irrespective of what numbers are chosen by participants; and
the invention allows for the involvement of an independent auditing party that can simultaneously and independently replicate the winning results as determined by any gaming operator using games the subject of this invention.

The invention initially comprises a ranking engine utilising a computer program for a computerised lottery. The ranking engine comprising one or more computers for recording entries and ranking entries, in which entries comprise at least one symbol selected from a set containing n symbols which symbols are typically numbers but could be any symbol, including colours. The computer or computers are capable of:
recording the symbol or symbols selected in or on each entry and optionally recording at least the identity or contact details, or place or point of entry, associated with each entry and;
recording, the number of times each symbol from the set of n symbols has been selected;
ranking each symbol from the set of n symbols from lowest to highest based on the number of times each symbol has been selected in or on the entries;
determining the result of the lottery by comparing one or more of the symbols associated with each entry against the ranking of at least some of the n symbols.

The use of the ranking engine and the resultant ranking list or lists enables a method of effecting a game such as a computerised lottery to be performed. The ranking of each symbol is preferred to take place following closure of entries into the game.

The expected number of entries into the lottery are high enough that the probability that each member of the set of n symbols will be chosen at least once is substantially certain. Also the lottery has a pre-defined close off time and/or date and the number of entries A is at least 10 times greater than the number of symbols n. Although an upper limit of expected entries to symbols n is difficult to state with exactitude it is believed that an upper limit of a number of expected entries that is 500,000 times the number of symbols n will provide a satisfactory lottery. In the computerised lottery an entry contains r different symbols selected from the available set of n symbols.

In a practical case when considering a game involving one set of n numbers, r is a number between 4 and 10 and is preferably 6. In another version of the computerised lottery there are two or more sets containing symbols n1, n2 . . . nN and each entry comprises a selection at least one symbol from each set of symbols.

Preferably each set of symbols comprises a set of symbols from 2 to 100, with each symbol identified by numerals, or that are numerals.

Preferably each set of symbols comprises a set of symbols from 2 to 40, with each symbol identified by numerals, or that are numerals.

Preferably there are two sets of symbols, with the first set comprising a set of symbols from 2 to 10 in number, and the second set comprising a set of symbols from 10 to 40 in number, with each symbol in each set identified by numerals, or that are numerals.

In a practical sense, when considering a game involving two sets of n numbers, one set of n numbers is usually a small set, such as between 2 to 10 n numbers, and the other set of n numbers usually comprises a larger set, such as between 10 to 40 n numbers. In this case, r is usually one number to be picked from the set of small numbers (say 4 n numbers) and r is usually between four and ten numbers to be picked from the larger set of n numbers (say 20 n numbers).

In the preferred form of the invention of the computerised lottery, the ranking engine contains additional rules to eliminate ties between symbols as will be described further herein after.

The computer program for conducting a lottery is adapted to record the entry point to the lottery through or in which the participant purchased the entry chosen from the group comprising (a) an identity of a lottery organization, (b) a lottery sub-type, and (c) a country or area, to enable the program to select a winning entry for each of those entry points to the lottery. Where the lottery provides a bearer document some or all of such information may not be required.

In the preferred form of the invention the results of the lottery are displayed/broadcast in the form of a software or computer driven simulation, the end result of which is based on the ranking of the n symbols, or where there are two sets of n symbols, the results are preferably based on the larger set of n symbols. The simulation is preferably a competitive simulation such as a race.

Thus the invention enables a method of conducting a lottery by providing a computerised gaming system, such as a lottery or promotional system, having at least one computer system for recording entries and determining one or more winners, in which participants are invited to select at least one symbol from a defined available range of n symbols, and to register their selection with the computer. The computer is capable of recording at least the symbol or symbols selected in or on the entry, including how many times each symbol in the available symbol range was selected in or on each of the entries in the game, and to provide a ranking list of the number of times each symbol was selected. The ranking of each symbol in the ranking list is determined by the number of times each symbol is selected in or on an entry. The identity or contact details of the participant may optionally be recorded. The gaming system may have at least two phases, the first phase running until a defined time has expired whereupon at least one of the n symbols is selected. The selection is made by selecting at least one of the symbols in the ranking list based on selection criteria pre-determined by reference to the rankings of the symbols in the ranking list, to provide a number of entries, at least some of whom have selected one of the n symbols selected, and moving the selected entries to a second phase of the game, which second phase comprises an elimination process to determine one or more winners from those entries that were selected to move from the first phase to the second phase, the winner or winners in the second phase being the final entry or entries at the end of a pre-determined elimination process.

The selected symbol from the ranking list is in the preferred form of the invention the symbol that is ranked as the least selected or most selected symbol in or on the entries in the game.

In one form of the invention, the first phase consists of one or more games from which the number of entries in each first phase game are reduced substantially to a selected number. The selected number comprises less than 40% of all entries in each first phase game and preferably comprises no more than 10% of all entries, and from which a winner or winners of each first phase game is and/or are determined, and in the second phase, the selected number from the one or more first phase games are entered into a final game from which a winner or winners are determined. The only way for a participant to obtain an entry into the final game is by way of a participant entering into a game in the first phase and becoming one of the selected numbers from that first phase game.

In another version of the game, participants are invited to select two or more symbols from a defined available range of symbols from one to n, and to register their selection with the computer system. The computer system is capable of recording at least the symbols selected in or on each entry, including how many times each symbol in the available symbol range from one to n was selected in or on each of the entries in the game, to provide a ranking list of the number of times each symbol in the range of one to n was selected, the ranking being determined either by the number of times each symbol is selected in or on entries, with the order of ranking of each symbol in the ranking list from first to n being determined by firstly, that symbol that is least chosen being ranked first, secondly, that symbol that is second least chosen is ranked second and subsequently continuing the order of ranking in like manner. Alternatively that symbol that is most chosen is ranked first, that symbol that is second most chosen is ranked second, and subsequently continuing the order of ranking in like manner. The game may have a single phase, the single phase running until a defined time has expired whereupon a winning sole entry or entries is or are selected. The winner or winners of the game is determined by comparing the symbol or symbols in all or at least some of the entries of all or at least some of the participants in the game against the ranking of the symbols as set out in the ranking list to make the desired eliminations, by comparing one or more of the symbols chosen in or on each entry against the ranking list of the symbols.

The step of comparing one or more of the symbols chosen in or on each entry against the ranking list of the symbols comprises the step of progressively eliminating those relevant entries that have a relevant symbol or symbols ranked lower, or alternatively higher, on the ranking list than the symbol or symbols in or on other entries until a winner or winners is or are found.

Alternatively the ranking value for each of the symbols in the defined available range of symbols from one to n can be based on their order of draw from a random draw of some or all of the symbols in the available range, and also recording a ranking list of the symbols from first to n with the order of the symbols in the ranking list being determined by reference to the order in which the symbols become randomly drawn, and using the resulting ranking list to eliminate entries and determine one or more winners. The comparison between the entries and the ranking list can then be made.

The computer system includes one or more transaction engines (i.e. for entry logging and storage of the raw data during the time the game is open to receiving entries) and a gaming engine, which receives the raw data from the transaction engine(s) after entry into the game is closed, and which then processes the raw data using the gaming software and determines the results of the game, including the winner/s.

The transaction engine(s) includes at least one database with each record having fields containing (a) customer information, typically a telephone number or credit card number or email address and/or place of purchase (b) the symbol or symbols chosen by the customer, (c) a receipt number or PIN disclosed to the customer as proof of that entry.

The gaming engine accesses at least one database.

The gaming engine's function results in n records with at least two fields per record comprising:

a first field containing a set of symbols within the available range of n symbols (so that the records can be sequential through the entire range of n symbols for that competition); and
a second numerical field capable of recording a placement value or ranking value for each n symbol, for example by recording a placement value for each n symbol if randomly drawn through the full range of n symbols, or alternatively recording the number of “hits” or number of times each symbol from the defined range of n symbols has been selected in or on entries in the game, in order that a selection total can be recorded for each of the n symbols;
and optionally a further two fields comprising:
a third field that records the ranking of each symbol within the defined range of n symbols calculated by reference to the fore mentioned second numerical field, including as relevant any symbols within the range of n symbols that are tied with other n symbols; and
a fourth field that can, if necessary, record a unique ranking for each symbol within the defined range of n symbols, with any ties eliminated or resolved by reference to the ranking value or the selection total number as recorded in the second numerical field, in order that each of the symbols in the defined range of n symbols has its own unique ranking within the range of the n symbols.

If desired the databases of the transaction engine and gaming engine are combined into a single database and operated within a single computer.

The transaction engine is separate from the gaming engine and it is desirable that the transaction engine only passes registered entries to the gaming engine once entry into the game is closed.

The transaction engine(s) and the gaming engine can be duplicated and the duplication controlled by an independent party in order for that party to be able to simultaneously or first receive the raw gaming data into its separate transaction engine(s), to hold that raw data in its transaction engine(s) until entries into the game are closed, to then pass that raw data from the independent party's transaction engine(s) to its gaming engine, to independently process the raw data using the independent party's copy of the gaming software stored on its gaming engine, to independently determine the results of the game, including the winner/s, and to produce an independent audit report of its results compared with those of the gaming operator.

Options are made available for the participant to be able to enter their own symbol/s such as number/s by remote data entry such as by entering it on a telephone key pad, by sending an SMS message, or email message containing the symbol/s such as number/s they have chosen. Other methods are available such direct from a website or kiosk, or from a computer terminal or by mail.

The participant may, of course, be allowed by the system to choose one or more symbols, at random. Usually entry will be by payment but there are some instances where a free entry may be provided, for example, in promotional ventures.

Dealing with symbols not chosen can be approached in various ways. For example, symbols not selected by any participant can be ignored, can belong to the house, can be given a ranking after the rankings of the symbols which have been selected, or given a ranking of the most chosen, or alternatively, the least chosen.

In a two phase game, the elimination process operating in the second phase requires entries to select further symbols from an available range, with participants avoiding elimination by selecting a symbol which has been selected the least in or on relevant entries in any elimination step relevant to the second phase.

The second phase of the elimination process also has secondary procedures usable if a preceding elimination procedure operating in the second phase of the game fails to select a single winner.

Part of the prize pool may be set aside for jackpot and/or super draws/games as described further herein after Tied symbols are ranked by firstly determining whether or not the selection total number is an ‘odd number’ or an ‘even number’ and secondly, using that ‘odd’ or ‘even’ determination to rank any tied symbols by ordering the tied symbols in accordance with whether the selection total number is ‘odd’ or ‘even’.

For example, a selection total number that is an ‘odd number’ would result in the tied symbols that are numbers or that can be identified by reference to a number being ordered with the highest face value number being placed first, and a selection total number that is an ‘even number’ would result in the tied symbols that are numbers or that can be identified by reference to a number being ordered with the lowest face value number being placed first.

Alternatively a selection total number that is an ‘even number’ would result in the tied symbols that are numbers or that can be identified by reference to a number being ordered with the highest face value number being placed first, and a selection total number that is an ‘odd number’ would result in the tied symbols that are numbers or that can be identified by reference to a number being ordered with the lowest face value number being placed first.

The information collected from the entries in a regional or worldwide game can then be used at least to rank the performance of all entries, firstly in the regional or worldwide lottery so that regional or worldwide winners are determined, and separately to determine lottery organization, country or area winners, and optionally, to determine the last placed entry in the regional or worldwide lottery and separately to determine the last placed entries from each participating lottery organization, country or area, the results being achieved using one set of data derived from the ranking and/or rating and/or placement values attributed to each symbol that is available to be chosen in the overall regional or worldwide lottery.

### EXAMPLES OF THE GAMING SYSTEM

The examples set out later herein are summarised in the table below:

| Example | |
|---|---|
| Number | Description |
| | EXAMPLE 1 |
| 1.0 | Two Phase Game (number range 1 to 100,000) |
| 1.1 | Assumed Game Profile |
| 1.2 | First Phase - The Elimination Processes |
| 1.3 | Table 1 - Ranking System for Example 1 - to |
| | determine 9 winners of First Phase |
| 1.4 | Table 2 - Ranking System for Example 1 - Ranking |
| | the 14 Participants in order of best |
| | results/performance in the game |
| 1.5 | End of Phase One - Announcement of First Phase |
| | Winners |
| 1.6 | Second Phase - Determining the “winner/s” |
| 1.7 | Prize Winnings |
| 1.8 | Second Phase - Winner wins in the first round of |
| | eliminations |
| 1.9 | Second Phase - Winner wins in the second round of |
| | eliminations |
| 1.10 | Second Phase - Winner wins in the third round of |
| | eliminations |
| 1.11 | Second Phase - Winning the Jackpot in week 11 |
| 1.12 | TV/Game Show |
| 1.13 | Incorporation of a “Super Game” |
| | EXAMPLE 2 |
| 2.0 | One Phase Game (number range 1 to 100,000) |
| 2.1 | Assumed Game Profile |
| 2.2 | The Elimination Processes to determine one winner |
| | in the First (Single) Phase |
| 2.3 | Table 3 - Ranking System for Example 2 - to |
| | determine 1 winner |
| 2.4 | Table 4 - Ranking System for Example 2 - Ranking |
| | the 14 Participants in order of best |
| | results/performance in the game |
| | EXAMPLE 3 |
| 3.0 | Two Phase Game (number range 1 to 30) |
| 3.1 | Assumed Game Profile |
| 3.2 | Table 5 - Ranking System for Example 3 - Results of |
| | 500,000 Participant Game and Ranking Placements |
| | of n numbers |
| 3.3 | Resolving ties within Ranking System |
| 3.4 | The Elimination Processes to determine 9 |
| | Participants to proceed to the Second Phase |
| 3.5 | Table 6 - Chosen numbers of top 10 Participants |
| 3.6 | Table 7 - Determine 9 Participants to proceed to the |
| | Second Phase |
| 3.7 | Use of Eliminations and/or Ranking System |
| | Table 8 - Description of Elimination Steps |
| 3.8 | Alteration to Ascribed Ranking Value - Same |
| | Results |
| 3.9 | Table 9 - Determine 9 Participants to proceed to the |
| | Second Phase using Alteration to Ascribed Ranking |
| | Value |
| 3.10 | End of Phase One - Announcement of First Phase |
| | Winners |
| 3.11 | Second Phase - Week Two - Determining the |
| | “winner/s” |
| 3.12 | Exampled Prize Winnings |
| 3.13 | Table 10 - Two Phase Game - Exampled Prize |
| | Winnings |
| 3.14 | TV/Game Show |
| 3.15 | Incorporation of a “Super Game” |
| 3.16 | The odds of winning |
| | EXAMPLE 4 |
| 4.0 | One Phase Game (number range 1 to 30) |
| 4.1 | Assumed Game Profile |
| 4.2 | Table 11 - Ranking System for Example 4 - Results |
| | of 500,000 Participant Game and Ranking |
| | Placements of n numbers |
| 4.3 | Resolving ties within Ranking System |
| 4.4 | The Elimination Processes to determine the winner |
| 4.5 | Table 12 - Chosen numbers of top 10 Participants |
| 4.6 | Table 13 - Determine the winner/s |
| 4.7 | Use of Eliminations and/or the Ranking System |
| | Table 14 - Description of Elimination Steps |
| 4.8 | Alteration to Ascribed Ranking Value - Same |
| | Results |
| 4.9 | Table 15 - Determine the Winner/s using Alteration |
| | to Ascribed Ranking Value |
| 4.10 | Fallback position - Ties involving winning |
| | Participants |
| 4.11 | Table 16 - One Phase Game - Exampled Prize Winnings |
| 4.12 | The odds of winning a weekly game |
| 4.13 | Incorporation of a Super Game |
| 4.14 | Prize Winnings for Super Game |
| 4.15 | Table 17 - One Phase Game - Exampled Prize |
| | Winnings for the annual Super Game |
| 4.16 | The odds of winning Super Game |
| 4.17 | Table 18 - Backroom Calculations - Eliminations |
| | EXAMPLE 5 - Virtual Racing |
| 5.0 | Virtual Horse Race (number range 1 to 20) |
| 5.1 | Assumed Game Profile |
| 5.2 | Table 19 - Results of Betting on a Virtual Horse |
| | Race by 500,000 Punters |
| 5.3 | Resolving ties (as between the horse numbers 1 to |
| | 20) within Ranking System |
| 5.4 | The Elimination Processes to determine the winning |
| | punter |
| 5.5 | Table 20 - Top 10 Punters' chosen Horses |
| 5.6 | Table 21 - Determine the winning punter |
| 5.7 | Use of Eliminations and/or the Ranking System |
| | Table 22 - Description of Elimination Steps |
| 5.8 | Alteration to Ascribed Ranking Value - Same |
| | Results |
| 5.9 | Table 23 - Determine the Winning Punter using |
| | Alteration to Ascribed Ranking Value |
| 5.10 | Fallback position - Ties involving winning Punters |
| 5.11 | Table 24 - Exampled Prize Winnings for weekly |
| | races |
| 5.12 | The odds of winning a weekly race |
| 5.13 | Incorporation of a Super Race |
| 5.14 | Super Race Prizes |
| 5.15 | Table 25 - Exampled Prize Winnings for the [semi- |
| | annual] Super Race |
| 5.16 | The odds of winning Super Race |
| 5.17 | Table 26 - Backroom Calculations - Eliminations |
| 5.18 | Other Virtual Racing Applications |
| | EXAMPLE 6 |
| 6.0 | Application of Gaming System for Regional or |
| | Worldwide Game or Lottery |
| 6.1 | Assumed Game or Lottery Profile with a Region |
| | comprising 3 Countries |
| 6.2 | Table 27 - Prizes to be paid by Regional Game or |
| | Lottery and Application of a Local Country Prize |
| 6.3 | Table 28 - Ranking System for Example 6 - Results |
| | of 500,000 Participant Regional Game or Lottery and |
| | Ranking Placements of n numbers |
| 6.4 | The Elimination Processes |
| 6.5 | Table 29 - Chosen numbers of top 10 Participants |
| 6.6 | Table 30 - determining the Winner/s of the Regional |
| | Game or Lottery |
| 6.7 | Local Country Prizes |
| 6.8 | Other Applications, including in respect of ‘standard |
| | LOTTO’ |
| | EXAMPLE 7 |
| 7.0 | Virtual Cricket Game - (number range 1 to 18) |
| | EXAMPLE 8 |
| 8.0 | Other variations of Example 7 |
| | EXAMPLE 9 |
| 9.0 | Gaming System based on picking one n number |
| | (number range 1 to 20) in a multiple series of 6 games |
| | (all of which comprise the one game) |
| | EXAMPLE 10 |
| 10.0 | Card Game (card/number range 1 to 14) |
| 10.1 | Assumed Card Game Profile |
| 10.2 | Table 31 - Ranking System for Example 10 - Results |
| | of 1,000 Participant First Phase Card Game, and |
| | Ranking Placements of 14 Cards |
| 10.3 | Resolving ties within Ranking System |
| 10.4 | The Elimination Processes to determine the winner |
| 10.5 | Table 32 - Chosen cards of top 10 Participants |
| 10.6 | Table 33 - Determine the winner/s |
| 10.7 | Use of Eliminations and/or the Ranking System |
| 10.8 | Alteration to Ascribed Ranking Value - Same |
| | Results |
| 10.9 | Table 34 - Determine the Winner/s using Alteration |
| | to Ascribed Ranking Value |
| 10.10 | Fallback position - Ties involving winning |
| | Participants |
| 10.11 | Table 35 - Exampled Prize Winnings - First Phase |
| | Card Game |
| 10.12 | The odds of winning a First Phase Card Game |
| 10.13 | Incorporation of a Super Card Game |
| 10.14 | Prize Winnings for Super Card Game |
| 10.15 | Table 36 - Exampled Prize Winnings for the Super |
| | Card Game - ‘guaranteed’ prize pool only |
| 10.16 | The odds of winning the Super Card Game |
| 10.17 | Cross Sold Regional or Area Card Game |
| 10.18 | Variations to the Card Game |
| 10.19 | Table 37 - Backroom Calculations - Eliminations |
| | EXAMPLE 11 |
| | What are the appropriate ranges of n Symbols or |
| | n Numbers |

### EXAMPLE 1

### Example 1.0

### Two Phase Game—(number range 1 to n, where n=100,000)

This example works on the basis of picking the ‘least picked’ numbers.

A game as described below is sold over a defined period, for example a week, with the participants purchasing during the week a selected number of numbers. A suitable number of numbers would be 10 selected numbers, or alternatively 10 randomly generated numbers. Each of the 10 selected numbers being chosen from a defined number range of 1 to 100,000.

The game has what we could describe as a first phase in which the objective for each participant in the game that week is to become one of a selected number of last or final participants remaining. A suitable number of final participants is 9, although it could be more or less. A participant in the game becomes a final participant by having one or more of his/her 10 chosen numbers as qualifying as being least picked by all the other participants in that week's game, and ultimately being ranked among the 9 participants that have the best results.

Minor prizes can be awarded for success in the first phase.

The game then enters a second phase which has the objective for those last 9 participants (or such fewer participants in the case of a participant having more than one qualifying number in the last 9), is to become in the following week, the last participant remaining, thereby winning the major prize.

Major prizes, including first prize, will be awarded for the second phase.

In the first phase, which would normally occur during week one of the game, the number of participants is reduced to the selected number (e.g. 9).

The participants in the first phase will purchase during the week a minimum of 10 numbers in the selected range of 1 to 100,000. Each number purchased at a cost of, say, $1 and thus the minimum amount is $10 for a block of 10 numbers.

Each participant may choose his/her own unique block of 10 numbers, to form one block, or alternatively, a participant can have his/her 10 numbers randomly picked by a random number generator.

### Participant's Objective

The objective for each participant is to choose one or more numbers that are least picked by all the other participants in the game, so that the final 9 participants are those who chose numbers that are the least picked numbers by all participants and who are among the 9 participants with the best results. Those final 9 participants then move to the “second phase”, and a chance to win the major prize.

The elimination of the participants in the first phase is done in any suitable manner for example by following the method/s set out in U.S. Pat. No. 7,100,822 B2 and repeated above.

While it will be relatively simple to eliminate most numbers/participants from a game involving a number range of 1 to 100,000, it will often be difficult to end up with exactly 9 participants from the first phase that are to move on to the second phase. So an elimination process is provided for some participants, so that exactly the selected number of 9 qualifying participants can proceed to the second phase and compete for the major prize/s.

### Example 1.1

### Assumed Game Profile

In this Example 1, it is assumed that:
the game has been played by 500,000 participants:
each participant purchases the minimum of $10 for one number block of 10 numbers—so there would be 5,000,000 numbers picked in total, all in the number range of 1 to 100,000, and there would be a pool of $5,000,000 available to cover expenses, costs and prizes;
99,000 numbers of the 100,000 number range have been chosen two or more times; and
300 numbers have been chosen only once; and
700 numbers have not been chosen by anyone.
Ties between n numbers in the number range 1 to 100,000 are left unresolved.

The numbers that have been chosen in the group of 99,000 numbers chosen two or more times are, in this example, all eliminated.

The 700 numbers that have not been chosen by anyone are ignored or if desired could be treated in some other way such as being passed to the “house”.

### Example 1.2

### First Phase—The Elimination Processes

Consistent in keeping with the game's objective in this example for participants to choose numbers that are least picked by the other participants, and to be rewarded accordingly, the elimination processes are consistent with this overall objective.

### First Elimination Process:

To achieve exactly 9 last qualifying participants (ticket purchasers) from the 300 ‘tied’ participants that have within their block of 10 numbers, a chosen number within the group of 300 n numbers chosen only once by all the participants in the game, each of the 300 participant's block of 10 numbers are computer analyzed to determine the ranking of each participant's 10 chosen numbers, ranked in order of the least chosen down to the most chosen.

This is achieved by determining, for each of the 300 participants, how many times each of their 10 numbers was chosen by all of the participants in the game. This process is exemplified in the table below which demonstrates the computer ranking system applicable for this example. Further, the example set out in the table below assumes that the number of participants being analyzed is a sample total of 14, from which 9 must be determined.

### Example 1.3

TABLE 1
Ranking System: To determine exactly 9 winners of the first
phase

| | Nos | | | | | | | | | | | | | | |
|---|---|---|---|---|---|---|---|---|---|---|---|---|---|---|---|
| | | | | | | | | | | | | | | | To |
| | P.1 | P.2 | P.3 | P.4 | P.5 | P.6 | P.7 | P.8 | P.9 | P.10 | P.11 | P.12 | P.13 | P.14 | P.300 |
| Best | 1 | 1 | 1 | 1 | 1 | 1 | 1 | 1 | 1 | 1 | 1 | 1 | 1 | 1 | . . . |
| 2^{nd} | 3 | 4 | 2 | 5 | 10 | 1 | 3 | 1 | 2 | 9 | 1 | 1 | 2 | 1 | . . . |
| 3^{rd} | 3 | 9 | 2 | 6 | 11 | 1 | 9 | 2 | 5 | 13 | 2 | 6 | 6 | 12 | . . . |
| 4^{th} | 7 | 9 | 3 | 7 | 13 | 3 | 20 | 25 | 7 | 13 | 3 | 6 | 15 | 16 | . . . |
| 5^{th} | 21 | 11 | 6 | 7 | 19 | 4 | 30 | 33 | 12 | 21 | 39 | 52 | 24 | 25 | . . . |
| 6^{th} | 36 | 29 | 13 | 9 | 28 | 7 | 42 | 39 | 15 | 22 | 59 | 66 | 109 | 150 | . . . |
| to 10^{th} | . . . | . . . | . . . | . . . | . . . | . . . | . . . | . . . | . . . | . . . | . . . | . . . | . . . | . . . | . . . |

### Determining the 9 Explained

Using the above example—from a pool of 14 participants—as can be seen from the table above, while all 14 participants had chosen one number from the number range of 1 to 100,000 that was only picked once by all the participants in the game, there were 8 participants that had their next best number picked only once or twice. Those 8 participants (being P.3, P.6, P.8, P.9, P.11, P.12, P.13, and P.14) would proceed to the second phase.

To determine the last (i.e. the 9^{th}) participant to also proceed to the second phase, P.1 and P.7 each had their second best number chosen in total 3 times by all the participants in the game. To resolve this tie between participants P.1 & P.7, the next best numbers of P.1 & P.7 are considered. In this example, P.1 would proceed to the second phase as the 9^{th} participant based on P.1's third best number being chosen only 3 times, while P.7's third best number had been chosen nine times.

Example 1.4, Table 2 below shows the same data as the table above, but now ranks the 14 participants based on their results/performance in the game. The ranking system ranks the participants—and the ‘top 9’, in their orders, are readily determined from the table below.

### Example 1.4

TABLE 2
Ranking System - Ranking the 14 Participants in order of
best results/performance in the game

| | Rankings | | | | | | | | | | | | | | |
|---|---|---|---|---|---|---|---|---|---|---|---|---|---|---|---|
| | 1st | 2^{nd} | 3^{rd} | 4^{th} | 5^{th} | 6^{th} | 7^{th} | 8^{th} | 9^{th} | 10^{th} | 11^{th} | 12^{th} | 13^{th} | 14^{th} | |
| | Participant Nos | | | | | | | | | | | | | | |
| | P.6 | P.11 | P.8 | P.12 | P.14 | P.3 | P.9 | P.13 | P.1 | P.7 | P.2 | P.4 | P.10 | P.5 | |
| Best | 1 | 1 | 1 | 1 | 1 | 1 | 1 | 1 | 1 | 1 | 1 | 1 | 1 | 1 | |
| 2^{nd} | 1 | 1 | 1 | 1 | 1 | 2 | 2 | 2 | 3 | 3 | 4 | 5 | 9 | 10 | |
| 3^{rd} | 1 | 2 | 2 | 6 | 12 | 2 | 5 | 6 | 3 | 9 | 9 | 6 | 13 | 11 | |
| 4^{th} | 3 | 3 | 25 | 6 | 16 | 3 | 7 | 15 | 7 | 20 | 9 | 7 | 13 | 13 | |
| 5^{th} | 4 | 39 | 33 | 52 | 25 | 6 | 12 | 24 | 21 | 30 | 11 | 7 | 21 | 19 | |
| 6^{th} | 7 | 59 | 39 | 66 | 150 | 13 | 15 | 109 | 36 | 42 | 29 | 9 | 22 | 28 | |
| to 10^{th} | . . . | . . . | . . . | . . . | . . . | . . . | . . . | . . . | . . . | . . . | . . . | . . . | . . . | . . . | . . . |

### Fallback Process:

The above described ranking and elimination processes should ensure that the elimination process to determine exactly 9 participants that are to proceed to the second phase can be fully completed and no fallback process should be required.

However, to provide for the very unlikely situation where the above described elimination process does not achieve the desired elimination results to achieve exactly 9 participants for the second phase of the game, then if two or more participants remain and can't be eliminated/separated, then in this example, any remaining participants will all move to the second phase of the game as one group to fill as between them the remaining place/s in the 9 required, and will participate and share in proportion as between them within that group. Preferably such a group will be represented in the second phase by an independent party nominated by the gaming organizer.

In the alternative, eliminations could be effected by chance.

### Example 1.5

### End of Phase One—Announcement of First Phase Winners

At the end of week one, the 9 winners eligible for the second phase are published and any winning numbers associated with any minor prizes won in the first phase are also published and paid.

The 9 winners eligible for the second phase are published (and announced) at the beginning of week two by the gaming organizers disclosing the 10 numbers from each winning participant's block of numbers. In this example, each of these 9 winners would receive a guaranteed minimum prize from the second phase.

Also at the beginning of week two, the next game is commenced, so that the next 9 participants can be determined and published (and announced) at the end of week two.

### Example 1.6

### Second Phase—Week Two—Determining the “winner/s”

The 9 winners eligible to participate in phase two of the game will then compete at the end of week two to become the “winner” in order to win the first prize.

Consistent in keeping with the game's objective, in this example for participants to choose numbers that are least picked by the 9 participants, and to be rewarded accordingly, the elimination processes for phase two are based on these objectives.

Eliminations Starting with the 9 Participants

Firstly: Each of the 9 participants will be required to nominate a number from the number range of, say, 1 to 5. The outcomes will be:

The participant/s that nominate a number that is least picked by the other participants will avoid elimination. The other participants will be eliminated. Participants eliminated in this first elimination stage may each receive a prize, say, $20,000. Only the lowest number of participants go through.

E.g. If 5 participants nominate the number 1; 2 participants nominate the number 3; and 2 participants nominate the number 5; then the 5 participants that nominated the number 1 are eliminated and the other 4 participants proceed to the next elimination stage. However, if 4 participants nominate the number 1; 3 participants nominate the number 3; and 2 participants nominate the number 5; then 7 participants are eliminated and only the 2 participants that nominated the number 5 proceed to the next elimination stage.

If at this first stage of eliminations involving all 9 participants, one of the participants has a nominated number that no other participant nominates and there are no other participants in the same position, then that participant is the winner. A participant winning at this first stage is eligible to win the Jackpot if provided. Otherwise the Jackpot carries over to the following week's game.

If none of the participants nominate a number that is least picked by other participants, resulting in a tie then the prize is shared equally but the Jackpot, if provided, cannot be won. Alternatively, the above elimination process could be repeated, with or without the jackpot at stake.

E.g. 3 participants nominate the number 1; 3 participants nominate the number 3; and the remaining 3 participants nominate the number 5; then that constitutes a tie.

If there are 4 to 6 Remaining Participants

Secondly: In the event the remaining participants number 4 or more, then each of the remaining participants that have not been eliminated will be required to nominate a further number, this time from the number range of 1 to 3. At this stage there will be no more than 6 participants left standing. The outcomes will be:

The participant/s that nominate a number that is least picked by the other participants will avoid elimination. The other participants will be eliminated. Participants eliminated in this second elimination stage may each receive a prize, say, $35,000. Only the lowest number of participants go through.

If at this stage one of the participants has a nominated number that no other participant nominates and there are no other participants in the same position, then that participant is the winner of the prize, but the Jackpot cannot be won, as it can only be won in the first elimination stage involving all 9 participants.

If none of the remaining participants nominate a number that is least picked by other participants, resulting in a tie, then the prize is shared equally. Alternatively, the above elimination process could be repeated.

If there are 3 Remaining Participants

Thirdly: In the event that at any time there becomes three remaining participants, each of the three remaining participants that have not been eliminated will again be required to nominate a number from the number range of 1 to 2. The outcomes will be:

The participant that nominates a number that is least picked will again avoid elimination.

That participant is the winner of the prize, but the Jackpot cannot be won, as it can only be won in the first elimination stage.

The other two participants eliminated in this stage may each receive a prize, say, $50,000.

If none of the three participants nominate a number that is least picked by the other participants, resulting in a 3-way tie, then the prize is shared equally. Alternatively, the above elimination process could be repeated again.

If there are 2 Remaining Participants

Fourthly: In the event that at any time there becomes two remaining participants, each of those two remaining participants will be required to nominate a number from the number range of 1 to 2. The gaming organizer will at the same time (so no one participant or the gaming organizer will have any prior knowledge of any chosen number) also nominate a number preferably by way of a random number generator, in the range of 1 to 2. The outcomes will be:

If one of the participants nominates a number that is not nominated by the other participant and not nominated by the gaming organizer, then that participant is the winner, but the Jackpot cannot be won, as it can only be won in the first elimination stage.

The other eliminated participant (eliminated by the gaming organizer) may receive a prize, say, $100,000.

If the two participants nominate a number that is picked by both of them, irrespective of whether or not the gaming organizer nominates the same number, then this results in a 2-way tie and the prize is shared equally, but the Jackpot cannot be won, as it can only be won in the first elimination stage.

As will be appreciated, any of the above outcomes where there is a tie between 2 or more participants could be resolved by reference back to each of those tied participants original 10 numbers and ranking their performances as described previously, so that one or more participants could always be eliminated and the elimination process then continues or a sole winner is determined.

### Example 1.7

### Prize Winnings

The earlier the winner is determined, the greater the amount of the winning prize.

### Example of the Prize Pool

### Assume That:

There are a series of games, with each having the same participation profile as described in the above example i.e. each having 500,000 participants, each purchasing the minimum of $10 for one block of 10 numbers—resulting in a pool of $5,000,000 available to cover expenses, costs and prizes; and

In this example, say, 600% of the revenue pool is paid out as prizes; so $3,000,000 is available for prizes in the second phase of eliminations in which the 9 participants compete for.

Each of the 9 participants eliminated in this first round of eliminations receives $20,000 Each of the 9 participants eliminated in any second round of eliminations receives $35,000

In the stage that requires elimination of participants when there are either two or three remaining participants in total, then as relevant, either the two participants that are then eliminated each receive $50,000, or the one eliminated participant receives $100,000.

If the winner wins in the first round of eliminations, net of the payments to be made to the 8 eliminated participants, that winner receives 100% of that relevant week's prize pool, and 100% of the jackpot pool that has accumulated from previous weeks.

If the winner wins in the second round of eliminations, net of the payments to be made to the 8 eliminated participants, that winner receives 35% of that relevant weeks prize pool (but 0% of the jackpot pool that has accumulated from previous weeks, as the jackpot can only be won in the first round of eliminations in the event of a clear winner being achieved).

If the winner wins during the third round of eliminations, net of the payments to be made to the eliminated participants, that winner receives 25% of the relevant weeks prize pool (but 0% of the jackpot pool that has accumulated from previous weeks).

### Example 1.8

### Winner Wins in the First Round of Eliminations and No Jackpot Exists (as it is the 1^{st} Week)

| | | $ to Jackpot for |
|---|---|---|
| | $ Prize amount | following week |
| 8 Eliminated Participants | $160,000 | |
| first round @ $20,000 | | |
| each | | |
| Winner | $2,840,000 | $0 |
| 100% of the weeks prize | | |
| pool from that week's | | |
| game; and | | |
| 100% of jackpot | | |
| Total each week | $3,000,000 | $0 |
| $3,000,000 | | |

### Example 1.9

### Winner Wins in the Second Round of Eliminations

| | | $ to Jackpot for |
|---|---|---|
| | $ Prize amount | following week |
| 3 Eliminated Participants | $60,000 | |
| first round @ $20,000 | | |
| each | | |
| 5 Eliminated Participants | $175,000 | |
| second round @ $35,000 | | |
| each | | |
| Winner | $967,750 | $1,797,250 |
| 35% of the weeks prize | | |
| pool from that week's | | |
| game: and | | |
| 0% of jackpot | | |
| Total each week | $1,202,750 | $1,797,250 |
| $3,000,000 | | |

### Example 1.10

### Winner Wins in the Third Round of Eliminations

| | | $ to Jackpot for |
|---|---|---|
| | $ Prize amount | following week |
| 3 Eliminated Participants | $60,000 | |
| first round @ $20,000 each | | |
| 4 Eliminated Participants | $140,000 | |
| second round @ $35,000 | | |
| each | | |
| 1 Eliminated Participant | $100,000 | |
| third round | | |
| Winner | $675,000 | $2,025,000 |
| 25% of the weeks prize | | |
| pool from that week's | | |
| game; and | | |
| 0% of jackpot | | |
| Total each week | $975,000 | $2,025,000 |
| $3,000,000 | | |

### Example 1.11

### Winning the Jackpot in Week 11

In this example, if the game is run on 10 consecutive weeks and assuming that the winner in each week is always for the 10 preceding weeks determined in the second round of eliminations, then an amount of $1,797,250 is contributed to the jackpot each week, for ten weeks, bringing the jackpot total to $17,972,500 by the time of the game having been run for the 11^{th} week.

A participant that wins in week 11 in the first round of eliminations becomes eligible to win the jackpot. That winning participant would, in this example, win prizes of $2,840,000 from that 11^{th} week's game prize pool and will also win the jackpot of $17,972,500.

In this example, total winnings in week 11 for that winner would therefore be $20,812,500.

### Example 1.12

### TV/Game Show

It is envisaged that phase two of the lottery will be conducted at the same time as the announcements of the winners of phase one of the following game are being announced.

Phase two could be conducted through a televised show, most likely of short duration, as phase two is believed to be suitable for a game or reality show, including being suitable with potential audience participation.

Each of the 9 winning participants can compete in phase two in person, or a participant can participate anonymously by telephone, or by other means of instantaneous communication, or by the gaming organizers appointing a person to participate on the winning participants behalf (the later occurring automatically if a phase two winning participant fails to identify him or herself as one of the 9 winners).

The second phase can be made exciting and it relies on each participants own choice.

### Example 1.13

### Incorporation of a “Super Game”

Using the base parameters set out in this Example 1, the invention preferably also includes the incorporation of a “Super Game”, with a set percentage of the weekly game's prize pool set aside for the “Super Game”, with a corresponding reduction to the amount available to be paid out as weekly prizes.

Preferably, this “Super Game” is won at defined periods such as annually, or six monthly, or in some other set way, such as when a set target amount of prize pool for the Super Game is reached.

Preferably the Super Game involves the same identical processes of elimination as applicable to the weekly draws as described above.

It will be clear that a large number of variations exist and the above descriptions as set out in this Example 1 are by way of example only.

### EXAMPLE 2

### Example 2.0

### One Phase Game—(Number Range 1 to n, where n=100,000)

This example works, as before, on the basis of picking the ‘least picked’ numbers.

### Example 2.1

### Assumed Game Profile

In this example of a game only having a first phase to determine the one winner, it is assumed, like above, that:
the game has been played by 500,000 participants,
each participant purchases the minimum of $10 for one number block of 10 numbers—so there would be 5,000,000 numbers picked in total, all in the number range of 1 to 100,000, and there would be a pool of $5,000,000 available to cover expenses, costs and prizes:
99,000 numbers of the 100,000 number range have been chosen two or more times; and
300 numbers have been chosen only once; and
700 numbers have not been chosen by anyone.
Ties between n numbers in the number range 1 to 100,000 are left unresolved.

The numbers that have been chosen in the group of 99,000 numbers chosen two or more times are, in this example, all eliminated.

The 700 numbers that have not been chosen by anyone are ignored or if desired could be treated in some other way such as being passed to the “house”.

The methods described in our patent U.S. Pat. No. 7,100,822 have been unsuccessful in determining a sole winner.

### Example 2.2

### The Elimination Processes to Determine One Winner in the First (Single) Phase

Consistent in keeping with the game's objective for participants to choose numbers that are least picked by the other participants, and to be rewarded accordingly, the elimination process to determine one winner at the First Phase should also be consistent with this overall objective.

### Elimination Processes:

To achieve exactly 1 qualifying sole winner from the 300 ‘tied’ participants that have within their block of 10 numbers, a chosen number within the group of 300 numbers chosen only once by all the participants in the game, each of the 300 participant's block of 10 numbers are computer analyzed to determine the ranking of each participant's 10 chosen numbers, ranked in order of the least chosen down to the most chosen.

This is achieved by determining, for each of the 300 participants, how many times each of the 10 numbers was chosen by all of the participants in the game. This process is exemplified in the table below. Further, the example set out below in Example 2.3—Table 3, assumes that the number of participants being analyzed is a sample total of 14, from which 1 winner must be determined. Further the table ranks the 14 participants by their number (for this purpose assume it is their ticket number) i.e. P.1, P.2, P.3 and so forth. It is not a ranking based on performance in the game

### Example 2.3

TABLE 3
Ranking System: To determine exactly 1 winner from the
First Phase

| | Nos | | | | | | | | | | | | | | |
|---|---|---|---|---|---|---|---|---|---|---|---|---|---|---|---|
| | | | | | | | | | | | | | | | To |
| | P.1 | P.2 | P.3 | P.4 | P.5 | P.6 | P.7 | P.8 | P.9 | P.10 | P.11 | P.12 | P.13 | P.14 | P.300 |
| Best | 1 | 1 | 1 | 1 | 1 | 1 | 1 | 1 | 1 | 1 | 1 | 1 | 1 | 1 | . . . |
| 2^{nd} | 3 | 4 | 2 | 5 | 10 | 1 | 3 | 1 | 2 | 9 | 1 | 1 | 2 | 1 | . . . |
| 3^{rd} | 3 | 9 | 2 | 6 | 11 | 1 | 9 | 2 | 5 | 13 | 2 | 6 | 6 | 12 | . . . |
| 4^{th} | 7 | 9 | 3 | 7 | 13 | 3 | 20 | 25 | 7 | 13 | 3 | 6 | 15 | 16 | . . . |
| 5^{th} | 21 | 11 | 6 | 7 | 19 | 4 | 30 | 33 | 12 | 21 | 39 | 52 | 24 | 25 | . . . |
| 6^{th} | 36 | 29 | 13 | 9 | 28 | 7 | 42 | 39 | 15 | 22 | 59 | 66 | 109 | 150 | . . . |
| to 10^{th} | . . . | . . . | . . . | . . . | . . . | . . . | . . . | . . . | . . . | . . . | . . . | . . . | . . . | . . . | . . . |

### Determining the 1 Winner Explained

Using the above example—from a pool of 14 participants—as can be seen from the table above, while all 14 participants had chosen one number from the number range of 1 to 100,000 that was only picked once by all the participants in the game, there were 5 participants that had their next best number picked only once as well. Those 5 participants (being P.6, P.8, P.11, P.12, and P.14) would then have their third best number choices analysed to determine which of them had their third choice numbers least picked by all the participants in the game.

In the above example, P.6 would be declared as the sole winner.

Example 2.4, Table 4 below shows the same data as the table above, but now ranks the 14 participants based on their results/performance in the game.

### Example 2.4

TABLE 4
Ranking System - Ranking the 14 Participants in order
best results/performance in the game

| | Rankings | | | | | | | | | | | | | | |
|---|---|---|---|---|---|---|---|---|---|---|---|---|---|---|---|
| | 1st | 2^{nd} | 3^{rd} | 4^{th} | 5^{th} | 6^{th} | 7^{th} | 8^{th} | 9^{th} | 10^{th} | 11^{th} | 12^{th} | 13^{th} | 14^{th} | |
| | Participant Nos | | | | | | | | | | | | | | |
| | P.6 | P.11 | P.8 | P.12 | P.14 | P.3 | P.9 | P.13 | P.1 | P.7 | P.2 | P.4 | P.10 | P.5 | |
| Best | 1 | 1 | 1 | 1 | 1 | 1 | 1 | 1 | 1 | 1 | 1 | 1 | 1 | 1 | |
| 2^{nd} | 1 | 1 | 1 | 1 | 1 | 2 | 2 | 2 | 3 | 3 | 4 | 5 | 9 | 10 | |
| 3^{rd} | 1 | 2 | 2 | 6 | 12 | 2 | 5 | 6 | 3 | 9 | 9 | 6 | 13 | 11 | |
| 4^{th} | 3 | 3 | 25 | 6 | 16 | 3 | 7 | 15 | 7 | 20 | 9 | 7 | 13 | 13 | |
| 5^{th} | 4 | 39 | 33 | 52 | 25 | 6 | 12 | 24 | 21 | 30 | 11 | 7 | 21 | 19 | |
| 6^{th} | 7 | 59 | 39 | 66 | 150 | 13 | 15 | 109 | 36 | 42 | 29 | 9 | 22 | 28 | |
| to 10^{th} | . . . | . . . | . . . | . . . | . . . | . . . | . . . | . . . | . . . | . . . | . . . | . . . | . . . | . . . | . . . |

### Fallback Elimination Process:

The first described elimination process as also set out in Tables 3 and 4 above, should ensure that the elimination process can be fully completed and no second elimination process should be required, or no fallback position should ever be necessary to determine the sole winner.

However, to provide for the very unlikely situation where, after analysing and ranking all 10 number selections by the participants, the above described elimination process does not achieve the desired elimination results to achieve exactly 1 winner of the game, then if two or more participants remain and can't be eliminated/separated, then it is proposed that those remaining participants will share the winner's prize equally, or a sole winner could be determined in such a scenario by chance—but such a scenario using this example of 10 number choices by each participant should ensure that this is extremely unlikely to ever occur.

It will be clear that a large number of variations exist and the above description for this Example 2 is by way of example only.

### EXAMPLE 3

### Example 3.0

### Two Phase Game—(Number Range 1 to n, where n=30)

This example works on the basis of picking the ‘least picked’ numbers.

The game, as described below, is a two phase game and is sold over a defined period, for example, weekly.

The participants each purchase during the week 6 different numbers in the selected range of 1 to 30—where each number picked is picked to be one of the ‘least picked’ by all the participants in the game. A number can only be picked once.

Each participant:
Picks 1 PRIMARY number.
Picks 5 SECONDARY numbers—which may be used in later elimination stages.

Each participant may choose his/her own unique block of 6 numbers, or alternatively, a participant can have some or all of his/her 6 numbers randomly picked by a random number generator.

### Player's Objective

The game has what we could describe as a first phase in which the objective for each participant in the game that week is to become one of a selected number of last or final participants remaining. A suitable number of final participants is 9, which is the same number of final participants as used in Example 1.

The game's first objective for a participant is to correctly pick the PRIMARY number (which could be any number from the number range of 1 to 30), which becomes the least picked number following the analysis of all the participants' picks of their PRIMARY numbers.

Minor prizes can be awarded for success in achieving the first objective.

Then, for those participants that have correctly chosen the winning PRIMARY number, the next objective is to have also correctly picked in order (through their choice of SECONDARY numbers) the next least picked numbers (based on all the participants choice of numbers), with the objective of becoming one of 9 participants that survive these further elimination processes, and who move to the second phase of the game to play for the major prizes.

In the game's second phase, the objective for those last 9 participants (or such fewer participants in the case of a participant having more than one qualifying ticket in the last 9), is to become in the following week, the last participant remaining, thereby winning the first prize.

Major prizes, including a first prize for the winner, can be awarded to the 9 participants in the second phase.

### Example 3.1

### Assumed Game Profile

In this Example 3, it is assumed that:
The game is commenced each week, with the first phase played in week one and the second phase is played in week two (concurrent with the running of the following week's game);
The participants in each week's game will each purchase 6 different numbers in the selected range of 1-30;
Each number block of 6 numbers, consists of 1 PRIMARY and 5 SECONDARY numbers, all of which must be different:
Each number block is purchased at a total cost of $10;
the game is played each week by 500,000 participants;
each participant purchases the minimum of $10 for one number block of 6 different numbers—so there would be 500,000 PRIMARY numbers picked in total, all in the number range of 1-30;
The total revenue from each week's game is $5,000,000:
The available prize pool is 50% of total revenue;
Total prizes available are $2,500,000;
Any numbers in the range of 1-30 that might not be chosen by any participant are ignored.
The number 13 is the PRIMARY number chosen the least.
There are 12,000 participants that have chosen 13 as their PRIMARY number.
Those 12,000 winners each receive one bonus entry into the following weeks game i.e. valued at $10 each ($120,000) and one entry into Super Game.
Example 3.2, Table 5 below sets out an example of the results of this 500,000 participants' game, and the number of times each PRIMARY number in the 1-30 number range was chosen by all the participants in the game.
Ties between n numbers in the number range 1 to 30 are ALL resolved—see Example 3.3 below.
The 12,000 winners are subjected to further eliminations using the SECONDARY numbers, which are conducted using the ranking of the n numbers determined from the one data set from the 500,000 participant's choices of the PRIMARY number. Alternatively, the ranking of the n numbers could be determined from the participants' choices of all their chosen numbers—an example is set out in FIG. 8. In a further alternative, the further eliminations could be conducted using firstly, the data set from the 500,000 participant's choices of their 1^{st} SECONDARY number, then secondly the data set from the 500,000 participant's choices of their 2^{nd} SECONDARY number, and so on up to the 5^{th} SECONDARY number, but we believe that this is too cumbersome and not a practical option in any application of the invention. Further it would increase the number of data sets that need to be handled and processed by the computer program and by the gaming organisers, from the preferred one set of data to effect all eliminations (when, in this example, only using the one data set arising from the PRIMARY number choices) to six different data sets. Disadvantages when using more than the one data set are increases in the risk of computer program error and if using multiple data sets, an imperfect or cumbersome ranking system. A further example of elimination methods using our invention and using numerous data sets is contained in FIG. 9.

### Example 3.2

TABLE 5
Example 3.2
Results of 500,000 Participant Game - One Data
Set from PRIMARY Number Selections

| BY RANKINGS | | | BY NUMBERS | | |
|---|---|---|---|---|---|
| RANK- | | | | | RANK- |
| INGS | NUMBER | | | NUMBER | INGS |
| OF | OF | NUM- | NUM- | OF | OF |
| LEAST | TIMES | BERS | BERS | TIMES | LEAST |
| PICKED | CHOSEN | CHOSEN | CHOSEN | CHOSEN | PICKED |
| 1 | 12,000 | 13 | 1 | 14,063 | 8 |
| 2 | 12,002 | 30 | 2 | 19,000 | 21 |
| 3 | 13,335 | 21 | 3 | 14,400 | 10 |
| 4 | 13,775 | 4 | 4 | 13,775 | 4 |
| 5 | 13,999 | 27 | 5 | 20,789 | 29 |
| 6 | 14,005 | 10 | 6 | 19,441 | 25 |
| 7 | 14,010 | 20 | 7 | 18,888 | 20 |
| 8 | 14,063 | 1 | 8 | 17,650 | 18 |
| 9 | 14,065 | 11 | 9 | 19,442 | 26 |
| 10 | 14,400 | 3 | 10 | 14,005 | 6 |
| 11 | 15,050 | 25 | 11 | 14,065 | 9 |
| 12 | 15,556 | 16 | 12 | 16,021 | 16 |
| 13 | 15,900 | 24 | 13 | 12,000 | 1 |
| 14 | 16,005 | 29 | 14 | 20,543 | 28 |
| 15 | 16,008 | 19 | 15 | 19,347 | 23 |
| 16 | 16,021 | 12 | 16 | 15,556 | 12 |
| 17 | 17,000 | 18 | 17 | 21,345 | 30 |
| 18 | 17,650 | 8 | 18 | 17,000 | 17 |
| 19 | 17,775 | 26 | 19 | 16,008 | 15 |
| 20 | 18,888 | 7 | 20 | 14,010 | 7 |
| 21 | 19,000 | 2 | 21 | 13,335 | 3 |
| 22 | 19,023 | 28 | 22 | 20,189 | 27 |
| 23 | 19,347 | 15 | 23 | 19,374 | 24 |
| 24 | 19,374 | 23 | 24 | 15,900 | 13 |
| 25 | 19,441 | 6 | 25 | 15,050 | 11 |
| 26 | 19,442 | 9 | 26 | 17,775 | 19 |
| 27 | 20,189 | 22 | 27 | 13,999 | 5 |
| 28 | 20,543 | 14 | 28 | 19,023 | 22 |
| 29 | 20,789 | 5 | 29 | 16,005 | 14 |
| 30 | 21,345 | 17 | 30 | 12,002 | 2 |
| | 500,000 | | | 500,000 | |

### Example 3.3

### Resolving Ties (as Between the Numbers 1 to 30) within the Ranking System

While the above Example 3.2, Table 5 does not have any ties, it will be inevitable that ties will occur where two or more numbers within the range of numbers from 1 to n (in this example, 1 to 30) are chosen exactly the same number of times by the participants in the game. Multiple numbers of ties could also occur. In this Example 3 of the game, it is preferable that all ties are resolved.

While there will be a number of ways to resolve ties, such as by using a random method, the preferred way to resolve all ties in this Example 3 of the use of the game is to use the unpredictability of the results of all the participants' choices in the game itself, by using the resulting ‘odds’ and ‘evens’ that arise for each n number—as set out in the column headed “NUMBER OF TIMES CHOSEN” in Example 3.2—Table 5 above (the “Selection Total”).

Referring to Example 3.2—Table 5, it will be apparent that each of the 30 numbers have been chosen a certain number of times and that this results in either an odd numbered Selection Total or an even numbered Selection Total, representing the number of times each of the 30 numbers was chosen. Whether a number available to be chosen within the range of numbers from 1 to n (in this example 1 to 30) is going to end up being chosen a number of times that is either an odd or even Selection Total number is entirely unpredictable, and is a chance result. This chance result creates a unique method to resolve ties.

In this example, to resolves ties, an even number Selection Total will result in the lowest face value of the tied numbers being ranked ahead of the higher face valued number/s. An odd number Selection Total will result in the highest face value of the tied numbers being ranked ahead of the lowest face valued number/s. For example if the following n numbers (2, 13, 20 and 29) were in a four-way tie with the same Selection Total number of, for example, 20,189, which is an odd Selection Total number, then the order of the four tied numbers becomes 29, 20, 13 and 2.

This process is further explained in FIG. 3.

### Example 3.4

### The Elimination Processes to Determine 9 Participants that Will Proceed to the Second Phase

In this Example 3, the first phase objective is to determine 9 participants. The process is overviewed below:

The First Eliminations:

The first elimination process involves reducing the participants in the game from 500,000 to a much lower number. This occurs by eliminating all participants other than those participants that chose number [13] as their PRIMARY number, which is the number that was least picked by all the 500,000 participants in the game, as it was chosen 12,000 times—see Example 3.2, Table 5.

Calculations:

With 500,000 participants in the game, divided by the number range of 1-30, this results in an average of 16,666 participants per number. Some numbers will be chosen more times, other numbers less. In this example, it is assumed that there are 12,000 participants that have each chosen [13] as their PRIMARY number and who are not eliminated.

The Second Eliminations:

The second elimination process involves reducing the remaining 12,000 participants from 12,000 to a much lower number by eliminating all participants other than those participants that chose number [30] as their 1^{st} SECONDARY number, which is the number that was the second least picked number by all the 500,000 participants in the game, as it was chosen 12,002 times—see Example 3.2, Table 5.

Calculations:

With 12,000 participants remaining in the game, divided by the remaining number range of 29 (as number 13 has now gone from the number range of 1-30), results in an average of 414 participants per number. Based on the law of averages, some of the remaining 29 numbers will be chosen more times, other numbers less. In this example, it is assumed that there are c. 400 participants that have chosen [30] as their 1^{st} SECONDARY number and which are not eliminated.

The Third Elimination:

The third elimination process involves reducing the remaining c. 400 participants by eliminating all participants other than those that chose [21] as their 2^{nd} SECONDARY number, which is the number that was the third least picked by all the 500,000 participants in the game, as it was chosen 13,335 times—see Example 3.2, Table 5.

Calculations:

With c. 400 participants remaining in the game, divided by the remaining number range of 28 (as number 13 and 30 have both now gone from the number range of 1-30), results in an average of c. 14 participants per number. Based on the law of averages, some of the remaining 28 numbers will be chosen more times, other numbers less. In this example, it is assumed that there are c. 10 participants that have chosen [21] as their 2^{nd} SECONDARY number and which are not eliminated.

Final Eliminations—the Ranking System:

With c. 10 participants remaining in this example, those small number of remaining participants can be ranked using their 3^{rd} SECONDARY number, and 4^{th} SECONDARY number if necessary, to determine the 9 participants that are to proceed to the second phase.

This above described process is exemplified in Example 3.6, Table 7 that follows, which focuses on the 10 best performing participants in the game. When considering Example 3.6, Table 7, the 6 number choices of the best 10 performing participants (having the best results for the ‘least picked’ PRIMARY number and 5 SECONDARY numbers) are set out in Example 3.5, Table 6 below:

### Example 3.5

TABLE 6
Chosen numbers of the Top 10 Participants

| | Primary | | | | | |
|---|---|---|---|---|---|---|
| Participant | Number | 1^{st} SEC | 2^{nd} SEC | 3^{rd} SEC | 4^{th} SEC | 5^{th} SEC |
| P.1 | 13 | 30 | 21 | 4 | 20 | 2 |
| P.2 | 13 | 30 | 21 | 4 | 3 | 11 |
| P.3 | 13 | 30 | 21 | 77 | 10 | 20 |
| P.4 | 13 | 30 | 21 | 11 | 18 | 20 |
| P.5 | 13 | 30 | 21 | 11 | 8 | 26 |
| P.6 | 13 | 30 | 21 | 16 | 25 | 20 |
| P.7 | 13 | 30 | 21 | 24 | 4 | 10 |
| P.8 | 13 | 30 | 21 | 29 | 27 | 4 |
| P.9 | 13 | 30 | 21 | 19 | 26 | 3 |
| P.10 | 13 | 30 | 21 | 12 | 2 | 1 |

### Example 3.6

TABLE 7
Determine the 9 Participants to proceed to the second phase.

| | Nos of | | | | | | | | | | |
|---|---|---|---|---|---|---|---|---|---|---|---|
| | Participants | | | | | | | | | | |
| | P.1 | P.2 | P.3 | P.4 | P.5 | P.6 | P.7 | P.8 | P.9 | P.10 | . . . To P. |
| From | 12,000 | 12,000 | 12,000 | 12,000 | 12,000 | 12,000 | 12,000 | 12,000 | 12,000 | 12,000 | 12,000 |
| PRIMARY | | | | | | | | | | | |
| no. 13 | | | | | | | | | | | |
| First | 12,002 | 12,002 | 12,002 | 12,002 | 12,002 | 12,002 | 12,002 | 12,002 | 12,002 | 12,002 | c. 400 |
| Secondary | | | | | | | | | | | left |
| (no of times | | | | | | | | | | | |
| chosen by | | | | | | | | | | | |
| all | | | | | | | | | | | |
| participants | | | | | | | | | | | |
| in game) | | | | | | | | | | | |
| 2^{nd} | 13,335 | 13,335 | 13,335 | 13,335 | 13,335 | 13,335 | 13,335 | 13,335 | 13,335 | 13,335 | c. 10 |
| Secondary | | | | | | | | | | | left |
| 3^{rd} | 13,775 | 13,775 | 13,999 | 14,065 | 14,065 | 15,556 | 15,900 | 16,005 | 16,008 | 16,021 | |
| Secondary | (1^{st}) | (2^{nd}) | (3^{rd}) | (4^{th}) | (5^{th}) | (6^{th}) | (7^{th}) | (8^{th}) | (9^{th}) | (10^{th}) | |
| 4^{th} | 14,010 | 14,400 | 14,005 | 17,000 | 17,650 | 15,050 | 13,775 | 13,999 | 17,775 | 19,000 | |
| Secondary | | | | | | | | | | | |
| 5^{th} | 19,000 | 14,065 | 14,010 | 14,010 | 17,775 | 14,010 | 14,005 | 13,775 | 14,400 | 14,063 | |
| Secondary | | | | | | | | | | | |
| Extra Nos | . . . | . . . | . . . | . . . | . . . | . . . | . . . | . . . | . . . | . . . | |
| if needed | | | | | | | | | | | |

As can be seen from Example 3.6, Table 7 above, P.1 to P.9 are the 9 participants that proceed to the second phase. For clarification, this table ranks P.1 to P.10 in order of performance in the game.

### Example 3.7

### Use of Eliminations and/or the Ranking System

The Ranking System described in this invention, in particular as referred to in Examples 3.2 and 3.3, can be used to rank each participants performance in a game. So in a game played by 500,000 participants, each participant can be ranked, from 1^{st} place down to last place. Accordingly, in one aspect of the invention, the winner is can be determined through this method. However, we believe it is preferable to have a group of winners (or class of winners) at various determined steps in the game. Accordingly, we believe it is preferable to also undertake elimination steps as we have described in Example 3.4 above.

Depending on the number of participants in a game as described in this Example 3, but assuming a minimum of 500,000 participants, these elimination steps occur, as we have set out in Example 3.4 above, using firstly the PRIMARY number, and then the 1^{st} and 2^{nd} SECONDARY numbers, and as may be necessary, the 3^{rd} SECONDARY number and so forth, until a ‘sufficiently small’ number of participants remain.

What constitutes ‘sufficiently small’ may vary for each game profile and will depend on the number of participants in the game and the number of individual ‘major’ prizes that the gaming organizers want to award to successful participants.

In this Example 3 of the game which is a game with 500,000 participants, we have continued the elimination processes up to and including the use of the 2^{nd} SECONDARY number, after which there is about 10 participants remaining. Then the computer software ranks in order each of those last 10 or so remaining participants, ranking their performance against each other, with reference to the ranking system as set out in Example 3.2, Table 5. We have used 10 final participants from which we then determine the last 9 as are required for the second phase of this example of the game.

If however, the use of the 2^{nd} SECONDARY number above resulted, for example, in there being less than 9 participants that had correctly chosen the relevant winning PRIMARY number, and then the 1^{st} and 2^{nd} SECONDARY numbers, then the following occurs:
Those participants, if any, all proceed to the second phase; and
The remaining participants that are required to make up the 9 are determined from the prior group of participants that had correctly chosen the relevant winning PRIMARY number, and also the 1^{st} SECONDARY number. The remaining participants are determined by reference to each of those participants other SECONDARY numbers which are then ranked by reference to the Ranking System as contained in Example 3.2, Table 5 and the methods described herein.
Table 8 below overviews this process in respect of determining 9 participants for most game sizes. The method set out in this Table below should be sufficient for most game sizes based on the results set out in Example 4.17, Table 18—“Backroom Calculations—Eliminations”. It will be appreciated that the process can be expanded if the number of participants in the games become sufficiently large, or the range of n numbers available for selection is less than what we have used in the examples set out, for instance the process can be expanded by adding more SECONDARY numbers.

TABLE 8
Description of Elimination Steps

| Steps | | Description of Elimination Steps |
|---|---|---|
| First | PRIMARY | Firstly, eliminate all participants other than those that |
| | | chose the correct PRIMARY number [13]. (“Primary |
| | | Winner Category”) |
| 2^{nd} | 1^{st} SECONDARY | Secondly, eliminate all Primary Winner Category |
| | | participants other than those that also correctly chose |
| | | the 1^{st} Secondary number [30]. (“1^{st} See Category”), |
| | | If the number of remaining participants is 9 or less, go |
| | | to the Final Step. Otherwise proceed below. |
| 3^{rd} | 2^{nd} SECONDARY | Thirdly, eliminate all 1^{st} See Category participants |
| | | other than those that also correctly chose the 2^{nd} |
| | | Secondary number [21]. (“2^{nd} Sec Category”), |
| | | If the number of remaining participants is 9 or less, go |
| | | to the Final Step. Otherwise proceed below. |
| 4^{th} | 3^{rd} SECONDARY | Fourthly, eliminate all 2^{nd} Sec Category participants |
| | | other than those that also correctly chose the 3^{rd} |
| | | Secondary number [4]. (“3^{rd} Sec Category”). |
| | | If the number of remaining participants is 9 or less, go |
| | | to the Final Step. Otherwise proceed below. |
| 5^{th} | 4^{th} SECONDARY | Fifthly, eliminate all 3^{rd} Sec Category participants |
| | | other than those that also correctly chose the 4^{th} |
| | | Secondary number [27]. (“4^{th} Sec Category”). |
| | | If the number of remaining participants is 9 or less, go |
| | | to the Final Step. Otherwise proceed below. |
| 6^{th} | 5^{th} SECONDARY | Sixthly, eliminate all 4^{th} Sec Category participants |
| | | other than those that also correctly chose the 5^{th} |
| | | Secondary number [10]. (“5^{th} Sec Category”). |
| Final | | [1] If the number of participants is 9 or less, those |
| Step | | participants, if any, proceed to the second phase; |
| | | and then |
| | | [2] If 1 or more participants are still required to make |
| | | up the 9 participants required for the second phase, |
| | | then using the group of participants from the |
| | | preceding stage/s as relevant, rank those participants |
| | | using their relevant Secondary number/s in |
| | | accordance with the Selection Total/s and Ranking |
| | | System of the n numbers to determine those that have |
| | | the best rankings and who are also to proceed to the |
| | | second phase in order to make up the required 9. |

### Example 3.8

### Alteration to Ascribed Ranking Value—Same Results

Example 3.6, Table 7 above ranks the participants' 6 number choices from the number range of 1-30, by reference to the one data set as set out in Example 3.2 Table 5. To illustrate this—and with reference to Example 3.2, Table 5 which ranks all the n numbers:
number 13 was the least chosen number, so it was placed first with a ranking number or ranking value of 12,000 (being the number of times that it had been chosen by all the participants in the game);
number 30 was the second least chosen number, so it was placed second with a ranking number or ranking value of 12,002 (being the number of times that it had been chosen by all the participants in the game): and so on as set out in Example 3.2, Table 5.

### Alteration to Ascribed Ranking Value

Instead of using the ascribed ranking value based on the number of times that each of the n numbers 1-30 had been chosen by all the participants in the game, the ascribed ranking value can be changed to equal the actual rankings or placement number of the 30 numbers, by ranking them 1^{st} to 30^{th}. To illustrate this—and again with reference to Example 3.2, Table 5 which ranks all the n numbers, and to Example 3.5, Table 6 which records the 6 chosen numbers of the top 10 participants:
number 13 was the least chosen number, so it was placed first with a ranking number or ranking value of 12,000 (being the number of times that it had been chosen by all the participants in the game). Its ranking value is changed from 12,000 to 1^{st}—i.e. a ranking value of 1—thereby being a “Selection Total” of 1;
number 30 was the second least chosen number, so it was placed second with a ranking number or ranking value of 12,002 (being the number of times that it had been chosen by all the participants in the game). Its ranking value is changed from 12,002 to 2^{nd}—i.e. a ranking value of 2—thereby being a “Selection Total” of 2; . . . and so on.

Example 3.9, Table 9 below is the same as Example 3.6, Table 7 above, but is now altered to show the change to using the ascribed ranking value/Selection Total of 1, 2, 3, etc as described in the paragraph above.

### Example 3.9

TABLE 9
Determine the 9 Participants to proceed to the second phase -
Using Alteration to Ascribed Ranking Value

| | Nos of Participants | | | | | | | | | | |
|---|---|---|---|---|---|---|---|---|---|---|---|
| | P.1 | P.2 | P.3 | P.4 | P.5 | P.6 | P.7 | P.8 | P.9 | P.10 | . . . To P. |
| From | 12,000 | 12,000 | 12,000 | 12,000 | 12,000 | 12,000 | 12,000 | 12,000 | 12,000 | 12,000 | 12,000 |
| PRIMARY | 1 | 1 | 1 | 1 | 1 | 1 | 1 | 1 | 1 | 1 | |
| no. 13 | | | | | | | | | | | |
| First | 12,002 | 12,002 | 12,002 | 12,002 | 12,002 | 12,002 | 12,002 | 12,002 | 12,002 | 12,002 | c. 400 |
| Secondary | 2 | 2 | 2 | 2 | 2 | 2 | 2 | 2 | 2 | 2 | left |
| (no of times | | | | | | | | | | | |
| chosen by | | | | | | | | | | | |
| all | | | | | | | | | | | |
| participants | | | | | | | | | | | |
| in game - | | | | | | | | | | | |
| then ranked | | | | | | | | | | | |
| 1^{st}, 2^{nd}, 3^{rd}, | | | | | | | | | | | |
| et) | | | | | | | | | | | |
| 2^{nd} | 13,335 | 13,335 | 13,335 | 13,335 | 13,335 | 13,335 | 13,335 | 13,335 | 13,335 | 13,335 | c. 10 |
| Secondary | 3 | 3 | 3 | 3 | 3 | 3 | 3 | 3 | 3 | 3 | left |
| 3^{rd} | 13,775 | 13,775 | 13,999 | 14,065 | 14,065 | 15,556 | 15,900 | 16,005 | 16,008 | 16,021 | |
| Secondary | 4 | 4 | 5 | 9 | 9 | 12 | 13 | 14 | 15 | 16 | |
| | (1^{st}) | (2^{nd}) | (3^{rd}) | (4^{th}) | (5^{th}) | (6^{th}) | (7^{th}) | (8^{th}) | (9^{th}) | (10^{th}) | |
| 4^{th} | 14,010 | 14,400 | 14,005 | 17,000 | 17,650 | 15,050 | 13,775 | 13,999 | 17,775 | 19,000 | |
| Secondary | 7 | 10 | 6 | 17 | 18 | 11 | 4 | 5 | 19 | 21 | |
| 5^{th} | 19,000 | 14,065 | 14,010 | 14,010 | 17,775 | 14,010 | 14,005 | 13,775 | 14,400 | 14,063 | |
| Secondary | 21 | 9 | 7 | 7 | 19 | 7 | 6 | 4 | 10 | 8 | |
| Extra Nos | . . . | . . . | . . . | . . . | . . . | . . . | . . . | . . . | . . . | . . . | |
| if needed | | | | | | | | | | | |

FIG. 4 shows, by way of an example in a series of computer printouts, a method of processing by a computer the results for a 100,000 participant game which is relevant to the example set out in this Examples 3. In particular FIG. 4 shows the computer processing method to determine the top 10 in order, from which the final 9 can be determined. This example set out in FIG. 4 can be easily scalable for any size game.

### Example 3.10

### End of Phase One—Announcement of First Phase Winners

At the end of week one, the 9 winners eligible for the second phase are published and any winning numbers associated with any minor prizes won in the first phase are also published and paid.

The 9 winners eligible for the second phase are published (and announced) at the beginning of week two by the gaming organizers disclosing the 6 numbers from each winning participant's block of 6 numbers and/or the entry ticket numbers of the 9 winners of the first phase. In this example, each of these 9 winners would receive a guaranteed minimum prize from the second phase.

Also at the beginning of week two, the next game is commenced, so that the next 9 participants can be determined and published (and announced) at the end of week two.

### Example 3.11

### Second Phase—Week Two—Determining the “winner/s”

As previously set out in Example 1, the 9 winners eligible to participate in phase two of the game set out in this Example 3 will then compete at the end of week two to become the “winner” in order to win the first prize.

Consistent in keeping with the game's objective in this example for participants to choose numbers that are least picked by the 9 participants, and to be rewarded accordingly, the elimination processes for phase two are based on these objectives.

Eliminations Starting with the 9 Participants

Firstly: Each of the 9 participants will be required to nominate a number from the number range of, say, 1 to 5. The outcomes will be:

The participant/s that nominate a number that is least picked by the other participants will avoid elimination. The other participants will be eliminated. Participants eliminated in this first elimination stage may each receive a prize, say, $20,000. Only the lowest number of participants go through.

E.g. If 5 participants nominate the number 1; 2 participants nominate the number 3; and 2 participants nominate the number 5; then the 5 participants that nominated the number 1 are eliminated and the other 4 participants proceed to the next elimination stage.

However, if 4 participants nominate the number 1; 3 participants nominate the number 3; and 2 participants nominate the number 5; then 7 participants are eliminated and only the 2 participants that nominated the number 5 proceed to the next elimination stage.

If at this first stage of eliminations involving all 9 participants, one of the participants has a nominated number that no other participant nominates and there are no other participants in the same position, then that participant is the winner. A participant winning at this first stage is eligible to win the Jackpot if provided. Otherwise the Jackpot carries over to the following week's game.

If none of the participants nominate a number that is least picked by other participants, resulting in a tie then the prize is shared equally but the Jackpot, if provided, cannot be won. Alternatively, the above elimination process could be repeated, with or without the jackpot at stake.

E.g. 3 participants nominate the number 1; 3 participants nominate the number 3; and the remaining 3 participants nominate the number 5; then that constitutes a tie.

If there are 4 to 6 Remaining Participants

Secondly: In the event the remaining participants number 4 or more, then each of the remaining participants that have not been eliminated will be required to nominate a further number, this time from the number range of 1 to 3. At this stage there will be no more than 6 participants left standing. The outcomes will be:

The participant/s that nominate a number that is least picked by the other participants will avoid elimination. The other participants will be eliminated. Participants eliminated in this second elimination stage may each receive a prize, say, $35,000. Only the lowest number of participants go through.

If at this stage one of the participants has a nominated number that no other participant nominates and there are no other participants in the same position, then that participant is the winner of the prize, but the Jackpot cannot be won, as it can only be won in the first elimination stage involving all 9 participants.

If none of the remaining participants nominate a number that is least picked by other participants, resulting in a tie, then the prize is shared equally. Alternatively, the above elimination process could be repeated.

If there are 3 Remaining Participants

Thirdly: In the event that at any time there becomes three remaining participants, each of the three remaining participants that have not been eliminated will again be required to nominate a number from the number range of 1 to 2. The outcomes will be:

The participant that nominates a number that is least picked will again avoid elimination.

That participant is the winner of the prize, but the Jackpot cannot be won, as it can only be won in the first elimination stage.

The other two participants eliminated in this stage may each receive a prize, say, $50,000.

If none of the three participants nominate a number that is least picked by the other participants, resulting in a 3-way tie, then the prize is shared equally. Alternatively, the above elimination process could be repeated again.

If there are 2 Remaining Participants

Fourthly: In the event that at any time there becomes two remaining participants, each of those two remaining participants will be required to nominate a number from the number range of 1 to 2. The gaming organizer will at the same time (so no one participant or the gaming organizer will have any prior knowledge of any chosen number) also nominate a number preferably by way of a random number generator, in the range of 1 to 2. The outcomes will be:

If one of the participants nominates a number that is not nominated by the other participant and not nominated by the gaming organizer, then that participant is the winner, but the Jackpot cannot be won, as it can only be won in the first elimination stage.

The other eliminated participant (eliminated by the gaming organizer) may receive a prize, say, $100,000.

If the two participants nominate a number that is picked by both of them, irrespective of whether or not the gaming organizer nominates the same number, then this results in a 2-way tie and the prize is shared equally, but the Jackpot cannot be won, as it can only be won in the first elimination stage.

As will be appreciated, any of the above outcomes where there is a tie between 2 or more participants could be resolved by reference back to each of those tied participants original 10 numbers and ranking their performances as described previously, so that one or more participants could always be eliminated and the elimination process then continues or a sole winner is determined.

### Example 3.12

### Exampled Prize Winnings

In this Example 3, assume that:

There are 500,000 participants in each game, with each participant purchasing the minimum of $10 for one block of 6 numbers—resulting in a pool of $5,000,000 available to cover expenses, costs and prizes; and

50% of the revenue pool is paid out as prizes; so
$2,500,000 is available for prizes in both phases of the game.

### In the First Phase of the Game:

Prizes are awarded to each participant that correctly chooses the winning PRIMARY number ($10 bonus ticket), further prizes are awarded to each participant that also correctly chooses the 1^{st} Secondary number ($300), and further prizes are awarded to each of those participants that also correctly chooses the 2^{nd} Secondary number ($3,000). (In this Example 3 it is assumed that the use of the ranking system to determine the 9 participants to proceed to the second phase occurs with the remaining participants at the 2^{nd} SECONDARY number stage).

### In the Second Phase of the Game:

Each of the 9 participants eliminated in this first round of eliminations receives $20,000

Each of the 9 participants eliminated in any second round of eliminations receives $35,000

In the stage that requires elimination of participants when there are either two or three remaining participants in total, then as relevant, either the two participants that are then eliminated each receive $50,000, or the one eliminated participant receives $100,000.

If the winner wins in the first round of eliminations that occur in the second phase of the game, then net of the prize payments to be made to the eliminated participants in the first phase and the prize payments to the 8 eliminated participants from the second phase, that winner receives 100% of the balance of that relevant week's prize pool, and 100% of any jackpot pool that has accumulated from previous weeks.

If the winner wins in the second round of eliminations, net of the other prize payments, that winner receives 35% of the balance of that relevant weeks prize pool (but 0% of the jackpot pool that has accumulated from previous weeks, as the jackpot can only be won in the first round of eliminations in the event of a clear winner being achieved). Unpaid prizes jackpot to the following week.

If the winner wins during the third round of eliminations, net of the other prize payments, that winner receives 25% of the balance of that relevant week's prize pool (but 0% of the jackpot pool that has accumulated from previous weeks). Unpaid prizes jackpot to the following week.

### Example 3.13

TABLE 10
Example 3.13 - Two Phase Game - Exampled Prize Winnings

| | Maximum | | Total | % of |
|---|---|---|---|---|
| | Number of | | Maximum | $2.5m |
| Elimination | Participants | Prizes per | Amount of | Prize |
| Factors | in each stage | Ticket | Prizes | Pool |
| | 500,000 | n/a | n/a | n/a |
| (÷30) | 16,667 | $10 (bonus | $170,000 | 6.8% |
| PRIMARY | | ticket) | | |
| (÷29) | 575 | $300 + | $200,000 | 8.0% |
| 1^{st} Secondary | | above | | |
| (÷28) | 21 | $3,000 + | $75,000 | 3.0% |
| 2^{nd} Secondary | | above | | |
| (÷27) | 9 Participants, | | $2,055,000 | 82.2% |
| 3^{rd} Secondary | for TV Game | | | |
| | Show | | | |
| | (including | | | |
| | winner) | | | |
| (÷26) | | | | |
| 4^{th} Secondary | | | | |
| (÷25) | | | | |
| 5^{th} Secondary | | | | |
| Totals | | | $2,500,000 | 100% |

### Example 3.14

### TV/Game Show

It is envisaged that in this Example 3, phase two of the lottery will be conducted at the same time as the announcements of the winners of phase one of the following game are being announced.

Phase two could be conducted through a televised show, most likely of short duration, as phase two is believed to be suitable for a game or reality show, including being suitable with potential audience participation.

Each of the 9 winning participants can compete in phase two in person, or a participant can participate anonymously by telephone, or by other means of instantaneous communication, or by the gaming organizers appointing a person to participate on the winning participants behalf (the later occurring automatically if a phase two winning participant fails to identify him or herself as one of the 9 winners).

The second phase can be made exciting and it relies on each participant's own choice.

### Example 3.15

### Incorporation of a “Super Game”

Using the base parameters set out in this Example 3, the invention preferably also includes the incorporation of a “Super Game”, with a set percentage of the weekly game's prize pool set aside for the “Super Game”, with a corresponding reduction to the amount available to be paid out as weekly prizes.

Preferably, this “Super Game” is won at defined periods such as annually, or six monthly, or in some other set way, such as when a set target amount of prize pool for the Super Game is reached.

Preferably the Super Game involves the same identical processes of elimination as applicable to the weekly draws as described above.

### Example 3.16

### The Odds of Winning

The odds of winning a prize in this Example 3 involving a two phase game—in the first instance correctly choosing the week's winning PRIMARY number—is 1 in 30.

The odds of being one of the final 9 to proceed to the second phase and win one of the 9 major prizes—is 1 in 55,555

Then, in this Example 3, the mathematical probability of one of the 9 participants being a sole winner in the first round of eliminations in the second phase of the game, and thereby winning Jackpot, is 36%, or c. 1 in 3.

It will be appreciated that the mathematical probability of one of the 9 participants being a sole winner in the first round of eliminations will vary if the number of participants is changed from 9 to a lesser or greater number. The mathematical probability will also change if the range of numbers to be selected in the first elimination stage of the second phase is changed, from 1-5 to something else.

As one example, if the number of final participants was changed to 8, and the number range was changed to 1-7, then the mathematical probability of one of the 8 participants being a sole winner in the first round of eliminations in the second phase of the game will change to 13.88%, or c. 1 in 7.

It will be clear that a large number of variations exist and the above descriptions as set out in this Example 3 are by way of example only.

### EXAMPLE 4

### Example 4.0

### One Phase Game—(Number Range 1 to n, where n=30)

This example works, as before, on the basis of picking the ‘least picked’ numbers.

The game, as described below, is a one phase game and is sold over a defined period, for example, weekly.

The participants each purchase during the week 6 different numbers in the selected range of 1 to 30—where each number picked is picked to be one of the ‘least picked’ by all the participants in the game. A number can only be picked once.

Each participant:
Picks 1 PRIMARY number.
Picks 5 SECONDARY numbers—which may be used in later elimination stages.

As also set out previously in Example 3, each participant may choose his/her own unique block of 6 numbers, or alternatively, a participant can have some or all of his/her 6 numbers randomly picked by a random number generator.

### Player's Objective

The game has what we could describe as only a first or single phase in which the objective for each participant in the game that week is to become the sole winner.

The games first objective for a participant is to correctly pick the PRIMARY number (which could be any number from the number range of 1 to 30), which becomes the least picked number following the analysis of all the participants' picks of their PRIMARY numbers.

Minor prizes can be awarded for success in correctly picking the least picked PRIMARY number.

Then, for those participants that have correctly chosen the winning PRIMARY number, the next objective is to have also correctly picked in order (through their choice of SECONDARY numbers) the next least picked numbers (based on all the participants choice of numbers), with the objective of becoming the sole winner and the winner of the first prize.

### Super Game

The game in this Example 4 can have a concurrent running “Super Game” that is played once every set period e.g. 6 monthly or yearly.

The assumptions below proceed on the basis that a Super Game is incorporated, drawn yearly, where participants who purchase in the weekly games and who have correctly chosen the correct PRIMARY number in any weekly game, receive one automatic entry into the Super Game.

For each week that a participant chooses the correct PRIMARY number, that participant receives an entry into Super Game—i.e. if a participant correctly chooses the winning PRIMARY numbers in a total of 20 weekly games during the year, then that participant will have 20 entries in the Super Game, drawn at the end of the year—at no cost of entry.

### Example 4.1

### Assumed Game Profile

In this example, it is assumed that:
The game is run weekly;
The participants in each week's game will each purchase 6 different numbers in the selected range of 1-30;
Each number block of 6 numbers, consists of 1 PRIMARY and 5 SECONDARY numbers, all of which must be different:
Each number block is purchased at a total cost of $10;
the game is played each week by 500,000 participants;
each participant purchases the minimum of $10 for one number block of 6 different numbers—so there would be 500,000 PRIMARY numbers picked in total, all in the number range of 1-30;
The total revenue from each week's game is $5,000,000:
The available prize pool is 50% of total revenue;
Total prizes available are $2,500,000;
Any numbers in the range of 1-30 that might not be chosen by any participant are ignored.
The number 13 is the PRIMARY number chosen the least.
There are 12,000 participants that have chosen 13 as their PRIMARY number.
Those 12,000 winners each receive one bonus entry into the following weeks game i.e. valued at $10 each ($120,000) and one entry into Super Game.
Example 4.2, Table 11 below sets out an example of the results of this 500,000 participants' game, and the number of times each PRIMARY number in the 1-30 number range was chosen by all the participants in the game.
Ties between n numbers in the number range 1 to 30 are ALL resolved—see Example 4.3 below.
The 12,000 winners are subjected to further eliminations using the SECONDARY numbers, which are conducted using the ranking of the n numbers determined from the one data set from the 500,000 participant's choices of the PRIMARY number. Alternatively, the ranking of the n numbers could be determined from the participants' choices of all their chosen numbers—an example is set out in FIG. 8. In a further alternative, the further eliminations could be conducted using firstly, the data set from the 500,000 participant's choices of their 1^{st} SECONDARY number, then secondly the data set from the 500,000 participant's choices of their 2^{nd} SECONDARY number, and so on up to the 5^{th} SECONDARY number, but we believe that this is too cumbersome and not a practical option in any application of the invention. Further it would increase the number of data sets that need to be handled and processed by the computer program and by the gaming organisers, from the preferred one set of data to effect all eliminations (when, in this example, only using the one data set arising from the PRIMARY number choices) to six different data sets. Disadvantages when using more than the one data set are increases in the risk of computer program error and if using multiple data sets, an imperfect or cumbersome ranking system. A further example of elimination methods using our invention and using numerous data sets is contained in FIG. 9.

### Example 4.2

TABLE 11
Example 4.2
Results of 500,000 Participant Game - One Data
Set from the PRIMARY Number Selections

| BY RANKINGS | | | BY NUMBERS | | |
|---|---|---|---|---|---|
| RANK- | | | | | RANK- |
| INGS | NUMBER | | | NUMBER | INGS |
| OF | OF | NUM- | NUM- | OF | OF |
| LEAST | TIMES | BERS | BERS | TIMES | LEAST |
| PICKED | CHOSEN | CHOSEN | CHOSEN | CHOSEN | PICKED |
| 1 | 12,000 | 13 | 1 | 14,063 | 8 |
| 2 | 12,002 | 30 | 2 | 19,000 | 21 |
| 3 | 13,335 | 21 | 3 | 14,400 | 10 |
| 4 | 13,775 | 4 | 4 | 13,775 | 4 |
| 5 | 13,999 | 27 | 5 | 20,789 | 29 |
| 6 | 14,005 | 10 | 6 | 19,441 | 25 |
| 7 | 14,010 | 20 | 7 | 18,888 | 20 |
| 8 | 14,063 | 1 | 8 | 17,650 | 18 |
| 9 | 14,065 | 11 | 9 | 19,442 | 26 |
| 10 | 14,400 | 3 | 10 | 14,005 | 6 |
| 11 | 15,050 | 25 | 11 | 14,065 | 9 |
| 12 | 15,556 | 16 | 12 | 16,021 | 16 |
| 13 | 15,900 | 24 | 13 | 12,000 | 1 |
| 14 | 16,005 | 29 | 14 | 20,543 | 28 |
| 15 | 16,008 | 19 | 15 | 19,347 | 23 |
| 16 | 16,021 | 12 | 16 | 15,556 | 12 |
| 17 | 17,000 | 18 | 17 | 21,345 | 30 |
| 18 | 17,650 | 8 | 18 | 17,000 | 17 |
| 19 | 17,775 | 26 | 19 | 16,008 | 15 |
| 20 | 18,888 | 7 | 20 | 14,010 | 7 |
| 21 | 19,000 | 2 | 21 | 13,335 | 3 |
| 22 | 19,023 | 28 | 22 | 20,189 | 27 |
| 23 | 19,347 | 15 | 23 | 19,374 | 24 |
| 24 | 19,374 | 23 | 24 | 15,900 | 13 |
| 25 | 19,441 | 6 | 25 | 15,050 | 11 |
| 26 | 19,442 | 9 | 26 | 17,775 | 19 |
| 27 | 20,189 | 22 | 27 | 13,999 | 5 |
| 28 | 20,543 | 14 | 28 | 19,023 | 22 |
| 29 | 20,789 | 5 | 29 | 16,005 | 14 |
| 30 | 21,345 | 17 | 30 | 12,002 | 2 |
| | 500,000 | | | 500,000 | |

### Example 4.3

### Resolving Ties (as Between the Numbers 1 to 30) within the Ranking System

While the above Example 4.2, Table 11 does not have any ties, it will be inevitable that ties will occur where two or more numbers within the range of numbers from 1 to n (in this example, 1 to 30) are chosen exactly the same number of times by the participants in the game. Multiple numbers of ties could also occur. In this Example 4 of the game, it is preferable that all ties are resolved.

While there will be a number of ways to resolve ties, such as by using a random method, the preferred way to resolve all ties in this Example 4 of the use of the game is to use the unpredictability of the results of all the participants' choices in the game itself, by using the resulting ‘odds’ and ‘evens’ that arise for each n number—as set out in the column headed “NUMBER OF TIMES CHOSEN” in Example 4.2—Table 11 above (the “Selection Total”).

Referring to Example 4.2—Table 11, it will be apparent that each of the 30 numbers have been chosen a certain number of times and that this results in either an odd numbered Selection Total or an even numbered Selection Total, representing the number of times each of the 30 numbers was chosen. Whether a number available to be chosen within the range of numbers from 1 to n (in this example 1 to 30) is going to end up being chosen a number of times that is either an odd or even Selection Total number is entirely unpredictable, and is a chance result. This chance result creates a unique method to resolve ties.

In this example, to resolves ties, an even number Selection Total will result in the lowest face value of the tied numbers being ranked ahead of the higher face valued number/s. An odd number Selection Total will result in the highest face value of the tied n numbers being ranked ahead of the lowest face valued n number/s. For example if the following n numbers (2, 13, 20 and 29) were in a four-way tie with the same Selection Total number of, for example, 20,189, which is an odd Selection Total number, then the order of the four tied numbers becomes 29, 20, 13 and 2.

This process is further explained in FIG. 3.

### Example 4.4

### The Elimination Processes to Determine the Winner

In this Example 4, the game is a one phase game, so the objective is to determine the number of participants to whom maior prizes are to be awarded. For this example we shall set that at 10 major prizes. The process is overviewed below:

The First Eliminations:

The first elimination process involves reducing the participants in the game from 500,000 to a much lower number. This occurs by eliminating all participants other than those participants that chose number [13] as their PRIMARY number, which is the number that was least picked by all the 500,000 participants in the game, as it was chosen 12,000 times—see Example 4.2, Table 11.

Calculations:

With 500,000 participants in the game, divided by the number range of 1-30, this results in an average of 16,666 participants per number. Some numbers will be chosen more times, other numbers less. In this example, it is assumed that there are 12,000 participants that have chosen[13] as their PRIMARY number and which are not eliminated.

The Second Eliminations:

The second elimination process involves reducing the remaining 12,000 participants from 12,000 to a much lower number by eliminating all participants other than those participants that chose number [30] as their 1^{st} SECONDARY number, which is the number that was the second least picked number by all the 500,000 participants in the game, as it was chosen 12,002 times—see Example 4.2, Table 11.

Calculations:

With 12,000 participants remaining in the game, divided by the remaining number range of 29 (as number 13 has now gone from the number range of 1-30), results in an average of 414 participants per number. Based on the law of averages, some of the remaining 29 numbers will be chosen more times, other numbers less. In this example, it is assumed that there are c. 400 participants that have chosen [30] as their 1^{st} SECONDARY number and which are not eliminated.

The Third Eliminations:

The third elimination process involves reducing the remaining c. 400 participants by eliminating all participants other than those that chose [21] as their 2^{nd} SECONDARY number, which is the number that was the third least picked by all the 500,000 participants in the game, as it was chosen 13,335 times—see Example 4.2, Table 11.

Calculations:

With c. 400 participants remaining in the game, divided by the remaining number range of 28 (as number 13 and 30 have both now gone from the number range of 1-30), results in an average of c. 14 participants per number. Based on the law of averages, some of the remaining 28 numbers will be chosen more times, other numbers less. In this example, it is assumed that there are c. 10 participants that have chosen [21] as their 2^{nd} SECONDARY number and which are not eliminated.

Final eliminations—The Ranking System:

With c. 10 participants remaining in this example, those small number of remaining participants can be ranked using their 3^{rd} SECONDARY number, and 4^{th} SECONDARY number if necessary, to determine the winner/s.

This above described process is exemplified in Example 4.6, Table 13 that follows, which focuses on the 10 best performing participants in the game. When considering Example 4.6, Table 13, the 6 number choices of the best 10 performing participants (having the best results for the ‘least picked’ PRIMARY number and 5 SECONDARY numbers) are set out in Example 4.5, Table 12 below:

### Example 4.5

TABLE 12
Chosen numbers of the Top 10 Participants

| | Primary | | | | | |
|---|---|---|---|---|---|---|
| Participant | Number | 1^{st} SEC | 2^{nd} SEC | 3^{rd} SEC | 4^{th} SEC | 5^{th} SEC |
| P.1 | 13 | 30 | 21 | 4 | 20 | 2 |
| P.2 | 13 | 30 | 21 | 4 | 3 | 11 |
| P.3 | 13 | 30 | 21 | 27 | 10 | 20 |
| P.4 | 13 | 30 | 21 | 11 | 18 | 20 |
| P.5 | 13 | 30 | 21 | 11 | 8 | 26 |
| P.6 | 13 | 30 | 21 | 16 | 25 | 20 |
| P.7 | 13 | 30 | 21 | 24 | 4 | 10 |
| P.8 | 13 | 30 | 21 | 29 | 27 | 4 |
| P.9 | 13 | 30 | 21 | 19 | 26 | 3 |
| P.10 | 13 | 30 | 21 | 12 | 2 | 1 |

### Example 4.6

TABLE 13
Determine the Winner/s.

| | Nos of Participants | | | | | | | | | | |
|---|---|---|---|---|---|---|---|---|---|---|---|
| | P.1 | P.2 | P.3 | P.4 | P.5 | P.6 | P.7 | P.8 | P.9 | P.10 | . . . To P. |
| From | 12,000 | 12,000 | 12,000 | 12,000 | 12,000 | 12,000 | 12,000 | 12,000 | 12,000 | 12,000 | 12,000 |
| PRIMARY | | | | | | | | | | | |
| no. 13 | | | | | | | | | | | |
| First | 12,002 | 12,002 | 12,002 | 12,002 | 12,002 | 12,002 | 12,002 | 12,002 | 12.002 | 12,002 | c. 400 |
| Secondary | | | | | | | | | | | left |
| (no of times | | | | | | | | | | | |
| chosen by | | | | | | | | | | | |
| all | | | | | | | | | | | |
| participants | | | | | | | | | | | |
| in game) | | | | | | | | | | | |
| 2^{nd} | 13,335 | 13,335 | 13,335 | 13,335 | 13,335 | 13,335 | 13,335 | 13,335 | 13,335 | 13,335 | c. 10 |
| Secondary | | | | | | | | | | | left |
| 3^{rd} | 13,775 | 13,775 | 13,999 | 14,065 | 14,065 | 15,556 | 15,900 | 16,005 | 16,008 | 16,021 | |
| Secondary | | (2^{nd}) | (3^{rd}) | | | (6^{th}) | (7^{th}) | (8^{th}) | (9^{th}) | (10^{th}) | |
| 4^{th} | 14,010 | 14,400 | 14,005 | 17,000 | 17,650 | 15,050 | 13,775 | 13,999 | 17,775 | 19,000 | |
| Secondary | (1^{st}) | | | (4^{th}) | (5^{th}) | | | | | | |
| 5^{th} | 19,000 | 14,065 | 14,010 | 14,010 | 17,775 | 14,010 | 14,005 | 13,775 | 14,400 | 14,063 | |
| Secondary | | | | | | | | | | | |
| Extra Nos. | . . . | . . . | . . . | . . . | . . . | . . . | . . . | . . . | . . . | . . . | |
| if needed | | | | | | | | | | | |

As can be seen from Example 4.6, Table 13 above, P. 1 is the sole winner.

### Example 4.7

### Use of Eliminations and/or the Ranking System

The Ranking System described in this invention, in particular as referred to in Examples 4.2 and 4.3 can be used to rank each participants performance in a game. So in a game played by 500,000 participants, each participant can be ranked, from 1^{st} place down to last place. Accordingly, in one aspect of the invention, the winner/s can be determined through this method. However, we believe it is preferable to have a group of winners (or class of winners) at various determined steps in the game. Accordingly, we believe it is preferable to also undertake elimination steps as we have described in Example 4.4 above.

Depending on the number of participants in a game as described in this Example 4, but assuming a minimum of 500,000 participants, these elimination steps occur, as we have set out in Example 4.4 above, using firstly the PRIMARY number, and then the 1^{st} and 2^{nd} SECONDARY numbers, and as may be necessary, the 3^{th} SECONDARY number and so forth, until a ‘sufficiently small’ number of participants remain.

What constitutes ‘sufficiently small’ may vary for each game profile and will depend on the number of participants in the game and the number of individual ‘major’ prizes that the gaming organizers want to award to successful participants.

In this Example 4 of the game, which is a game with 500,000 participants, we have continued the elimination processes up to and including the use of the 2^{nd} SECONDARY number, after which there is about 10 participants remaining. Then the computer software ranks in order each of those last 10 or so remaining participants, ranking their performance against each other, with reference to the ranking system as set out in Example 4.2, Table 11. We have used 10 for demonstration purposes, from which we then determine the winner/s of the major prizes in this example of the game.

If however, the use of the 2^{nd} SECONDARY number above resulted, for example, in there being less than the required number of participants for major prizes, being those participants that had correctly chosen the relevant winning PRIMARY number, and then the 1^{st} and 2^{nd} SECONDARY numbers, then the following occurs:
Those participants, if any, that had correctly chosen the relevant winning PRIMARY number, and then the 1^{st} and 2^{nd} SECONDARY numbers all get major prizes from 1 down to the relevant placing; and
The remaining participants that are required for prizes are determined from the prior group of participants that had correctly chosen the relevant winning PRIMARY number, and also the 1^{st} SECONDARY number. The remaining participants are determined by reference to each of those participants other SECONDARY numbers which are then ranked by reference to the Ranking System as contained in Example 4.2, Table 11 and the methods described herein.
Table 14 below overviews this process in respect of determining 10 participants in a one phase game that are to win the major prizes. The method set out in this Table below should be sufficient for most game sizes based on the results set out
in Example 4.17, Table 18—“Backroom Calculations—Eliminations”. It will be appreciated that the process can be expanded as required, for instance by adding more SECONDARY numbers.

TABLE 14
Description of Elimination Steps

| Steps | | Description of Elimination Steps |
|---|---|---|
| First | PRIMARY | Firstly, eliminate all participants other than those that |
| | | chose the correct PRIMARY number [13]. (“Primary |
| | | Winner Category”) |
| 2^{nd} | 1^{st} SECONDARY | Secondly, eliminate all Primary Winner Category |
| | | participants other than those that also correctly chose the |
| | | 1^{st} Secondary number [30]. (“1^{st} Sec Category”). |
| | | If the number of remaining participants is 10 or less, go |
| | | to the Final Step. Otherwise proceed below. |
| 3^{rd} | 2^{nd} SECONDARY | Thirdly, eliminate all 1^{st} Sec Category participants other |
| | | than those that also correctly chose the 2^{nd} Secondary |
| | | number [21]. (“2^{nd} See Category”). |
| | | If the number of remaining participants is 10 or less, go |
| | | to the Final Step. Otherwise proceed below. |
| 4^{th} | 3^{rd} SECONDARY | Fourthly, eliminate all 2^{nd} Sec Category participants |
| | | other than those that also correctly chose the 3^{rd} |
| | | Secondary number [4]. (“3^{rd} See Category”), |
| | | If the number of remaining participants is 10 or less, go |
| | | to the Final Step. Otherwise proceed below. |
| 5^{th} | 4^{th} SECONDARY | Fifthly, eliminate all 3^{rd} Sec Category participants other |
| | | than those that also correctly chose the 4^{th} Secondary |
| | | number [27]. (“4^{th} Sec Category”). |
| | | If the number of remaining participants is 10 or less, go |
| | | to the Final Step. Otherwise proceed below. |
| 6^{th} | 5^{th} SECONDARY | Sixthly, eliminate all 4^{th} Sec Category participants other |
| | | than those that also correctly chose the 5^{th} Secondary |
| | | number [10]. (“5^{th} Sec Category”). |
| Final | | [1] If the number of participants is [10] or less, those |
| Step | | participants, if any, will be winners of the relevant major |
| | | prizes. To determine which participants win which |
| | | prizes occurs by ranking those participants using their |
| | | relevant Secondary number/s in accordance with the |
| | | Selection Total/s and Ranking System of the n numbers |
| | | to determine those that have the best rankings; |
| | | and then |
| | | [2] If 1 or more participants are still required to make up |
| | | the [10] participants required for the major prizes, then |
| | | using the group of participants from the preceding |
| | | stage/s as relevant, rank those participants using their |
| | | relevant Secondary number/s in accordance with the |
| | | Selection Total/s and Ranking System of the n numbers |
| | | to determine those that have the best rankings and who |
| | | are also to receive some of the major prizes in order to |
| | | make up the required [10] major prize winners. |

### Example 4.8

### Alteration to Ascribed Ranking Value—Same Results

Instead of using the ascribed ranking value based on the number of times that each of the numbers 1-30 had been chosen by all the participants in the game, the ascribed ranking value can be changed to equal the actual rankings or placement number of the 30 numbers, by ranking them 1^{st} to 30^{th}. To illustrate this—and again with reference to Example 4.2, Table 11 which ranks all the numbers, and to Example 4.5, Table 12 which records the 6 chosen numbers of the top 10 participants:
number 13 was the least chosen n number, so it was placed first with a ranking number or ranking value of 12,000 (being the number of times that it had been chosen by all the participants in the game);
number 30 was the second least chosen n number, so it was placed second with a ranking number or ranking value of 12,002 (being the number of times that it had been chosen by all the participants in the game); and so on as set out in Example 4.2, Table 11.

### Alteration to Ascribed Ranking Value

Instead of using the ascribed ranking value based on the number of times that each of the numbers 1-30 had been chosen by all the participants in the game, the ascribed ranking value can be changed to equal the actual rankings or placement number of the 30 numbers, by ranking them 1^{st} to 30^{th}. To illustrate this—and again with reference to Example 4.2, Table 11 which ranks all the 30 numbers, and to Example 4.5, Table 12 which records the 6 chosen numbers of the top 10 participants:
number 13 was the least chosen n number, so it was placed first with a ranking number or ranking value of 12,000 (being the number of times that it had been chosen by all the participants in the game). Its ranking value is changed from 12,000 to 1^{st}—i.e. a ranking value of 1—thereby being a “Selection Total” of 1;
number 30 was the second least chosen n number, so it was placed second with a ranking number or ranking value of 12,002 (being the number of times that it had been chosen by all the participants in the game). Its ranking value is changed from 12,002 to 2^{nd}—i.e. a ranking value of 2^{nd}—thereby being a “Selection Total” of 2: . . . and so on.

Example 4.9, Table 15 below is the same as Example 4.6, Table 13 above, but is now altered to show the change to using the ascribed ranking value/Selection Total of 1, 2, 3, etc as described in the paragraph above.

### Example 4.9

TABLE 15
Determine the Winner/s using alteration to ascribed ranking value

| | Nos of Participants | | | | | | | | | | |
|---|---|---|---|---|---|---|---|---|---|---|---|
| | P.1 | P.2 | P.3 | P.4 | P.5 | P.6 | P.7 | P.8 | P.9 | P.10 | . . . To P. |
| From | 12,000 | 12,000 | 12,000 | 12,000 | 12,000 | 12,000 | 12,000 | 12,000 | 12,000 | 12,000 | 12,000 |
| PRIMARY | 1 | 1 | 1 | 1 | 1 | 1 | 1 | 1 | 1 | 1 | |
| no. 13 | | | | | | | | | | | |
| First | 12,002 | 12,002 | 12,002 | 12,002 | 12,002 | 12,002 | 12,002 | 12,002 | 12,002 | 12,002 | c. 400 |
| Secondary | 2 | 2 | 2 | 2 | 2 | 2 | 2 | 2 | 2 | 2 | left |
| (no of times | | | | | | | | | | | |
| chosen by | | | | | | | | | | | |
| all | | | | | | | | | | | |
| participants | | | | | | | | | | | |
| in game - | | | | | | | | | | | |
| then ranked | | | | | | | | | | | |
| 1^{st}, 2^{nd}, 3^{rd}, | | | | | | | | | | | |
| et) | | | | | | | | | | | |
| 2^{nd} | 13,335 | 13,335 | 13,335 | 13,335 | 13,335 | 13,335 | 13,335 | 13,335 | 13,335 | 13,335 | c. 10 |
| Secondary | 3 | 3 | 3 | 3 | 3 | 3 | 3 | 3 | 3 | 3 | left |
| 3^{rd} | 13,775 | 13,775 | 13,999 | 14,065 | 14,065 | 15,556 | 15,900 | 16,005 | 16,008 | 16,021 | |
| Secondary | 4 | 4 | 5 | 9 | 9 | 12 | 13 | 14 | 15 | 16 | |
| | | (2^{nd}) | (3^{rd}) | | | (6^{th}) | (7^{th}) | (8^{th}) | (9^{th}) | (10^{th}) | |
| 4^{th} | 14,010 | 14,400 | 14,005 | 17,000 | 17,650 | 15,050 | 13,775 | 13,999 | 17,775 | 19,000 | |
| Secondary | 7 | 10 | 6 | 17 | 18 | 11 | 4 | 5 | 19 | 21 | |
| | (1^{st}) | | | (4^{th}) | (5^{th}) | | | | | | |
| 5^{th} | 19,000 | 14,065 | 14,010 | 14,010 | 17,775 | 14,010 | 14,005 | 13,775 | 14,400 | 14,063 | |
| Secondary | 21 | 9 | 7 | 7 | 19 | 7 | 6 | 4 | 10 | 8 | |
| Extra Nos | . . . | . . . | . . . | . . . | . . . | . . . | . . . | . . . | . . . | . . . | |
| if needed | | | | | | | | | | | |

As can be seen from Example 4.9, Table 15 above, the alteration to the ascribed ranking values to 1, 2, 3, and so forth makes no change. P.1 is the sole winner.

FIG. 4 shows, by way of an example in a series of computer printouts, a method of processing by a computer the results for a 100,000 participant game which is relevant to the example set out in this Examples 4. In particular FIG. 4 shows the computer processing method to determine the top 10 in order, from which the winner can be determined, together with 2^{nd} place down to 10^{th} as relevant. This example set out in FIG. 4 can be easily scalable for any size game.

### Example 4.10

### Fallback Position—Ties Involving Winning Participants

The above illustrated elimination processes using 5 SECONDARY numbers should ensure that the elimination process to determine one sole winner can be fully completed within those 5 Secondary numbers and no fallback position should ever be necessary.

While this gaming system guarantees a winner, a joint winner is possible but unlikely. In this example of the game (in order 6/30), once a winner is determined (using the full set of 6 number choices from the 30 numbers if required), the chances of one or more other players having also chosen in order the exact same 6 numbers as chosen by the winning player is/are remote, as the odds of correctly choosing the 6 numbers in order are 1 in 427,518,000—see FIG. 7a.

The odds of:

a double event occurring (two entries that correctly chose the same 6 winning numbers) is 1 in 717,375,204 (Calculation: the odds to one×1.678—source: Scarne's New Complete Guide to Gambling, chapter 2; Published by Simon and Schuster, New York, 1974); a triple event occurring is 1 in 1,143,610,650—(Calculation: the odds to one×2.675); a quad event occurring is 1 in 1,571,128,650—(Calculation: the odds to one×3.672); and a quint event occurring is 1 in 1,996,509,060—(Calculation: the odds to one×4.670).

However, to provide for the unlikely situation where the above illustrated elimination processes using firstly the PRIMARY number, and then the 5 SECONDARY numbers does not achieve one sole winner, then if two or more participants remain and can't be eliminated or separated, then those tied participants share in proportion as between them the relevant prize/s.

### Example 4.11

TABLE 16
Example 4.11 - One Phase Game - Exampled Prize Winnings

| | Maximum | | Total | % of |
|---|---|---|---|---|
| | Number of | | Maximum | $2.5m |
| Elimination | Participants | Prizes per | Amount of | Prize |
| Factors | in each stage | Ticket | Prizes | Pool |
| | 500,000 | n/a | n/a | n/a |
| (÷30) | 16,667 | $10 + Super | $170,000 | 6.8% |
| PRIMARY | | Game | | |
| (÷29) | 575 | $300 + | $200,000 | 8.0% |
| 1^{st} Secondary | | above | | |
| (÷28) | 21 | $3,000 + | $75,000 | 3.0% |
| 2^{nd} Secondary | | above | | |
| (÷27) | [9] Major | $10,000 to | $180,000 | 7.2% |
| 3^{rd} Secondary | prize winning | $50,000 + | | |
| | participants | above | | |
| | other than | | | |
| | sole winner | | | |
| (÷26) | Winner - | $1,250,000 | $1,250,000 | 50.0% |
| 4^{th} Secondary | Sole Survivor | | | |
| (÷25) | | | | |
| 5^{th} Secondary | | | | |
| To Super | | | $625,000 | 25.0% |
| Game | | | | |
| Totals | | | $2,500,000 | 100% |

### Example 4.12

### The Odds of Winning a Weekly Game

The odds of winning a prize in the weekly draw—in the first instance correctly choosing the weeks winning PRIMARY number—is 1 in 30.

The odds of winning first prize in this Example 4 of a one phase game, is equal to the number of participants in the week's lottery—in this case, it is 1 in 500,000.

### Example 4.13

### Incorporation of a “Super Game”

As stated above, and as can be seen from Example 4.11, Table 16 above, this example of the game includes a Super Game that is drawn annually.

The Super Game involves the same identical processes of elimination as applicable to the weekly games as previously described in this Example 4.

Preferably, the participation in the Super Game is only achieved by:
Purchasing a ticket in a weekly game; and
Correctly picking a winning PRIMARY number in a weekly game.

Preferably, the number of tickets/entries a participant can have in Super Game is based on how many times a participant chooses the winning PRIMARY number in one or more of the weekly games.

### Random Allocation of Super Game Numbers

Preferably, the Super Game numbers are randomly allocated. Those random numbers comprise, as they do for the weekly games, 1 PRIMARY number and 5 SECONDARY numbers. This random allocation is to ensure that no participant can stipulate what Super Game numbers he or she wants and it is to ensure the integrity of the Super Game result.

In this example, the Super Game numbers are only allocated to those ‘weekly’ participants that correctly pick the winning PRIMARY number for the relevant week's game.

In addition, to further ensure the integrity of the Super Game result, the Super Game numbers from each week's game are not merged by the gaming engine at any time into any combined set of numbers until after the last weekly game has been closed, prior to the Super Game. This is to further ensure that no party can identify what numbers, when combined, are less nominated than other n numbers, so that the Super Game is not subject to interference or fraud by any party.

### Example 4.14

### Prize Winnings for Super Game

The prizes available for the winner/s of the Super Game will be significantly higher than the weekly game.

Assume that:
the Super Game is conducted annually, at the end of a 50 week cycle of weekly games; and
there are 50 weeks of games, with each weeks game having the same participation and winning profile as described previously in Examples 4.1 and 4.11; and
in each of the 50 weeks, as set out in Example 4.11, $625,000 is set aside from each weekly game—to accumulate for the Super Game; and
at the end of 50 weeks, there is $31,250,000 available for Super Game prizes; and
The process of winning Super Game is the same as for the weekly draws.

### Example 4.15

TABLE 17
Example 4.15 - One Phase Game - Exampled
Prize Winnings for annual Super Game

| | Maximum | | | |
|---|---|---|---|---|
| | Number of | | Total | % of |
| | Participants | | Maximum | $31.25m |
| Elimination | in each stage | Prizes per | Amount of | Prize |
| Factors | of Super Game | Ticket | Prizes | Pool |
| | 16,667 | n/a | n/a | n/a |
| | maximum | | | |
| | participants | | | |
| | per week × | | | |
| | 50 weeks = | | | |
| | 833,350 | | | |
| (÷30) | 27,778 | $100 | $2,812,500 | 9.0% |
| PRIMARY | | | | |
| (÷29) | 957 | $1,000 + | $1,093,750 | 3.5% |
| 1^{st} Secondary | | above | | |
| (÷28) | 34 | $10,000 + | $500,000 | 1.6% |
| 2^{nd} Secondary | | above | | |
| (÷27) | [9] Prize | $100,000 to | $3,406,250 | 10.9% |
| 3^{rd} Secondary | Winning | $1,000,000 + | | |
| | participants | above | | |
| | other than | | | |
| | sole winner | | | |
| (÷26) | Winner - | $23,437,500 | $23,437,500 | 75% |
| 4^{th} Secondary | Sole Survivor | | | |
| (÷25) | | | | |
| 5^{th} Secondary | | | | |
| Totals | | | $31,250,000 | 100% |

### Example 4.16

### The Odds of Winning Super Game

The odds of winning a prize in Super Game is dependent on the number of entries a participant has in Super Game—i.e. the number of times a participant enters weekly games and correctly chooses the winning PRIMARY number in each weekly game.

In this Example 4, for a participant that has only one entry into Super Game, the odds of winning the minor prize in Super Game ($100) is 1 in 30.

For a participant with only one entry in Super Game, the odds of winning first prize in Super Game is no more than 1 in 833,350.

A participant with 1 entry has odds of at least 1 in 30 of winning any prize. The odds get shorter for each additional entry into Super Game that a participant has.

A participant with 10 entries comprising 10 different PRIMARY numbers has odds of at least 1 in 3 of winning any prize in Super Game, and will have odds of less than 1 in 83,335 of winning the first prize in Super Game.

It will be clear that a large number of variations exist and the above descriptions as set out in this Example 4 are by way of example only.

### Example 4.17

TABLE 18
Example 4.17 - Backroom Calculations - Eliminations
The table below demonstrates that 5 SECONDARY numbers should
be sufficient to effect the necessary eliminations for most game sizes.
Additional SECONDARY numbers can be added if/as necessary.

| No. Tickets | 500,000 | 5,000,000 | 50,000,000 | 5,000,000,000 |
|---|---|---|---|---|
| Number Range | (÷30) | (÷30) | (÷30) | (÷30) |
| 1-30 | | | | |
| PRIMARY No. | 16,667 | 166,667 | 1,666,667 | 166,666,667 |
| (÷30) | | | | |
| 1^{st} | 575 | 5,747 | 57,471 | 5,747,126 |
| SECONDARY | | | | |
| (÷29) | | | | |
| 2^{nd} | 21 | 205 | 2,053 | 205,255 |
| SECONDARY | | | | |
| (÷28) | | | | |
| 3^{rd} | | 8 | 76 | 7,602 |
| SECONDARY | | | | |
| (÷27) | | | | |
| 4^{th} | Winners | Winners | 3 | 292 |
| SECONDARY | | | | |
| (÷26) | | | | |
| 5^{th} | | | Winners | 12 |
| SECONDARY | | | | |
| (÷25) | | | | |
| 6^{th} | | | | Winners |
| SECONDARY | | | | |
| (÷24) | | | | |

### EXAMPLE 5

### Virtual Racing

A further example of the use of the invention is the use of the gaming system in Virtual Races involving any racing or competition application in which a number of ‘characters’ or ‘things’ can compete. For example, Virtual Racing involving horses, racing cars, racing yachts, cycling, or even avatar type races or competitions are examples of events or competitions that are suitable for a virtual racing application using the gaming system invention that has been described herein.

### Example 5.0

### A Virtual Horse Race (Number Range 1 to n, where n=20)

The following describes a virtual horse race. It will be apparent that the horses are symbols which in fact represent numbers. The techniques here below described with respect to the horse race could be used to provide a virtual event or could be utilised to provide any other event where a symbol can be ascribed to a number, including any type of competitive race. With modest adjustment of the techniques even “knock out” events such as a tennis tournament could be presented in virtual form where the tie break techniques, such as the odd/even approach described above could be used if necessary.

Objective:

To develop a high class virtual horse race capable of operating with/through various mediums such as the internet and iPhone, that can be cross sold in different states/countries and which creates for player buy in, suspense and satisfaction with repeat plays.

Target Operators:

The virtual horse race is for a target operator such as the TAB, race betting agencies, or the horse racing divisions of lottery and gaming operators in the relevant countries worldwide. The target operators are worldwide and consist largely of government approved or authorised operators.

Racing to be on Different Courses:

The virtual horse race game is to be raced each week (possibly more regularly) and is to be preferably set in world recognised venue/s—For example only:
Churchill Downs in Louisville, Ky. which is home of the Kentucky Derby,
Pimilico Race Course in Baltimore, Md. which hosts the Preakness Stakes,
Belmont Park on Long Island which hosts the Belmont Stakes.
The Royal Ascot in Berkshire, United Kingdom which hosts the Gold Cup.
The Flemington Racecourse in Melbourne, Australia which hosts the Melbourne Cup.
Nakayma Racecourse, Japan which runs the Nakayama Grand Jump.
The Aintree Racecourse, Liverpool, England which hosts the UK's Grand National.
The Meydan Racecourse in Dubai, United Arab Emirates, which hosts the Dubai World Cup.

Each Horse Must have a Finishing Placement Value:

Because the gaming system described herein ranks each horse, each horse must finish the race with its jockey, or alternatively a horse that goes down or loses its jockey will be deemed to come last. In the event of there being more than one horse or jockey going down, then the horse and jockey that went the greatest distance in the race will be placed ahead of the other downed horse/s etc.

In-Game Sponsorship:

To create within the virtual race the commercial opportunity to sell sponsorship and advertorial space e.g. The ‘Citibank’ Stadium, the ‘Budweiser’ Sweepstakes, and the timekeeping opportunity for Omega, TAG Heuer etc.

Number of Horses:

[20], although the virtual horse race needs to have flexibility to have more or less horses added or taken away—preferably the maximum number is no more than 30.

The Horses:

The [20] horses are to be named and given character, as are the jockeys.

Capacity for Different Race Profiles:

If the virtual horse race game is run weekly and the race has the same racing profile, then it would quickly lose part of its excitement. So the race profile of the [20] horses (as opposed to the final placements which are determined by the ranking system) needs to be random and not able to be picked or easily recognised by the punters during the running of the virtual races.

Punters Entry:

During the week, punters consider the race course, and the field of [20] horses. From the field of [20], they must select in the anticipated order of winning, 6 horses. The selections occur during the week and closes say 1 hour before the running/broadcasting of the race. Punters may elect some or all of the 6 horses to be chosen randomly.

Punter's Choice:

Each choice by a punter represents 1 unit of weight, which the horse has to carry around the race track. The horse that is chosen the least therefore has the least weight to carry and will therefore be the winner and so forth—i.e. the ‘least’ chosen wins, the second least chosen gets second, and so forth with the most chosen getting last. The punters in effect when making their choices of their 6 horses are trying to outthink the choices of all the other punters.

Encryption—No Knowledge of Punters Choices:

Each entry by each punter must be received (or stored) in an encrypted or secure way so no person has the ability to determine how many times the horses have been chosen and therefore how much weight they will each carry. The encryption is only revealed through the outcome of the running of the race, broadcast ‘live’ on the internet/TV.

Running of the Race:

The race is to be run/broadcast at a set time each week ‘live’ on the internet, with the capacity to broadcast it on TV.

Race Duration:

Say [2-3] minutes, and preferably with a lead up and post event revealing of each horse's weights, prize awards for competitors etc—total all up race matters, say [10-15] minutes.

Announcement of Winning Punter's Choices:

First [5-10] punters picks announced, and last place punter also announced.

### Example 5.1

### Assumed Game Profile

In this example, to demonstrate how the gaming system can operate in respect of a virtual horse race involving [20] horses, it is assumed that:
The game is played weekly, and is played each week by 500,000 punters;
During the week each punter chooses, in winning order, 6 different horses from a range of [20] horses and pays a total cost of $10 for his 6 horses;
The total revenue from each week's game is $5,000,000;
The available prize pool is 50% of total revenue;
Total prizes available for payment to the eligible punters are $2,500,000—of which 25% ($625,000) is set aside for a SUPER RACE;
Any horses in the range of [20] horses that might not be chosen by any punter are ignored;
Each horse is also given a unique number, being number 1, 2, 3 and so forth, up to number [20], so that the computer system can recognize each of the 20 horses competing in the game/race;
Each choice by a punter of a horse represents 1 unit of weight, which the horse has to carry around the race track. These units of weight are very small, but heavy, so they go into a weight saddle (or pack) that does not change in dimension in any way, so when the virtual race is being broadcast, no punter can tell which horse is carrying the least or greatest weight.
The horse that is chosen the least therefore has the least weight to carry and will therefore become the winner of the race, and so forth—i.e. the ‘least’ chosen horse wins, the second least chosen horse gets second, and so forth with the most chosen horse getting last in the race:
In this example, horse [13] is the horse that is chosen the least by all the 500,000 punters in the game, and therefore carries the least weight and becomes the winner of the race;
There are 19,500 punters that have chosen that have chosen horse [13] as the winning horse;
Those 19,500 winning punters each receive one bonus entry into the following weeks race i.e. valued at $10 each ($195,000) and one entry into the SUPER RACE.
Ties between any of the 20 horses are ALL resolved—see Example 5.3 below.
The 19,500 winning punters are subject to further eliminations using the results of those punters other choices of horses, using the one data set from the 500,000 punters choices of the winning horse.

### Punter's Objective

Pick 6 different horses from a range of [20] horses that are to compete against each other in a virtual race.

The objective for a punter is to pick 6 different horses, where each horse picked is picked to be one of the ‘least picked’ contestants in the race, least picked by all the punters in the game. The ‘least picked’ horse will carry the least weight in the race and will, when the virtual race is broadcast, become the winner of the race. The second least picked horse will carry the second least weight, and will get second in the race, and so on.

A punter's objective is to avoid eliminations by correctly picking as his/her first horse choice, the horse that is to become the winner of the race, and the 2^{nd} and 3^{rd} and 4^{th} placed horses etc, and failing by punters to correctly chose a relevant horse placement, then the punter/s with the next best choice/s ultimately becomes the winner of the game's major prize.

### Example 5.2

TABLE 19
Example 5.2
Results of Betting on a Virtual Horse Race by 500,000
Punters - One Data Set from the Winning Horse Selections

| BY RANKINGS | | | BY NUMBERS | | |
|---|---|---|---|---|---|
| RANK- | | | | | RANK- |
| INGS | NUMBER | | | NUMBER | INGS |
| OF | OF | | | OF | OF |
| LEAST | TIMES | HORSE | HORSE | TIMES | LEAST |
| PICKED | CHOSEN | CHOSEN | CHOSEN | CHOSEN | PICKED |
| 1^{st} | 19,500 | 13 | 1 | 19,657 | 2^{nd} |
| 2^{nd} | 19,657 | 1 | 2 | 27,000 | 13^{th} |
| 3^{rd} | 20,560 | 19 | 3 | 21,974 | 7^{th} |
| 4^{th} | 20,988 | 9 | 4 | 25,000 | 10^{th} |
| 5^{th} | 21,344 | 7 | 5 | 29,333 | 19^{th} |
| 6^{th} | 21,765 | 14 | 6 | 28,111 | 16^{th} |
| 7^{th} | 21,974 | 3 | 7 | 21,344 | 5^{th} |
| 8^{th} | 22,348 | 15 | 8 | 26,332 | 11^{th} |
| 9^{th} | 24,864 | 20 | 9 | 20,988 | 4^{th} |
| 10^{th} | 25,000 | 4 | 10 | 31,500 | 20^{th} |
| 11^{th} | 26,332 | 8 | 11 | 27,830 | 14^{th} |
| 12^{th} | 26,791 | 16 | 12 | 28,369 | 17^{th} |
| 13^{th} | 27,000 | 2 | 13 | 19,500 | 1st |
| 14^{th} | 27,830 | 11 | 14 | 21,765 | 6^{th} |
| 15^{th} | 27,983 | 18 | 15 | 22,348 | 8^{th} |
| 16^{th} | 28,111 | 6 | 16 | 26,791 | 12^{th} |
| 17^{th} | 28,369 | 12 | 17 | 28,751 | 18^{th} |
| 18^{th} | 28,751 | 17 | 18 | 27,983 | 15^{th} |
| 19^{th} | 29,333 | 5 | 19 | 20,560 | 3^{rd} |
| 20^{th} | 31,500 | 10 | 20 | 24,864 | 9^{th} |
| | 500,000 | | | 500,000 | |

### Example 5.3

### Resolving Ties (as Between the Horse Numbers 1 to 20) within the Ranking System

While the above Example 5.2, Table 19 does not have any ties, it will be inevitable that ties will occur where two or more horses within the 20 horses used in this example are chosen exactly the same number of times by the punters in the game. Multiple numbers of ties between horses could also occur. In this Example 5 of the game, it is preferable that all ties are resolved.

While there will be a number of ways to resolve ties, such as by using a random method, the preferred way to resolve all ties in this Example 5 of the use of the game in a virtual horse race is to use the unpredictability of the results of all the punters' choices in the virtual horse race game itself, by using the resulting ‘odds’ and ‘evens’ that arise for each of the 20 horses—as set out in the column headed “NUMBER OF TIMES CHOSEN” in Example 5.2—Table 19 above (the “Selection Total”).

Referring to Example 5.2—Table 19, it will be apparent that each of the 20 horses have been chosen a certain number of times and that this results in either an odd numbered Selection Total or an even numbered Selection Total, representing the number of times each of the 20 horses was chosen. Whether a horse to be chosen within the range of 20 horses is going to end up being chosen a number of times that is either an odd or even Selection Total number is entirely unpredictable, and is a chance result. This chance result creates a unique method to resolve ties.

In this example, to resolves ties, an even number Selection Total will result in the lowest face value relevant to a tied horse being ranked ahead of the higher face valued numbered horse. An odd number Selection Total will operate in reverse. For example if the following horses (horses 2, 13, 18 and 20) were in a four-way tie with the same Selection Total number of, for example, 26,333, which is an odd Selection Total number, then the order of the four tied numbers becomes 20, 18, 13 and 2.

This process or concept is further explained in FIG. 3.

### Example 5.4

### The Elimination Processes—to Determine the Winning Punter

The First Elimination:

The first elimination process involves reducing the punters in the game from 500,000 to a much lower number. This occurs by eliminating all punters other than those punters that chose horse number [13] as their first choice, which is the horse number that was least picked by all the 500,000 punters in the game, as it was chosen 19,500 times and which won the race—see Example 5.2—Table 19.

Calculations:

With 500,000 punters in the game, divided by the number of horses available for punters to choose [i.e. 20], results in an average of 25,000 punters per horse.

Some of the [20] horses will be chosen more times, other horses less. In this example, it is assumed that there are 19,500 punters that have chosen horse [13] as their first horse choice and which are not eliminated.

The Second Elimination:

The second elimination process involves reducing the remaining 19,500 punters from 19,500 to a much lower number. This is done by eliminating from the remaining 19,500 punters, all punters except those that also chose horse [1] as their 2^{nd} horse choice, which is the horse that was the second least picked horse by all the 500,000 punters in the game, as it was chosen 19,657 times and got second in the race—see Example 5.2—Table 19.

Calculations:

With 19,500 punters remaining in the game, divided by the remaining number range of 19 (as horse 13 has now gone), results in an average of 1.026 punters per the remaining 19 horses. Based on the law of averages, some of the remaining 19 horses will be chosen more times, other horses less. In this example, it is assumed that there are c. 900 punters that have chosen horse [1] as their 2^{nd} horse and which are not eliminated.

The Third Elimination:

The third elimination process involves reducing the remaining c. 900 punters from c. 900 to a much lower number. This is done by eliminating from the remaining c. 900 punters, all punters except those that also chose horse [19] as their 3^{rd} horse choice, which is the horse that was the third least picked by all the 500,000 punters in the game, as it was chosen 20,560 times and got third in the race—see Example 5.2—Table 19.

Calculations:

With c. 900 participants remaining in the game, divided by the remaining number range of 18 (as horses 13 and 1 have both now gone), results in an average of c. 50 punters per the remaining 18 horses. Based on the law of averages, some of the remaining 18 horses will be chosen more times, other horses less. In this example, it is assumed that there are c. 40 participants that have chosen horse [19] as their 3^{rd} horse and which are not eliminated.

Further Eliminations—the Ranking System:

By this time, with c. 40 punters remaining, those small number of remaining punters can be ranked using their 4^{th} chosen horse, and 5^{th} and 6^{th} if necessary, to determine the winner/s.

When considering Example 5.6, Table 21 below, the 6 horse choices of the best 10 performing punters are set out in Example 5.5, Table 20 below:

### Example 5.5

TABLE 20
Top 10 Punters' chosen Horses [by reference to the
assigned horse number]

| | 1^{st} | 2^{nd} | 3^{rd} | 4^{th} | 5^{th} | 6^{th} |
|---|---|---|---|---|---|---|
| | Horse | Horse | Horse | Horse | Horse | Horse |
| | Choice | Choice | Choice | Choice | Choice | Choice |
| Punter | 13 | 1 | 19 | 14 | 4 | 10 |
| P.1 | | | | | | |
| Punter | 13 | 1 | 19 | 14 | 8 | 9 |
| P.2 | | | | | | |
| Punter | 13 | 1 | 19 | 14 | 8 | 7 |
| P.3 | | | | | | |
| Punter | 13 | 1 | 19 | 15 | 9 | 3 |
| P.4 | | | | | | |
| Punter | 13 | 1 | 19 | 4 | 2 | 5 |
| P.5 | | | | | | |
| Punter | 13 | 1 | 19 | 4 | 11 | 9 |
| P.6 | | | | | | |
| Punter | 13 | 1 | 19 | 4 | 11 | 7 |
| P.7 | | | | | | |
| Punter | 13 | 1 | 19 | 4 | 10 | 7 |
| P.8 | | | | | | |
| Punter | 13 | 1 | 19 | 8 | 9 | 10 |
| P.9 | | | | | | |
| Punter | 13 | 1 | 19 | 8 | 7 | 9 |
| P.10 | | | | | | |

### Example 5.6

TABLE 21
Determining the winning punter

| | No. of Punters | | | | | | | | | | |
|---|---|---|---|---|---|---|---|---|---|---|---|
| | | | | | | | | | | | . . . To P. |
| | P.1 | P.2 | P.3 | P.4 | P.5 | P.6 | P.7 | P.8 | P.9 | P.10 | 500,000 |
| 1^{st} Horse: | 19,500 | 19,500 | 19,500 | 19,500 | 19,500 | 19,500 | 19,500 | 19,500 | 19,500 | 19,500 | 19,500 |
| 13 | | | | | | | | | | | |
| (no of | | | | | | | | | | | |
| times | | | | | | | | | | | |
| chosen by | | | | | | | | | | | |
| all punters | | | | | | | | | | | |
| in game) | | | | | | | | | | | |
| 2^{nd} Horse: 1 | 19,657 | 19,657 | 19,657 | 19,657 | 19,657 | 19,657 | 19,657 | 19,657 | 19,657 | 19,657 | c. 900 |
| | | | | | | | | | | | left |
| 3^{rd} Horse: | 20,560 | 20,560 | 20,560 | 20,560 | 20,560 | 20,560 | 20,560 | 20,560 | 20,560 | 20,560 | c. 40 |
| 19 | | | | | | | | | | | left |
| 4^{th} Horse: 9 | 21,765 | 21,765 | 21,765 | 22,348 | 25,000 | 25,000 | 25,000 | 25,000 | 26,332 | 26,332 | By Rank |
| | | | | (4^{th}) | | | | | | | |
| 5^{th} Horse: 7 | 25,000 | 26,332 | 26,332 | 20,988 | 27,000 | 27,830 | 27,830 | 31,500 | 20,988 | 21,344 | |
| | (1^{st}) | | | | (5^{th}) | | | (8^{th}) | (9^{th}) | (10^{th}) | |
| 6^{th} Horse: | 31,500 | 20,988 | 21,344 | 21,974 | 29,333 | 20,988 | 21,344 | 21,344 | 31,500 | 20,988 | |
| 14 | | (2^{nd}) | (3^{rd}) | | | (6^{th}) | (7^{th}) | | | | |
| Extra | . . . | . . . | . . . | . . . | . . . | . . . | . . . | . . . | . . . | . . . | |
| Horses | | | | | | | | | | | |
| if needed | | | | | | | | | | | |

As can be seen from Example 5.6, Table 21 above, Punter P.1 is the sole winner.

### Example 5.7

### Use of Eliminations and/or the Ranking System

The Ranking System described in this invention, in particular as referred to in Examples 5.2 and 5.3 can be used to rank each punters performance in a game. So in a virtual horse race game played by 500,000 punters, each punter can be ranked, from 1^{st} place down to last place. Accordingly, in one aspect of the invention, the winner/s can be determined through this method. However, we believe it is preferable to have a group of winners (or class of winners) at various determined steps in the virtual horse race game. Accordingly, we believe it is preferable to also undertake elimination steps as we have described in Example 5.4 above.

Depending on the number of punters in a virtual horse race game as described in this Example 5, but assuming a minimum of 500,000 punters, these elimination steps occur, as we have set out in Example 5.4 above, using firstly the punters choice of the winning horse, and then as relevant the punters choices of their 2^{nd} and 3^{rd} places and as may be necessary, the punters 4^{th} place horse choice and so forth, until a ‘sufficiently small’ number of punters remain.

What constitutes ‘sufficiently small’ may vary for each virtual horse race game profile and will depend on the number of punters in the game and the number of individual ‘major’ prizes that the gaming organizers want to award to successful punters.

In this Example 5 of the game which is a game with 500,000 punters, we have continued the elimination processes up to and including the use of the 3^{rd} placed horse, after which there is about 40 punters remaining. Then the computer software ranks in order each of those last 40 or so remaining punters, ranking their performance against each other, with reference to the ranking system as set out in Example 5.2, Table 19. We have used the top 10 punters for demonstration purposes, from which we then determine the winner/s of the major prizes in this example of the game.

If however, during the elimination stages, the use of the 3^{rd} placed horse above resulted, for example, in there being less than the required number of participants for major prizes, being those participants that had correctly chosen the relevant winning horse number, and then the 2^{nd} and 3^{rd} placed horses, then the following occurs:
Those punters, if any, that had correctly chosen the relevant winning horse number, and then the 2^{nd} and 3^{rd} placed horses all get major prizes from 1^{st} down to the relevant placing: and
The remaining punters that are required for prizes are determined from the prior group of participants that had correctly chosen the relevant winning horse, and also the 2^{nd} placed horse. The remaining punters required for prizes are determined by reference to each of those punters other picks of horse placements (i.e. in order each of the punters picks for the 3^{rd}, and as necessary, the 4^{th}, 5^{th}, and 6^{th} horse placings which are then ranked by reference to the Ranking System as contained in Example 5.2, Table 19 and the methods described herein.
Table 22 below overviews this process in respect of determining the top 10 punters to win the major prizes. The method set out in this table below should be sufficient for most virtual horse race game sizes based on the results set out in Example 5.17, Table 26—“Backroom Calculations—Eliminations”. It will be appreciated that the process can be expanded as required, for instance by requiring the punters to pick the placements of 7 horses, instead of the 6 used in this example.

TABLE 22
Description of Elimination Steps

| Steps | Horse Placing | Description of Elimination Steps |
|---|---|---|
| First | 1^{st} Placed Horse | Firstly, eliminate all punters other than those that chose |
| | | the correct winning horse [13]. (“1^{st} Category”) |
| 2^{nd} | 2^{nd} Placed Horse | Secondly, eliminate all 1^{st} Category punters other than |
| | | those that also correctly chose the 2^{nd} placed horse [1]. |
| | | (“2^{nd} Category”). |
| | | If the number of remaining punters is 10 or less, go to |
| | | the Final Step. Otherwise proceed below. |
| 3^{rd} | 3^{rd} Placed Horse | Thirdly, eliminate all 2^{nd} Category punters other than |
| | | those that also correctly chose the 3^{rd} placed horse [19]. |
| | | (“3^{rd} Category”). |
| | | If the number of remaining punters is 10 or less, go to |
| | | the Final Step. Otherwise proceed below. |
| 4^{th} | 4^{th} Placed Horse | Fourthly, eliminate all 3^{rd} Category punters other than |
| | | those that also correctly chose the 4^{th} placed horse [9]. |
| | | (“4^{th} Category”). |
| | | If the number of remaining punters is 10 or less, go to |
| | | the Final Step. Otherwise proceed below. |
| 5^{th} | 5^{th} Placed Horse | Fifthly, eliminate all 4^{th} Category punters other than |
| | | those that also correctly chose the 5^{th} placed horse [7]. |
| | | (“5^{th} Category”). |
| | | If the number of remaining punters is 10 or less, go to |
| | | the Final Step. Otherwise proceed below. |
| 6^{th} | 6^{th} Placed Horse | Sixthly, eliminate all 5^{th} Category punters other than |
| | | those that also correctly chose the 6^{th} horse placing [14]. |
| | | (“6^{th} Category”). |
| Final | | [1] If the number of punters is [10] or less, those |
| Step | | punters, if any, will be winners of the relevant major |
| | | prizes. To determine which punters win which prizes |
| | | occurs by ranking those punters using their relevant |
| | | choice of horse placing in accordance with the Selection |
| | | Total/s and Ranking System of all the horses in the race |
| | | (in this example it is 20 horses) to determine those |
| | | punters that have the best results/rankings; |
| | | and then |
| | | [2] If 1 or more punters are still required to make up the |
| | | [10] punters required for the major prizes, then using the |
| | | group of punters from the preceding stage/s as relevant, |
| | | rank those punters using their relevant choice of horse |
| | | placement in accordance with the Selection Total/s and |
| | | Ranking System of all the horses in the race (in this |
| | | example it is 20 horses) to determine those punters that |
| | | have the best results/rankings and who are also to |
| | | receive some of the major prizes in order to make up the |
| | | required [10] major prize winners. |

### Example 5.8

### Alteration to ‘Ascribed Ranking Values’—Same Results

Example 5.2, Table 19 above records all the punters' 6 horse choices from the [20] horses competing in the race and by doing so is able to ascribe a unique ranking value to each of the 20 horses. This ascribed ranking value is equal to the number of times that each of the 20 horses had been chosen by all the 500,000 participants in the game. All the [20] horses available to be chosen in the game are ascribed a unique ranking value. To illustrate this—and with reference to Example, Table 19 which ranks all the [20] horses:
Horse 13 was the least chosen horse, so horse 13 had the least weight to carry around the race course and was therefore placed first, with a ranking number of 19.500 (being the number of times that horse 13 had been chosen by all the 500,000 punters in the game);
Horse 1 was the second least chosen horse, so horse 1 had the second least weight to carry around the race course and was placed second, with a ranking number of 19,657 (being the number of times that horse 1 had been chosen by all the 500,000 punters in the game); and so on as set out in Example 5.2, Table 19.

Alteration to Ascribed Ranking Value:

Instead of using the ascribed ranking value based on the number of times that each of the [20] horses had been chosen by all the 500,000 participants in the game, the ascribed ranking value can be changed to equal the actual rankings or placement number of each of the [20] horses that are to compete in the race. To illustrate this—and again with reference to Example 5.2, Table 19 which ranks all the horses, and to Example 5.5, Table 20 which records the chosen numbers of the top 10 punters:
Horse 13 was the least chosen horse, so horse 13 was placed first with a ranking number of 19,500 (being the number of times that horse 13 had been chosen by all the 500,000 punters in the game). Its ranking value is changed from 19,500 to 1^{st} i.e. a ranking value of 1;
Horse 1 was the second least chosen horse, so horse 1 was placed second with a ranking number of 19,657 (being the number of times that horse 1 had been chosen by all the 500,000 punters in the game). Its ranking value is changed from 19,657 to 2^{nd} i.e. a ranking value of 2; and so on as also set out/identified in Example 5.2, Table 19.

Example 5.9, Table 23 below is the same as Example 5.6, Table 21, but now changed to show the change to using the ascribed ranking value of 1, 2, 3, etc as described above.

### Example 5.9

TABLE 23
Determining the winning punter: Using alteration to ascribed ranking value

| | No. of Punters | | | | | | | | | | |
|---|---|---|---|---|---|---|---|---|---|---|---|
| | | | | | | | | | | | . . . To P. |
| | P.1 | P.2 | P.3 | P.4 | P.5 | P.6 | P.7 | P.8 | P.9 | P.10 | 500,000 |
| 1^{st} Horse: | 19,500 | 19,500 | 19,500 | 19,500 | 19,500 | 19,500 | 19,500 | 19,500 | 19,500 | 19,500 | 19,500 |
| 13 | 1 | 1 | 1 | 1 | 1 | 1 | 1 | 1 | 1 | 1 | |
| (no of times | | | | | | | | | | | |
| chosen by | | | | | | | | | | | |
| all punters | | | | | | | | | | | |
| in game) | | | | | | | | | | | |
| 2^{nd} Horse: 1 | 19,657 | 19,657 | 19,657 | 19,657 | 19,657 | 19,657 | 19,657 | 19,657 | 19,657 | 19,657 | c. 900 |
| | 2 | 2 | 2 | 2 | 2 | 2 | 2 | 2 | 2 | 2 | left |
| 3^{rd} Horse: | 20,560 | 20,560 | 20,560 | 20,560 | 20,560 | 20,560 | 20,560 | 20,560 | 20,560 | 20,560 | c. 40 |
| 19 | 3 | 3 | 3 | 3 | 3 | 3 | 3 | 3 | 3 | 3 | left |
| 4^{th} Horse: 9 | 21,765 | 21,765 | 21,765 | 22,348 | 25,000 | 25,000 | 25,000 | 25,000 | 26,332 | 26,332 | By |
| | 6 | 6 | 6 | 8 | 10 | 10 | 10 | 10 | 11 | 11 | Rank |
| | | | | (4^{th}) | | | | | | | |
| 5^{th} Horse: 7 | 25,000 | 26,332 | 26,332 | 20,988 | 27,000 | 27,830 | 27,830 | 31,500 | 20,988 | 21,344 | |
| | 10 | 11 | 11 | 4 | 13 | 14 | 14 | 20 | 4 | 5 | |
| | (1^{st}) | | | | (5^{th} ) | | | (8^{th}) | (9^{th}) | (10^{th}) | |
| 6^{th} Horse: | 31,500 | 20,988 | 21,344 | 21,974 | 29,333 | 20,988 | 21,344 | 21,344 | 31,500 | 20,988 | |
| 14 | 20 | 4 | 5 | 7 | 19 | 4 | 5 | 5 | 20 | 4 | |
| | | (2^{nd}) | (3^{rd}) | | | (6^{th} ) | (7^{th}) | | | | |
| Extra | . . . | . . . | . . . | . . . | . . . | . . . | . . . | . . . | . . . | . . . | |
| Horses | | | | | | | | | | | |
| if needed | | | | | | | | | | | |

As can be seen from Example 5.9, Table 23 above, the alteration to the ascribed ranking values to 1, 2, 3, and so forth makes no change. The punter P.1 is the sole winner.

### Example 5.10

### Fallback Position—Ties Involving Winning Punters

The above illustrated elimination processes using the six horse choices of the punters should ensure that the elimination process to determine one sole winner can be fully completed and no fallback position should ever be necessary.

While this gaming system guarantees a winner, a joint winner is possible but unlikely. In this example of the game (in order 6/20), once a winner is determined (using the full set of 6 horse choices from the 20 horses if required), the chances of one or more other punters having also chosen in order the exact same 6 horses as chosen by the winning punter is/are remote, as the odds of correctly choosing the 6 horses in order are 1 in 27,907,200—see FIG. 7a.

The odds of:

a double event occurring (two entries that correctly chose the same 6 winning horses) is 1 in 46,828,281 (Calculation: the odds to one×1.678—source: Scarne's New Complete Guide to Gambling, chapter 2; Published by Simon and Schuster, New York, 1974); a triple event occurring is 1 in 74,651,760—(Calculation: the odds to one×2.675); a quad event occurring is 1 in 102,475,238—(Calculation: the odds to one×3.672); and a quint event occurring is 1 in 130,326,624—(Calculation: the odds to one×4.670). However, to provide for the situation where the above illustrated elimination processes does not achieve one sole winner, then if two or more punters remain and can't be eliminated or separated, then those tied punters share in proportion as between them the relevant prize/s.

### Example 5.11

TABLE 24
Example 5.11 - Exampled Prize Winnings for Weekly
Races - Prizes are 50% of the Entry Price

| | Maximum | | Total | % of |
|---|---|---|---|---|
| Elimina- | Number of | | Maximum | $2.5m |
| tion | Punters in | Prizes per | Amount of | Prize |
| Factors | each stage | Ticket | Prizes | Pool |
| | 500,000 | n/a | n/a | n/a |
| (÷20) 1^{st} | 25,000 | $10 + Super | $250,000 | 10.0 |
| Horse | | Draw | | |
| (÷19) 2^{nd} | 1,315 | $200 + above | $265,000 | 10.6 |
| Horse | | | | |
| (÷18) 3^{rd} | 73 | $2,000 + | $140,000 | 5.6% |
| Horse | | above | | |
| (÷17) 4^{th} | [10] Remaining | $20,000 + | $200,000 | 8.0% |
| Horse | participants | above | | |
| | other than | | | |
| | sole winner | | | |
| (÷16) 5^{th} | Winner | $1,000,000 + | $1,000,000 | 40.0% |
| Horse | | above | | |
| (÷15) 6^{th} | | | | |
| Horse | | | | |
| To Last | | | $20,000 | 0.8% |
| Place | | | | |
| To Super | | | $625,000 | 25.0% |
| Race | | | | |
| Totals | | | $2,500,000 | 100% |

### Example 5.12

### The Odds of Winning in a Weekly Race

In this Example 5, the odds of winning a prize in the weekly virtual horse race—in the first instance correctly choosing the week's winning horse—is 1 in 20.

The odds of winning first prize in the weekly race—is equal to the number of punters/tickets in the week's race—in this case, it is 1 in 500,000.

### Example 5.13

### Incorporation of a “Super Race”

As can be seen from Example 5.11, Table 24 above (last entry), the game includes a Super Race, which receives an allocation of 25% of the weekly prize fund for prizes in a latter Super Race that is to be run six monthly.

The Super Race involves the same identical processes of eliminations and winning as applicable to the weekly race.

The participation by punters in the Super Race is only achieved by:
Purchasing a ticket in a weekly race; and
Correctly picking a winning horse (i.e. the 1 place) in a weekly race.

The number of tickets/entries a punter can have in the Super Race is based on how many times a punter correctly chooses the winning horse in one or more of the weekly races.

### Random Allocation of Super Race Horses

The 6 horses allocated for the Super Race are only allocated to those ‘weekly’ punters that correctly pick the winning horse (1^{st} place) for the relevant week's race. This random allocation is to ensure that no punter can stipulate what horses he or she wants to choose for the Super Race, thereby ensuring the integrity of the Super Race result.

In addition, to further ensure the integrity of the Super Race result, the 6 Super Race horses allocated to the relevant punters from each week's lottery are not merged at any time into any combined set of data until after the last weekly race has been run, and the data is only merged for the purpose of ‘broadcasting’ the Super Race.

### Example 5.14

### Super Race Prizes

The prizes available for the winner of the Super Race will be significantly higher than the weekly race.

Assume that:
the Super Race is conducted semi-annually, at the end of a 25 week cycle of weekly races; and
there are 25 weeks of races, with each week's race having the same participation and winning profile as described previously; and
in each of the 25 weeks, $625,000 is set aside from each weekly race—to accumulate for the Super Race; and
at the end of 25 weeks, there is $15,625,000 available for Super Race prizes; and
the process of winning Super Race is the same as for the weekly draws.

### Example 5.15

TABLE 25
Example 5.15 - Exampled Prize Winnings for
[the semi-annual] Super Race

| | Maximum | | Total | |
|---|---|---|---|---|
| | Number of | | Maximum | % of |
| | Punters in | | Amount of | $15.625 |
| Elimina- | each stage | Prizes per | Prizes | million |
| tion | of Super | Entry | (at each | Prize |
| Factors | Race | Ticket | stage) | Pool |
| | 25,000 | n/a | n/a | n/a |
| | maximum | | | |
| | punters per | | | |
| | week × | | | |
| | 25 weeks = | | | |
| | 625,000 | | | |
| (÷20) 1^{st} | 31,250 | $100 | $3,125,000 | 20.00% |
| Horse | | | | |
| (÷19) 2^{nd} | 1,644 | $1,000 + | $1,640,625 | 10.50% |
| Horse | | above | | |
| (÷18) 3^{rd} | 91 | $10,000 + | $906,,250 | 5.80% |
| Horse | | above | | |
| (÷17) 4^{th} | [4] Remaining | $100,000 + | $400,000 | 2.56% |
| Horse | punters other | above | | |
| | than sole | | | |
| | winner | | | |
| (÷16) 5^{th} | Winner | $23,437,500 + | $9,375,000 | 60.00% |
| Horse | | above | | |
| (÷15) 6^{th} | | | | |
| Horse | | | | |
| To Last | | | $100,000 | 0.64% |
| Place | | | | |
| To costs | | | $78,125 | 0.50% |
| of running | | | | |
| Super | | | | |
| Race | | | | |
| Game/ | | | | |
| misc | | | | |
| Totals | | | $15,625,,000 | 100% |

### Example 5.16

### The Odds of Winning Super Race

The odds of winning a prize in Super Race is dependent on the number of entries a punter has in the Super Race—i.e. the number of times a punter enters weekly races and correctly chooses the winning horse (i.e. 1^{st} place) in each weekly race.

For a punter that has only one entry into Super Race, the odds of winning the minor prize in Super Race ($100) is 1 in 20.

The odds of winning Super Race—based on the assumptions set out in this Example 5, for the punter with only one entry in Super Race—the odds of winning must be no more than 1 in 625,000.

A punter with 1 entry in Super Race has odds of at least 1 in 20 of winning any prize. The odds get shorter for each additional entry into Super Race that a punter has. A punter with entries comprising 10 different winning horse choices has odds of at least 1 in 2 of winning any prize.

If a punter has 10 entries into Super Race comprising 10 different winning horse choices, the odds must be no more than 1 in 62,500 of winning the first prize in Super Race.

### Example 5.17

TABLE 26
Example 5.17 - Backroom Calculations - Eliminations
The table below demonstrates that choosing 6 horses should be sufficient
to effect the necessary eliminations for most race sizes, using [20] horses.
Additional horses and choices can be added to the game if/as necessary.

| | No. Of Tickets/Punters | | | |
|---|---|---|---|---|
| | 500,000 | 5,000,000 | 50,000,000 | 5,000,000,000 |
| Number Range | (÷20) | (÷20) | (÷20) | (÷20) |
| Of Horses | | | | |
| 1-20 | | | | |
| 1^{st} | 25,000 | 250,000 | 2,500,000 | 250,000,000 |
| Horse | | | | |
| (÷20) | | | | |
| 2^{nd} | 1,315 | 13,157 | 131,578 | 13,157,894 |
| Horse | | | | |
| (÷19) | | | | |
| 3^{rd} | 73 | 730 | 7,309 | 730,994 |
| Horse | | | | |
| (÷18) | | | | |
| 4^{th} | 4 | 42 | 429 | 42,999 |
| Horse | | | | |
| (÷17) | | | | |
| 5^{th} | Winners | | 26 | 2,687 |
| Horse | | | | |
| (÷16) | | | | |
| 6^{th} | | Winners | | 179 |
| Horse | | | | |
| (÷15) | | | | |
| 7^{th} | | | Winners | 12 |
| Horse | | | | |
| (÷14) | | | | |

### Example 5.18

### Other Virtual Racing Applications

As will be obvious to a person skilled in the art, there will be many applications for the gaming system described in this invention to be used in a Virtual Race type application, such as running, cycling, yachting, roller skating, ice skating, jet boating, Formula 1. NASCAR, spacecraft racing and many others, where participants choose symbols from a symbol or number range from 1 to n, and a 1^{st} place or winner is to be determined, together with 2^{nd}, 3^{rd}, 4^{th} places and so on in respect of some race or competitive event using the methods described earlier.

Other applications for the gaming system include competitive events such as destruction type games. For example, war games where participants can choose ‘objects’ or ‘characters’ from a symbol or number range of 1 to n. These objects or characters could be ships, or tanks, or soldiers, in which the ranking system can be used to determine a placement or finishing place for each of the 1 to n objects or characters in a competitive gaming event using the systems described herein.

Another application includes the use of the system in casino type games. For example in a game designed around cards, where participants are invited to select one or more cards from a range of n cards, where the winner or winners are determined using the methods and the ranking system described herein above.

### Horse Race Example

FIG. 5 shows in storyboard form a game design of a regional or worldwide Virtual Horse Race game where players pick 6 horses from a range of 20 horses. The storyboard game design does not determine the winner which is in fact determined by the least, or most, picked numbers as described above. Thus the storyboard game design is a method of delivering the results and not a selection method itself.
FIG. 5a shows the front page of a story board for a Virtual Horse Race and may include items such as the brand name of the lottery, in this case SUPERVIVO.
FIG. 5b shows the pre race set up and refers to results and the draw number. A background of the race course which will be used to deliver the lottery results is also given. At the foot of the figure is shown the sound effects and also the commencement of possible dialogue between the race callers.
FIG. 5c shows the starting line for the race and shows some horses in the starting stalls. The actual presentation could show the horses being led into the starting stalls if desired. The dialogue continues.
FIG. 5d shows the early stages of the Virtual Horse Race. Also shown are the draw number and the first prize total in the top right hand corner of the figure. Paid advertising can also be seen along with a time or distance line showing the position of the horses as they progress towards the finish line. Dialogue of the callers continues to be shown.
FIG. 5e shows further discussion by the callers of the numbers and the game mechanics.
FIG. 5f shows further racing and includes further discussion including game explanations.
FIG. 5g shows the horses approaching the finish of the race and shows the leading horses in a panel above the horses as well as the horses' position on the time or distance line.
FIG. 5h shows the finish line and the winning horses. The winning horses are shown above the horses as well as on the time or distance line.
FIG. 5i shows a slow motion replay of the winning horse winning the race, in this example the winning horse is horse 6.
FIG. 5j shows the 5 secondary numbers. In particular, the placements of the 2^{nd} to 6^{th} horses.
FIG. 5k shows the placements of each of the 20 horses in the race.
FIG. 5l shows the announcement of the winner of the game.
FIG. 5m shows the top 10 winning participants in a regional or worldwide game, their ticket numbers, their country, and their chosen 6 numbers/horses.
FIG. 5n shows the local country winners of, in this example, the 10 member countries comprising the exampled regional game.
FIG. 5o shows a control panel for participants in the game to seek further information in relation to the game, and past games.

### Space Race Example

FIG. 6 is a storyboard relating to a game design of a regional or worldwide Virtual Space Race game where players pick 6 space vehicles from a range of 20 space vehicles. Again the race is a delivery method and does not of itself determine the game's winner/s.
FIG. 6a shows the front page of a storey board for a Virtual Space Race.
FIG. 6b shows the number/space shuttle selection panel, comprising in this example, 20 available selection choices.
FIG. 6c shows the number confirmations of a participant's 6 number selections.
FIG. 6d shows the game draw number and the announcer's introductions. The draw number and winning prize value are also shown. The commentary is also commenced.
FIG. 6e shows the space shuttles and the announcer's profiling of one of the shuttle drivers.
FIG. 6f shows the starting line of the Virtual Space Race.
FIG. 6g shows lap 2 of the Virtual Space Race. A course is also shown at the top right hand corner of the figure along with the shuttle positions around the course.
FIG. 6h shows the inside of a space shuttle cockpit profiled during lap 2 of the race.
FIG. 6i shows an example of the number/space shuttle eliminations during lap 2 of the race.
FIG. 6j shows space shuttle number 6 winning the space race at the conclusion of lap 3—number 6 in this example is the least picked number/space shuttle, as least picked by all the participants in the game.
FIG. 6k shows the placements of each of the 20 space vehicles in the race.
FIG. 6l shows the top 10 winning participants in a regional or worldwide game, their ticket numbers, their country, and their chosen 6 numbers/shuttles.
FIG. 6m shows the local country winners of, in this example, the 10 member countries comprising the exampled regional game.
FIG. 6n shows a control panel for participants in the game to seek further information in relation to the game, and past games.
FIG. 6o shows examples of racetrack themes for a Virtual Space Race.

### EXAMPLE 6

### Example 6.0

### Application for Regional or Worldwide Game or Lottery

In a further variation of the invention it is possible to provide the system with means to accommodate differing payout requirements of various countries or regions.

The gaming system's unique advantages include that each number in the range of numbers from 1 to n that can be chosen by participants is ascribed a unique and individual ranking number, or ranking value or placement value.

Consequently, each participant in a game utilizing the gaming system described herein, including each participant in a regional or worldwide game, can be individually placed in the game, from first place to last place in respect of the overall game, or in respect of that participants performance within a subset of participants, such as the placement from first place to last place among only the participants who entered the game from Country A, or alternatively, and separately, the placement from first place to last place among only those participants that entered from Country B, and so on.

These above described features become evident by reference to Examples 3.2, 3.3 and 3.7.

This capability of the invention enables the regional or worldwide game organizers to identify, from the one set of gaming data from the regional or worldwide game, not only the overall winner/s of any regional or worldwide game, but also the local area or local country winners—to whom a local area or local country prize can be paid.

This provides a means to accommodate differing payout requirements of gaming operators in various countries or regions (often imposed upon a licensed gaming operator by their respective government) in a way that is advantageous to the formation and running of a regional or worldwide game or lottery, as described below.

### Example 6.1

### Assumed Game or Lottery Profile with a Region comprising 3 Countries

The assumptions below are provided for illustration purposes and assume that there are three countries (hereafter referred to as Country A, Country B and Country C) cross selling a regional game or lottery using the gaming system of the invention.

An example of how Country A, B and C have different requirements relating to the amount of revenues to be returned to them, and how this difference can be accommodated through the use of the gaming system described herein and the payment of the local country prize, is set out in Example 6.2, Table 27 below:

### Example 6.2

TABLE 27
Example 6.2

| Allocation to: | Country A | Country B | Country C |
|---|---|---|---|
| Prizes paid by the | 45% | 45% | 45% |
| regional or worldwide | | | |
| game or lottery | | | |
| The Relevant Local | 55% | 55% | 55% |
| Country Operator | | | |
| Additional Local | 0% | 10% | 5% |
| Country Prize | | | |
| (Country variable) | | | |
| Decided and paid by | | | |
| Relevant Local Country | | | |
| Operator | | | |
| Net to the Relevant | 55% | 45% | 50% |
| Local Country | | | |
| Operator | | | |

In this Example 6, to demonstrate how the regional game/lottery works utilizing the gaming system and methods described herein, it is assumed that:
A regional game or lottery is sold by three countries, relevantly Country A, Country B and Country C;
The participants purchasing tickets within each of the three countries will each purchase 6 different numbers in the selected range of say 1-30;
Each number block of 6 numbers, consists of 1 PRIMARY and 5 SECONDARY numbers, each of which must be different;
Each number block is purchased at a total cost of $10;
The regional lottery is played by 500,000 participants, with:
300,000 participants from Country A; (60%)
150,000 participants from Country B; (30%) and
50,000 participants from Country C. (10%)
Each participant purchasing tickets within each of the three countries purchases the minimum of $10 for one number block of 6 different numbers—so there would be 500,000 PRIMARY numbers picked in total, all in the number range of 1-30;
Thus the total revenue from the regional game/lottery is $5,000,000;
The prize pool payable by the regional game/lottery is set at 45% of total revenue,
Thus, there being prizes of $2,250,000 to be paid by the regional game/lottery organizers;
The amount of revenues to be paid to Countries A, B and C is therefore 55% of the total revenue, which is a combined total of $2,750,000.
Country A, Country B and Country C each receive 55% of the sales revenues attributed to their respective sales achieved within their own country. Relevantly, in this example:

Country A gets $1,650,000 ($2,750,000×60%)

Country B gets $825,000 ($2,750,000×30%)

Country C gets $275,000 ($2,750,000×10%)
In this example, there are restrictions on who can receive a local country prize. In this example the restriction is that the local country prize can only be paid by a country to a country's citizen, or resident, or to a person that can prove he/she was in the country at the time of the ticket's purchase. Other restrictions are possible.
Any numbers in the range of 1-30 not chosen by any participant are ignored.
The number 13 is the PRIMARY number that is chosen the least by all the 500,000 participants in the regional or worldwide game or lottery.
There are 12,000 participants that have chosen 13 as their PRIMARY number.
Ties between the n numbers in the number range 1 to 30 are ALL resolved using the methods as earlier set out in Examples 3.3 and 4.3 above.
Example 6.3, Table 28 below sets out the results of this example regional game or lottery with 500,000 participants, and shows the number of times each number in the 1-30 number range was chosen by all the participants in the regional game or lottery.
The 12,000 winners are subjected to further eliminations using the SECONDARY numbers, which are conducted using the one data set from the 500,000 participant's choices of the PRIMARY number.

### Example 6.3

TABLE 28
Example 6.3 - Results of 500,000
Participant Regional Game/Lottery

| BY RANKINGS | | | BY NUMBERS | | |
|---|---|---|---|---|---|
| RANK- | | | | | RANK- |
| INGS | NUMBER | | | NUMBER | INGS |
| OF | OF | NUM- | NUM- | OF | OF |
| LEAST | TIMES | BERS | BERS | TIMES | LEAST |
| PICKED | CHOSEN | CHOSEN | CHOSEN | CHOSEN | PICKED |
| 1 | 12,000 | 13 | 1 | 14,063 | 8 |
| 2 | 12,002 | 30 | 2 | 19,000 | 21 |
| 3 | 13,335 | 21 | 3 | 14,400 | 10 |
| 4 | 13,775 | 4 | 4 | 13,775 | 4 |
| 5 | 13,999 | 27 | 5 | 20,789 | 29 |
| 6 | 14,005 | 10 | 6 | 19,441 | 25 |
| 7 | 14,010 | 20 | 7 | 18,888 | 20 |
| 8 | 14,063 | 1 | 8 | 17,650 | 18 |
| 9 | 14,065 | 11 | 9 | 19,442 | 26 |
| 10 | 14,400 | 3 | 10 | 14,005 | 6 |
| 11 | 15,050 | 25 | 11 | 14,065 | 9 |
| 12 | 15,556 | 16 | 12 | 16,021 | 16 |
| 13 | 15,900 | 24 | 13 | 12,000 | 1 |
| 14 | 16,005 | 29 | 14 | 20,543 | 28 |
| 15 | 16,008 | 19 | 15 | 19,347 | 23 |
| 16 | 16,021 | 12 | 16 | 15,556 | 12 |
| 17 | 17,000 | 18 | 17 | 21,345 | 30 |
| 18 | 17,650 | 8 | 18 | 17,000 | 17 |
| 19 | 17,775 | 26 | 19 | 16,008 | 15 |
| 20 | 18,888 | 7 | 20 | 14,010 | 7 |
| 21 | 19,000 | 2 | 21 | 13,335 | 3 |
| 22 | 19,023 | 28 | 22 | 20,189 | 27 |
| 23 | 19,347 | 15 | 23 | 19,374 | 24 |
| 24 | 19,374 | 23 | 24 | 15,900 | 13 |
| 25 | 19,441 | 6 | 25 | 15,050 | 11 |
| 26 | 19,442 | 9 | 26 | 17,775 | 19 |
| 27 | 20,189 | 22 | 27 | 13,999 | 5 |
| 28 | 20,543 | 14 | 28 | 19,023 | 22 |
| 29 | 20,789 | 5 | 29 | 16,005 | 14 |
| 30 | 21,345 | 17 | 30 | 12,002 | 2 |
| | 500,000 | | | 500,000 | |

### Example 6.4

### The Elimination Processes

The First Eliminations:

The first elimination process involves a computer analysis reducing the participants in the regional game from 500,000 to a much lower number. This occurs by eliminating all participants other than those participants that chose number [13] as their PRIMARY number. The number [13] is the number in this example that was least picked by all the 500,000 participants in the regional game, as it was chosen 12,000 times—see Example 6.3, Table 28.

Calculations:

With 500,000 participants in the regional game, divided by the number range of 1-30, this results in an average of 16,666 participants per number. Of course, some numbers will be chosen more times, other numbers less. In this example, it is assumed that there are 12,000 participants that have chosen [13] as their PRIMARY number and which, therefore, are not eliminated.

The Second Eliminations:

The second elimination process involves a further computer analysis which reduces the remaining 12,000 participants from 12,000 to a much lower number by eliminating all participants other than those participants that chose number [30] as their 1^{st} SECONDARY number. The number [30] is the number that was the second least picked number by all the 500,000 participants in the regional game, as it was chosen 12,002 times—see Example 6.3, Table 28.

Calculations:

With 12,000 participants remaining in the regional game, divided by the remaining number range of 29 (as number 13 has now gone from the number range of 1-30), results in an average of 414 participants per number. Of course, some of the remaining 29 numbers will be chosen more times, other numbers less. In this example, it is assumed that there are c. 400 participants that have chosen [30] as their 1^{st} SECONDARY number and which are, therefore, not eliminated.

The Third Eliminations:

The third elimination process involves a computer analysis which reduces the remaining c. 400 participants by eliminating all participants other than those that chose [21] as their 2^{nd} SECONDARY number. The number [21] is the number that was the third least picked by all the 500,000 participants in the regional game, as it was chosen 13,335 times—see Example 6.3, Table 28.

Calculations:

With c. 400 participants remaining in the regional game, divided by the remaining number range of 28 (as number 13 and 30 have both now gone from the number range of 1-30), results in an average of c. 14 participants per number. Of course, some of the remaining 28 numbers will be chosen more times, other numbers less. In this example, it is assumed that there are c. 10 participants that have chosen [21] as their 2^{nd} SECONDARY number and which are, therefore, not eliminated.

Final eliminations—The Ranking System:

With c. 10 participants remaining in this example, those small number of remaining participants can be ranked using their 3^{rd} SECONDARY number, and 4^{th} SECONDARY number if necessary, to determine the winner/s.

This above described process is exemplified in Example 6.6, Table 30 that follows, which focuses on the 10 best performing participants in the regional game/lottery. When considering Example 6.6, Table 30, the 6 number choices of the best 10 performing participants (having the best results for the ‘least picked’ PRIMARY number and 5 SECONDARY numbers) are set out in Example 6.5, Table 29 below:

### Example 6.5

TABLE 29
Chosen numbers of the Top 10 Participants in Regional
Game/Lottery

| | Primary | | | | | |
|---|---|---|---|---|---|---|
| Participant | Number | 1^{st} SEC | 2^{nd} SEC | 3^{rd} SEC | 4^{th} SEC | 5^{th} SEC |
| P.1 | 13 | 30 | 21 | 4 | 20 | 2 |
| P.2 | 13 | 30 | 21 | 4 | 3 | 11 |
| P.3 | 13 | 30 | 21 | 27 | 10 | 20 |
| P.4 | 13 | 30 | 21 | 11 | 18 | 20 |
| P.5 | 13 | 30 | 21 | 11 | 8 | 26 |
| P.6 | 13 | 30 | 21 | 16 | 25 | 20 |
| P.7 | 13 | 30 | 21 | 24 | 4 | 10 |
| P.8 | 13 | 30 | 21 | 29 | 27 | 4 |
| P.9 | 13 | 30 | 21 | 19 | 26 | 3 |
| P.10 | 13 | 30 | 21 | 12 | 2 | 1 |

### Example 6.6

TABLE 30
Determine the winner of the Regional Game or Lottery
(the winning process is shaded, underlined and bolded):

| | Nos of Participants | | | | | | | | | | |
|---|---|---|---|---|---|---|---|---|---|---|---|
| | | | | | | | | | | | . . . To |
| | P.1 | P.2 | P.3 | P.4 | P.5 | P.6 | P.7 | P.8 | P.9 | P.10 | P. |
| From | | | | | | | | | | | 12,000 |
| PRIMARY | | | | | | | | | | | |
| no. 13 | | | | | | | | | | | |
| Country or | C | A | A | B | A | A | A | B | A | A | |
| Region of | | | | | | | | | | | |
| participants | | | | | | | | | | | |
| Country or | Yes | No | No | Yes | No | No | No | Yes | No | No | |
| Region | | | | | | | | | | | |
| electing a | | | | | | | | | | | |
| local | | | | | | | | | | | |
| country or | | | | | | | | | | | |
| region | | | | | | | | | | | |
| prize | | | | | | | | | | | |
| First | 12,002 | 12,002 | 12,002 | 12,002 | 12,002 | 12,002 | 12,002 | 12,002 | 12,002 | 12,002 | c. 400 |
| Secondary | | | | | | | | | | | left |
| (no of times | | | | | | | | | | | |
| chosen by | | | | | | | | | | | |
| all | | | | | | | | | | | |
| participants | | | | | | | | | | | |
| in lottery | | | | | | | | | | | |
| 2nd | 13,335 | 13,335 | 13,335 | 13,335 | 13,335 | 13,335 | 13,335 | 13,335 | 13,335 | 13,335 | c. 10 |
| Secondary | | | | | | | | | | | left |
| 3rd | 13,775 | 13,775 | 13,999 | 14,065 | 14,065 | 15,556 | 15,900 | 16,005 | 16,008 | 16,021 | |
| Secondary | | (2nd) | (3rd) | | | (6th) | (7th) | (8th) | (9th) | (10th) | |
| 4th | 14,000 | 14,400 | 14,005 | 17,000 | 17,650 | 15,050 | 13,775 | 13,999 | 17,775 | 19,000 | |
| Secondary | (1st) | | | (4th) | (5th) | | | | | | |
| 5th | 19,000 | 14,065 | 14,010 | 14,010 | 17,775 | 14,010 | 14,005 | 13,775 | 14,400 | 14,063 | |
| Secondary | | | | | | | | | | | |
| Extra Nos | . . . | . . . | . . . | . . . | . . . | . . . | . . . | . . . | . . . | . . . | |
| if needed | | | | | | | | | | | |

### Determining the Regional Winner/s Explained

As can be seen from Example 6.6, Table 30 above, participants P.1 and P.2 have each picked the same number for the primary number and 1^{st}, 2^{nd} and 3^{rd} SECONDARY numbers and in each case this is the number least picked. No other player has matched this. However once the least picked 4 SECONDARY number is considered, participant P.1 has the least picked number and becomes the winner of the regional game/lottery. Participant P.2 becomes the 2^{nd} placed participant. The 4^{th}, 5^{th} and 6^{th} placed participants, and so on are determined in a like manner. P.1 is the sole winner of the regional game/lottery. Further as P.1 is a participant from Country C which is paying out a local country prize, P.1, in this example, also wins the local country prize provided P.1 meets the restrictions such as being a citizen or resident of Country C, or being able to prove that P.1 was in Country C at the time P.1 purchased the ticket.

### Example 6.7

### Local Country Prizes

The above illustrated Example 6.6, Table 30, utilizing the computer division (by elimination) and ranking system, also shows the country (relevantly Country A or B or C) from which the lottery winners came from, and it shows the top 10 ranked participants in order.

In this Example 6, there are only three countries (Country A and Country B and Country C) participating in the regional game or lottery, and only Country B and C have elected to pay a local country prize. In this exampled case, that local country prize is:
10% to be paid by Country B of the revenues attributed to Country B (which were
30% of all the sales in the regional lottery—relevantly a local country prize of $150,000)
5% to be paid by Country C of the revenues attributed to Country C (which were 10% of all the sales in the regional lottery—relevantly a local country prize of $25,000)

If Country B and C both elected the local country prize to be paid only to one ticket holder, being its ‘local country winner’—then in the above example, the local country winner for Country B is participant P.4 who gets paid a local country prize of $150,000, and for Country C it is participant P.1 who gets paid a local country prize of $25,000.

While Example 6.3, Table 30 sets out only the top ten participants overall from the regional or worldwide game/lottery, it is recognized that not all local country winners may initially feature in the final results. Because of the computer ranking system, and the use of the one data set, the winner of each local country prize can also be determined by the regional gaming or lottery operator and advised to the relevant parties.

As will be evident from the various examples showing the use of the invention set out herein, and using the one set of data results determined by the regional or worldwide game (i.e. relevantly for this Example 6, the one set of data and the ranking system as set out in Example 6.3, Table 30), the invention using the computer division (by eliminations) and ranking systems, can be run in respect of the participants for each country so as to identify local country winners and other rankings such as 2^{nd}, 3^{rd}, and so forth even down to the last ranked participant from each country.

Further, the invention allows for the regional game or lottery of the present invention, or the local country winner aspect of the game, or both, to incorporate a worst result prize e.g. the participant with the PRIMARY number and one or more of the 5 SECONDARY numbers that had been picked the most by all the participants in the lottery could be readily identified. That relevant participant with the worst result could be paid a prize for that worst result.

FIG. 4 shows, by way of an example in a series of computer printouts, a method of processing by a computer the results for a 100,000 participant game, which is relevant to the example set out in this Examples 6. In particular FIG. 4 shows a method by which the computer processing determines the top 10 in order, from which the winner of a regional or worldwide game can be determined. FIG. 4 also records the relevant country. The operation of a control panel requiring the relevant country to be inserted (although not shown) identifies the local country winner. This example set out in FIG. 4 can be easily scalable for any size game.

### Example 6.8

### Other applications, Including in Respect of ‘Standard’ LOTTO

As will also be evident to persons skilled in this art, there will be variations on the methods described above. For example, the use of the invention in respect of ranking and ordering all the n numbers in the range of numbers from one to n that are available for selection by participants in a ‘standard’ LOTTO game will also allow for a local country winner/s prize as exampled in this Example 6, or the identification of the worst result.

A ‘standard’ LOTTO game as referred to in this Example 6 is one where players pick a set of numbers, say 6 numbers, from a larger range of n numbers, say from 1-49, the object being for a participant to match the 6 numbers that will later be drawn from the larger range of n numbers by the lottery operator. Once the lottery operator conducts the ‘standard’ lottery draw and draws the 6 numbers, the other 43 numbers are of no effect and have no ranking value.

If such a ranking or ordering system were to be adopted and applied to all numbers that are available to be chosen in a ‘standard’ LOTTO type game (in this example, a unique ranking of all the 49 numbers), then this would enable lottery organizations to utilize the invention and methods described and exampled herein, including in relation to using a standard LOTTO game in a regional or worldwide lottery cross sold by two or more lottery operators in which other winners can also be determined, such as a local country winner/s, or a local country worst result winner.

### EXAMPLE 7

### Example 7.0

### Virtual Cricket Gaming Event—(Number Range 1 to n, where n=18)

This example works on the basis of picking the ‘least picked’ numbers (balls).

This example uses the methods set out elsewhere herein and is believed to have particular application in the arena of T20 and one day cricket events.

The virtual cricket gaming event described in this example involves a ‘recognized’ batsman facing three overs from one or more ‘recognized’ bowlers (relevantly the batsman will face 18 balls), and hitting each of the 18 balls as far as the batsman can, including for six. A ‘virtual eye’ will be incorporated into the game and will provide a measurement of the distance each ball has been hit, and it could also measure the speed of each ball.

### Participant's Objective

Participants in the game choose 6 balls from the range of 18 balls. The participants chose their balls in order of which balls they believe are to be hit the greatest distance. For example a participant might choose, in order, balls 18, 5, 13, 1, 17 and 8.

The objective for a participant is to pick the ‘least picked’ balls to be bowled at the virtual batsman, ‘least picked’ by all the participants in the game.

The ‘least picked’ ball will carry the least weight when bowled at the batsman and will, when the virtual game is broadcast, become the cricket ball that is hit the furthest by the virtual batsman.

The second ‘least picked’ ball will carry the second least weight, and will become the cricket ball that is hit the 2^{nd} furthest by the virtual batsman, and so on for the other 16 balls.

All 18 balls will be ascribed a unique ranking or placement value based on how many times each ball was picked by all the participants in the game in the same way as we have described in other examples referred to herein (e.g. see Example 5.2 Table 19).

A participant's prime objective is to avoid eliminations by correctly picking as his/her first cricket ball, the ball that is to become the furthest hit by the virtual batsman, and then correctly choosing the 2^{nd}, 3^{rd} and 4^{th} furthest hit balls, or as close as the participant can get to those results.

There may be no participants that correctly choose in order all six balls most furthest hit. As set out previously herein the invention provides that the participant with the next ‘best choice/s’ ultimately becomes the winner of the game's major prize (e.g. see Example 4.9 participant P.1), The methods described herein insure that a winner can be determined.

### Conducting the Game

Tickets in the virtual cricket game are sold over a defined period, usually of short duration, and are matched to a T20 or one day cricket game. Tickets are sold prior to and during the relevant cricket game, with ticket sales occurring over the internet, mobile phones or other forms of mobile/remote entry and with ticket sales being closed at the commencement of half time of the relevant game.

Ideally the virtual cricket game is then broadcast during the half time break of the relevant T20 or one day game and prizes are paid to the relevant winners, with one winner receiving the major prize.

### EXAMPLE 8

### Example 8.0

### Other Variations of Example 7

It will be appreciated that there are numerous variations that could be made to the gaming event described in Example 7 above. For example, the methods described in the virtual cricket gaming event could be adapted for application in virtual games of:
Baseball (longest hitting/home runs)
American Football (yards gained or thrown)
Golf (longest drives)
Olympic Sports such as the shot put, discuss or javelin (longest throws)

### EXAMPLE 9

This example expands on the existing ranking process of the above games where the least or alternatively most picked symbol/s or number/s are determinative of what participant/s win/s the game.

This Example 9 sets out a further application of the invention that requires this to be done 6 times on a single game sheet.

Each of the 6 ‘rounds’ will run as one of a series of games, which together comprise the whole game. The winner(s) will be those that picked the least picked, or alternatively, most picked symbols or numbers in all 6 rounds overall, or in some other variation where the results can be used to determine one or more winners consistent with the methods described herein above.

Various prize options could be available for winners of 1 or more rounds, and the overall winner or winners.

FIG. 9 contains an example of two player entry cards, the entry card identified under Table A is in respect of a participant that has selected number 17 in each of the six rounds of games. Table B is in respect of a participant that has selected different numbers in each of the six rounds of games.

### EXAMPLE 10

### Casino Card Game

A further example of the use of our gaming system invention is the use of it in casino type games. For example, in a computer game involving cards.

### Example 10.0

### A Card Game (Number Range 1 to n, where n=14)

The following describes a use of the gaming system in a casino card game. It will be apparent that the cards carry or are symbols, which in fact represent numbers. As will be apparent to a person skilled in the art, the techniques described in this example could be used to provide other casino type games using symbols and/or numbers on media other than cards.

FIG. 10a shows a simple world map with a game server (50) at a selected location. Linked to the server (50) are a number of hubs (51). These hubs represent casino or gaming operators. In FIG. 10a 13 hubs are shown but of course this number can be any suitable chosen number. From each hub (51) depend a number of gaming terminals (52). In the drawing each hub is shown with two to four gaming terminals but of course in reality the number of gaming terminals (52) would be far greater, perhaps hundreds or more.

FIG. 10b shows the arrangement of FIG. 10a in more detail, and in for example a casino operation. A national operation is shown in New Zealand with two casinos. Each casino has a number of gaming terminals (52) feeding back to a hub (51). The hubs are linked via the internet to hubs (51) and gaming engines (52) in other countries which can be located in any secure location.

FIG. 10c shows a possible promotional poster for a casino card game using the methods of the invention. The aim is to select cards least selected by other players and will be described further hereinafter in this Example 10.

### Example 10.1

### Assumed Card Game Profile

in this example, to demonstrate how the gaming system can operate in respect of a casino card game involving [14] cards, it is assumed that:
The card game is called “Diamond Cut”;
The card game is played by way of a number of first phase games, and one second phase game (the Super Card Game);
Entry into the Super Card Game can only be attained by correctly choosing the winning (first ranked) card in a first phase game;
The first phase games are played a number of times a day, we assume 10 times per day;
The Super Card Game is played every third day—after 30 first phase card games, although it could be played more or less frequently;
Each player enters through a first phase card game by choosing, in anticipated winning order, 6 different cards from a range of [14] diamond cards (including a Joker) and pays a total cost of $10 for his/her entry;
The [14] diamond cards in order of 1-14 are: A♦; 2♦; 3♦; 4♦; 5♦; 6♦; 7♦; 8♦; 9♦; 10♦; J♦; Q♦; K♦; and the Joker.
On average, 1,000 players enter each first phase card game of “Diamond Cut”;
Any cards in the range of [14] cards that are not be chosen by any player are ignored;
Each of the [14] cards is also given a unique number, being number 1, 2, 3 and so forth, up to number [14], so that the computer system can easily recognize each of the [14] cards in the game;
The card that is chosen the least is to be the first placed/ranked card in a ranking list comprising the [14] cards, the second least chosen card will be the second placed/ranked card, and so forth with the most chosen card placed/ranked last in the ranking list;
In this example, the 11 card (J♦) is the card that is chosen the least by all the 1,000 players in the card game as their first choice card, and therefore is the first placed/ranked card in the ranking list of the 14 cards;
There are 59 players that have chosen card J♦ as their first choice card on the basis that it will be the least picked, and which is the least picked first choice card by all the 1,000 players in the game;
Those 59 winning players who all correctly chose the first placed/ranked card (i.e. the least picked, being the J♦) each receive one entry into the Super Card Game—one Super Card Game entry comprising an entry with 6 different cards randomly chosen from the [14] available card choices.
Ties in the ranking list between any of the [14] cards are ALL resolved—see Example 10.3 below.
The 59 winning players are then subject to further eliminations using, as necessary, the players other choices of cards and comparing some or all of those choices against the ranking list of some or all of the 14 cards so that a winner/s is/are determined.
The Super Card Game is played in an identical fashion to the first phase games.
Revenues: The total revenue from each first phase card game is $10,000 ($10×1,000 entries);
Guaranteed Prizes: The ‘guaranteed’ available prize pool over all games (first phase and the associated Super Game) is 40% of total revenues. Total ‘guaranteed’ prizes available from each first phase card game is therefore $4,000—from which half ($2,000) is set aside to accumulate for the ‘guaranteed’ prizes in the Super Card Game. The balance of $2,000 is paid out to the winning players of the relevant first phase game;
Extra Prizes—Super Game Only: In addition to the ‘guaranteed’ prizes available in the Super Card Game, additional extra prizes will be paid to players in the Super Game that have on their entries, in order, the first 4 ranked cards ($50,000), and/or 5 cards ($500,000), and/or 6 cards ($5,000,000) in the Super Game—see Example 10.14.
The cost of these extra prizes is a cost borne by the gaming operator. This is calculated at 9.25% of ALL revenues and has been calculated by reference to the estimated cost of obtaining third party insurance, using a rate of 2 times the insured risk—see Example 10.14.

### Player's Objective

Pick 6 different cards from a range of [14] cards, where each card picked is picked to be one of the ‘least picked’ cards picked by all the players in the relevant first phase game.

The ‘least picked’ first choice card will be placed or ranked first in the ranking list of the [14] cards. The second least picked first choice card will be ranked second, and so on.

A player's objective is at least twofold:

Firstly: to avoid initial elimination in a first phase game by correctly picking as his/her first card choice, the card that is to become ranked 1^{st}—thereby winning a monetary prize and gaining entry into the Super Card Game (which has big ‘guaranteed’ prizes that will be won, and even bigger extra prizes that may be won), and remaining eligible to continue in the first phase game and compete for its first prize;

Secondly: to avoid further eliminations in the first phase game by correctly picking as his/her,
second card choice, the card that is to become ranked 2^{nd}, and
third card choice, the card that is to become ranked 3^{rd}, and so on.

Any failing by players to correctly chose a relevant card placement is of no effect in respect of determining the winner as the player/s with the next best choice/s ultimately becomes the winner of the first phase game's major prize.

Entry into the Card Game

Entry into the card game when players are in a casino offering “Diamond Cut” can be through a gaming machine, internal kiosk, or ATM or POS machine located within the casino. Additionally this game is suitable for offerings by internet gaming operators, where players can enter by computer over the internet, or by mobile phones and/or devices such as iPhones, iPads and androids.

### Example 10.2

TABLE 31
Example 10.2 - Results of a First Phase Card Game played by
1,000 Players - One Data Set from the First Card Selections

| BY RANKINGS | | | BY CARDS | | |
|---|---|---|---|---|---|
| RANK- | | | | | RANK- |
| INGS | NUMBER | | | NUMBER | INGS |
| OF | OF | | | OF | OF |
| LEAST | TIMES | CARD | CARD | TIMES | LEAST |
| PICKED | CHOSEN | CHOSEN | CHOSEN | CHOSEN | PICKED |
| 1^{st} | 59 | J♦ | A♦ | 63 | 3^{rd} |
| 2^{nd} | 61 | K♦ | 2♦ | 81 | 13^{th} |
| 3^{rd} | 63 | A♦ | 3♦ | 71 | 7^{th} |
| 4^{th} | 65 | 9♦ | 4♦ | 76 | 10^{th} |
| 5^{th} | 67 | 7♦ | 5♦ | 80 | 12^{th} |
| 6^{th} | 68 | Joker | 6♦ | 73 | 8^{th} |
| 7^{th} | 71 | 3♦ | 7♦ | 67 | 5^{th} |
| 8^{th} | 73 | 6♦ | 8♦ | 77 | 11^{th} |
| 9^{th} | 74 | 10♦ | 9♦ | 65 | 4^{th} |
| 10^{th} | 76 | 4♦ | 10♦ | 74 | 9^{th} |
| 11^{th} | 77 | 8♦ | J♦ | 59 | 1^{st} |
| 12^{th} | 80 | 5♦ | Q♦ | 85 | 14^{th} |
| 13^{th} | 81 | 2♦ | K♦ | 61 | 2^{nd} |
| 14^{th} | 85 | Q♦ | Joker | 68 | 6^{th} |
| | 1,000 | | | 1,000 | |

### Example 10.3

### Resolving Ties (Between the 14 Cards) within the Ranking System

While the above Example 10.2, Table 31 does not have any ties, it will be inevitable that ties will occur where two or more cards within the 14 cards used in this example are chosen exactly the same number of times by the players in the game. Multiple numbers of ties between cards could also occur. In this Example 10 of the game, it is preferable that all ties are resolved.

While there will be a number of ways to resolve ties, such as by using a random method, the preferred way to resolve all ties is to use the unpredictability of the results of all the players' choices in the card game itself, by using the resulting ‘odds’ and ‘evens’ that arise for each of the 14 cards—as set out in the column headed “NUMBER OF TIMES CHOSEN” in Example 10.2—Table 31 above (the “Selection Total”).

Referring to Example 10.2—Table 31, it will be apparent that each of the 14 cards have been chosen a certain number of times and that this results in either an odd numbered Selection Total or an even numbered Selection Total, representing the number of times each of the 14 cards was chosen. Whether a card to be chosen within the range of 14 cards is going to end up being chosen a number of times that is either an odd or even Selection Total number is entirely unpredictable, and is a chance result. This chance result creates a unique method to resolve ties that arise in this exampled card game.

In this example, to resolves ties, an even number Selection Total will result in the lowest face value relevant to a tied card being ranked ahead of the higher face value numbered card. An odd number Selection Total will operate in reverse. For example if the following cards (cards 2♦, 10♦, Q♦ and the Joker) were in a four-way tie with the same Selection Total number of, for example, 71, which is an odd Selection Total number, then the order of the four tied numbers becomes the Joker, Q♦, 10♦ and 2♦.

This process or concept is further explained in FIG. 3.

### Example 10.4

### The Elimination Processes—to Determine the Winning Player of a First Phase Game

The First Elimination: The first elimination process involves reducing the players in the game from 1,000 to a much lower number. This occurs by eliminating all players other than those players that chose card J♦ as their first card choice, which is the card that was least picked by all the 1,000 players in the game, as it was chosen 59 times and became ranked first—see Example 10.2—Table 31.

Calculations:

With 1,000 players in the first phase card game, divided by the number of cards available for players to choose [i.e. 14], results in an average of approximately 71 players per card. Some of the [14] cards will be chosen more times, other cards less. In this example, it is assumed that there are 59 players that have chosen card J♦ as their first card choice and which are therefore not eliminated. These players continue to the second elimination.

The Second Elimination:

The second elimination process involves reducing the remaining 59 players from 59 to a much lower number. This is done by eliminating from the remaining 59 players, all players except those that also chose card K♦ as their 2^{nd} card choice, which is the card that was the second least picked card by all the 1,000 players in the game, as it was chosen 61 times and got a ranking of 2^{nd} place—see Example 10.2—Table 31.

Calculations:

With 59 players remaining in the card game, divided by the remaining number range of 13 (as card J♦ has now gone), results in an ‘expected’ average of approximately 4½ players per the remaining 13 cards. In this example, it is assumed that there are 5 players from within the group of 59 remaining players that have chosen card K♦ as their 2^{nd} card and which are therefore not eliminated. These five players continue to the next elimination step.

Note:

In the calculations above, we have assumed 5 players remain non-eliminated following the second round of eliminations, which is a number pool that is greater than the ‘expected’ average of 4½. This is to recognise that from the second eliminations onwards, it is possible to have a remaining pool of non-eliminated players that is greater than the ‘expected’ average, and it is possible that the remaining non-eliminated pool is much greater than the ‘expected’ average. (This applies to our other examples as well). In this Example 10, this can occur in the event that the non-eliminated players remaining after the first elimination phase (in this example 59 players) also substantially or mostly all also picked as their second card choice, the card that was the second least picked card and which was ranked 2^{nd} in the ranking list of the 14 cards.

However, this eventuality is extremely unlikely to ultimately affect the ability of the “Diamond Cut’ card game to identify a single winner, as the odds of correctly choosing 6 different cards from a range of 14 cards is 1 in 2,162,160—see FIG. 7a.

Further, the odds against there being multiple winners, is greater than this. The odds of: a double event (two entries that correctly chose the same 6 winning cards) is 1 in 3,628,105 (Calculation: the odds to one×1.678—source: Scarne's New Complete Guide to Gambling, chapter 2, published by Simon and Schuster, New York, 1974; a triple event is 1 in 5,783,778—(Calculation: the odds to one×2.675); a quad event is 1 in 7,939,452—(Calculation: the odds to one×3.672); and a quint event is 1 in 10,097,287—(Calculation: the odds to one×4.670).

Further eliminations—The Ranking System:

By this time in this example with about 5 players remaining, those small number of remaining players can be ranked using their 3^{rd} chosen card, and 4^{th}, 5^{th} and 6^{th} if necessary, to determine the winner/s.

When considering Example 10.6, Table 33 below, the 6 card choices of the best 10 performing players are set out in Example 10.5, Table 32 below. We have set out the Top 10, as this is consistent with our prior examples and, as previously described, the invention can rank every entry in a game using the methods described herein.

### Example 10.5

TABLE 32
Top 10 Players' chosen Cards [by reference to the
assigned card symbol]

| | 1^{st} | 2^{nd} | 3^{rd} | 4^{th} | 5^{th} | 6^{th} |
|---|---|---|---|---|---|---|
| | Card | Card | Card | Card | Card | Card |
| | Choice | Choice | Choice | Choice | Choice | Choice |
| Player | J♦ | K♦ | 9♦ | Q♦ | 2♦ | 5♦ |
| P.1 | | | | | | |
| Player | J♦ | K♦ | Joker | A♦ | 9♦ | 7♦ |
| P.2 | | | | | | |
| Player | J♦ | K♦ | 4♦ | A♦ | Q♦ | 2♦ |
| P.3 | | | | | | |
| Player | J♦ | K♦ | 2♦ | Joker | 9♦ | 8♦ |
| P.4 | | | | | | |
| Player | J♦ | K♦ | Q♦ | A♦ | Joker | 9♦ |
| P.5 | | | | | | |
| Player | J♦ | A♦ | K♦ | 9♦ | 6♦ | 5♦ |
| P.6 | | | | | | |
| Player | J♦ | A♦ | K♦ | Joker | 2♦ | 5♦ |
| P.7 | | | | | | |
| Player | J♦ | A♦ | K♦ | Joker | Q♦ | 9♦ |
| P.8 | | | | | | |
| Player | J♦ | A♦ | 2♦ | K♦ | 3♦ | 9♦ |
| P.9 | | | | | | |
| Player | J♦ | 9♦ | Joker | K♦ | Q♦ | 7♦ |
| P.10 | | | | | | |

### Example 10.6

TABLE 33
Determining the winning “Diamond Cut” player - (and the Top 10)

| (all ranked | No. of Players | | | | | | | | | | |
|---|---|---|---|---|---|---|---|---|---|---|---|
| from 1^{st} to | | | | | | | | | | | . . . To P. |
| 1,000^{th}) | P.1 | P.2 | P.3 | P.4 | P.5 | P.6 | P.7 | P.8 | P.9 | P.10 | 1,000 |
| 1^{st} Ranked | 59 | 59 | 59 | 59 | 59 | 59 | 59 | 59 | 59 | 59 | 59 |
| Card: J♦ | | | | | | | | | | | |
| (no of times | | | | | | | | | | | |
| chosen by | | | | | | | | | | | |
| all players | | | | | | | | | | | |
| in game) | | | | | | | | | | | |
| 2^{nd} Chosen | 61 | 61 | 61 | 61 | 61 | 63 | 63 | 63 | 63 | 65 | c. 5 |
| Card | | | | | | | | | | (10^{th}) | left |
| 3^{rd} Chosen | 65 | 68 | 76 | 81 | 85 | 61 | 61 | 61 | 81 | 68 | By |
| Card | (1^{st}) | (2^{nd}) | (3^{rd}) | (4^{th}) | (5^{th}) | | | | (9^{th}) | | Rank |
| 4^{th} Chosen | n/a | n/a | n/a | n/a | n/a | 65 | 68 | 68 | n/a | n/a | |
| Card | | | | | | (6^{th}) | | | | | |
| 5^{th} Chosen | n/a | n/a | n/a | n/a | n/a | n/a | 81 | 85 | n/a | n/a | |
| Card | | | | | | | (7^{th}) | (8^{th}) | | | |
| 6^{th} Chosen | n/a | n/a | n/a | n/a | n/a | n/a | n/a | n/a | n/a | n/a | |
| Card | | | | | | | | | | | |
| Extra Cards | . . . | . . . | . . . | . . . | . . . | . . . | . . . | . . . | . . . | . . . | |
| can be | | | | | | | | | | | |
| added into | | | | | | | | | | | |
| the game if | | | | | | | | | | | |
| needed. | | | | | | | | | | | |

As can be seen from Example 10.6, Table 33 above, Player P.1 is the sole winner.

### Example 10.7

### Use of Eliminations and/or the Ranking System

The Ranking System described in this invention, in particular as referred to in Examples 10.2 and 10.3 can be used to rank each players performance. So in this example of a card game played by 1,000 players, each player can be ranked, from 1^{st} place down to last place—i.e. 1,000^{th} place. Accordingly, in one aspect of the invention, the winner/s can be determined through this method. However, we believe it is preferable to have a group of winners (or class of winners) at various determined steps. Accordingly, we believe it is preferable to also undertake elimination steps as we have described in Example 10.4 above.

Depending on the number of players in a “Diamond Cut” card game as described in this Example 10, and assuming a repeating pool of 1,000 players, these elimination steps occur, as we have set out in Example 10.4 above, using firstly whether or not the players have correctly chosen the winning (first ranked) card, eliminating those that haven't, and then as relevant using the remaining non-eliminated players choices of their 2^{nd} and 3^{rd} cards and as may be necessary, the players 4^{th} card choice and so forth, until a ‘sufficiently small’ number of players remain.

What constitutes ‘sufficiently small’ may vary for each card game profile and will depend on the number of players in the game and the number of individual ‘major’ prizes that the gaming organizers want to award to successful players. For example, major prizes could be awarded to the Top 10 players.

In this Example 10 of the card game, which is a game with 1,000 players, we have continued the elimination processes up to and including the use of the 2^{nd} card choice, after which there are 5 players remaining that have both the first and second ranked (least picked) cards. Then the computer software ranks in order each of those last 5 players to determine the winner/s, ranking their performance against each other, with reference to the ranking system as set out in Example 10.2, Table 31. We have identified the Top 10 players for demonstration purposes only.

The winner/s of the major prizes in this example of the game could be just the sole winner P.1, or there could be additional prizes awarded to 2^{nd} and 3^{rd} places, or some other mixture as determined by the gaming operator. As we have previously stated, the gaming system can rank all participants in a game. So, for example, additional prizes could be awarded for set places, such as 8^{th}, 88^{th}, and/or 888^{th}, and/or last place.

### Example 10.8

### Alteration to ‘Ascribed Ranking Values’—Same results

Example 10.2, Table 31 above records all the players' first card choices from the [14] available cards and by doing so is able to ascribe a unique ranking value to each of the 14 cards. This ascribed ranking value is equal to the number of times that each of the 14 cards had been chosen by all the 1,000 players in the game as their first card choice. All the [14] cards available to be chosen in the game are ascribed a unique ranking value. To illustrate this—and with reference to Example 10.2, Table 31 which ranks all the [14] cards:
Card J♦ was the least chosen first card choice, so was therefore ranked first, with a ranking number of 59 (being the number of times that card J♦ had been chosen by all the 1,000 players in the game):
Card K♦ was the second least chosen first card choice, so was therefore ranked second, with a ranking number of 61 (being the number of times that card K♦ had been chosen by all the 1,000 players in the game); and so on as set out in Example 10.2, Table 31.

Alteration to Ascribed Ranking Value:

Instead of using the ascribed ranking value based on the number of times that each of the [14] cards had been chosen by all the 1,000 players in the game as their first card choice, the ascribed ranking value can be changed to equal the actual rankings or placement number of each of the [14] cards. To illustrate this—and again with reference to Example 10.2, Table 31 which ranks all the cards, and to Example 10.5, Table 32 which records the chosen cards of the top 10 players:
Card J♦ was the least chosen first card choice, so was therefore ranked first, with a ranking number of 59 (being the number of times that card J♦ had been chosen by all the 1,000 players in the game). Its ranking value is changed from 59 to 1^{st} i.e. a ranking value of 1;
Card K♦ was the second least chosen first card choice, so was therefore ranked second, with a ranking number of 61 (being the number of times that card K♦ had been chosen by all the 1,000 players in the game). Its ranking value is changed from 61 to 2^{nd} i.e. a ranking value of 2, and so on as set out in Example 10.2, Table 31.

Example 10.9, Table 34 below is the same as Example 10.6, Table 33, but now changed to show the change to using the ascribed ranking value of 1, 2, 3, etc as described above

### Example 10.9

TABLE 34
Determining the winning “Diamond Cut” player - Using
alteration to ascribed ranking value

| | No. of Players | | | | | | | | | | |
|---|---|---|---|---|---|---|---|---|---|---|---|
| | P.1 | P.2 | P.3 | P.4 | P.5 | P.6 | P.7 | P.8 | P.9 | P.10 | . . . To P. |
| (all ranked | | | | | | | | | | | 1,000 |
| from 1^{st} to | | | | | | | | | | | |
| 1,000^{th}) | | | | | | | | | | | |
| 1^{st} Ranked | 59 | 59 | 59 | 59 | 59 | 59 | 59 | 59 | 59 | 59 | 59 |
| Card: J♦ | 1 | 1 | 1 | 1 | 1 | 1 | 1 | 1 | 1 | 1 | |
| (no of times | | | | | | | | | | | |
| chosen by | | | | | | | | | | | |
| all players | | | | | | | | | | | |
| in game) | | | | | | | | | | | |
| 2^{nd} Chosen | 61 | 61 | 61 | 61 | 61 | 63 | 63 | 63 | 63 | 65 | c. 5 |
| Card | 2 | 2 | 2 | 2 | 2 | 3 | 3 | 3 | 3 | 4 | left |
| | | | | | | | | | | (10^{th}) | |
| 3^{rd} Chosen | 65 | 68 | 76 | 81 | 85 | 61 | 61 | 61 | 81 | 68 | By |
| Card | 4 | 6 | 10 | 13 | 14 | 2 | 2 | 2 | 13 | 6 | Rank |
| | (1^{st}) | (2^{nd}) | (3^{rd}) | (4^{th}) | (5^{th}) | | | | (9^{th}) | | |
| 4^{th} Chosen | n/a | n/a | n/a | n/a | n/a | 65 | 68 | 68 | n/a | n/a | |
| Card | | | | | | 4 | 6 | 6 | | | |
| | | | | | | (6^{th}) | | | | | |
| 5^{th} Chosen | n/a | n/a | n/a | n/a | n/a | n/a | 81 | 85 | n/a | n/a | |
| Card | | | | | | | 13 | 14 | | | |
| | | | | | | | (7^{th}) | 8^{th}) | | | |
| 6^{th} Chosen | n/a | n/a | n/a | n/a | n/a | n/a | n/a | n/a | n/a | n/a | |
| Card | | | | | | | | | | | |
| Extra Cards | . . . | . . . | . . . | . . . | . . . | . . . | . . . | . . . | . . . | . . . | |
| can be | | | | | | | | | | | |
| added into | | | | | | | | | | | |
| the game if | | | | | | | | | | | |
| needed. | | | | | | | | | | | |

As can be seen from Example 10.9, Table 34 above, the alteration to the ascribed ranking values to 1, 2, 3, and so forth makes no change. The “Diamond Cut” player (P.1) is the sole winner.

FIG. 11 shows, by way of an example in a series of computer printouts, a method of processing by a computer the results for a 1,000 participant card game which is relevant to this Example 10. In particular FIG. 11 shows the computer processing method to determine the top 10 in order, from which the winner can be determined, together with 2^{nd} place down to 10^{th} as relevant—see FIG. 11h. This example set out in FIG. 11 can be easily scalable for any size game.

In FIGS. 11a to 11i the game using the 14 cards of Example 10 are matched with numbers 1-14. Each number represents a corresponding card.

Each player is presumed to have picked 6 cards (numbers). FIG. 11a shows ticket numbers in column 60 and in columns 61 the selected numbers, in order, for each ticket are displayed. It is assumed that this is a game being played in a casino. The casino identity is displayed in column 62 along with a geographic location in column 63. Table 64 replaces the 14 numbers by the equivalent card and indicates the correspondence between card and number and the number of hits (picks) each card received in the game as a players' first choice card. In table 65 the cards have been re-ordered into a ranking list with the least hit (picked) card ranked first. Any ties are resolved as described herein and a final list displayed in table 66. In this example no ties needed to be resolved.

In FIG. 11b it is noted that card 4 was the least chosen and 58 participants chose that card. This is shown in table 66. Attention then passes to the second chosen card, being number 2, there being four persons who chose 4 as the first card and 2 as the second. Attention will then move to the third card and if necessary fourth card chosen and so on until a winner or small number of winners are found.

Table 67 tabulates these results and adds the city of the participant.

FIG. 11c repeats table 66 and adds the corresponding table for the second card at 68.

Table 69 in FIG. 11d relates to the third card.

FIG. 11e repeats this for the fourth card in table 70. FIG. 11f adds the fifth card in table 71, and table 72 for the sixth card in FIG. 11g.

Tables 69 to 72 are blank as no player in this example had correctly chosen: the 1^{st}, 2^{nd} and 3^{rd} cards (table 69); the 1^{st}, 2^{nd}, 3^{rd} and 4^{th} cards (table 70); the 1^{st}, 2^{nd}, 3^{rd}, 4^{th} and 5^{th} Cards (table 71); the 1^{st}, 2^{nd}, 3^{rd}, 4^{th}, 5^{th} and 6^{th} cards (table 72).

Table 66 in FIG. 11h repeats previous table 66 but also shows the card corresponding to each number up to the sixth least picked number. Table 74 shows the top ten winning tickets and table 75 shows the final result with cards replacing numbers.

FIG. 11i shows “special results” which can be determined by the ranking list previously formed. Thus sub winners are selected for geographic areas such as Auckland and Queenstown. Of course other sub groups could be selected such as a casino or a gaming machine in a casino.

FIGS. 12a to 12d show similar games but where the cards of FIG. 11 are replaced by horses, dogs, cars and speedboats respectively.

### Example 10.10

### Fallback Position—Ties Involving Winning Players

The above illustrated elimination processes using the six card choices of the players should ensure that the elimination process to determine one sole winner can be fully completed and no fallback position should ever be necessary.

While this gaming system guarantees a winner, a joint winner is possible but unlikely. In this example of the card game “Diamond Cut”, once a winner is determined (using the full set of 6 card choices from the 14 cards if required), the chances of one or more other players having also chosen in order the exact same 6 cards as chosen by the winning player is/are remote, as the odds of correctly choosing the 6 cards in order are 1 in 2,162,160—see FIG. 7a.

The odds of:
a double event occurring (two entries that correctly chose the same 6 winning cards) is 1 in 3,628,105 (Calculation: the odds to one×1.678—source: Scarne's New Complete Guide to Gambling, chapter 2; Published by Simon and Schuster, New York, 1974); a triple event occurring is 1 in 5,783,778—(Calculation: the odds to one×2.675); a quad event occurring is 1 in 7,939,452—(Calculation: the odds to one×3.672); and a quint event occurring is 1 in 10,097,287—(Calculation: the odds to one×4.670).

However, to provide for the situation where the above illustrated elimination processes does not achieve one sole winner, then if two or more players remain and can't be eliminated or separated using their six chosen cards, then those tied winning players share in proportion as between them the relevant prize/s.

### Example 10.11

TABLE 35
Example 10.11 - Exampled Prize Winnings for First Phase “Diamond
Cut” Card Games with 1,000 entries of $10 each

| | Maximum | Prizes per | | |
|---|---|---|---|---|
| | Number of | Ticket | Total | % of |
| Elimina- | Players | (Tickets cost | Maximum | $4,000 |
| tion | in each | $10 per | Amount of | Prize |
| Factors | stage | entry) | Prizes | Pool |
| | 1,000 | n/a | n/a | n/a |
| (÷14) 1^{st} Card | 71 | $10 + Super | $710 | 17.75% |
| | | Game Entry | | |
| (÷13) 2^{nd} Card | 5 | $40 + above | $240 | 6.00% |
| (÷12) 3^{rd} Card | Winner | $1,000 + | $1,000 | 25.00% |
| | | above | | |
| (÷11) 4^{th} Card | | | | |
| (÷10) 5^{th} Card | | | | |
| (÷9) 6^{th} Card | | | | |
| To Last Place | | | $50 | 1.25% |
| To Super Game | | | $2,000 | 50.0% |
| Totals | | | $4,000 | 100% |

### Example 10.12

### The Odds of Winning in a First Phase “Diamond Cut” Card Game

In this Example 10, the odds of winning a prize in a first phase “Diamond Cut” game—in the first instance correctly choosing the winning (first ranked) card—is 1 in 14.

The odds of winning first prize in the first phase game—is equal to the number of players/tickets in the game—in this case, it is 1 in 1,000.

### Example 10.13

### Incorporation of a “Super Game”

As can be seen from Example 10.11, Table 35 above (last entry), the game includes a Super Card Game, which receives an allocation of funds from each first phase game's prize fund for prizes in a later Super Card Game that is to be run following a series of first phase games, for example, every third day, following the completion of 30 first phase “Diamond Cut” card games.

The Super Card Game involves the same identical processes of eliminations and winning as applicable to a first phase card game/s.

The participation by players in the Super Card Game is only achieved by:
Purchasing a ticket in a first phase card game: and
Correctly picking the winning card (i.e. the 1^{st} ranked card) in a first phase game.

The number of tickets/entries a player can have in the Super Card Game is based on how many times a player correctly chooses the winning (first ranked) card in one or more of the first phase games.

### Random Allocation of the 6 Cards for the Super Game

The 6 cards allocated to each successful player for the Super Card Game are randomly allocated to those ‘first phase’ players that correctly pick the winning (1^{st} ranked) card for the relevant first phase card game. This random allocation is to ensure that no player can stipulate what cards he or she wants to choose for the Super Card Game, thereby ensuring the integrity of the Super Card Game result.

Preferably the entry ticket into a first phase game has a random entry generated on it for the Super Card Game, which only becomes ‘live’ in the event that the first phase game entry correctly chooses the winning (first ranked) card in the first phase game.

In addition, to further ensure the integrity of the Super Card Game result and its delivery, the relevant 6 Super Game cards allocated to the relevant players from each first phase game are preferably not merged at any time into any combined set of data by the gaming operator until after the last first phase card game has been played, and the results of the Super Game are to be determined.

### Example 10.14

### Super Card Game Prizes

The prizes available for the winner of the Super Card Game will be significantly higher than any first phase game.

Assume that:
The Super Card Game is conducted every third day, at the end of a cycle of 30 first phase games.
There are 30 first phase card games, with each game having the same participation of 1,000 players, entry cost of $10, and a winning profile as described previously.
In each of the 30 first phase card games, $2,000 is set aside—to accumulate for the Super Card Game prizes.
The process of winning the Super Game is the same as for the first phase games.
Guaranteed Prizes: at the end of the 30 first phase games, there is $60,000 available as a ‘guaranteed’ prize pool for Super Game prizes.
Extra Prizes: The following extra prizes may also be won in each play of a Super Card Game:

| | Odds (1 in . . .) | |
|---|---|---|
| Event | see FIG. 7a | Extra Prize Amount |
| First 4 Cards in order | 1 in 24,024 | $50,000 |
| First 5 Cards in order | 1 in 240,240 | $500,000 |
| First 6 Cards in order | 1 in 2,162,160 | $5,000,000 |

Cost to the Gaming Operator of Extra Prizes: The cost to the gaming operator of providing the three extra prizes as set out above, is calculated by us at 9.25% of ALL revenues from each relevant first phase game. It is a cost to the gaming operator. We have calculated this cost based on a third party insurer requiring a premium of 2× the insured risk. (Alternatively this could be self insured by the gaming operator). This calculation is set out in the table below:

| | | | | Ins Cost | Adjust Ins | |
|---|---|---|---|---|---|---|
| | | Total | | per each | cost per | Cost as a |
| | | Premium | | Entry in | ALL | % of each |
| | | (2 × ins | Odds | Super | entries | $10 entry |
| Event | Ins Amt | amt) | (1 in . . . ) | Game | ( 1/14^{th}) | fee |
| 4 in order | $50,000 | $100,000 | 24,024 | $4.1625 | $0.2973 | 2.973% |
| 5 in order | $500,000 | $1,000,000 | 240,240 | $4.1625 | $0.2973 | 2.973% |
| 6 in order | $5,000,000 | $10,000,000 | 2,162,160 | $4.6250 | $0.3304 | 3.304% |
| Total | | | | | | 9.250% |

### Example 10.15

TABLE 36
Example 10.15 - Exampled Prize Winnings for Super
Game - ‘guaranteed’ prize pool only.

| | Maximum | | | |
|---|---|---|---|---|
| | Number of | | Total | |
| | Players | Prizes | Maximum | % of |
| Elimina- | in each | per | Amount of | $75,000 |
| tion | stage of | Entry | Prizes (at | Prize |
| Factors | Super Game | Ticket | each stage) | Pool |
| | 71 maximum | n/a | n/a | n/a |
| | players per | | | |
| | week × 30 | | | |
| | weeks = 2,130 | | | |
| (÷14) 1^{st} Card | 150 | $100 | $15,000 | 25.0% |
| (÷13) 2^{nd} Card | 12 | $1,000 + | $12,000 | 20.0% |
| | | above | | |
| (÷12) 3^{rd} Card | Winner | $30,000 + | $30,000 | 50.00% |
| | | above | | |
| (÷11) 4^{th} Card | | | | |
| (÷10) 5^{th} Card | | | | |
| (÷9) 6^{th} Card | | | | |
| To Last Place | | | $1,500 | 2.5% |
| To costs | | | $1,500 | 2.5% |
| of running | | | | |
| Super Game/ | | | | |
| misc | | | | |
| Totals | | | $60,000 | 100% |

### Example 10.16

### The Odds of Winning the Super Card Game

The odds of winning a prize in a Super Card Game of “Diamond Cut” is dependent on the number of entries a player has in the Super Game—i.e. the number of times a player enters a first phase game and correctly chooses the winning card (i.e. 1^{st} ranked card) in the relevant first phase game.

For a player that has only one entry into Super Game, the odds of winning a minor prize in Super Game ($100) is 1 in 14.

The odds of winning the ‘guaranteed’ first prize in a Super Card Game (for the player with only one entry in Super Game and based on the assumptions set out in this Example 10), must be no more than 1 in 2,130.

A player with 1 entry in a Super Card Game has odds of at least 1 in 14 of winning a prize. The odds get shorter for each additional entry into Super Game that a player has. A player with 14 entries in the Super Game, comprising 14 different winning card choices (i.e the player has the field covered in his 14 first card choices) has odds of at least 1 in 1 of winning a prize, so is certain of winning at least the $100 prize.

Again based on the assumptions set out in this Example 10, the same player with 14 entries into the Super Card Game comprising 14 different winning (first ranked) card choices, has odds of no more than about 1 in c. 150 of winning the ‘guaranteed’ first prize in the Super Card Game.

In addition, the odds for an entry in Super Draw of winning the extra prizes are: First 4 cards in order are odds of 1 in 24,024; first 5 cards in order are odds of 1 in 240,240; and first 6 cards in order are odds of 1 in 2,162,160—see FIG. 7a.

### Example 10.17

### Cross Sold Regional/Area Card Game

It will be apparent to a person skilled in the art that the casino card game exampled in this Example 10 can be adapted for a card game to be offered and cross sold by a number of participating casinos from different areas and/or countries, using methods similar to those disclosed in Example 6. In addition, FIGS. 10a and 10b examples this.

This will have the advantage of significantly increasing the size of the player pool, the size of the guaranteed prizes, and potentially the size of the extra prizes offered in the Super Card Game.

As set out in Example 6, an advantage of our gaming system invention includes that in such a card game, an overall winner (and overall last place if desired) of the card game can be determined and separately, local area/casino winners (and local area/casino last places if desired) can also be determined.

### Example 10.18

### Variations to the Card Game

This example sets out a method to use the gaming system invention in a card game involving first phase games played each time by a pool of 1,000 players, followed by a Super Game for successful players.

As will be appreciated by a person skilled in the art, there will be many variations able to be made to the exampled card game using the methods relating to this invention.

For example, the exampled card game could be amended so that a ‘single player’ could play an instant first phase card game against a computer that uses a random generation of a set number (say 1,000) of other player/house entries (in place of other live players), followed by a Super Game for those successful players (including from the house) that played the first phase game using the instant method.

One of the benefits of altering the card game in this way would be that the entry or ticket price could be reduced for the ‘single player’, although there would need to be a reduction to the exampled prizes as set out previously in this Example 10.

### Example 10.19

TABLE 37
Example 10.19 - Backroom Calculations - Eliminations
The table below demonstrates that choosing 6 cards should be sufficient to
effect the necessary eliminations for most “Diamond Cut” card game sizes,
using a range of [14] cards, even if cross sold by a number of casinos.
Additional cards and choices can be added to the game if/as necessary.

| | No. Of Tickets/Players | | | |
|---|---|---|---|---|
| | 10,000 | 100,000 | 1,000,000 | 10,000,000 |
| Number Range | (÷14) | (÷14) | (÷14) | (1÷4) |
| Of Cards | | | | |
| 1-14 | | | | |
| 1^{st} Card | 714 | 7,140 | 71,400 | 714,000 |
| (÷14) | | | | |
| 2^{nd} Card | 55 | 550 | 5.500 | 55,000 |
| (÷13) | | | | |
| 3^{rd} Card | 5 | 50 | 500 | 5,000 |
| (÷12) | | | | |
| 4^{th} Card | Winners | 5 | 45 | 450 |
| (÷11) | | | | |
| 5^{th} Card | | Winners | 5 | 45 |
| (÷10) | | | | |
| 6^{th} Card | | | Winners | 5 |
| (÷9) | | | | |
| 7^{th} Card | | | | Winners |
| (÷8) | | | | |

### Example 11

### What are the Appropriate Ranges of n Symbols or n Numbers

The invention can be played using a range of 1 to n symbols or numbers from which each participant makes their one or more symbol or number choices. In Examples 1 and 2, this range of n numbers is 1-100,000, from which participants pick 10 different numbers. In Examples 3, 4 and 6, this range of n numbers is 1-30, from which participants pick 6 different numbers. In Example 5 (the virtual horse race example), the range of n numbers is 1-20 (being horses numbered 1-20); from which participants pick 6 different horses by picking their relevant number. In Example 10 (the card game), the range of n numbers/symbols is 1-14 (being cards Ace of Diamonds to King of Diamonds and the Joker); from which participants pick 6 different cards.

The appropriate range of n symbols or n numbers, and the number of picks that a participant is required to make on an entry has to be determined by the gaming operator to meet the relevant game's operating profile, in particular it must be determined with consideration given to the number of participants that may enter the game.

As will be apparent to anyone skilled in the art, if a very small number of n symbols or n numbers was chosen in respect of a game that was to involve a very large number of participants, then the object of the game may not be achieved in that the small number of n symbols or n numbers and number of participants would result in a large number of ties and a large number of joint winners. It would be unlikely that a single winner would emerge from such a game.

To illustrate this point, if a game was formulated with the range of n numbers being 1-7, and the number of picks to be made by each participant from the range of n numbers was picks each (in correct order), then the number of possible number combinations is 2,520—see FIG. 7a. Then, if the number of participants/entries in the game was 1,000,000, this would result in an average of approximately 396 participants for each possible number combination (each entry). Generally this would make a game as described above commercially impractical unless the promoter of the game wished a large number of winners for some purpose. For ease we have assumed that a participant=one entry ticket.

If the number of participants in a game is expected to be c. 1,000,000, then for our invention, the most practical range of n symbols or n numbers and the number of picks to be made by each participant would be a combination that results in a number of possible number combinations (by reference to FIG. 7a) that exceeds the 1,000,000 participants. By having the number of possible number combinations exceeding the expected number of 1,000,000 participants/entries, there is a greater chance that a single winner will emerge from the game (as opposed to 2 or 3 joint winners that would have to share first prize).

We believe that the most practical factor by which the number of possible number combinations needs to exceed the number of expected participants/entries to allow for a single winner and to meet the other requirements of games using our invention, is by a factor of at least 5.

Referring to FIG. 7a, using 1,000,000 participants as the number of entries into each game, and using the factor of 5 as the minimum buffer for a game using our invention, an example of a suitable minimum range of n symbols or n numbers and the minimum number of picks to be made on each entry would be:
n Number Range Pool (1-24) and 5 numbers to be picked in order—results in 5,100,480 possible number combinations.
n Number Range Pool (1-16) and 6 numbers to be picked in order—results in 5,765,760 possible number combinations.
n Number Range Pool (1-13) and 7 numbers to be picked in order—results in 8,648,640 possible number combinations.

To illustrate this point further, and referring to Example 5—which involves the virtual horse race for 20 horses—being an n number range of 1-20 with participants being required to pick 6 numbers (horses) in order from that 1-20 number range (in order 6/20).

The number of possible number combinations is therefore 27,907,200—see FIG. 7a.

The odds of:

a double event occurring (two entries that correctly chose the same 6 winning horses) is 1 in 46,828,281 (Calculation: the odds to one×1.678—source: Scarne's New Complete Guide to Gambling, chapter 2; Published by Simon and Schuster, New York, 1974);
a triple event occurring is 1 in 74,651,760—(Calculation: the odds to one×2.675);
a quad event occurring is 1 in 102,475,238—(Calculation: the odds to one×3.672); and
a quint event occurring is 1 in 130,326,624—(Calculation: the odds to one×4.670).

Using 1,000,000 as being the consistent number of entries into each play of the above exampled game (in order 6/20), then a joint winner is only likely to occur on average once every 46 games—the calculation being 1 in 46,828,281+1,000,000 entries. And if there were 5,000,000 consistent entries into each play, then a joint winner is likely to occur on average once in every 9 or so games—the calculation being 1 in 46,828,281+5,000,000 entries.

However, if the number of players increased to say 10,000,000, then a joint winner is likely to occur on average once every 4-5 games—the calculation being 1 in 46,828,281+10,000,000 entries. In this event, the gaming operator could make a change to the parameters of the above game if the operator wished to reduce the incidences of joint winners. For example, the operator could just increase the n numbers to, say, 1-22, which would result in the number of possible number combinations increasing from 27,907,200 to 53,721,360, and the incidences of joint winners would then only occur once every 9 or so games—(calc. 53,721,360×1.678+10,000,000).

Alternatively, the operator could require that the participants pick in order 7 numbers from 20, which would result in the number of possible number combinations increasing from 27,907,200 to 390,700,800—see FIG. 7a. This change would make it virtually certain that a sole winner would always eventuate. Using 10,000,000 as being the consistent number of entries into each play of an adjusted game (in order 7/20), then a joint winner is only likely to occur on average once every 65 or so games—the calculation being 1 in 390,700,800×1.678+10,000,000 entries.

Number combinations of about 30-50 times the expected number of participants, or even greater, could be used, without affecting the ability of the gaming system to determine a winner. In a practical sense, the greater the number of number combinations to participants/entries, reduces the chances of there being two or more joint winners, has no affect on being able to determine a winner of the first prize from each game, and makes a sole winner virtually certain.

### VARIATIONS

Some of the examples show a single transaction engine and a single gaming or lottery engine. Although it is possible to combine both processes in a single computer we prefer not to do this as it might compromise security. It is possible to have a number of separate transaction engines feeding data to a common gaming or lottery engine. For example a single high value game may be run with contestants able to enter by a variety of routes at the same time.

Further, the transaction engine and the gaming engine described above can be duplicated and held and controlled by an independent party in order for that party to be able to simultaneously receive gaming data, to independently determine for itself the gaming results, and then to check the gaming results of the gaming operator against its own determinations, and to produce an independent audit report of this. The game may be run in combination with other promotions, and may include spot prizes. For example spot prizes could be awarded to each ten-thousandth entrant, or for the participant's place in the queue. As an example, a spot prize might be awarded for the participant number 9999, or participant 88,888 (to reflect the Chinese preference for the lucky number 8) or some other group of numbers, reflecting the ethnic mix of the participants, or the promoters desire to encourage rapid participation in the game—in which case an entry by email would be time stamped, as would an entry by telephone or ATM, each time stamped entry would be forwarded to the gaming or lottery engine and processed in turn based on each entry's time stamp. Each time stamp should also show the identity of the originating transaction engine so that when a winning entry (and any other runner up entries) is/are determined at the close of the game, the gaming or lottery engine can communicate with the relevant transaction engine to identify the winner(s).

In the claims we refer to “the participants are invited to select at least one number” but the participants need not enter the number themselves, as one option is for participants to allow the system to use a random number generator to select the number/s from a defined range of n numbers, for participants.

It will be appreciated that the parameters of the game can be varied in many different ways, for example the potential pool of numbers 1 to n may be varied depending on the potential population having access to the game—and we have address issues relating to this in Example 11. Numbers to be selected by participants could be in the form of number equivalents such as represented by a ‘character’ or thing, with the computer program recognising the relevant selected ‘character’ and treating it in the same ways as set out in the examples. An example is the use of the gaming system in virtual racing, such as horse racing where the selections could be made on a horse's name, as opposed to a number.

Furthermore, it will be clear that there are many variations to the above alternatives, including: changes could be made to the game as set out in Examples 3, 4 and 6 which have participants selecting 1 PRIMARY number and 5 SECONDARY numbers. For example:
the game could be altered so that there could be two or more PRIMARY numbers to be selected in order to increase the chances of a participant having a winning selection;
changes could be made to the above exampled block of numbers comprising six numbers, to comprise a greater or lesser amount of numbers;
changes could be made to whether or not the order in which participants choose their numbers was or was not important;
changes could be made to allow for different ticket pricing. Examples 3, 4 and 6 assume a ticket price of $10 for each pick of 1 PRIMARY number and 5 SECONDARY numbers. In order to allow for ticket prices of say $2, a change could be made to Examples 3, 4 and 6 whereby for those participants who want to play but only want to spend $2, then those participants have to pick one additional number from a separate qualifying number range of 1-5. These $2 entry participants purchase 1 PRIMARY number and 5 SECONDARY numbers for the cost of $2 but their entries only then qualify for prizes in the main game provided that they first correctly pick the winning number in that additional qualifying number range of 1-5. Consistent with the methods set out herein, the winning number in that additional qualifying number range of 1-5 will be the number that is least picked by those $2 entry participants.
Changes could be made to the Super Game examples set out in Examples 3, 4 and 6 and the Super Race example set out in Example 5. A change could be made so that each week all the funds accumulated in the Super Game or Super Race account were able to be won in a weekly game or race. These funds would only be able to be won in the event that a participant or punter in a weekly game had correctly chosen, in order, all 6 numbers (or in the case of Example 5, correctly chosen in order all 6 horses).
The game need not have a monetary prize but could be used as a promotional tool to choose the winner or winners of a prize such as a car, stereo, or other item. Alternatively, the gaming system and methods set out or referred to herein could be used in games that have no entry fee and no monetary prizes (or money equivalent) such as the successful game known as ‘Farmville’ that is played by participants on Facebook.

### Optional Preliminary Eliminations:

Referring to Example 5, to accommodate those participants that may have difficulty in paying the entry fee of, say $10, an entry could be purchased for, say, $3. This cheaper entry could be subject to a preliminary elimination round. This could be achieved by requiring the purchaser of the cheaper $3 entry to pick a further symbol, such as to pick a number from 1 to 4, or a colour, or other symbol from a set of 4 colours or symbols. Entries which select the preliminary number or symbol least selected from the range of 4 choices would progress to the main part of the game where their chosen six horses would take a full part in the remainder of the virtual horse race game as above described in Example 5. So a $3 entry could participate as a full $10 entry provided that it survived the preliminary elimination round.

A game using this preliminary elimination can be described as a game involving the participants picking from two sets of symbols, one or more symbols from each set.

An example of such a game involving the participants picking from two sets of symbols is one where participants are required to pick one ‘r’ number from a set of 4 numbers in the range of 1-4, and to separately pick six ‘r’ numbers from a set of 20 numbers in the range of 1-20. This example is relevant to the $3 entry and the preliminary eliminations described above.

### Substantial Additional Prize—Insurance or Self Insurance

The invention includes the ability for the gaming operator to offer, at a relatively affordable cost to the participants and to the gaming operator, a ‘substantial additional prize’ in Super Draw (i.e. a game the entry to which is achieved by winning a prize in a first or preliminary game) that ‘may’ be won, in addition to the prizes on offer in Super Draw that the gaming system guarantees ‘will’ be won.

For example, using the example set out in Example 5—the Virtual Horse Race involving a participant selecting in order 6 horses from a field of 20 horses. This ‘substantial additional prize’ can be set in reference to the winner of Super Draw correctly choosing in order the 6 winning symbols (horses) in the Super Draw/Race, in which case the ‘substantial additional prize’ will then become payable. The odds against a participant correctly choosing in order the 6 winning horses are 1 in 27,907,200—see FIG. 7a. To illustrate this advantage, the cost to insure a ‘substantial additional prize’ of, say $50 million—calculated on a per entry into Super Draw basis (with the original entry costing a participant $10) is an insurance premium of c. 2 times the risk. A premium of 2 times the risk means that the insurer wants to receive $100 million in premiums from the sale of 27,907,200 entries (paid as entries are sold) in exchange for insuring the event for $50 million. In other words the insurer charging a premium of 2 times the risk expects that on average the insured amount of $50 million would go off once every 27,907,200 entries. The insurance premium cost for the gaming operator would therefore be approximately $3.58 per entry, or 35.8% of an original $10 entry fee. At $3.58 per entry×27,907,200 entries=$100 million (rounded). This insurance is expensive and would in most cases be cost prohibitive. Self insurance can in one sense reduce the ‘insurance cost’ provided events transpire in accordance with expected probabilities, but exposes the gaming operator to greater risk in the event that the promised event occurs earlier than planned for, and/or more frequently than expected. However, an advantage for the gaming operator and the participants when using this method of this invention as above described and offering such a ‘substantial additional prize’ of $50 million to be paid as an additional prize if an entry correctly chose in order the 6 winning horses, paid by insurance, is that the $3.58 insurance cost applicable to each entry that makes the Super Draw, can be ‘spread’ against all the entries in all the first phase games, as each of those entries would have been made on the basis of attempting to gain entry into Super Draw and thereby to gain access to the ‘substantial additional prize’ of $50 million. The cost of providing this ‘substantial additional prize’ would then be no more than $0.1792 per entry, (and even less if self insured) being an amount easily absorbed within the costs of the overall game. So while the cost to cover any ‘substantial additional prize’ of $50 million on a per entry in Super Draw basis would be of itself high ($3.58, or 35.8% of the relevant entry fee), when spread over all the participants in the first phase games, that cost becomes low ($0.18, or 1.8% spread over each entry fee), which is calculated on the basis that a maximum of 5% of all entries can become eligible for Super Draw).

Finally various other alterations or modifications may be made to the foregoing without departing from the scope of this invention.

### ADVANTAGES

### Numerous Entry Methods, Including by Remote Entry

One of the advantages of this gaming system is that it can be operated through numerous entry methods. For example, via a message sent in many ways, including by mail, by fax, by email, by SMS or WAP, or by logging into a server on the internet, or by entry through a machine such as a gaming machine, kiosk, lottery terminal, ATM or POS machine, or through a registration process, or via telephone. In either of these cases the participants may have purchased a number of potential entries in advance, or pre-registered and established a credit balance with the operator, or may wish to pay by credit card, or some other rapid payment system.

Low Cost and Convenience:

The preferred embodiments of this invention making use of remote entry such as by telephone or email or SMS, enable a gaming or lottery system to be run at low cost, as it does not need to have established a wide network of resellers with physical premises such as convenience stores, or to issue pre-printed tickets or receipts (although simple printed receipts are possible as in the ATM or POS examples), as the entry and the billing process can be handled for example through participant's telephone accounts or the participant's accounts with the gaming operator. The cost of entry can be debited to a participant's telephone account, or the cost can be debited to a participant's gaming account in circumstances where participant's have pre-registered and/or have built up a credit with the gaming operator. This reduces the barrier to entry to a gaming event, particularly where the event may be televised, as participants may respond directly to a television advertisement, by entering the competition using their home telephone, mobile phone or email. In some cases users may have, for convenience, chosen a particular set of numbers which they have stored on their mobile phone or computer, and which they use each time they enter a new game which further favours remote entry.

Easy to Notify Winners:

By using the caller's telephone number, credit card, email address, mobile phone number etc., (from the mode of entry) as the participant's identification, the incidence of unclaimed prizes should be reduced. Further, it is also possible for the organiser or promoter of the gaming event to quickly contact the winner once a winning number has been revealed by the lottery engine.

Integrity of the Winning Result:

It is also an advantage of the preferred embodiments of this invention that the final winning numbers of the gaming event's, in fact all placements in the gaming event from first to last, arise from the interaction of the participants themselves and are a consequence of the participants' own choices of the numbers selected by them when entering the event. Of course a large number of participants will for convenience reasons elect to have their numbers randomly generated, but this is the choice given to a participant and is a process that can be of the highest integrity with the random number generator subject to checking by the licensing bodies. This is an advantage because the final winning numbers, and, in fact all placements, are not externally arrived at by a selection process that could be the subject of fraud or interference or built in bias—e.g. the subsequent selection of numbered balls in LOTTO “after the ticket sales have closed”, which decide the winner, BUT where one or more balls, or any other subsequent selection process, may be tampered with. The integrity of the winning results of this invention can be seen by reference to the processes set out in FIGS. 1, 4 and 11. These processes provide that the ticket entries, the chosen numbers relevant to those entries, and the resulting computer storing and subsequent processing of them after closure of entries into the game can be established to enable an audit trail of the highest standards of all entries, all chosen numbers and the subsequent processing of all results. This independent audit process can be done immediately after each game or even years later. We believe this will significantly reduce, if not eliminate entirely, the chance of fraud affecting the winning result.

Advantages of the Transaction Engine:

The transaction engine operates as a data storage device of the relevant game's raw data only, and has locking features where the participants' number choices cannot be accessed. During the time period when entries are being accepted into the game, the transaction engine only allows the gaming operator to know limited information such as how many entries have been made, the entry fees paid, and where those entries are from. This feature is an advantage as it further enhances the integrity of the game and the winning results.

Advantages of Gaming Engine:

In addition the gaming engine itself can be rendered substantially tamperproof, as participants will not be able to gain direct access to the gaming engine, as their entries will be received by an interface device (i.e. the transaction engine) which once having accepted the entry will then terminate the call (or contact) with the participant, and only AFTER the entries into the game have closed, then does the interface device (or transaction engine) forward the participant's entry, ID and other data to the gaming engine for processing. By this means the outcome of the game will be truly operator independent and thus risk of interference, or bias on the part of the operator can be minimised if not completely removed, making the gaming engine free of bias or distortion that might otherwise be introduced by one or more of the operators of the system.

Advantages of involvement of Independent Auditing Party:

Further, as set out in FIG. 2, the preferred embodiments of this invention involve the use of an independent party that can simultaneously and independently receive raw gaming data and, following the closure of the relevant game, check and verify the integrity of the winning results as determined by the gaming operator using duplicate gaming software. This involvement of an independent party is only able to be implemented as a consequence of the elimination and ranking system as set out herein and as exampled in FIG. 4 (a-k) and FIG. 11 (a-i). We believe this process involving an independent party independently being able to run its own processes and duplicating the game results outside of the activities or influence of the gaming operator by the methods described, is unique to this invention. For comparison, and using a LOTTO draw as an example, an independent party could not set up a duplicate LOTTO ball jumbler in its premises and conduct a simultaneous draw that results in the same winning numbers being drawn in order as that of the LOTTO operator when conducting its draw. This ability to involve an independent auditing party in the manner described is of significant advantage and it enhances the integrity of the results of games using our invention. On the basis that the independent party itself operates at all times as independent, then we believe the involvement of an independent party as we have described will further reduce the risk of fraud affecting the winning result to a negligible level, if not eliminate the risk of fraud entirely.

All Selected Numbers of Participant's can be Ranked:

An advantage of the invention, as can be seen from all the examples above, is that each number picked by each participant (in this case each of the 10 numbers when considering Examples 1 and 2, and each of the 6 numbers when considering Examples 3 to 10) are ascribed a ranking value, which is then used in determining the performance of each participant against all the participants in the gaming event. Participants are able to see and review the results of their own choices, against the choices of all others.

All n Numbers can be Ranked:

An advantage of the invention, as can be seen from all the examples above, is that each number in the selected number range, from one to n, ends up with a placement or ranking value e.g. as can be seen in Example 1 at 1.3 and 1.4; Example 2 at 2.3 and 2.4; Example 3 at 3.2; Example 4 at 4.2; Example 5 at 5.2; Example 6 at 6.3; and Example 10 at 10.2. Of particular advantage when used in gaming events similar to those as set out in Examples 3 to 10, where participants select one or more symbols or numbers from a defined range of symbols or numbers, for example between one and n, where n=30, or where n is another ‘smallish’ number such as between 10 to 100, is that each n number in the defined number range can end up with a unique placement or ranking value, as set out in Examples 3.3, 4.3, 5.3, 10.3 and FIGS. 3 and 8, and as also set out and its use demonstrated in FIGS. 4 and 11.

Gaming System Guarantees a Winner:

A further advantage of the invention, when the gaming system is used as set out in all the examples, is that the gaming system can undertake eliminations and at relevant stages, separate participants that are tied. It does this by utilising one or more of the symbols or numbers chosen by the participants, which are ranked in accordance with the ranking system of the n symbols or n numbers. Further, each of the participant's performances can be ranked against each other, resulting in the invention being able to always determine a winner of the first prize, or winners that share first prize, for each gaming event using the system. LOTTO can't guarantee a first division winner, whether that be a single first division winner or two or more winners that share the first prize. Our gaming system can, and it can do so irrespective of the number choices made by the participants in the gaming event. The only circumstances where the gaming system of this invention cannot determine a single winner of the first prize is where the winning chosen ‘r’ numbers (as defined in FIG. 7) have been identically chosen by two or more participants, who then share the first prize, although they could be separated by other means such as time of entry.

Gaming System Identifies All Places in a Gaming Event:

A further advantage of the invention is that the gaming system can be used in determining the performance of each participant in the gaming event, from 1^{st} place down to last place, which gives great flexibility to gaming operators as described in the examples above. The only circumstances where the gaming system of this invention cannot separate the performance or placements of all the participants is where there are situations where there are two or more participants that have identically chosen their ‘r’ numbers (as defined in FIG. 7) who then share the relevant placement, for example there could be two participants tied on 99^{th} place, although they could be separated by other means such as the time of entry.

Gaming System can be Structured to be Significantly Certain that a Single Winner Will Always Occur:

In contrast to LOTTO type games, games using this invention guarantee a winner and the greater the odds against winning, then the greater the odds of there being just a single winner. This is the opposite to a game like LOTTO. FIG. 7a and FIG. 7c sets out the odds of picking ‘r’ numbers in order (FIG. 7a) or in any order (FIG. 7b). Referring to FIG. 7a: The odds of correctly picking in order six ‘r’ numbers from a range of 1-20 n numbers that become ranked 1^{st} to 6^{th} in the ranking list of the n numbers as we have described herein—are odds of 1 in 27,907,200. But despite these odds, the gaming system of this invention always guarantees a winner or winners. The chances against there being two or more winners that correctly pick the first six ranked n numbers in any game using our invention can be further extended so that it becomes significantly certain that there will always be only a single winner of the first prize. For example, the odds can be extended by increasing the number of ‘r’ numbers that are required to be picked. For example if the ‘r’ numbers were changed from picking 6 r numbers to now picking 7 r numbers and the range of n numbers from which to pick remained constant at 20, then the odds would increase from 1 in 27,900,200 to 1 in 390,700,800—but this would have no effect on the ability of games using our invention to select a winner. In summary, increasing the odds as we have described makes it significantly certain that there is always only a single winner. This is another commercial advantage of our invention. This process is further explained in Example 11.

Gaming System can Accelerate Outcome:

An advantage of the invention when used as set out in Examples 1 and 2, where participants select one or more numbers from a defined range of numbers, for example between one and n, where n=100,000, or where n is another large number such as 1,000,000, is that the gaming system allows for the acceleration, by one or more steps, of the game down to a winner. This allows a gaming event that uses a large n number to be run on a regular basis, to set times. This advantage also applies to Examples 3 to 10.

Gaming System can be used in a Two Phase Game—TV Show:

A further advantage is that the gaming system can be used in a two phase game as described in Examples 1 and 3. Further, the gaming system used in a two phase game also allows in the second phase for the creation of a TV Game Show around a predetermined number of remaining participants, which can allow the gaming event to create a second phase TV Game Show with excitement and suspense, during which the final winner is then determined.

Gaming System can be Used in a Series of Phase One Games Leading to a Super Draw Game in Phase Two:

A further advantage is that the gaming system can be used in a game comprising at least two phases as described in Examples 4, 5 and 10—involving a Super Draw. The first phase can involve one or more games from which selected entries obtain entry into the second phase of the game, which can be described as a Super Draw. The preferred method is that the only way an entry can be obtained into the Super Draw is by successfully becoming one of the selected entries from a phase one game. Preferably the selected entries comprise a small number of entries from the first phase such as 5% to 10% of the entries in each phase one game. The advantages for participants' in a game involving this method of use of the invention is that those participants that obtain entry into the Super Draw have great odds of winning substantial prizes. This is because there would be only a small number of all participants playing in Super Draw for the ‘Super Draw Prizes’. Also the gaming system described herein can guarantee for those small number of participants, a winner or winners of the Super Draw prizes.

Gaming System can be used in a series of phase one games leading to a Super Draw game in phase two allowing for the offer of a ‘substantial additional prize’: A further advantage of the invention is that the invention includes the ability for the gaming operator to offer, at a relatively affordable cost to the participants and to the gaming operator, a ‘substantial additional prize’ in Super Draw that ‘may’ be won, in addition to the prizes on offer in Super Draw that the gaming system guarantees ‘will’ be won as described hereinbefore.

Gaming System can be Used in Virtual Racing Games:

A further advantage of the invention, which arises from each of the n numbers being ascribed a unique ranking value or placement, is that the gaming system can be used in virtual racing games—an example of which is the Virtual Horse Race involving 20 horses as set out in Example 5.

Gaming System can be used in Virtual Sporting or Competition Events:

A further advantage of the invention, which also arises from each of the n numbers being ascribed a unique ranking value or placement, is that the gaming system can be used in virtual sporting or competition events—an example of which is the Virtual Cricket Game as set out in Example 7, or the applications of the gaming system in respect of Baseball, American Football, Golf, race events and others as identified in Example 8.

Advantages for use in a Regional or Worldwide Lottery over LOTTO:

The lottery system of this invention has an advantage when used for example in a regional or worldwide lottery compared with the standard ‘LOTTO’ type lotteries. This advantage is that each of the numbers in a selected range of numbers, from one to n, which are available to be chosen by participants in a regional or worldwide lottery, according to this lottery system, will have a unique ranking or a unique placement value which can be used to rank the performance of all participants in the regional or worldwide lottery, or which can be used to rank the performance of only those participants from a certain class, such as a Country, or even to rank the worst performance/s, including last place. A further advantage of the invention when used in a regional or worldwide lottery is the ability to use an independent party to independently and simultaneously receive a copy of the raw data and, following the closure of entries, to then independently verify the winning results as determined by the gaming operator of games using this invention.

Great Flexibility:

This advantage of the lottery system of this invention is of use because it allows the regional or worldwide lottery to identify regional winners or country winners or class winners as well as the overall winners of the regional or worldwide lottery. This provides great flexibility to lottery operators. Once each n number in the standard ‘LOTTO’ type lottery has obtained a ranking or a placement value, then similar methods as described above could be adopted to rank the performance of all participants in such a lottery, thereby, like the invention using a lottery system herein described, a local country winner determined from within the results of the regional or worldwide lottery can be determined, or even the worst result can be identified. This enables each lottery operator participating in a regional or worldwide lottery to make individual decisions on the level of prize payouts to their players by allowing for a local country prize for their citizens, as described earlier in Example 6 above.

Adaptation for Standard LOTTO:

Furthermore, this invention can be adapted for a standard ‘LOTTO’ type lottery that may be sold by a lottery operator, or that may be cross sold as a regional or worldwide lottery so that each of the numbers from the range of selected numbers, from one to n, that are available for choosing by participants, can obtain a unique ranking or placement value which could be used to rank the performance of all participants in such a lottery. For example, this could be done by drawing all the n numbers that were available to be chosen and ascribing them an order of draw number, or alternatively computer recording the number of times each number was chosen by all the participants in the lottery, and using the resulting data to rank each number as previously described in Example 6.8.

Advantages in Presenting Results:

Furthermore the use of ranking or placement values of the n numbers in determining the winner can simplify the presentation of results to participants, including in any regional or worldwide lottery. For example, the data in Example 3.2, Table 5, could be made available for participants' review, or adapted as may be necessary for publication. Further, it can enhance the participants' views on the integrity of the result, as the results are a consequence of the interaction of the participants' own choices and are a computer derived and analyzed result which by its very nature will (or can) be subject to audit and checking, which reduces the chance for fraud.

1-21. (canceled)

22. A computer system for recording entries and determining one or more winners of a lottery or a lottery game, in which participants are invited to select at least one symbol from a defined available range of symbols, between one and n, to register their selection with the computer system, the computer system being capable of recording at least the symbol or symbols selected in or on entries and the originating lottery organization, country or area for each entry, and optionally the identity or contact details of the participant and the date and time of the entry, including how many times each symbol in the available symbol range was selected in or on each of the entries in the game and to provide a ranking list of the number of times each symbol was selected, the ranking of each symbol in the ranking list being determined by the number of times each symbol is selected in or on entries, and wherein the lottery has at least two phases, the first phase running until a defined time has expired whereupon at least one of the n symbols is selected, the selection being made by selecting at least one of the symbols in the ranking list based on selection criteria pre-determined by reference to the rankings of the symbols in the ranking list, to provide a number of entries, at least some of whom have selected one of the n symbols selected, and moving the selected entries to a second phase of the lottery, which second phase comprises an elimination process to determine one or more winners from those entries that were selected to move from the first phase to the second phase, the winner or winners in the second phase being the final entry or entries at the end of a pre-determined elimination process, and optionally where the computer system can also record one or more winners from each originating lottery organization, country or area in the first phase and/or second phase.

23. A computer system for recording entries and determining one or more winners of a lottery or a lottery game in which participants are invited to select two or more symbols from a defined available range of symbols from one to n, and to register their selection with the computer system, the computer system being capable of recording at least the symbols selected in or on each entry, including how many times each symbol in the available symbol range from one to n was selected in or on each of the entries in the game, to provide a ranking list of the number of times each symbol in the range of one to n was selected, the ranking being determined either by the number of times each symbol was selected in or on entries, with the order of ranking of each symbol in the ranking list from first to n being determined by firstly, that symbol that is least chosen being ranked first, secondly, that symbol that is second least chosen is ranked second and subsequently continuing the order of ranking in like manner, or alternatively that symbol that is most chosen is ranked first, that symbol that is second most chosen is ranked second and subsequently continuing the order of ranking in like manner, and recording the originating lottery organization, country or area for each participant or entry, and optionally the computer system being capable of recording the identity or contact details of the participant and the date and time and place of the entry, and wherein the regional or worldwide lottery has only a single phase, the single phase running until a defined time has expired whereupon a winning sole entry or entries is or are selected for the regional or worldwide lottery and where the computer system can also record a winning sole entry or entries from each originating lottery organization, country or area, the relevant winner or winners of the game being determined by comparing the symbol or symbols in or on all or some of the entries of all or at least some of the participants in the game against the ranking of the symbols as set out in the ranking list to make the desired eliminations, by comparing one or more of the symbols chosen in or on each entry against the ranking list of the symbols.

24. A computer system as claimed in claim 23 wherein the step of comparing one or more of the symbols chosen in or on each entry against the ranking list of the symbols comprises the step of progressively eliminating those relevant entries that have a relevant symbol or symbols ranked lower, or alternatively higher, on the ranking list than the symbol or symbols in or on other entries until a winner or winners is or are found.

25. A computer system as claimed in claim 22 wherein the computer system includes one or more transaction engines able to log the entry and store the raw gaming data during the time the game is open to receiving entries, and a gaming engine, which receives the raw data from the transaction engine(s) after entry into the game is closed, and which then processes the raw data using the gaming software and determines the results of the game, including the winner/s.

26. A computer system as claimed in claim 25 wherein the transaction engine(s) includes at least one database with each record having fields containing (a) customer information, typically a telephone number or credit card number or email address, (b) the number or numbers chosen by the customer, (c) a receipt number or PIN disclosed to the customer as proof of that entry, and the lottery organisation, country or area through or in which the participant purchased the entry.

27. A computer system as claimed in claim 26 wherein the gaming engine accesses at least one database.

28. A computer system as claimed in claim 27 wherein the gaming engine can receive and record the information from the transaction engine(s) and in which the gaming engine's function results in n records with at least two fields per record comprising:
a first field containing a number within the range of n numbers, so that the records can be sequential through the entire range of n numbers for that competition;
a second numerical field capable of recording a placement value or ranking value for each n number;
and optionally two further fields comprising:
a third field that records the ranking of each number within the defined range of n numbers calculated by reference to the fore mentioned second numerical field, including as relevant any numbers within the range of n numbers that are tied with other n numbers;
a fourth field that can, if necessary, record a unique ranking for each number within the defined range of n numbers, with any ties eliminated or resolved by reference to the ranking value or the selection total number as recorded in the second numerical field, in order that each of the numbers in the defined range of n numbers has its own unique ranking number within the range of the n numbers.

29. A computer system as claimed in claim 28, wherein the second numerical field is capable of recording a placement value or a ranking value for each n number by recording a placement value for each n number if randomly drawn through the full range of n numbers.

30. A computer system as claimed in claim 28, wherein the second numerical field is capable of recording a placement value or a ranking value for each n number by recording the number of “hits” or number of times each number from the defined range of n numbers has been selected by participants in the game, in order that a selection total can be recorded for each of the n numbers.

31. A computer system as claimed in claim 25 wherein databases of the transaction engine and lottery engine can be combined into a single database and operated within a single computer.

32. A computer system as claimed in claim 22 wherein the participant is allowed to enter their own number/s by remote data entry such as by entering it on a telephone key pad, by sending an SMS message, or email message containing the number/s they have chosen.

33. A computer system as claimed in claim 22 wherein the participant can allow the system to chose one or more symbols at random, so that the participant could for example elect for the computer system to select one or more of the symbols for the participant, in which case the computer system would select one or more numbers at random and enter them into the competition for the participant.

34. A computer system as claimed in claim 25, where the transaction engine(s) and the gaming engine are duplicated and with the duplication independently controlled by an independent party in order for that party to be able to simultaneously or first receive the raw gaming data into the independent party's separate transaction engine(s), to hold that raw data in its transaction engine(s) until entries into the game are closed, to then pass that raw data from its transaction engine(s) to its gaming engine, to independently process the raw data using the independent party's copy of the gaming software stored on its gaming engine, to independently determine the results of the game, including the winner/s, and to produce an independent audit report of its results compared with those of a gaming operator.

35. A computer system as claimed in claim 22 wherein the elimination process or processes operating in the second phase requires participants to select further symbols from a defined available range, with participants avoiding elimination by selecting a symbol which has been selected the least or alternatively, selected the most by all the relevant participants at that relevant elimination step operative in the second phase.

36. A computer system as claimed in claim 22 wherein in selecting entries for the second phase, symbols not selected in or on any entry are given a ranking after symbols which have been selected.

37. A computer system as claimed in claim 22 wherein symbols not selected in or on any entry belong to a house that operates the lottery.

38. A computer system as claimed in claim 22 wherein symbols not selected in or on any entry are given a ranking of the most selected symbol.

39. A computer system as claimed in claim 36 wherein at least the second phase of the elimination process has secondary procedures usable if a preceding elimination procedure operating in the second phase of the lottery fails to select a single winner.

40. A computer system as claimed in claim 22 wherein the symbol or symbols are a number or numbers.

41. A computer system as claimed in claim 22 having a transaction engine separate from a gaming or lottery engine, the transaction engine only passing registered entries to the gaming or lottery engine after entries into the relevant game are closed.

42. A ranking system in a form of a ranking engine for a computerised lottery, the ranking engine comprising one or more computers for recording entries, which entries include at least one symbol selected from a set containing n symbols, the computer or computers being capable of:
recording the symbol or symbols selected in or on each entry and optionally recording at least the identity or contact details, or place or point of entry, associated with each entry;
recording, the number of times each symbol from the set of n symbols has been selected;
ranking each symbol from the set of n symbols from lowest to highest based on the number of times each symbol has been selected in or on the entries;
determining the result of the lottery by comparing one or more of the symbols associated with each entry against the ranking of at least some of the n symbols.

43. A ranking system as claimed in claim 42, wherein the ranking of each symbol takes place following closure of entries into the lottery.

44. A computer system which makes use of the ranking system as claimed in claim 42.

45. A computer system as claimed in claim 44, wherein the expected number of entries is high enough that the probability that each member of the set of n symbols will be chosen at least once is substantially certain.

46. A computer system as claimed in claim 45 wherein the lottery has a pre-defined close off time and/or date and the number of entries A is at least 10 times greater than the number of symbols n.

47. A computer system as claimed in claim 46, wherein the number of entries A is between 10 times and 500,000 times the number of symbols n.

48. A computer system as claimed in claim 47, wherein each entry comprises r different symbols selected from the set of n symbols.

49. A computer system as claimed in claim 48, wherein r is a number between 4 and 10.

50. A computer system as claimed in claim 49, wherein r is 6.

51. A computer system as claimed in claim 48, wherein there are two or more sets containing symbols n1, n2 . . . nN and each entry comprises a selection at least one symbol from each set of symbols.

52. A computer system as claimed in claim 44, wherein the ranking engine contains additional rules to eliminate ties between symbols.

53. A computer system as claimed in claim 44, wherein each set of symbols comprises a set of symbols from 2 to 100, with each symbol identified by numerals, or that are numerals.

54. A computer system as claimed in claim 53, wherein each set of symbols comprises a set of symbols from 2 to 40, with each symbol identified by numerals, or that are numerals.

55. A computer system as claimed in claim 53 where there are two sets of symbols, with the first set comprising a set of symbols from 2 to 10 in number, and the second set comprising a set of symbols from 15 to 40 in number, with each symbol in each set identified by numerals, or that are numerals.

56. A computer program for conducting a computerised lottery, the computer program being stored on a computer useable medium, the computer program allowing the recording of entries and ranking entries which select at least one symbol from a set containing n symbols, the computer program being capable of:
recording the symbol or symbols selected in or on each entry and optionally recording at least the identity or contact details, or place or point of entry, associated with each entry;
recording, the number of times each symbol from the set of n symbols has been selected;
ranking each symbol from the set of n symbols from lowest to highest based on the number of times each symbol has been selected in or on the entries;
determining the result of the lottery by comparing one or more of the symbols associated with each entry against the ranking of at least some of the n symbols.

57. A computer program for conducting a lottery as claimed in claim 56, wherein the program is adapted to record the entry point to the lottery through or in which the participant purchased the entry and to record other information chosen from the group comprising (a) an identity of a lottery organization, (b) a lottery sub-type, and (c) a country or area; to enable the program to select a winning entry for each of those entry points to the lottery.
